(19) United States
(12) Patent Application Publication
(10) Pub. No.: US 2022/0042497 A1
(43) Pub. Date: Feb. 10, 2022

(54) ENHANCED LOW TEMPERATURE DIFFERENCE-POWERED DEVICES, SYSTEMS, AND METHODS

(71) Applicant: NAVITA ENERGY, INC., Melville (CA)

(72) Inventor: John Warren, Melville (CA)

(21) Appl. No.: 17/408,368

(22) Filed: Aug. 20, 2021

Related U.S. Application Data
(63) Continuation-in-part of application No. 16/985,192, filed on Aug. 4, 2020, now Pat. No. 11,125,183.

(51) Int. Cl. F03G 7/06

(52) U.S. Cl. CPC F03G 7/06

(57) ABSTRACT

The invention described herein provides new devices suitable for effectively converting temperature differences, including relatively low temperature differences, into useful work (e.g., for generating electrical power), related systems, and methods of using and developing such devices/systems. The devices are characterized in, inter alia, comprising an at least partially enclosed moveable component (e.g., a piston), an enclosed/isolated pressurized gas, and an enclosed temperature modifying liquid or energy transfer fluid system having portions which obtain temperature characteristics from two sources, which portions are alternatingly dispensed (e.g., as droplets by improved dispensation components) into the pressurized gas, or which operate as a liquid displacer of pressurized gas, in either case creating a pressure on the movable component, causing the moveable component to move back and forth along a stroke distance, and which, in aspects, is opposed by a counter pressure system, such as a vacuum counter pressure system. Other and related devices, systems, and methods also are provided.

### CROSS REFERENCE TO RELATED APPLICATION

This patent application is a continuation-in-part of and claims priority to co-pending and presently allowed U.S. patent application Ser. No. 16/985,192, filed Aug. 4, 2020, entitled “Effective Low Temperature Differential Powered Engines, Systems, and Methods.” This application claims the benefit of priority to, and incorporates by reference the entirety of, this above-referenced priority application.

### FIELD OF THE INVENTION

The invention described here relates to heat engines capable of converting relatively small temperature differentials into useful work, systems comprising such devices, and further related methods of using such devices and systems to produce useful amounts of work.

### BACKGROUND OF THE INVENTION

The need to develop systems to transform energy into work has driven the invention of systems for creating energy since at least the dawn of the Industrial Revolution. Attempts to harness steam for practical work purposes were first made in the early 17^{th} century. Technology utilizing gas under pressure in the form of steam was introduced throughout the late 1700s and continued to be developed and improved into the 19^{th} century, at which time steam locomotion became a commercial success. Steam engines were largely replaced by internal-combustion engines in the early 20^{th} century. However, both steam and internal combustion systems that are capable of meaningful work, such as in transportation, often also require significant inputs of fuel, typically fossil fuels, which are often limited resources and can lead to pollution and disruption of environmental systems, as well as significant costs in terms of extraction, delivery, and the like.

Around the time the steam engine first gained commercial success, another type of “hot air engine” was conceived, which ultimately led to the development of the Stirling Engine (first patented in 1816). Stirling Engines also use temperature and pressure to generate work, however via a mechanism comprising two pistons and a cyclic compression and expansion of a gas, often called a working fluid. As opposed to steam engines, Stirling Engines maintain the working fluid in a gaseous state within a closed circuit but can perform work with very little input of external energy. Despite efforts over the years to improve on this technology, Stirling Engine technology remains primarily only used for specialized applications, as a secondary or alternative power source, or for applications outside of performing meaningful work (e.g., as novelty devices), as practical constraints such as size limit the establishment of systems using such technology to produce sufficient work to meet high-energy demands.

Given the issues associated with fossil fuels, interest in alternative energy sources having a lower environmental impact has led to numerous efforts to develop efficient, sustainable, non-carbon-based work-producing systems, such as power generators. An increasing amount of energy today is generated through solar, hydrothermal, geothermal, and wind-powered systems. However, each of these systems has limitations that have prevented such alternative systems from completely replacing fossil fuels, and many of these systems still require significant energy inputs for successful operation.

In recent years there also have been several reported attempts to conceive and, in some cases, actually develop, systems that can generate work from temperature differences for applications such as power generation. U.S. patent application Ser. No. 16/985,192 (“US'192”), filed Aug. 4, 2020, lists several examples of such proposed technologies. None of these prior art systems appears to provide a credible workable solution for sustainably and reliably taking low temperature differentials and converting such differentials into significant power generation.

US'192 discloses my prior inventions in this field, which include devices, systems, and associated methods of use, to generate significant usable energy utilizing a fluid at first and second temperatures, dispensed in alternating fashion into pressurized gas, the expansion and contraction of the gas causing movement of a movable component, and the movement of the movable component then being used to generate power. The devices and systems of US'192 are closed systems, whereby little energy is required to expose the gas to the pressure-changing fluid. The inventive methods/systems described in US'192 disclose use of a second volume of pressurized gas as a counter force for the alternating movement of the movable component. US'192 provides for efficient, low temperature differential energy production devices and systems.

### Construction, Definitions & Abbreviations

The following principles apply to the disclosure provided here unless contradicted by express statement, context, or plausibility.

“Uncontradicted” means not contradicted explicitly, clearly by context, or by inoperability/impossibility.

Terms e.g., “here” and “herein” means “in this disclosure.” The abbreviation “TD” similarly means “this disclosure.” Uncontradicted, any part if this disclosure is applicable to any other suitable part of TD.

The invention has several different, but related aspects. Uncontradicted, the term “aspects” refers to “aspects of this invention” (“AOTI” or simply “aspects”). The invention encompasses all aspects, as described individually and as can be arrived at by any combination of such individual aspects.

The primary intended audience for this disclosure (“readers”) are persons having ordinary skill in the art in the practice of the technologies discussed herein (“skilled persons”). Technological aspects of elements/steps provided here are sometimes omitted in view of the knowledge of readers. The terms “technology” and “art” here refer to the knowledge of or readily available to such skilled persons. In cases, citation of reference(s) adaptable to or otherwise related to aspects are included here. All such patent documents and other cited publications, including those in the Background, are hereby incorporated by reference to the same extent as if each reference were individually and specifically indicated to be incorporated by reference and were set forth in its entirety herein. Content of such references can be combinable with this disclosure; however, incorporation of patent documents is limited to the technical disclosure thereof and does not reflect on validity, patentability, or enforceability thereof. Moreover, in the event of any conflict between TD and the teachings of such documents, the content of this disclosure will control regarding properly understanding aspects of the invention. Readers will understand that some features of cited art are not applicable to all aspects of the invention.

Heading(s) and subheadings are included for convenience. In general, heading(s) do not limit the scope of any aspect. Uncontradicted, aspects described under one heading can apply to other aspect in TD.

The inclusion of “(s)” after an element (a step, component, feature, or the like) indicates that greater than one (≥1) of such an element can be present, performed, etc. E.g., “an element (or system) comprising component(s)” means an element (or system) including 1 component and an element comprising 2 or more components, each part of the statement being separate aspects and collectively representing a higher level (genus) aspect.

Uncontradicted, “a,” “an,” “the,” and similar referents indicate both the singular and the plural form of any associated element. Uncontradicted, terms presented in the singular implicitly convey the plural and vice versa here (e.g., a passage referring to use of an “element” implicitly discloses use of corresponding “elements,” and vice versa). Uncontradicted, “also” means “also or alternatively” (sometimes also abbreviated “AOA”). Terms like “combination,” “a combination,” or “and combinations,” regarding listed elements mean “a combination of any or all of such elements.” The abbreviation “CT” means “combination thereof,” and readers should interpret it similarly.

The term “i.a.” means “inter alia” or “among other things.” “AKA” means “also known as” (“also referred to as”). Uncontradicted, “elsewhere” means “elsewhere herein.”

Uncontradicted, the term “some” in respect of elements of a collection/group/class means “2 or more” of the collection/group and the term “some” regarding a part of a whole means “at least 5%” (i.e., ≥5%).

Ranges here concisely refer to values within the range within an order of magnitude of the smallest endpoint. E.g., readers should interpret “1-2” as implicitly disclosing each of 1.0, 1.1, 1.2, . . . and 2.0, “5-20” as implicitly disclosing each of 5, 5.1, 5.2, . . . , 6, 6.1, 6.2, . . . 19, 19.1, . . . , 19.9, and 20, and “10-20” is to be interpreted as implicitly providing support for each of 10, 11, 12, 13, . . . , 19, and 20. Uncontradicted, ranges here include end points, regardless of how the range is described (e.g., a range “between” 1 and 5 will include 1 and 5 in addition to 2, 2.1, . . . , 3, 3.1, . . . , 4, 4.1, . . . , and 4.9), regardless of the terminology used to describe the range. Uncontradicted, applying a modifier to 1 or 2 endpoints does not change the range's value (e.g., “about 10-20” means “about 10-about 20”).

Terms of approximation, e.g., “about” or “approximately” (or ˜) here refer to a range of closely related values, a value that is difficult/impossible to precisely measure, or both, and, thus, include the precise value as an aspect of the disclosure (e.g., “10” is an aspect of a disclosure of “about 10”). Similarly, readers should understand that precise values provided herein implicitly support approximately similar ranges unless contradicted. The scope of an approximate value depends on the value, context, and technology (e.g., criticality or operability, other evidence, statistical significance, or general understanding). In the absence of guidance here or in the art, terms of approximation e.g., “about” or “approximately” mean+/−10% of the indicated reference value(s).

Uncontradicted, each member of each list of elements reflects an independent aspect of the invention (often having distinct/nonobvious properties with respect to the other listed elements/aspects or features).

The conjunction “or” means “and/or” here unless contradicted (e.g., by association with a clarifying modifier e.g., “either” as in “either A or B”), regardless of any occasional use of “and/or.” A “/” symbol is sometimes used to indicate an “or” relationship between elements (e.g., “A/B” means “A or B”). Uncontradicted, a phrase e.g., “A, B, and/or C” or “A, B, and C” implicitly supports each of the following embodiments: A, B, and C; A, B, or C; A or C; A or B; B or C; A and C; A and B; B and C; A (alone); B (alone); and C (alone).

“Significant” and “significantly” means results/characteristics that are statistically significant using an appropriate test in the given context (e.g., p≤0.05/0.01). “Detectable” means measurably present/different using known tools. The acronyms “DoS” and “DOS” mean “detectable(ly) or significant(ly).”

Uncontradicted, terms e.g., “including” “containing,” and “having” mean “including, but not limited to,” “including, without limitation,” or “comprising.” “Comprising” means including any detectable amount of a feature or including any detectable performance of a step. An aspect described as “comprising” or “including” a step/element can include that step/feature alone or in combination with any other associated element.

Uncontradicted, terms such as “comprising” when used in reference to an element of/in a collection or composition also simultaneously provides implicit simultaneous disclosure of some of the element being present, the element making up most of the composition/collection, the element making up nearly all of the composition/collection (the composition/collection consisting essentially of the element), or the element making up all of the composition/collection or type of element in the composition/collection. Uncontradicted terms such as “comprising” and “including,” implicitly disclose corresponding aspects in which ≥1 or ≥2 of the referenced element is/are present or in which ≥1%, ≥5%, ≥10%, ≥25%, ≥33%, ≥50%, ≥65%, ≥75%, ≥90%, ≥95%, ≥99%, or 100% of the composition/collection being made up of the referenced element.

Uncontradicted, terms such as “comprising” when used in connection with a step of a method provides implicit support for (a) the method consisting essentially of the step or consisting of the step or (b) performing the step ≥2 times. Uncontradicted, terms such as “comprising” when used in connection with a step of a method and an outcome/effect provide implicit support for the step causing some, most, or all of the effect (e.g., ≥1%, ≥5%, ≥10%, ≥25%, ≥33%, ≥50%, ≥65%, ≥75%, ≥90%, ≥95%, ≥99%, or 100% of the effect).

Uncontradicted, the use of “comprising,” “including,” and the like with respect to an element in a collection or composition provides implicit support for the collection/composition comprising one of the element(s), some of the element, mostly being composed of the element, generally all of the collection/composition being made up of the element, and nearly all of the collection/composition being made up of the element. Terms like “generally all” or “generally” means ≥70% and “nearly all” (or “substantially all” or “substantially consists of”) means at least 95%. “Nearly entirely” means the same thing as “nearly all.” Uncontradicted, “essentially” means “consists essentially of,” which means consisting of the referenced element/step and any other elements/steps do not materially affect the basic and novel characteristics of the applicable aspect.

Uncontradicted, any aspect described with respect to element(s) provides implicit support for a corresponding aspect in which one, some, most, or even (if sensible) all such elements are lacking in any composition, collection, device, system, step, or method associated with the element(s). Changes to tense or presentation of terms (e.g., using “comprises predominately” in place of “predominately comprises”) do not modify the meaning of the related phrase unless indicated.

Uncontradicted, methods described here be performed in any suitable order. Uncontradicted, devices/systems can be assembled/generated in any suitable manner by any suitable method. Uncontradicted, any combination of elements, steps, components, or features of aspects and apparent variations thereof, are aspects of the invention.

Numerous examples of aspects/elements are provided in this disclosure to illuminate aspects. The breadth and scope of the invention should not be limited by any of the exemplary embodiments. E.g., the term “typical” should be understood as referring to embodiments/characteristics that are often present, but are, nonetheless, optional. No language in the specification should be construed as indicating any element is essential to the practice of the invention unless such a requirement is explicitly stated.

### Terms Specific to the Invention

Uncontradicted, a “device” in this disclosure means a “device of the invention,” a “method” means a “method of the invention,” and a “system” means “a system of the invention.” Devices of the invention can also be referred to as “heat engines.”

Uncontradicted, “operation” (or “device operation” or “regular operation”) used in regard to device(s) or system(s) means condition(s) where the difference in a first temperature (T1) to a second temperature (T2) is sufficient to cause at least one moveable component (“MC”) of a device to move at least 33% of its stroke length (in any direction), and typically ≥50% of its stroke length, without input of extraneous energy.

Uncontradicted, the term “stroke” refers to the movement of a movable component (MC) from one end of a stroke length (“SL”) to the other end of the SL. A “stroke cycle” is the movement of an MC from one end of the SL to the other and at least substantially back to the starting position. A “stroke period” is the time required to complete a stroke.

A “dispensation gap” is the time between the end of dispensation of a 1st temperature modulating liquid (“TML”) and beginning dispensation of a second TML. In aspects, the 1^{st} TML is at a first temperature and referred to as “T1L” (temperature 1 liquid) and the second TML is at a second temperature and referred to as “T2L.”

An “operation cycle” (or “operating cycle”) is a period during which MC(s) of a device complete ≥1 stroke cycle based mostly, generally, nearly entirely, or entirely on differences in a first temperature source/input (T1) and second temperature source/input (T2). An operating cycle typically comprises the steps of device initiation, device operation, inactivity, and re-initiation, wherein most, generally all, nearly all, or all of the energy of operation is provided by the difference in T1 and T2. An “operating cycle period” or “OCP” is a period comprising ≥2 operation cycles. In aspects, an OCP comprises ≥3, ≥10, ≥14, ≥50, ≥60, ≥100, ≥150, ≥200, ≥300, ≥500, ≥1000, 5000, or 10000 stroke cycles. In aspects, an OCP also or alternatively lasts a period of ˜1 week, ˜1 month, ˜3 months, ˜1 year, or longer. In aspects, device(s) operate under substantially identically conditions (e.g., in terms of average energy output, average stroke period, etc.) over any of such operating cycles/periods.

Phrases such as “useful work” herein mean performing work that is equivalent to at least about 1000 watts. In aspects, “useful work” means performing work equivalent to at least ˜1500 watts, ˜2000 watts, ˜2500 watts, ˜3000 watts, ˜4000 watts, or at least ˜5000 watts. In aspects, “useful work” means at least ˜1.2, ˜1.4, ˜1.6, ˜1.8, or ˜2 times such amounts, such as at least ˜3000 watts or at least ˜10,000 watts. Terms such as “useful work,” “significant work,” and “meaningful work” herein simultaneously and implicitly disclose each of these levels of work. Alternatively, corresponding measurements in Joules, Horsepower, and the like also can suitably be used to describe “useful work.”

Terms such as “mechanically linked (to)”, “mechanically tied (to)”, “mechanically connected (to)”, or “mechanically driven (by)” refer to the activity of one component physically affecting or effectuating the operation of another component by a physical mechanical relationship (e.g., component A causing component B to move), typically automatically upon the occurrence of an event or condition. Such terms do not include coordinated movement of separate parts by operation of a processor.

Uncontradicted, a “barrier” or “barrier component” is any component or collection of components that forms a barrier that is at least substantially impervious to loss of a pressurized gas (“PG”) and that forms a pressurized gas chamber (“PGC”). Examples of a “barrier” are, e.g., a collection of sidewalls, a cylindrical container/tube, and the like. Uncontradicted, the term “housing” refers to any suitable housing for containing other elements of a device or system. A housing or a barrier component can also form chamber(s), which can include other elements (e.g., a chamber that contains pressurized gas is called a “pressurized gas chamber” or “PGC”).

Terms such as “substantially closed” and “substantially impervious” means that no more than about 5%, e.g., no more than ˜3.5%, ˜3%, ˜2.5%, ˜2%, ˜1.5%, ˜1%, ˜0.5%, ˜0.25%, or no more than 0.1% of the volume of PG, TML, or both are lost or increased during operation. In aspects, device(s) remain substantially closed for numerous OCP(s) (e.g., ≥1, ≥˜3, ≥˜6, ≥˜12, ≥˜24, or ≥˜60 months).

The term “stored power” refers to power generated by the device which is not immediately applied/used by the device or converted by the device for use outside of the devices or systems described herein. Typically, “stored power” refers to power generated by a device, temporarily stored in the device (e.g., in a battery or other energy storage), and subsequently used in operation of the device, e.g., in operation of pump(s).

The terms “sides”, “ends”, or other similar terms may be used to refer to one or more parts of a component or device (such as, e.g., a movable component or a chamber). Such terms can be used to describe any “side” or “end” of such a component, such as a side, a top, a bottom, etc. Accordingly, such terms should not be considered limited to any particular orientation, position, etc., except where explicitly stated. A “side” then can mean any part of a component, device, etc., that is distinct from other referenced/described part(s), that typically are either not touching the referenced “side” or are adjacent to the referenced “side” but oriented in a different plane/orientation from the referenced “side” (e.g., by being perpendicular to the side). Thus, uncontradicted, a term such as “side” should be understood as implicitly supporting the referenced element being a top, a bottom, a sidewall/end, or the like. A “side” does not have to have a specific shape. However, each reference to a side, end, and the like, is to be interpreted as implicitly providing support for each other type of possible parts/components (e.g., top, bottom, sidewalls, etc.), each of which being a separate aspect.

The following table lists acronyms that are frequently used in this disclosure and provides a description of the meanings/scope thereof:

TABLE 1
Acronyms

| Acronym | Term | Brief Description |
|---|---|---|
| BI | Barrier interior | The interior side(s)/part(s) of a barrier component |
| CS | Contact surface | A surface of a PGC-MC that encounters TML-induced |
| | | temperature-modulated gas when the device is in operation. |
| DC | Dispensing/ | A device, component, or system that dispenses TMF into a |
| | dispensation | PGC of a heat engine. A DC can comprise, e.g., a conduit |
| | component | and one or more dispensing/dispensation outlets. In aspects, |
| | | a DC can comprise multiple conduits, multiple outlets, or |
| | | both. |
| DCU | Data collection unit | A component of an electronic control unit (ECU) that |
| | | receives data from one or more sensors associated with a |
| | | device. |
| DDFP | Device design and | A processor used for designing a device according to user |
| | fabrication processor | inputs and design constraints and optionally causing the |
| | | fabrication of device component(s). |
| DLCS | Device liquid | A portion/part of a device that conducts TML, contacts T1L |
| | conducting system | and T2L, and which may contact T1S or T2S or be adapted |
| | | to engage an SLCS that contacts T1S or T2S. |
| ECU | Electronic control | A component of an operation control component (OCC), |
| | unit | often comprising or linked with a data collection unit (DCU), |
| | | a data relay, and processing units (PU(s)). |
| ELCS or | Extended liquid | A system/component that conducts TML. Typically, a 1st |
| SLCS | conducting system | portion of the ELCS is in contact with T1S, and a 2^{nd} portion |
| | or system liquid | is in contact with T2S, and comprises connection element(s) |
| | conducting system | capable of connecting the device to the ELCS to maintain a |
| | | closed TMS; the system may also be referred to as a system |
| | | liquid conducting system (SLCS). |
| EPCCU | Electronic | A unit responsible for receiving information signal(s) for one |
| | programmable | or more DCUs and storing data. |
| | complex control unit | |
| HDC | Heat decreasing | A chamber, separate from a PGC containing an MC, where a |
| | chamber | PG can be cooled. An HDC is a type of heat exchange |
| | | chamber (HEC). |
| HEC | Heat exchange | A chamber, separate from a PGC containing an MC, where a |
| | chamber | PG can be heated or cooled; an HEC can be a heat-increasing |
| | | chamber (HIC) or a heat-decreasing chamber (HDC). |
| HIC | Heat increasing | A chamber, separate from a PGC containing an MC, where a |
| | chamber | PG can be heated. An HIC is a type of heat exchange |
| | | chamber (HEC). |
| IVS | Internal void space | A portion of a PGC that is entirely free of solid structures in |
| | | operation. |
| LCC | Liquid capture | Component of device (e.g., feature of housing) where post- |
| | component | dispensation, accumulated TML collects for draining from |
| | | the housing. |
| LCS | Liquid conducting | A system for conducting TML flow through a device (DLCS) |
| | system | or system (SLCS). Can be an extended component of a |
| | | system (ELCS). An LCS can conduct TML comprising a 1st |
| | | portion (T1L) in contact with a 1st temperature input (T1S) & |
| | | a 2^{nd} portion (T2L) in contact with a second temperature |
| | | input (T2S). |
| MC | Moveable | A component of a device that moves a stroke length (SL) in |
| | component | response to a pressure differential within the device/system |
| | | caused by dispensing T1L and T2L into a PG. MCs include |
| | | VPCPS-MC(s) and PGC-MC(s). |
| MLMC(s) | Mechanically linked | Components of a device which are movable only by way of |
| | movable | mechanical linkage to a working MC (AKA PGC-MC). |
| | component(s) | |
| OCC | Operation control | A component of an automated system providing automated |
| | component | control of a device; commonly comprising an electronic |
| | | control unit (ECU). |
| PG | Pressurized gas | The pressurized gas that fills a PGC of the device in |
| | | operation. |
| PGC | Pressurized gas | A chamber of a device that contains PG and a PGC-MC. |
| | chamber | |
| PGC-MC | Pressurized gas | An MC that is positioned at least in part in a PGC. |
| | chamber-MC | |
| PM | Protruding member | An element of a movable component (MC) which, if present, |
| | | can protrude through a SLIPBO and be exposed to the |
| | | exterior of the housing. Sometimes referred to as a “pin”. |
| | | Can connect to MLMC(s) or serve as a safety mechanism. |
| PMS | Pressure modulating | A system of a device comprising components required to |
| | system | modulate the pressure of a PG of the device/system; |
| | | typically, at least a first container, an MC, a PG, and a TMS |
| | | or ability to communicate with (e.g., operate in conjunction |
| | | with) a TMS. |
| RFO and | Ready for operation | A state of a device or system wherein the device or system is |
| RFOS | (RFO) and RFO | operable/ready to be operated but is not in operation. |
| | state, respectively | |
| SL | Stroke length | The maximum distance traveled by an MC in operation of a |
| | | device. The SL is also often used synonymously here with |
| | | the entire “track,”“course,” or distance that an MC travels |
| | | when the device is in operation. A stroke length can refer to |
| | | the maximum distance traveled by an MC in operation of a |
| | | device in any direction. |
| SLIP | Stroke length | An inner portion of an SL which lacks detectable or |
| | interior portion | significant pressurized gas (PG). In aspects, a SLIP |
| | (interior portion of | comprises opening(s) in the barrier surrounding the SLIP |
| | an SL) | (e.g., one or more SLIPBOs). |
| SLIPBO(s) | SLIP barrier | An opening in part of a barrier surrounding a SLIP, through |
| | opening(s) | which, e.g., a PM may extend from the MC through the |
| | | barrier to the exterior of the housing without allowing DoS |
| | | pressurized gas (PG) to escape. Often exemplified as a “slit,” |
| | | “slot,” or “opening.” |
| SOOASF | Selectively operable | A safety feature of a device/system which automatically |
| | or automatic/ | modifies system function(s) (e.g., shuts down the |
| | automated safety | device/system) if an event occurs triggering preprogrammed |
| | feature | instructions. E.g., an automatable shut off valve/switch |
| | | operatively linked to sensor(s). |
| SOP | Selectively operable | A pump which may be controlled by manual or mechanical |
| | pump | means or also or alternatively automatically controlled, e.g., |
| | | by an operating system. |
| SS | Source switch | A component of a device that changes the input to dispensing |
| | | component(s) from T1S to T2S and from T2S to T1S. |
| | | Sometimes alternative called an “orientation switch” (“OS”). |
| T1; T1F; | Temperature 1 (T1); | T1 is 1 of 2 different temperatures that power the device. |
| T1L; T1G; | T1 liquid; T1 gas; | T1F is a portion of a TMF having a temperature modified by |
| and T1S | and T1 source | contact with a T1S; T1L is a liquid form of a T1F; T1G is PG |
| | | modified by contact with T1F (T1L); T1S is a source of a T1 |
| | | temperature, such as an environmental condition or heat |
| | | source. |
| T2, T2F; | Temperature 2 and | T2 is the 2nd of the 2 temperatures that power the device; |
| T2L, T2G, | temperature 2 liquid | T2F is a fluid, typically a portion of the TMF, having a |
| and T2S | | temperature modified by contact with T2S; T2L is a liquid |
| | | form of a T2F; T2G is PG modified by contact with T2F; and |
| | | T2S is a source of a T2 temperature, e.g., an environment at a |
| | | different temperature than T1S |
| T1ΔT2 | Difference in | The temperature difference that exists between a first |
| | temperature between | temperature (T1) and a second temperature (T2). |
| | T1 and T2 | |
| TMF | Temperature | A fluid that contacts T1S or T2S to generate T1F and T2F |
| | modulating fluid | and is dispensed into a PGC of a device to modulate gas |
| | | temperatures. May also be referred to as a heat transfer |
| | | medium. |
| TML | Temperature | A liquid in contact with T1S and T2S and that is dispensed |
| | modulating liquid | into a PGC of a device to modulate gas temperatures. May |
| | | also be referred to as a heat transfer medium. |
| TMS | Temperature | A system comprising TML in indirect contact with a T1S and |
| | modulating system | T2S and dispenser(s) (dispensing component(s)) and, i.a., |
| | | components for transporting and dispensing TML. |
| VAC | Visual aid | A window or equivalent component providing visual access |
| | component | to (viewing of) an interior space from the exterior of a |
| | | device/system. |
| VPCPS | Vacuum powered | Any system for providing a vacuum force providing a force |
| | counter pressure | opposite the force applied by the expanding or contracting |
| | system | PG on a PGC-MC. |
| VPCPS- | A VPCPS movable | A movable component within a vacuum-powered counter |
| MC | component | pressure system which moves upon movement of a PGC- |
| | | MC. |
| VPCPS- | VPCPS-MC | A component mechanically joining two or more VPCPS- |
| MC-UC | unifying component | MCs or otherwise linking movement of all VPCPS-MCs in a |
| | | device. |

### SUMMARY OF THE INVENTION

This disclosure describes new devices and systems that effectively transform temperature differences, even relatively low temperature differences, into useful work, and related methods. Included in this description are devices, systems, and methods that represent substantially different or improved characteristics with respect to the devices, systems, and methods described in US '192.

As with the devices of US '192, the devices of the invention described here can comprise a collection of “closed” components. In aspects, at least one such closed component of devices comprises a suitable fluid, such as a suitable gas, under relatively high pressure (each a “pressurized gas” or “PG”) contained in closed portion(s) of the device (each a “pressurized gas chamber” or “PGC”, and in certain embodiments, a heat exchange chamber (HEC)). By various methods described herein, the temperature of the PG in such a system is changed in operation of the device causing movement of a moveable component (e.g., a piston) in the pressurized gas chamber (a “PGC-MC”) and a counter-acting force, generated by other described method(s), causes the PGC-MC to return to its starting position (completing a stroke cycle).

In aspects, the invention provides devices wherein a liquid dispensation system alternately dispenses a first portion liquid and a second portion liquid in droplet form into a portion of a first container. In inventive aspects provided here, the invention provides devices comprising a dispensation system wherein the dispensation system alternately dispenses a first portion liquid and the second portion liquid in a form which is mostly, essentially, substantially entirely, or entirely not droplet form (e.g., is not provided as a mist or a spray), such as being provided in, e.g., stream form, into a portion of the first container.

In one aspect, devices described herein are modified/improved over the devices of US '192 in comprising a vacuum pressure counter pressure system (“VPCPS”), which contributes to the PGC-MC returning to its starting position. A VPCPS typically comprises one or more vacuum chambers, typically each comprising a VPCPS moveable component (VPCPS-MC) that is connected to or otherwise engaged with a pressurized gas chamber moveable component (PGC-MC), which corresponds to the type of moveable component (MC) described in US '192. The inclusion of a VPCPS can detectably or significantly (DoS) improve the performance of devices of the invention over the devices described in US '192.

In aspects, the invention provides devices for transforming/converting temperature differences into work comprising a primary pressure modulating system. In aspects, the primary pressure modulating system comprises a first container. In aspects, the primary pressure modulating system comprises a first movable component positioned in the first container. In aspects, the primary pressure modulating system comprises a pressurized fluid, such as a pressurized gas contained in the first container or that, in operation, is at least sometimes contained in the first container. In aspects, the primary pressure modulating system comprises a temperature modulating system. In aspects, the temperature modulating system comprises a fluid, such as a liquid, having a first portion and a second portion each having a different temperature. In aspects, such a liquid can be a temperature modulating liquid (TML) such as any TML described in US '192. In alternative aspects (described elsewhere), such a liquid can have characteristics which may be different from those described in US '192. In aspects, the temperature modulating system comprises a dispensation system that in operation alternately dispenses the first portion fluid/liquid/gas and second portion fluid/liquid/gas to create temperature differences in the first container that cause the movable component to repeatedly move back and forth across a stroke length.

In aspects, devices of the invention vacuum powered counter pressure system (VPCPS). In aspects, the VPCPS comprises a second container. In aspects, the second container comprises a second movable component. In aspects, movement of the second moveable component is operationally linked to the movement of the first movable component. In aspects, the vacuum powered counter pressure system comprises a vacuum (e.g., a vacuum-generating device/component or means for performing a vacuum function). Typically, in operation a vacuum component/device applies a vacuum to one side of the second movable component of a device/system. In aspects, alternating dispensation of the first portion liquid/fluid/gas and the second portion liquid/fluid/gas creates pressure differences in the first container which cause the first movable component to repeatedly move back and forth across the stroke length.

In specific aspects, the invention provides a device for transforming a temperature differential into work comprising (a) a movable component having a first side and a second side, wherein the first and second sides are at least substantially opposite each other and wherein the movable component is configured to move back-and-forth along a path having a stroke length when acted on by a sufficient force; (b) a pressurized fluid (a liquid, gas, or mixture thereof); and (c) a vacuum, wherein the first side of the movable component is in communication with the pressurized fluid and the second side of the movable component is in communication with the vacuum; (d) a first temperature source; and (e) a second temperature source, wherein the device is at least substantially closed with respect to the pressurized gas and the vacuum, and wherein, in operation (I) the alternating contact of the pressurized fluid to the first temperature source and the second temperature source results in the pressurized fluid causing the movable component to move in a first direction and at least substantially opposite second direction, respectively and (II) the first pressure, the second pressure, or both, are each detectably countered by the vacuum.

In specific aspects, the invention provides a method of converting a temperature differential into work comprising: (a) providing a device comprising (I) a pressurized fluid, (II) a movable component that moves in alternating directions along a stroke length in response to force applied on the movable component, (III) a vacuum, and (IV) first and second temperature sources (or direct/indirect access thereto), the first and second temperature sources having sufficiently different in temperature to create a pressure difference that can move the movable component. In initial operation of the device the movable component contacts the pressurized fluid and the pressurized fluid and the vacuum remain are at least substantially closed with respect to the outside environment (e.g., by being contained in a container of the device), (b) temporarily or at least temporarily causing the pressurized fluid and first temperature source to be in contact, directly or indirectly, to increase temperature in the pressurized fluid, thereby applying a force to move the moveable component in a first direction; (c) temporarily or at least temporarily contacting the pressurized fluid, directly or indirectly, with the second temperature source, to decrease temperature in the pressurized fluid, the second side of the movable component being oriented at least substantially opposite of the first side of the moveable component, thereby applying a force to move the movable component in the second direction; and (d) permitting or causing the vacuum to apply a force on the second side of the movable component, thereby detectably promoting movement of the movable component in the second direction. The “promotion” of movement in this respect means that movement occurs, the amount of movement occurs, the work generated, etc., is detectably greater due to the application/presence of the vacuum(s).

Additional variations/improvements over the aspects of US '192 systems/devices also are provided here. One example of such a refinement is new dispensation component design and configuration described herein. In aspects, the invention provides devices wherein the dispensation system comprises a plurality of dispensation components to dispense liquid into a single volume of the pressurized gas. In aspects, the invention provides dispensation components of such devices comprising a plurality of conduits, each dispensing a portion of liquid. In aspects, the invention provides dispensation components of such devices comprising one or more dispensation outlets oriented such that a minimum force is required to dispense liquid. In certain aspects, such dispensation outlets are configured concentrically within the first container. In certain aspects, one or more such dispensation outlets can dispense liquid in two opposing directions. In aspects, such dispensation in two opposing directions occurs simultaneously. In alternative aspects, device(s) can comprise a dispensation system comprising dispensation outlets which do not dispense liquid in droplet form. In aspects, a dispensation system can comprise one or more dispensation outlets which dispense a liquid primarily, essentially, substantially only, or entirely as a stream, as opposed to a mist. These terms are understood in the art. Typically, a “stream” of liquid is liquid refers to a composition in which molecules of a liquid are sufficiently densely packed such that the liquid has a detectable ability to flow and form a continuous run of liquid across a measurable distance of >20 mm, >50 mm, >100 mm, >250 mm, >0.5 cm, >1 cm, >10 cm, >20 cm, or >30 cm. This is in contrast to a “mist”, the term “mist” here meaning a microscopic suspension of mostly separated liquid droplets in a gas, such as the atmosphere, or, e.g., such as nitrogen.

In still another aspect, new/improved devices provided here are devices for transforming temperature differences into work comprising a primary pressure modulating system comprising use of a heat exchange material (HEM). In aspects, use of one or more HEMs provides an alternative to, or in aspect may detectably or significantly enhance the efficiency of operation of, devices provided here over those provided in US '192. In aspects, the invention comprises devices in which HEM(s) are used to modify the temperature of a pressurized gas (PG), which, in turn, causes movement of a movable component (MC). In aspects, devices provided by the invention can comprise a temperature modulating system comprising a heat exchange system (HES). In aspects, an HES can comprise heat exchange chamber(s) (HECs), e.g., a first (HEC1) and a second (HEC2) heat exchange chamber. In aspects, HECs can be separate from a primary container comprising a primary pressurized fluid/gas chamber containing the moveable component. In aspects, one HEC can be a heat increasing chamber (HIC), and another can be a heat decreasing chamber (HDC), wherein volume(s) of pressurized gas increase or decrease in temperature by exposure to the HEMs held therein, respectively. In aspects, the HIC, HDC, or both, comprise an efficient heat-exchanging material (HEM, e.g., HEM1 and HEM2), such as a material that efficiently transfers heat, has significant surface area, or both. An example of such a material comprises, primarily comprises, consist essentially of, or consists of a metal material (e.g., a copper or aluminum heat exchanger component) and in aspects such a heat exchanger comprises a material with a significant amount of surface area, such as a metal wool (e.g., a copper wool, tungsten wool, and the like), e.g., a steel wool material (e.g., a stainless steel wool or a regular/plain steel wool, either of which being classifiable as fine, coarse, or a mixture thereof), or a material with similar heat exchange attributes (in terms of temperature transfer over time, conductivity, surface area, etc.).

In aspects, such as those comprising HEM(s), a liquid (e.g., a TML) does not modulate the temperature of a pressurized gas as described in US '192 (e.g., by dispensation into a PG in droplet/mist form), but, rather, one or more liquid(s) are used to transfer heat or to act as a displacer for moving gas/fluid through a system/device. In aspects, a first heat exchange chamber (e.g., HEC1), a second heat exchange chamber (e.g., HEC2), or both HEC1 and HEC2 is/are configured to maintain both a pressurized gas and a liquid in alternating fashion. In aspects, an energy transfer liquid can comprise a first portion and a second portion. In aspects, a first portion of the energy transfer liquid can be accessible to both the primary chamber and a single HEC, e.g., a first heat exchange chamber (HEC1). In aspects, a second portion of the energy transfer liquid can be accessible to both the primary chamber and a different HEC, e.g., a second heat exchange chamber (HEC2). In aspects, temperatures of the first and second portions of energy transfer liquid establish the temperatures of the first and second heat exchange materials, respectively; during at least 75% of a single operating cycle effectively match the temperatures of the first and second heat exchange materials, respectively; or both. In aspects, the temperature of the heat exchange materials is (are) established by other mechanisms not related to the liquid directly, and as such the temperature of the liquid is not responsible for changing the temperature of the heat exchange materials. In aspects, a first heat exchange material and a second heat exchange material maintain a temperature differential of at least 1 degree Celsius during at least about 90% of a 24-hour period. In aspects, an energy transfer liquid from the HIC is delivered to the PGC, displacing PG, and displaced PG is allowed to flow out of the PGC to the HIC where the PG is heated by contact with the heat-exchanging material. In aspects, the PG is allowed to return to the PGC, causing movement of the PGC-MC in one direction (with the corresponding HDC cycle being performed to return the PGC-MC to its starting position by causing movement of the PGC-MC in the opposite direction). That is, in aspects, the alternating exposure of the PG to the first and second heat exchange materials alternatingly increases and decreases the temperature of the PG, and hence the pressure of the PG, such that a movable component of the primary pressure modulating system moves back and forth across a stroke length.

The invention also provides related systems, methods of energy production, and the like, which in aspects are like those similar/corresponding systems, methods, and the like, described in US '192. These and additional aspects of the invention are described, illustrated, and exemplified in further detail in the following sections of this disclosure.

### BRIEF DESCRIPTION OF THE DRAWINGS/FIGURES

FIG. 1 illustrates a configuration of a device/system described in the prior filed '192 application, comprising a single liquid conducting pump.

FIG. 2 illustrates another possible configuration of the device/system described in FIG. 1 and in the prior filed '192 application, comprising two liquid conducting pumps.

FIG. 3 illustrates one embodiment of a dispensing component, the dispensing component having multiple outlets for dispensing liquid.

FIGS. 4A-4D illustrate one embodiment of a dispensing component, and an exemplary dispensation pattern of such a dispensing component, of the device described herein.

FIGS. 5A-5D illustrate operating principles of devices provided by the invention and which aid in understanding vacuum embodiment of the device illustrated in FIG. 6.

FIGS. 6A and 6B illustrate an embodiment of a device comprising a vacuum-powered counter pressure system (VPCPS).

FIG. 7 illustrates another possible configuration of the device/systems comprising heat exchange component(s).

FIG. 8 is a flow chart illustrating a process for designing a power system of the present invention using a computer processor.

FIG. 9 is a flow chart illustrating one embodiment of the operation of the devices described herein using an electronic control system.

FIG. 10 is a flow chart illustrating one embodiment of the operation of a system comprising an associated powered device (e.g., a car waste heat system) and an electronic control processor.

FIG. 11 is a description of a series of inputs which can be provided to a device design and fabrication processor to arrive at an expected work/power output.

### DETAILED DESCRIPTION OF THE INVENTION

Disclosed here are devices, systems, and methods for the effective conversion of temperature differences to useful work, e.g., to mechanical energy, which in aspects are further converted to other types of energy, such as electricity.

Because devices are also elements of the systems and methods described herein, any aspect of the invention (“AOTI”) described in relation to devices can be applied to system and method aspects of the invention and vice versa. Uncontradicted references to “devices” herein are with respect to devices of the invention.

The devices of the invention typically can incorporate feature(s) of the US '192 devices/systems, and typically will share at least some of the components of the US '192 devices. As such, such components are sometimes described herein in less detail than in US '192, which is incorporated herein by reference.

### A. General Components and Elements

Devices and/or systems of the present invention comprise a temperature modulation system (TMS). A TMS can, e.g., modulate temperature of a pressurized gas (PG), thereby changing temperature and pressure in chamber(s) (e.g., a primary chamber) comprising PG. In aspects, a TMS effectuates this through (1) changing temperature of portions of the TML by contact with T1S & T2S (directly or indirectly) and the alternate dispensing of T1L & T2L into PG, (2) exposing PG to heat exchange materials (HEMs) having different temperatures (e.g., a first HEM having a first temperature (T1HEM) and a second HEM having a second temperature (T2HEM)), or (3) a combination thereof. Typically, a TMS comprises a fluid, often a liquid, such as a TML(s), an energy transfer liquid, or both, and often a TMS comprises one or more components designed to dispense fluid(s), e.g., liquid(s), into a pressurized gas or a chamber of a container which may comprise a pressurized gas (e.g., a pressurized gas chamber) (dispensation component(s)). In aspects, dispensation component(s) can be part of a dispensation system (e.g., comprising DC(s) and DLCS). In aspects, a TMS can further comprise one or more LCC(s) and switches, such as source switches (SS(es)), fluid switch(es) (T1L/T2L switch(es)), or both. In aspects, devices/systems do not comprise fluid switches. In aspects, a TMS also or alternatively comprises a heat exchange system (HES), typically comprising one or more heat exchange materials (HEMs).

According to aspects, a TMS comprises one or more liquids or one or more portions of a liquid having DoS different average temperature(s); typically, an average temperature difference of ≥about 1° C., e.g., ≥˜2, ≥˜3, ≥˜4, ≥˜5, ≥˜7, ≥˜8.5, or, e.g., ≥about 10° C. during operation. Typically, a device/system will operate with a single type of liquid that has two portions having a first and a second average temperature, respectively (T1L and T2L) that create the temperature differential that powers the device or participate in the TMS which powers the device. In aspects, if a sufficient temperature difference is present between the 1st & 2nd portions, alternating dispensation of liquid into the pressurized gas present in the chamber of the housing of the first container creates a temperature change in the PG and hence a pressure differential on opposing sides of the PGC-MC, causing the MC to repeatedly move, due to the presence of a VPCPS, from a 1st position located at an end of the SL to a 2nd position wherein the pressure of the gas is relatively lower than the 1st position upon TML dispensation. In aspects, the first and second portions of the TML are generated by exposing parts of the TML to T1S & T2S, respectively. The 1st and 2nd portions are maintained sufficiently separate to maintain a sufficient temperature difference to power the device/system during most, generally all, or substantially all (MGAOSA) or all intended periods of operation (e.g., the portions are not in contact or located in near enough proximity to effectuate any DoS transfer of temperature (heat) between the first and second portions).

In aspects, in operation, alternating displacement of a fluid, such as a pressurized gas (PG), by first and second portions of an energy transfer liquid occurs in coordination with the alternating exposure of a PG to a first heat exchange material (HEM1) having a first temperature (T1HEM) and a second heat exchange material (HEM2) having a second temperature (T2HEM). In aspects, the first and second heat exchange materials are maintained sufficiently separate to maintain a sufficient temperature difference to power the device/system during most, generally all, or substantially all (MGAOSA) or all periods/intended periods of operation (e.g., the heat exchange materials are not in contact or located in near enough proximity to effectuate any DoS transfer of temperature (heat) between the first and second HEMs.

### Temperature Sources

Devices typically use two different substances/media which are at different temperatures (which can be referred to as “T1” and “T2”), and which act as sources of a temperature difference that provides the energy for most, generally all, substantially/nearly all, or all of the work performed by the device. The different media/sources (which can be called source 1 and source 2, or T1S and T2S, respectively) cause fluid(s) contained in the device to also have different temperatures (which can respectively be called T1F and T2F or, alternatively, T1L or T2 L (the “L” vs. “F” reflecting that the reference is specifically to a liquid)). These fluids with different temperatures (or this fluid with portions at different temperatures) can, in aspects, be transmitted to a pressurized gas (PG) contained in a pressurized gas chamber (PGC) comprising a moveable component (a PGC-MC), which moves in at least one direction in response to PG modulated by T1F or T2F. Alternatively, the heat from media/sources can be transferred directly or indirectly to fluids of a device. In alternative aspects, T1S, T2S, or both can each influence, e.g., establish, the temperature of one or more HEMs (e.g., HEM1 and HEM2). In aspects, HEM1 and HEM2 can establish the temperature of the PG which can, when established in alternating fashion, cause the movement of a moveable component (a PGC-MC) in alternating directions. In aspects, exposure of an energy transfer fluid (e.g., an energy transfer liquid) to T1S, T2S, or both (e.g., one portion of an energy transfer fluid exposed to T1, and one portion of an energy transfer fluid exposed to T2) can establish the temperature of any such energy transfer fluid. In aspects, the temperature of an energy transfer fluid can significantly impact, such as can generally, substantially, or completely establish the temperature of an HEM, either directly or indirectly, such as either by making direct contact with an HEM or by, e.g., being sufficiently close to an HEM and accepting or transmitting energy transferred as heat from or to an HEM. In aspects, as described elsewhere herein (“DEH”), such a heat transfer could be accomplished by, e.g., circulating such an energy transfer fluid around a heat exchange container, heat exchange chamber, or both (e.g., by use of a heating or cooling blanket).

In aspects, temperature sources (T1S and T2S) that power devices of the invention can originate from naturally occurring sources (e.g., a lake and a land area) or otherwise available sources (e.g., industrial, mechanical, or consumer waste stream(s) (e.g., an exhaust from a device such as a car, a power plant, a refrigerator, air conditioner, and the like). Examples of such sources are described in US '192 and include different environmental sources, waste heat streams, etc. In aspects, T1S or T2S are naturally occurring sources, e.g., different parts of an environment (e.g., lake and air). In aspects, T1S, T2S, or both, are a waste stream from another power consuming or power generating process (e.g., combustion exhaust, air conditioning, factory exhaust, and the like).

The difference in T1 and T2 can be any suitable difference. Typically, there is a sufficient T1ΔT2 to detectably cause movement of the PGC-MC in at least a 1st direction. In such aspects, alternating dispensing of T1F & T2F can, e.g., create pressure differential on opposing sides of the PGC-MC, which causes the MC to repeatedly move back and forth along/across the stroke length (SL). Typically, the difference in T1 and T2 is sufficient to cause a PGC-MC to move in at least one direction a number of times sufficient to produce useful work for ≥about 4, ≥˜6, ≥˜8, ≥˜10, ≥˜12, ≥˜15, or ≥˜18 hours per 24-hour period (minimum, on average, generally always, nearly always, or always). In aspects, devices can produce useful work at relatively low temperature differences (e.g., a 5 about 7° C., ≤˜5° C., ≤˜4° C., ≤˜3° C., ≤˜2.5° C., or ≤˜2° C. difference), such as in situations in which the average minimum T1 and T2 temperature differences during operation are of any such amounts.

According to aspects, TIS or T2S each have an average temperature which fluctuate due to conditions, either regularly or in response to events. In aspects, T1S, T2S, or both, are environmental inputs, and, in such aspects, can have average temperatures that fluctuate periodically throughout any 24-hour period. In aspects, T1S and T2S can reverse, e.g., T1S being warmer in the day and colder at night and T2S having the opposite temperature profile (colder by day and warmer by night). E.g., in aspects T1S and T2S are a body of water and a body of air, where, in cases, e.g., the air is warmer than the lake in the day and cooler than the lake in the evening.

In aspects, devices/systems comprise more than 2 temperature inputs, e.g., “T3S”, “T4S”, “T5S”, etc.; e.g., 3, 4, 5, or more inputs, such as >3, >5, or >10 environmental inputs, with different combinations of such input(s) contributing TML to the device/system (e.g., during parts of the day TML is sourced from 2, 3, or 4 depths of a body of water or during times TML is sourced from inputs associated with different activities/waste streams).

In aspects, device(s) comprise liquids, such as a TML. In aspects, such devices can comprise liquid conducting system(s) (LCS(s); DLCS(s)) and related system(s) can comprise system LCS(s) or SLCS(s)). A DLCS is a “device liquid conducting system,” in which a portion/part of a device that conducts a liquid contacts T1L and T2L, and which may contact T1S or T2S or be adapted to engage an SLCS that contacts T1S or T2S. In aspects, system LCS(s) (SLCS(s)) comprise T1S, T2S, or both T1S & T2S input(s) (or even more input(s)). In aspects, input(s) comprise environmental condition(s). Such condition(s) can be, for example, a surface (above ground) or subterranean body of water, a surface or subterranean body of air, or a subterranean location (e.g., a subterranean location not comprising a body of water or air).

In aspects, T1S, T2S, or other inputs comprise a waste stream, such as a waste stream from one or more processes otherwise unrelated to the system/device. In aspects, such a waste stream can be a relatively warm or hot waste stream (e.g., excess heat generated from a manufacturing process or energy production process, or e.g., from the operation of an engine such as an automobile engine) or a relatively cold waste stream, e.g., from a process which has extracted heat and cold waste is generated. In aspects, an LCS can comprise one or more temperature inputs which is a naturally occurring environmental condition and one or more temperature inputs which is a waste stream.

In AOTI, a device/system is operable when ≥˜2 inputs (e.g., T1S & T2S) have a temperature differential of at least about a fraction of a degree, such as ≥˜a half of one ° C., ≥˜1° C., ≥˜2° C., ≥˜3° C., ≥˜4° C., ≥˜5° C., ≥˜6° C., ≥˜7° C., ≥˜8° C., ≥˜9° C., or, e.g., at least about 10° C., over a period of at least about 1, ˜2, ˜4, ˜6, ˜8, ˜10, ˜12, ˜15, ˜18, or ˜24 or more hours.

### Temperature Modulating Fluid(s) (TMF(s))

In aspects, in operation, devices can comprise temperature modulating fluid(s) (TMF(s)) that transfer heat, typically indirectly, with T1S and T2S, thereby forming T1F and T2F fluid(s) or fluid portions, respectively. Sometimes such media are simply referred to as a “fluids” or a “fluid.” In cases, T1F and T2F refer to portions of a single fluid. T1F or T2F TMFs can change the temperature of media/fluid, such as a pressurized gas (PG), causing movement of pressurized gas chamber moveable component(s) (PGC-MC(s)).

Typically, a TMF is, at least in operation, at least substantially closed/contained in the device or system. E.g., nearly all or all of the TMF is retained in the system in operation (as opposed to being lost to or exchanged with air or other environmental materials).

In aspects, such fluid(s) comprise, mostly comprise, substantially consist of, essentially consist of, or is/are liquid(s). As noted, different temperature liquid can be similarly referenced, e.g., as T1L and T2L. In cases a TMF is a temperature modulating liquid (TML). For example, in aspects, a TML, such as is described in US '192, can be used in embodiments of device(s)/system(s) comprising a VPCPS, HIC/HDC components, or both. In aspects, differently heated TML is dispensed into the pressurized gas (PG) to form a relatively hot and relatively cool gas state (TIG and T2G, respectively), causing the PGC-MC to move in at least one direction, as discussed in US '192.

In aspects, pressurized gas (PG) alternatingly heated or cooled by HEM(s) which cause a PGC-MC to move in at least one direction as opposed to a TML. In aspects, an energy transfer fluid (e.g., heat transfer liquid) may serve as a liquid displacer, physically displacing PG in operation as is discussed elsewhere here. Further, in such aspects, first and second portions of an energy transfer fluid (e.g., liquid) can alternatingly displace the PG such that the PG is alternatingly exposed to a first and second HEM (HEM1 and HEM2). a TMF is, itself, a pressurized gas (PG), and it is the TMF itself which, when in two portions (T1F and T2F) having different temperatures (T1F and T2F) and when the T1FΔT2F is sufficient, their alternating exposure to a movable component causes a movable component to move back and forth.

In aspects, most, generally all, or all, of the operational fluid in devices, such as TMF, PG, or both, is, in operation, both closed to the environment and pressurized. In aspects, a device in a ready for operation (RFO) state (“RFOS”) comprises a substantially uniform pressure throughout (e.g., pressures that are within +/−5%, =/−2.5%, or +/−1% of each other).

A system for changing temperature in PG can be referred to as a temperature modulating system (TMS). In aspects, the TMF can be considered a component of a TMS (e.g., a TMF can be contained within component(s) that make up the TMS, such as tubing/pipe(s) or other conduit(s), chamber(s), pump(s), or a combination thereof). In aspects, a TMS typically will also include other components for modulating temperature of the TMF. E.g., in aspects, as in devices of US '192, the TMS comprises a temperature modulating liquid (TML), transported from points of indirect contact with T1S and T2S via a liquid conducting system (“LCS”) and typically further including dispensation component(s) (DC(s)) that dispense the TML into the PG. In other TMS embodiments, a TMS can comprise a heat exchange system comprising one or more heat exchange chambers (HEC(s)). In aspects, each HEC can comprise a heat exchange material (HEM). In aspects, a volume of PG, when exposed to an HEM within an HEC can have its temperature detectably or significantly modified such that a volume of PG alternatingly exposed to a first HEM (HEM1), e.g., an HEM1 within a first HEC (HEC1), and a second HEM (HEM2), e.g., an HEM2 within a second HEC (HEC2) can provide sufficient changes in pressure within a pressurized gas chamber (PGC) to affect alternating movement of a movable component (e.g., a PGC-MC).

The inventive devices described herein comprise, in yet another aspect of the invention, new and improved dispensing/dispensation component(s) (DC(s)). DC(s) can comprise(s) outlet(s) through which TMF, such as TML is dispensed, typically in droplet form (e.g., as a mist), as discussed in US '192. In aspects, most, generally all, nearly all, or all dispensation outlets (e.g., vents, nozzles, or the like) of a dispensation component (DC) are oriented such that at least a measurable amount of force is required to dispense liquid from the DC outlets. E.g., in aspects parts of the DC are oriented in an upward direction (with respect to the flow of TML therefrom) to DoS reduce the risk of uncontrolled DoS release of TML (e.g., via detectable or significant levels of undesirable TML dripping). In certain aspects, part(s) of the DC are oriented in a horizontal direction. In aspects, part(s) of the DC are oriented in a horizontal direction and the horizontal orientation DoS aids in the dispersion of dispensed liquid from the DC or reduces the risk of uncontrolled DoS release of TML. In aspects, part(s) of the DC are not oriented in a downward facing direction, generally, nearly always, or always preventing DoS gravitational release of T1L or T2L from DC outlet(s). In aspects, at least a part of a DC, such as most, generally all, or all of a DC, is positioned near or adjacent to internal void space(s) (IVS(s)), such as below an IVS, such that TML is dispensed into an IVS from the DC. In aspects, an IVS surrounds a DC, e.g., in aspects where a DC is positioned coaxially within a chamber comprising the DC, as is discussed elsewhere here.

In some aspects, such as in aspects wherein a liquid such as an energy transfer liquid operates as a liquid displacer, a dispensation component can dispense a liquid as a stream of liquid, having the intent of dispensing liquid quickly, that is, in as short a time as possible so as to increase operating efficiency of the device/system, as opposed to in a form having maximum surface area (e.g., as droplets such as in mist form). In aspects, such a dispensation component can be in PGC(s), HEC(s), or both.

In aspects, a TML typically has a boiling point and freezing point which allows for the liquid to remain a liquid under normal device operation. In aspects, the TML AOA typically has a viscosity of about 0.05 cP-about 3.5 cP at 300 deg K and atmospheric pressure, e.g., ˜0.05 cP-˜3 cP, ˜0.05-˜2.8 cP, ˜0.05-˜2.6 cP, ˜0.05-˜2.4 cP, ˜0.5 cP-˜2.2 cP, or about 0.5-˜2 cP, such as for example ˜0.6 cP-3.5 cP, ˜0.7-3.5 cP, or ˜0.8-3.5 cP at about 300° K and atmospheric pressure, as in e.g., about 0.8 cP-about 3.4 cP, ˜0.8-3.3 cP, ˜0.8-3.2 cP, ˜0.8-3.1 cP, or ˜0.8-about 3 cP, or ˜1-˜3 cP at ˜300° K and atmospheric pressure.

In aspects, the specific heat of the liquid is between about 1.3-4.7 kJ/kgK, e.g., ˜1.35-4.65 kJ/kgK, ˜1.4-4.6 kJ/kgK, ˜1.45-4.55 kJ/kgK, ˜1.5-4.5 kJ/kgK, ˜1.55-4.45 kJ/kgK, or ˜1.6-4.4 kJ/(kgK).

In aspects, the TML has a surface tension of ˜18-80 dynes/cm, e.g., ˜19-78 dynes/cm, ˜20-77 dynes/cm, ˜20-77 dynes/cm, ˜21-76 dynes/cm, ˜22-75 dynes/cm, ˜22-75 dynes/cm, ˜23-75 dynes/cm, ˜24-75 dynes/cm, or ˜20-40 dynes/cm, ˜20-35 dynes/cm, ˜21-38 dynes/cm, ˜22-36 dynes/cm, ˜23-34 dynes/cm, or ˜24-32 dynes/cm.

In aspects, the freezing point of the TML is between ˜185-300° K, e.g., ˜190-about 295° K, ˜195-290° K, ˜200-285° K, ˜200-280° K, ˜205-277° K, ˜208-275° K, or ˜208° K-235° K.

In aspects, the boiling point of the TML is about 350-600° K, such as ˜355-595° K, ˜360-590° K, ˜365-585° K, ˜370-580° K, or between about 373° K-about 575° K. In aspects, the boiling point of the TML is between about 400-575° K, such as between ˜405-575° K, ˜410-575° K, ˜415-575° K, ˜420-575° K, or between about 422-575° K.

In aspects, the TML is an aqueous liquid, e.g., water or a liquid that at least mostly is composed of water. In aspects, the TML is a nonaqueous liquid (e.g., a liquid comprising <50%, <33%, <20%, <10%, <5%, <2%, or <1% water). In aspects, the TML primarily comprises, generally comprises, essentially comprises, substantially/nearly entirely comprises, or consists of hydrocarbons, e.g., TMLs can primarily comprise, generally consist of, substantially/nearly entirely consist of, or consist of (“PC, GCO, SCO, or CO”) of 4-30 or 5-30 carbon hydrocarbon compound liquids. In aspects, the TML is PC, GCO, SCO, CEO, or consists of organic compounds and can be classified as an oil. In aspects, the TML is turpentine or another oil that PC, GCO, SCO, or consists of terpenes. In aspects, the TML is kerosene or another oil that PC, GCO, SCO, or consists of one or more hydrocarbons of similar sizes as those typically found in kerosene. In aspects, the TML PC, GCO, SCO, CEO, or consists of a low vapor pressure aliphatic hydrocarbon (e.g., kerosene in combination with other materials such as, for example but not limited to a petroleum base oil (e.g., a paraffin), mineral oil, other aliphatic hydrocarbons, alkanes, isoalkanes, cyclics, and aromatics, such as for example C9-C11 n-alkanes, iso-alkanes, cyclics, and aromatics). In aspects the TML can comprise, e.g., as principal components, C9-C14 alkanes and mineral oil. According to certain aspects, the liquid is selected from the group comprising turpentine, kerosene, or a formulation sold under the brand WD-40® (WD-40 Company, San Diego, Calif.), or an equivalent thereof (a liquid having about the same viscosity, about the same lubricity, or both, as WD-40® (the lubricity properties of WD-40® as described in, e.g., US20110114537). In aspects, the TML comprises, materially comprises, or primarily comprises a liquid that is classified in the art as a lubricant. In aspects, the lubricant is composed of organic compound(s). In aspects, a lubricant can be but may not be limited to a petroleum fraction or mineral oil; a synthetic oil (e.g., Super Lube® Synthetic Lightweight Oil); PTFE, molybdenum, or a bio lubricant (e.g., a vegetable oil). In aspects, the TML PC, GCO, SCO, CEO, or consists of an oil that is suitable for atomization in ˜0.5-5-micron particles, e.g., ˜1-3-micron droplets, and spraying as a mist, and typically have a relatively low wax content (e.g., naphthenic oils, low wax ISO 100 paraffinic mineral oils or similar synthetic oils such as ISO 68 PAOs and ISO 68 or 100 diesters). In aspects, MGASAOA of the TML is not converted to gas during normal operation.

In some respects, a/one fluid of the device(s)/system(s) described here can be described as an energy transfer fluid. The term “energy transfer fluid” can be used to describe a fluid serving as a fluid displacer; wherein in aspects a volume of the fluid serves to replace (displace) a volume of a media, such as pressurized gas (PG) within a defined area (e.g., in a chamber). In such aspects, the energy transfer fluid serves to transfer PG from one location to another, one such location being a location wherein the PG is exposed to a temperature modification source such as a heat exchange material (HEM). Because in such aspects the fluid serves to transfer the energy of a PG from a first location (e.g., a pressurized gas chamber) to a second location (e.g., a heat exchange chamber), such a process yielding a change in the energy of the PG by way of the PG experiencing a change in temperature, the term “energy transfer fluid” can be appropriate. In specific aspects, the energy transfer fluid can be a liquid, and accordingly such an energy transfer fluid can be called an “energy transfer liquid”. In aspects, the energy transfer fluid can be any fluid having any one or more characteristics of a TML described above (e.g., any energy transfer liquid having any one or more such characteristics). In aspects, an energy transfer fluid can have one or more characteristics which are different from any one or more characteristics of a TML described above (e.g., any energy transfer liquid having any one or more such characteristics). In aspects, for example, an energy transfer fluid can be a gas having a detectably or significantly different density than that of the PG. In aspects, an energy transfer fluid can be, comprise, mostly comprise, generally consist of (generally comprise), or nearly/substantially consist of a liquid such as water (e.g., an aqueous fluid). In aspects, an energy transfer fluid is a nonaqueous fluid, such as a hydrocarbon-based fluid as described elsewhere herein. In aspects, an energy transfer fluid can be, e.g., any liquid having a viscosity which is suitable for pumping through the system as described here to and from a PGC and an HEC) with minimal effort or energy requirement. In aspects, an energy transfer fluid is any fluid which can have its temperature quickly and effectively modified by exposure to a T1/T2 source.

### Pressurized Gas (PG)

Devices that comprise a gas under pressure can comprise/employ any pressurized gas (PG) that is suitable for use under the intended system pressure and design characteristics of the device. Devices can, in aspects, employ any >1 PG which can repeatedly undergo temperature modulation in response to the dispensing of T1L & T2L TMF/TML per certain methods of the invention. Devices can, in additional or alternative aspects, employ any PG which can repeatedly undergo temperature modulation in response to the exposure to HEM(s) according to certain methods of the invention.

In aspects, the PG comprises, mostly comprises, generally is, essentially is, or is an inert gas (with respect to generally all, nearly all, or all device/system components the PG contacts (including materials thereof). In aspects, a DoS amount of PG does not escape from or pass through the barrier component, unless intentionally opened. In aspects, the PG is inert with respect to the TML or energy transfer fluid (e.g., energy transfer liquid), and any absorption of gas by the fluid/liquid or dissolution of the gas within the TML or energy transfer fluid does not DoS impact the frequency at which one or more containers or other components of the device(s)/system(s) must be re-pressurized. In aspects/AOTI, chemical reactions between the PG & either the TML or energy transfer fluids or component(s) are not DoS.

In aspects, the PG has a molar specific heat at constant pressure (Cp; the amount of heat transfer required to raise the temperature of one mole of a gas by 1K at constant volume), and a molar specific heat at constant volume (Cv; the amount of heat transfer required to raise the temperature of one mole of a gas by 1K at constant pressure), or both a Cp and a Cv, that is DoS greater than that of air. In aspects, PG has both a Cp and a Cv DoS higher than that of air. Examples of such gasses include carbon monoxide, helium, hydrogen, neon, and nitrogen. In aspects, the PG mostly, generally, nearly entirely, essentially, or entirely is N₂ gas. In aspects, a device/system comprises a source of gas. In aspects, a device/system lacks a gas source, as gas in aspects of the invention is only added infrequently (e.g., no more than every ˜1, ˜3, ˜6, ˜12, ˜18, ˜24, ˜36, ˜48, or ˜60 months). In aspects, a source of gas can be a secondary component of a device, or, e.g., a part of a system comprising device(s).

In aspects, gas/PG is maintained in a gaseous state, and does not DoS condense from a gas to a liquid during operation (or is not DoS condensed in operation). In aspects, most, generally all, nearly all, or all PG does not experience a phase change during device/system operation. In aspects, device(s)/system(s) comprise a single amount/aliquot of PG, and DC(s) dispense TML into the single aliquot of PG. In aspects, device(s)/system(s) comprise a single aliquot of PG, and the single aliquot of PG is alternatingly exposed to first and second heat exchange materials to affect changes in PG temperature).

### Pressurized Gas Chamber(s) (PGC(s))

Devices typically comprise chamber(s) that in operation contain pressurized gas (PG). Such chambers are called pressurized gas chambers (“PGCs”). PGCs also include moveable component(s) (“PGG-MC(s)”). The PGC comprises or is formed by barrier component(s) that do not release PG, that maintain pressure of pressurized PG, and that maintain the PGC as a closed system unless selectively opened. Aspects of barrier component(s) are described below in connection with fluid vessels, such as PGC vessels, which are vessels/containers that contain PGC(s). A container comprising ≥1 PGC is called a “PGC container.” In aspects, a device comprises a PGC container comprising ≥2 PGCs. In aspects, a device comprises ≥2 PGC containers. In aspects a device comprises a single PGC container, comprising 1 or 2 PGCs. In aspects, a device can comprise chambers which are not pressurized gas chambers; that is, a device can comprise one or chambers which do not comprise a PG.

The housing of a PGC container, e.g., the housing of a PGC container comprising a primary pressurized gas chamber, can comprise connection(s) to other components of a device, such as vacuum chamber(s) of a VPCPS. In aspects, such a VPCPS can further comprise additional container(s) and PGC(s).

The barrier component (BC) of any one or more containers of the device/system can have any suitable configuration and composition. In aspects, a BC can enclose one or more chambers. In aspects a chamber enclosed by a BC can comprise a PG. In other aspects, a chamber enclosed by a BC does not comprise a PG. In aspects, a barrier component (BC) can comprise a barrier interior (BI). In aspects, a BI can be formed of one or more solid “sidewalls,” above, below, and around the chamber(s) of container(s). Typically, the BC/barrier or the BI is composed of material(s) is substantially impervious to unintentional loss of TMF (e.g., TML), energy transfer fluid (e.g., energy transfer liquid), or PG, or to the loss of a vacuum pressure created or maintained within. In certain facets, the BC of a container housing (a PGC container, vacuum container, or both) is capable of maintaining more than ˜80% of the gas held therein over OCPs of at least ˜1 month, e.g., about ≥˜2, ≥˜4, ≥˜6, ≥˜8, ≥˜12, ≥˜18, ≥˜24, ≥˜30, ≥˜36, ≥˜48, or ≥about 60 months. Typically, a BI is not DoS chemically reactive with the TMF (e.g., TML), energy transfer fluid (e.g., energy transfer liquid), or the PG. In certain facets, the BC of the housing is capable of maintaining more than ˜80% of the vacuum pressure held therein over OCPs of at least ˜1 month, e.g., about ≥˜2, ≥˜4, ≥˜6, ≥˜8, ≥˜12, ≥˜18, ≥˜24, ≥˜30, ≥˜36, ≥˜48, or ≥about 60 months.

In aspects, a device comprises a PG container (PGC), wherein a movable component maintained therein (the PGC-MC) effectively defines one end of the PGC. In aspects, a PGC comprises a single internal void space (IVS) located on one side of the PGC-MC, located on one end of the SL of the PGC-MC, or both.

In aspects, a PGC comprises a consistent diameter; that is, in aspects the diameter of the first container varies by no more than ˜5%, ˜4%, ˜3%, ˜2%, or about 1% across its length. In aspects, a PGC comprises portions each having a different diameter; that is, in aspects, the first container can have a first portion that has a diameter of ˜75%, ˜70%, ˜65%, ˜60%, ˜55%, ˜50%, ˜45%, ˜40% or less, e.g., ˜35%, ˜30%, ˜25%, ˜20%, ˜15%, ˜10%, or ˜5% or less than the diameter of a second portion of a PGC.

In operation, in some embodiments, most, generally all, nearly all, or all PG movement is caused by expansion and contraction of PG effectuated by the dispensation of TML into the PG chamber. In aspects, any movement of PG is at least generally, at least substantially, or entirely within the PGC. In aspects, PG does not travel to multiple locations of a device/system, e.g., does not DoS travel from one significantly distinguishable compartment to another. In aspects, gas is not forced to pass through a path comprising any angle of more than ˜30°, ˜45°, ˜75°, or ˜90° in the device. In aspects, the device lacks any components that force the PG to wind, curve, or pass through any tortuous route. In aspects, any movement or flow of gas within the closed system in regular operation is substantially in the same planar orientation. E.g., in a horizontally oriented device, in certain embodiments, flow of PG will primarily, generally, nearly entirely, essentially, or entirely consist of horizontal flow (albeit back and forth with changes in temperature/pressure brought about by alternating dispensing of T1L and T2L into the PG). In aspects, the device lacks any component that agitates the PG other than any agitation caused by dispensing TML (e.g., the device does not rotate/circulate PG or comprise a PG rotor or similar component).

In operation, in some embodiments, PG can move from one location to another, such as, e.g., from one container to another, as in, for example, from a first, primary container comprising a pressurized gas chamber and a movable component (e.g., from a primary pressurized gas chamber/primary pressure chamber) to container(s) which make up a part of a temperature modulating system, such as one or more containers making up a heat exchange system (HES), e.g., one or more heat exchange chamber(s) (HECs) within such container(s). In aspects, in operation, PG can move from a primary pressure chamber, to a first HEC (HEC1), back to the primary pressure chamber, then to a second HEC (HEC2), then back to the primary pressure chamber, then back into HEC1, such a cycle continuing during continuous operation. In aspects, PG can pass through one or more conduits when moving from one location to another within the device/system, such as through one or more pressurized gas conducting system lines (which in aspects may also be referred to generally as a flow line; flow lines herein can, depending on the embodiment, conduct passage of a fluid, e.g., a liquid, a gas, or both). Typically, a flow line conducts a liquid or a gas but not both. In aspects, such lines can be made of any material which is at least mostly, generally, substantially, or completely inert with respect to the PG, such that exposure of the PG to such material does not cause significant changes in the amount, volume, pressure, or combination thereof of the PG resulting in a requirement that the device/system be repressurized within a period of less than about 6 months, such as, e.g., within a period of ≤˜5 months, ≤˜4 months, ≤˜3 months, ≤˜2 months, ≤˜1 month, or even less, such as ≤˜2 weeks due to loss of PG due to exposure to the material. In aspects, such a material can be a glass, a plastic, a metal, a polymer, a natural material, a synthetic material, and the like or any material known in the art for its inert nature relative to the chemical nature of the PG, or any combination(s) thereof.

According to aspects, a pressure chamber, such as a PGC (e.g., a primary pressure chamber) is configured to maintain both a pressurized gas (PG) and an energy transfer fluid (e.g., an energy transfer liquid), in alternating fashion when the device/system is in operation.

In aspects, device/systems comprise visual aid component(s) (“VAC(s)”). A VAC can allow for visibility of an interior space of a device or system, e.g., a chamber or a fluid (e.g., a liquid or a gas) flow path, from the exterior of the device/system. In aspects, such a VAC can be positioned within a housing/barrier, within a flow line, or within any area of a device or system where visual access may be useful or beneficial. In aspects, a VAC is a window comprised of any material capable of withstanding the pressures and temperatures to which it is exposed (e.g., if a VAC is in a closure component of the housing, the VAC is capable of withstanding the pressures and temperatures commonly present in the housing over a sustained period of use, e.g., ≥6 months). A VAC is typically non-corrodible or obscurable by any TML, gas, or environmental condition to which it may be exposed, while allowing for an operator to view the inside of the device from the exterior of the VAC. In aspects, such a window can be selectively openable, e.g., itself closed or coverable by a cover closure until intentionally opened by a user. In aspects, suitable material can be glass, a polycarbonate, acrylic, or the like. In aspects, use of the VAC can alert the operator to unusual operating conditions, such as for example but not limited to a TML viscosity change, a clogged DC, a clogged LCC, or other visually identifiable condition.

### Internal Void Space(s)

A PGC can in aspects comprise ≥1 internal void spaces (IVS(s)). In aspects, a PGC does not comprise any void space described here. In aspects, an IVS makes up a portion of the chamber that is sufficiently large to allow T1ΔT2 to significantly promote or detectably cause movement of the PGC-MC along most of the SL during OCPs (e.g., account for most, generally all, or nearly all of the movement). In aspects, each internal void space (“IVS”) comprises only PG or PG and TML and, in some respects, an/each IVS comprises a dimension (e.g., a length) that is at least about 5%, is ≥7.5%, or is ≥10% of a dimension of the PGC.

In operation, an IVS contains no solid parts and, in aspects, an IVS contains essentially only PG and TML (when TML is dispensed in PG). In aspects, ≥1 internal void space is present in pressurized gas chamber(s). In aspects, ≥2 IVSs are present in a device. In such aspects, a device can comprise ≥2 containers, each comprising a PGC-MC, or only 1 container comprising 2 IVSs positioned on different sides of a PGC-MC. In aspects, devices comprising only 1 IVS comprise a VPCPS. In aspects, a PGC container comprises an IVS on a single side of the CS or SLIP. An IVS typically mostly, generally, nearly entirely, essentially, or entirely comprises only PG & TML in operation. An IVS can similarly contain atmospheric air in place of PG if the device is open. In other words, an IVS mostly, generally entirely, nearly entirely, essentially entirely, or entirely lacks any solid physical structures. In other words, in aspects an internal void space is a space that is uninterrupted by solid physical structures in all directions for the distance(s) that define(s) the IVS. In aspects, an IVS has a dimension (e.g., length, or a dimension corresponding to the orientation of PGC-MC travel) which is at least about 5%, ≥7.5%, ≥10%, ≥12.5%, ≥15%, at least about 17.5%, ≥20%, ≥22.5%, ≥25%, ≥27.5%, or ≥30% of that of the maximum dimension (e.g., length or corresponding dimension) of the largest housing chamber, housing, or both. In aspects, IVS(s) have a volume which is at least ˜5%, such as ≥˜7.5%, ≥10%, ≥12.5%, ≥15%, ≥17.5%, ≥20%, ≥22.5%, ≥25%, ≥27.5%, or ≥about 30% of the total volume of the chamber(s) comprising the IVS. In alternative embodiments, an IVS is a space that surrounds a dispensation component, such as in embodiments wherein the dispensation component is positioned coaxially within a PGC. In such aspects, the IVS at all times comprises only PG or PG and a TML but comprises no additional physical structures. In aspects, coaxially located dispensation components can deliver/dispense TML into such an IVS in multiple directions.

In aspects, devices do not comprise an IVS.

### PGC-Moveable Component(s) (MC(s))

Except for any protruding member(s) (PM(s)), which can be associated with a movable component (MC), most, generally all, substantially all, or all of an MC or all MC(s) of a device resides within a container; in aspects, e.g., within a housing; and further, in aspects, e.g., within a barrier component. In aspects, an MC (e.g., a first MC, e.g., a PGC-MC), housed within a first container (the first container being a part of the primary pressure modulating system) has a contact surface that is exposed to dispensed TML and contacts a portion of the dispensed TML in operation. In aspects, such an MC has a contact surface that is exposed to an energy transfer fluid such as an energy transfer liquid. In aspects, the MC has a contact surface that is exposed to both PG and a liquid/fluid, such as a TML or energy transfer liquid. In aspects, the MC has a contact surface that is alternatingly exposed to a single chamber comprising at least generally all or substantially all PG then at least generally all or substantially all TML or energy transfer liquid.

Generally, an MC (PGC-MC or VPCPS-MC) can be any kind of structure, device, etc., capable of moving in a first and an opposite second direction when acted on by pressure changes (e.g., pressure changes induced by dispensation of T1L and T2L into the chamber in the first container comprising a PG or pressure changes induced by exposure of a PG to a heat exchange material (HEM)). In aspects, an MC moves a stroke length (SL) when acted on by a minimum force. In aspects, an MC is characterizable as (ICA) a plunger or a piston. In aspects, the PGC-MC, within a first container comprising a chamber comprising PG (PGC), which, in aspects unlike other MC(s) of the device/system comes into contact with at least a portion of TML or a portion of an energy transfer fluid (e.g., an energy transfer liquid) upon its dispensation therein, can be referred to as a “working piston.” As used herein, the term “movable component” commonly refers to only the plunger- or piston-like component and not to the plunger- or piston-like rod or connecting component transferring motion to or from the MC. That is, for example, in describing the uniformity (in certain aspects) of the diameter of an MC across its length, such a description refers to the plunger- or piston-like element of the MC, and a plunger- or piston-like rod attached to such a component may have a diameter which varies from that of such a component (e.g., it may be significantly smaller in diameter). In some contexts, the term “movable component” can refer to full unit comprising the plunger- or piston-like component and to the plunger- or piston-like rod attached to it. In certain aspects, no movable component within the device/system alternates movement in two opposing directions consistently (e.g., in a recognizable and timed pattern) unless and until the MC in the first container (the “PGC-MC,” also characterized as a “working piston” described above) moves. In aspects, movement of a second, third, or further MC of the device/system is reliant upon the movement of the first MC (PGC-MC). In aspects, no other component of the device/system other than an MC, and/or components attached directly or indirectly thereto which rely upon the movement of such MC(s) and which move according to such MC movement, moves in a manner which results in DoS energy production above and beyond that produced by movement of the PGC-MC, an MC within a VPCPS (a VPCPS-MC), or a combination of any two or more MC(s).

In aspects, an MC separates two chambers. In aspects, an MC separates a first pressurized gas chamber (a first or primary pressure chamber) from a second pressure chamber (secondary chamber), e.g., chambers contained within a larger container, such as in a primary chamber comprising a working piston.

In aspects, an MC generally consists of (GCO), substantially consists of (SCO), consists essentially of (CEO), or consists of a single component with a uniform composition, comprises no subcomponents that move independently of one another, or both. In aspects, the portion of an MC that travels within a chamber GCO, SCO, CEO, or consists of a single component with a uniform composition and has no subcomponents that move independently of one another.

In aspects, an MC has essentially or fundamentally (e.g., fundamentally as used here meaning well understood by skilled persons/POOSITA to be similar or equivalent based on function) the same shape as the inner diameter of the housing (e.g., both are cylindrical or rectangular) of a container within which it resides. In aspects, the diameter of at least part of an MC (e.g., the ends of the MC, e.g., the plunger component of an MC), such as an MC residing within the VPCPS (a VPCPS-MC), and the inner diameter of the housing of a container within which it resides, e.g. the diameter of a container further comprising a chamber comprising a vacuum, differ by no more than about 0.5%, about 0.4%, about 0.3%, about 0.2%, about 0.1%, or even less, such as by no more than about 0.09%, ˜0.08%, ˜0.07%, ˜0.06%, ˜0.05%, ˜0.04%, ˜0.03%, ˜0.02%, or no more than about ˜0.01%. Accordingly, an MC in aspects can create a substantially impassible barrier with respect to TML, energy transfer fluid, PG, vacuum pressure, e.g., an at least substantially or entirely impassible barrier, thus, e.g., the MC defines at least in part one wall of a chamber, as DEH. In other aspects, an MC, such as, e.g., a first MC located within the first container comprising a PG and which makes up a part of the primary PMS (e.g., a PGC-MC) can have a diameter that is ˜95%, ˜90%, ˜85%, ˜80%, ˜75%, ˜70%, ˜65%, ˜60%, ˜55%, ˜50%, ˜45%, ˜40%, ˜35%, ˜30%, ˜25%, ˜20%, ˜15%, or ˜10% that of the largest diameter of the housing of the container within which it resides.

In aspects, a stroke length (SL) of the PGC-MC(s) is smaller than a corresponding dimension of the PGC within which the PGC-MC at least partially resides (e.g., the length of the PGC). E.g., in aspects a/the PGC-MC does not enter an/any IVS. In aspects, an SL of any MC within a device/system described herein is smaller than a corresponding dimension of a container, chamber, or both within which the MC at least partially resides, such that the MC does not make contact with a BC (e.g., a BI component) at either end of a stroke length.

In aspects, less than about 1%, such as <˜0.9%, <˜0.8%, <˜0.7%, <˜0.6%, <˜0.5%, <˜0.4%, <˜0.3%, <˜0.2%, or, e.g., less than about 0.1% of a volume of gas on one side of the PGC-MC is able to pass to the opposite side of the movable component during a stroke of the PGC-MC (e.g., during a movement of the movable component its maximum distance in either direction). In aspects, the vacuum of a VPCPS of a device here is reduced by less than about 1%, such as less than ˜0.9%, <˜0.8%, <˜0.7%, <˜0.6%, <˜0.5%, <˜0.4%, <˜0.3%, <˜0.2%, or, e.g., <˜0.1% due to gaps or passages across an MC of a VPCPS. In aspects no DoS passage of gas or release of a vacuum occurs due to passage(s) through or around an MC.

In aspects, a detectable amount of PG flows around part of the PGC-MC, e.g., from one end/side of the PGC-MC to the other (e.g., in a gap between the PGC-MC and the barrier). In aspects, PG does not flow around the PGC-MC. In aspects, nearly all or all of any volume of PG on one side of a PGC-MC remains on that side of the PGC-MC during operation. In aspects, nearly all or all of any volume of PG on one side of a PGC-MC remains within portion(s)/component(s) of the device accessible to the PGC, such portion(s)/component(s) either directly or indirectly accessible to the PGC and either accessible to the PGC at all times or selectively. In aspects, a container can comprise multiple PGCs, which are separated in part, by, a PGC-MC. In aspects, the device comprises (or each PGC comprises) a single volume of PG.

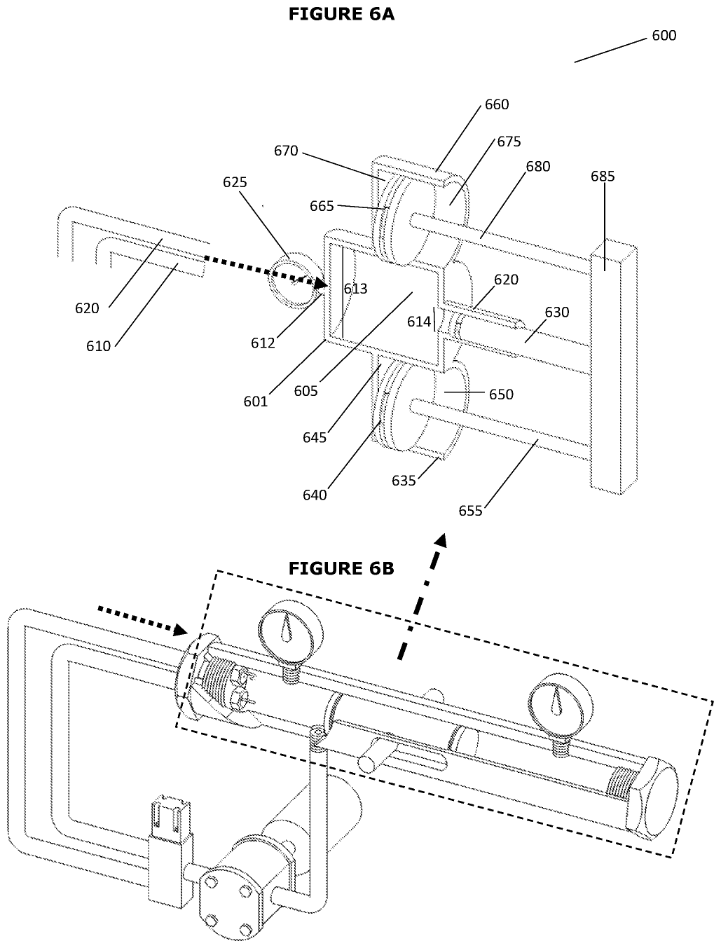

In aspects, a PGC-MC resides at least in part within a portion of a PGC that has a smaller diameter than that of a second portion of the PGC. In aspects, over the length of a complete stroke, the PGC-MC can be within a portion of the PGC having a larger diameter, a portion of the first container having a smaller diameter, or both. In aspects, an MC can be in both portions simultaneously. In aspects, the diameter of the PGC-MC is detectably or significantly smaller than the largest diameter of the PGC, the smallest diameter of the PGC, or both. In aspects, the diameter of the PGC-MC is DoS smaller than the diameter of the PGC. In aspects, the diameter of the PGC-MC is less than about one half of the largest diameter of the PGC, such as less than ˜⅓, or <˜¼ of the largest diameter of the PGC. In aspects, most, generally all, nearly all, or all of the PGC-MC travels within a restricted diameter component of the PGC during at least part of an SL. To aid in visualizing such an MC, this particular embodiment is exemplified by FIG. 6A.

In aspects, at least one part of an MC (e.g., a PGC-MC or VPCPS-MC) has a detectably or significantly different size than at least one other part of an MC. In aspects, at least one part of an MC can comprise, e.g., a width, such as, e.g., a diameter, which is more than about 0.1%, 0.5%, ˜1%, ˜2%, ˜3%, ˜4%, ˜5%, ˜10%, ˜20%, ˜30%, ˜40%, ˜50%, ˜60%, ˜70%, ˜80%, ˜90%, or ˜100% greater or more than at least one other part of an MC. In aspects, a difference in size of at least one part of an MC can restrict movement of the MC to within a specified space. In aspects, a difference in size of at least one part of an MC can prevent movement of an MC from moving past a predetermined location at the end of a stroke length. In aspects, a difference in size of at least one part of an MC can serve as a safety mechanism, restricting the movement of an MC too far in a single direction. In aspects, at least one part of a movable component cannot enter or otherwise move within a space in which another one or more part(s) of a movable component can move (such as, e.g., a space within a PGC having a diameter smaller than the diameter of another space within a PGC).

Typically, in some, most, generally all, or all (SMGAOA) of an MC (e.g., across most, generally all, or all the length of an MC), there is at least a slight enough difference in diameter between the MC and the inner diameter of the housing (BI) of the container within which it resides whereby the movable component can slide freely with minimal friction in response to pressure differentials on either side of the MC. Such a slight enough difference in diameter between an MC and the inner diameter of the housing (BI) of a container within which it resides can exist between an MC of the primary TMS (PGC-MC), an MC of the VPCPS (VPCPS-MC), or both. In aspects, such a slight difference exists between a VPCPS-MC and the BI of the container within which it resides, and a significantly larger difference exists between the diameter of an MC of the primary temperature modulating system and the largest diameter of a BI of container within which it resides, but such a slight difference exists between a PGC-MC and a portion of a container in which it resides having a reduced diameter and within which at least part of the SL of the working piston is contained. In aspects, movement of an MC encounters relatively little contact with the interior of a housing and does not create an associated level of friction during movement that DoS reduces the maximum velocity of the MC, DoS reduces the maximum work production of the device, or both DoS reduces the maximum velocity of the MC and reduces the maximum work production of the device. In aspects, such friction reduces MC movement, velocity, or both by less than about 20%, such as ≤˜5%, ≤˜10%, ≤˜5%, ≤˜4%, ≤˜3%, ≤˜2%, or less than about 1% or even less. In certain aspects, the time for an MC to complete a SL is reduced by less than about 20%, such as ≤˜15%, ≤˜10%, ≤˜5%, ≤˜4%, ≤˜3%, ≤˜2%, or less than about 1% or even less due to friction encountered between the MC and the BI.

In aspects, an MC GCO, SCO, CEO, or consists of a component having a uniform diameter apart from any protruding member (PM) of the MC, apart from any rod (e.g., piston rod) or other component(s) directly connected to an MC to transfer motion to or from an MC), or apart from both a PM and one or more other component directly attached to an MC such as a rod for transferring motion to/from the MC. In certain facets, a movable component has a diameter which is substantially the same, e.g., substantially identical, across MGAOSA or all its length. That is, in aspects an MC can comprise a diameter wherein the diameter does not vary by more than about 10%, more than about 8%, more than about 6%, more than about 4%, or more than about 2% across its length, or even less such as the diameter can vary by no more than about 1% across its length. As described previously, such a relative uniformity in diameter in most aspects refers to a relative uniformity in the diameter of the plunger- or piston-like element of an MC, and not to the inclusion of a plunger- or piston-rod or similar component directly attached to the MC. In alternative aspects, an MC may lack any component identifiable as a piston- or plunger-like rod (connecting element) and the entire MC can comprise a diameter which is substantially the same, e.g., substantially identical across MGAOSA or all of its length.

According to certain aspects, a contact surface (CS) of the MC of the primary PMS (PGC-MC) is relatively flat, with no purposeful shape modification of the CS. In certain further aspects, the CS comprises no physical connection to any other component of the system, such as for example, comprises no piston rod or the like. This can be beneficial as it can increase the surface area of the CS capable of being impacted by a change in pressure of the chamber within which it resides. In aspects, the CS lacks contact with any solid component (e.g., the CS comprises no additional solid component or the CS does not make contact with the BI upon reaching the end of a full stroke in one direction.

In aspects, the PGC-MC comprises only one contact surface (CS) and a, most, generally all, or all dispensing component(s) (DC(s)) is/are oriented (e.g., the outlets of the DC are positioned) to dispense TML on only one side of the CS and on only one side of the MC.

The stroke length SL represents the maximum distance a moveable component (MC) moves, such as a PGC-MC. An SL is typically oriented in a single direction/orientation. The SL orientation is typically coaxial with the orientation of the housing of the associated container.

In aspects, one or more MCs comprise(s) protruding member(s) (“PM(s)”) that protrude through an opening in the barrier (barrier opening(s) referred to as (“SLIPBO(s)” in US '192). In aspects, the protruding member(s) DoS enhance the safety of the device, longevity of the device, effectiveness of the device, or combination of any or all thereof.

SLIPBO(s) can comprise any suitable size or shape. In aspects, SLIPBO(s) (sometimes ORT as “slots”/“openings” in the housing, barrier, or both) have a first dimension, e.g., a width, that is less than a second dimension, e.g., a length. Typically, the maximum orientation of the SLIPBO(s) corresponds to the orientation of the housing (e.g., in a horizontally oriented housing/device, the SLIPBO is also primary horizontally oriented, facilitating movement of an MC in the same orientation as the housing/device). Typically the other dimension will be such that it will allow for efficient movement of the MC, but will not allow the MC to move significantly in any orientation other than the orientation of the device (e.g., will not allow the MC to move more than ˜10%, ≥7.5%, ≥5%, ≥2.5%, or ≥about 1.5% in an orientation other than the orientation of the device, such as an orientation perpendicular to the orientation of the device, thus, e.g., the MC is prevented from rotating within the housing). Typically, the ratio between the largest dimension of the SLIPBO(s) (e.g., length) and the second dimension (e.g., height) is at least about 1.5:1, ≥2:1, ≥2.5:1, ≥3:1, ≥4:1, or at least about ≥5:1. In aspects, a device container housing comprises a single SLIPBO. In aspects, a device container housing comprises 2 SLIPBOs. In aspects, 2 SLIPBOs are positioned on opposite sides of a single device container housing. In other aspects, the device can comprise one or more containers housing one or more MC(s), however which do not comprise SLIPBO(s) within the container housing. In aspects, a device and/or system comprises at least one PM and at least one SLIPBO. In aspects a device and/or system comprises at least one PM and at least two SLIPBOs. In aspects, equivalent such housing/barrier slit/slot features (e.g., openings in barrier/housing of a container providing for the protrusion of a PM attached to an MC) can exist in a second or third housing (of VPCPS containers) associated with VPCPS-MCs. However. as the term “SLIPBO” has been described as not allowing DoS PG to escape, and such second and third housings do not comprise a PG, such slit(s)/slot(s)/opening(s) of second, third, or additional containers associated with a VPCPS may be identified only as such slit(s)/slot(s)/opening(s), though their functionality can be similar to that of a SLIPBO in that they do not allow an unintentional DoS release of vacuum pressure.

According to specific exemplary facets, any one or more SLIPBOs (e.g., “slits”/“slots”/“openings”) is/are an elongated slit or slot of less than ½ of an inch wide, e.g., less than ¼th of an inch, less than ⅛th of an inch, or less than 1/16th of an inch in width. As used here, the term “width” refers to the dimension of the SLIPBO perpendicular to the longest dimension of the housing in which it resides, perpendicular to the orientation of movement of the MC with which the SLIPBO is associated, or both. According to alternative facets, the opening is an elongated slit having a width wider than ˜½ inch (˜1.3 cm), such as ˜⅝th of an inch (˜1.6 cm), ˜¾th of an inch (˜1.9 cm), ˜⅞th of an inch (˜2.2 cm), ˜1 inch (˜2.5 cm), or wider, e.g., ˜1.5 inches (˜3.8 cm), ˜1.75 inches, or ˜2 inches (˜5.1 cm). In aspects, the width of the opening represents less than ˜50%, such as less than ˜45%, ≤40%, ≤35%, ≤30%, ≤25%, ≤20%, ≤15%, ≤10%, ≤5%, ≤4%, ≤3%, ≤2%, or ≤about 1% of the circumference of the housing (e.g., when the housing is in the shape of a cylinder), or ≤about 50%, such as ≤45%, ≤40%, ≤35%, ≤30%, ≤25%, ≤20%, ≤15%, ≤10%, ≤5%, ≤4%, ≤3%, ≤2%, or ≤about 1% of the circumference of the housing of the width of a side of the housing (e.g., when the housing is in the shape of a cube or rectangular box).

According to facets, the SLIPBO/opening is an elongated slit or slot having a length which is less than ˜2 feet in length (less than ˜61 cm), e.g., ≤about 22 inches (≤˜56 cm), ≤20-inches (≤˜50.8 cm), ≤˜18 inches (≤˜45.7 cm), ≤˜16 inches (40.6 cm), ≤˜14 inches (≤˜35.6 cm), ˜12 inches (≤˜30.5 cm), ≤10˜inches (≤˜25.4 cm), ≤˜8 inches (≤˜20.3 cm), or ≤about 6 inches (≤˜15.2 cm) in length. In aspects, the length of the opening represents less than approximately 50% of the overall length of the housing in which it resides, e.g., ≤about 40%≤, ≤35%, or ≤about 30% of the housing length, such as ≤about ˜25%, ˜20%, ˜15%, ˜10%, or less than ˜5% of the housing length, such as ≤about 4%, ≤3%, ≤2%, or ≤about 1% of the overall length of the housing.

PM(s) (sometimes ORT as “pins”) typically are composed of a material and have a design whereby the PM(s) can withstand an impact with the housing at velocities that exceed the intended maximum MC velocity (e.g., by ≥about 10%, ≥25%, ≥33%, ≥50%, ≥75%, or ≥about 100% (2×)). A pin/PM can comprise any shape or size capable of moving through an opening/slot (SLIPBO) in the housing (DEH). In aspects, PM(s) comprise a width (as used here, the term “width” is similar to that used to describe the SLIPBO in that it refers to the dimension of the PM(s) which is perpendicular to the longest dimension of the housing in which it resides, perpendicular to the orientation of movement of the MC with which it is associated, or both) that is at least generally or substantially the width of the opening within which it slides (SLIPBO) thus, e.g., the pin prevents the MC from being able to DoS bounce, jiggle, or rotate within the chamber. In aspects, the PM(s) have a width slightly narrower than the width of the SLIPBO (e.g., about 2% or less, e.g., ˜1.5%, 1%, 0.5%, 0.25%, or 0.1% or less than the width of the SLIPBO).

In certain aspects, the PM(s) has a width that is the same in all directions (e.g., the PM(s) is/are cylindrical in shape). In alternative aspects, a PM can have any suitable shape which allows it to move/slide within the SLIPBO with which it is associated.

In aspects, PM(s) AOA serve to limit the SL, by holding the MC back (retaining the MC) from further, unintentional, or undesired movement in any one direction.

In aspects, the PM, e.g., “pin”, acts as a safety mechanism that prevents (or, e.g., DoS reduces the likelihood of) one or more MC(s) from traveling beyond the SL when an MC is traveling at maximum or near maximum velocity. In aspects, a single PM can act as a safety mechanism for the MC to which it is immediately attached. In aspects, a single PM can serve as a safety mechanism for the MC to which it is immediate attached as well as a safety mechanism for one or more additional MC(s) of the device/system which move upon movement of the MC to which the PM is immediately attached. Alternatively, each MC of a device/system can comprise a PM which serves as a safety mechanism only for the MC to which it is immediately attached. In aspects, a PM/pin/safety component moves within a SLIPBO/opening with the movement of the MC. Typically, a pin travels to or close to the end of the opening/slot. In cases where an MC unexpectedly attempts to move beyond the SL in either direction, a/the pin (PM) travels the maximum length of the slot and contacts the end of the slit/slot/opening in the housing, thus e.g., the pin can travel no further in that direction, causing the MC to be stopped. Such AOTI are DFEH and described in US '192.

In further facets, PM(s) can serve as a connector to other component(s) of a device/system allowing for the movement of the MC to be transferred to such other component(s). In aspects, PM(s) connect directly or indirectly to MC(s) other than the MC to which they are immediately attached such that movement of the MC to which the PM is immediately attached causes movement of one or more other MCs of the device/system. In aspects, such a one or more other MC(s) can be an MC in a second container comprising a vacuum (e.g., a VPCPS-MC), whereby movement of the VPCPS-MC creates a counter pressure that works against, or acts counter to, the movement of the MC to which the PM is immediately attached. In aspects, PM(s) connect to power offtake component(s)/device(s)/system(s).

### Fluid Vessels and Barrier Components

Devices of the invention comprise containers that comprise and can be primarily formed of a housing, which can comprise barrier component(s). A housing can be of any suitable shape, size, and orientation and be composed of any suitable materials. In aspects, most, generally all, or all of the housing of a container has a single orientation (e.g., largest direction/angle and dimension). In aspects, the housing is vertically oriented. In aspects, the housing is horizontally oriented. In aspects, the device can operate in any orientation or in several orientations (e.g., when the housing is either in a vertical or a horizontal orientation). In certain aspects, two or more containers can have generally the same, substantially the same, or the same orientation. In alternative aspects, two or more containers can differ in their orientation, such as, e.g., a first container may be oriented at least substantially perpendicular to that of a second container or may be oriented such that the two containers form an angle between them of between about 1 degree and 170 degrees. In aspects, the housing can have one dimension which is longer than any one or more other dimensions of the housing. A housing of a first, a second, or any other container present in the device/system, can have a shape that mostly, generally, essentially, or entirely consists of a box-like shape, rectangular shape, or a cylindrical shape. In aspects, a housing can comprise one or more VACs. In aspects, the device is oriented so post-dispensation collected TML gravitationally moves to liquid capture component(s) (“LCC(s)”). In aspects, the housing is relatively stationary during operation.

In aspects, devices comprise a housing that houses ≥1 PGC-MC. In aspects, devices can further comprise a 2nd housing comprising a vacuum chamber. In aspects, devices can also or alternatively comprise a 2^{nd} or 3^{rd} housing comprising a heat exchange chamber. In either case, a housing comprises a barrier component, e.g., walls, that form a chamber in which, e.g., MC(s) or HEM(s) are at least partially located. The barrier component is at least substantially closed to retain its contents, e.g., to retain and maintain vacuum pressure, a liquid, or pressurized gas (PG). In aspects, the housing or barrier component comprises one or more visual aid component(s) (VAC(s)).

In aspects, the invention provides selectively openable systems for transforming temperature differences into work comprising (a) a device having any one or more of the various characteristics described above, (b) one or more secondary components separate from the device, the secondary components comprising a liquid conducting system capable of holding and conducting a liquid comprising (i) a first portion in contact with a first temperature input and (ii) a second portion in contact with a second temperature input, and (c) at least one connection element capable of connecting one or more secondary components of the secondary components to a connection element of the device.

The housing of containers of the device/systems herein comprises or is formed of a barrier component (barrier), which at least in part forms and/or defines chamber(s) within the containers. In aspects, a barrier component (e.g., a collection of 1, 2, 3, 4, or more walls) is a component that is at least substantially impervious to unintentional fluid, e.g., liquid, loss (or, e.g., pressure loss) and which forms at least in one aspect a selectively sealable pressurized gas chamber (“PGC”)

In aspects, the interior of the barrier (“BI” or “barrier interior”) of a PGC forms, at least in part, a chamber which can in aspects comprise a PG or, e.g., an IVS. In aspects, the term “barrier interior” is functionally synonymous with “barrier component”, in that a BC of a PGC forms, at least in part, a chamber such as that described here. In aspects, the term “BI” simply means the barrier component which faces or makes contact with a chamber (e.g., an inward-facing face of such a component), as opposed to an outward-facing face of a barrier. For example, if a barrier component is a wall having a thickness, a BI can be the inward-facing face of such a wall, as opposed to the outward-facing face of the wall, however it is the barrier component itself which still forms, at least in part, a chamber. In aspects, the BI comprises at least a portion of the SL (e.g., most, or generally all of the SL). In aspects, the BI comprises some, most, or generally all of an PGC-MC during the crossing of such an SL.

MGASAOA of the composition of the BI, PM(s), MC(s), and other components of the device/system (e.g., the DC(s)) is/are comprised of material(s) which cannot be corroded by water (i.e., non-water corrosive materials), the TML, energy transfer liquid, a PG, or any combination thereof (e.g., SMGAOA of SMGAOA of such component(s) are composed of material(s) or are at least plated (e.g., covered) with material(s) that are non-corrodible by kerosene, turpentine, WD-40® or its equivalent, or other liquid used as an energy transfer liquid or any combination thereof). In aspects, material(s) that make up SMGAOA of SMGAOA of such component(s) has a yield strength of at least about 40,000 psi, such as at least about 45,000 psi, ≥50,000 psi, ≥55,000 psi, ≥60,000 psi, at least about 65,000 psi, ≥70,000 psi, ≥75,000 psi, ≥80,000 psi, or even more, such as at least about ≥85,000 psi or ≥about 90,000 psi. In aspects, the material(s) that make up SMGAOA of SMGAOA of such component(s) has a tensile strength of at least about 60,000 psi, e.g., ≥about 65,000 psi, ≥70,000 psi, ≥75,000 psi, ≥80,000 psi, ≥85,000 psi, or even more, e.g., ≥90,000 psi or ≥about 95,000 psi. In certain exemplary aspects, one or more components of the device are comprised of a heat-treated stress relieved steel 41/40.

In some respects, less than about half, less than ˜25%, or ≤˜10% of any component(s) of the device/system are bound by welding.

In aspects, the yield strength of any one or more components, is defined by its weakest point, such a weakest point comprising a yield strength of at least about 40,000 psi, such as at least about 45,000 psi, ≥50,000 psi, ≥55,000 psi, ≥60,000 psi, at least about 65,000 psi, ≥70,000 psi, ≥75,000 psi, ≥80,000 psi, or even more, such as at least about ≥85,000 psi or ≥about 90,000 psi. In aspects, the device or device components comprise no detectable area of weakness or material stress. E.g., in aspects at least about 75%, at least ˜80%, at least ˜85%, at least ˜90%, at least ˜95% or even more, such as ˜96%, ˜97%, ˜98%, ˜99%, or even 100% of the barrier of the chamber has the same stress relief properties. As used here, the term “stress relief” refers to the properties of a component/device or part that reflect how the component/device or part responds to stress (e.g., fluidity or compression properties, of a material when heated and cooled). Differences in “stress relief” properties typically reflect changes in material composition, amount, or configuration, e.g., where a metal is welded vs. where it is not welded. In aspects there are no areas of the device which exhibit differing stress relief characteristics due to welding. In aspects, a drill and tap method is used for most, generally all, or all connections of components in the device/system. In aspects, threading is used to connect one or more components. In aspects, heat-treated materials, e.g., heat-treated stress relieved steel 41/40 makes up some, most, generally all, substantially all, or all of the barrier, MC, or other components of the device, e.g., the components of the device outside of any LCS, viewing component (VAC), etc. In aspects characteristics of a suitable material used in such parts/components of devices/systems include but may not be limited to high yield strength and non-corrodibility (by any fluid, e.g., liquid or gas, of the device or system with which it may make contact). In some respects, a suitable material may be a layered material, e.g., a layered material wherein one layer provides strength characteristics (e.g., a braided reinforcement layer) and another layer provides corrosion protection (e.g., a PVC layer).

In aspects, a container housing can further comprise one or more closure component(s) that facilitate selective opening/closing of the housing. In aspects, closure component(s) form an end of the BC (or BI) of a container. Such closures can be any type of closure serving to seal the housing such that the housing comprises a chamber within it that is substantially impervious to unintentional fluid (e.g., liquid), gas, and or pressure (e.g., vacuum pressure) loss. In aspects, one or more ends of a/the housing is/sealed due to such an end being comprised of the same singular body of the housing walls (e.g., the boundaries of the housing in the opposite plane as then end of the housing). In aspects, the closures can be caps which can be attached to the housing by welding or similar type of sealing, by threading (e.g., the caps can be screwed onto or into the housing), hinged and sealed by clamping, or the like. Such attachment by any mechanism can be capable of withstanding at least the highest operating pressures of the device or system without compromise, preferably significantly more, e.g., at least about 10%, ≥20%, ≥30%, ≥40%, ≥50%, ≥60%, ≥70%, ≥80%, ≥90%, or ≥about 100%, or even more, such as ˜3×, ˜5×, ˜7×, or about 10× more pressure than the highest operating pressure of the system.

In aspects, the housing of the first container (e.g., the container comprising the primary PG chamber and PGC-MC or working piston) comprises access port(s) to the first container, or, e.g., specifically to the PG chamber, the access port(s) providing access for filling the chamber with PG. Where the device/system comprise(s) PG tank(s), such tank(s) can be connected to access port(s). Alternatively, access port(s) can comprise fittings (e.g., threading, seals, and the like) that sealingly engage extraneous PG tank(s) when PG gas administration/pressurization is required/desired. Access port(s) are typically selectively closeable & sealed to DoS PG loss if closed.

In aspects, initial pressurization, or re-pressurization of the chamber(s) comprising PG within the housing of the first container occurs primarily, generally only, or only through the filling the cylinder with a gas (e.g., N₂ gas), and henceforth pressure of PG within the PG chamber is only intentionally changed by dispensation of a TML or exposure of the PG to HEM(s). In aspects, closure component(s) can comprise VAC(s).

In aspects, an interior part of the SL (“SLIP”) is closed to PG. In aspects, some of a PGC-MC is at least sometimes in operation positioned in a SLIP. In aspects, the portion of the housing surrounding the SLIP comprises opening(s) in a barrier component/housing.

The components of a container comprising PGC(s) can be arranged in any suitable manner. In one example, the components are arranged from one end to another end in an IVS-other parts of PGC-SLIP arrangement, with the PGC-MC sometimes being at least partially contained in the PGC and sometimes being at least partially contained in the SLIP.

In aspects, the temperature of the barrier modulates the average temperature of the PG by about ≤1% during MGASAOA operation cycles, such as by less than ˜0.85%, ≤0.7%, ≤0.6%, ≤0.5%, ≤0.4%, ≤0.3%, ≤0.2%, or ≤0.1% of the average PG temperature. In aspects, the barrier of a heat exchange chamber can allow for the modulation of the temperature of a heat exchange material held therein, such that it can allow a flow of energy in the form of heat into and out of a heat exchange chamber, such as which may occur if a heat exchange chamber was wrapped in a heating or cooling blanket. In certain aspects, a barrier of a heat exchange chamber can allow for an external temperature source to impact the temperature of an HEM therein, such as, e.g., a body of air to establish a “warm HEM” or relatively cool water (e.g., relative to the temperature of a body of air) to establish a “cool HEM”.

### Control of Fluid Flow in Devices and Systems

The TMS can, in aspects, comprise a recirculation system that captures and recycles dispensed TML, returning such TML to the DLCS. In aspects, the DLCS is generally, substantially, essentially, or completely free of PG. In aspects, the device comprises LCC(s) that collect TML and returns the collected TML to the DLCS for recycling. In aspects, ≥˜90%, ≥95%, ≥97%, or ≥˜99% of the TML volume is retained after sustained OCPs, e.g., ≥about 3, ≥6, ≥9, ≥12, ≥18, ≥24, ≥30, ≥36, ≥48, or ≥about 60 months.

The TMS can, in aspects, comprise a recirculation system that captures and recycles one or more portions of an energy transfer fluid, e.g., an energy transfer liquid, returning such energy transfer liquid to an HEC after having been in a PGC, and vice versa. In aspects, the device comprises LCC(s) that collect energy transfer liquid from a primary PGC and allows for the energy transfer liquid to exit the PGC, at which time energy transfer liquid flows through energy transfer fluid line(s) to HEC(s). In aspects, device(s)/system(s) can comprise two or more portions of an energy transfer fluid each portion flowing only between a PGC and a single HEC. In aspects, timing of flow, direction of flow, volume of flow, and other such flow characteristics can be controlled, either manually or automatically (e.g., via pre-determined/pre-programmed preferences) by a control system comprising microcontroller(s).

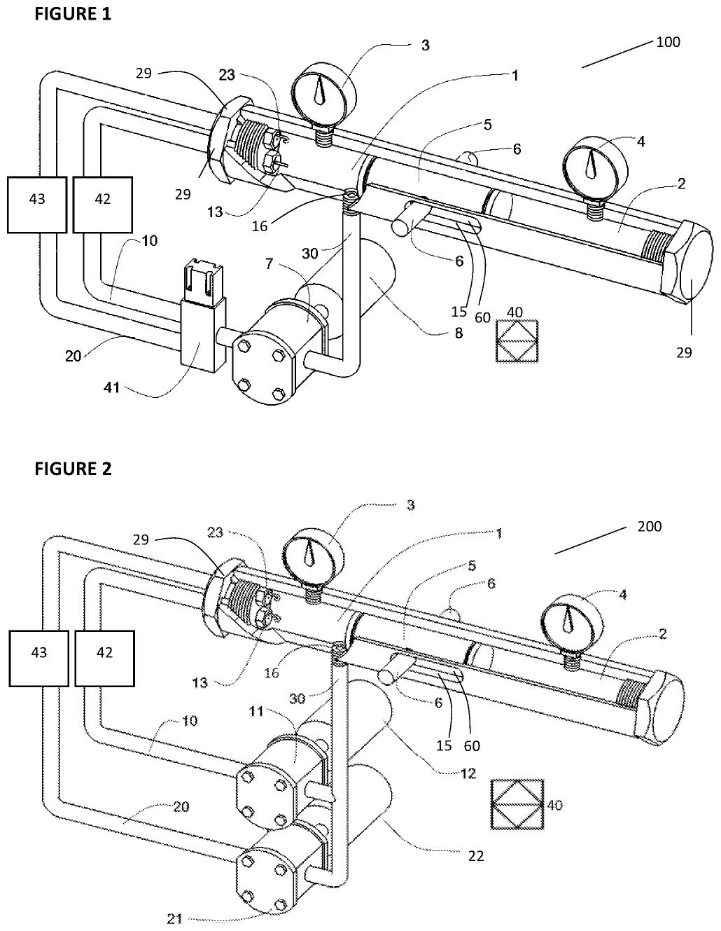

According to aspects, the device and/or system can comprise a mechanism for allowing the system to switch the flow from T1S and T2S to other parts of the system, such as the DC(s). In aspects, a device/system comprises a component/device that acts as a switch (a “source switch” (“SS”)), that reverses the flow from T1S & T2S to other parts of the system/device. In aspects, the SS comprises a valve. In certain facets the valve can be positioned between DC(s) of the device and other parts/components of a TMS. An SS can be in a device, system, or both. In aspects, a source switch (SS) is positioned between (in terms of normal flow, spatially, or both) pump(s) and DC(s). This is exemplified in, for example, one aspect of FIG. 1, a single embodiment, herein. In aspects, a device/system comprises dispensation enclosures & SS(s) change the connection between the dispensation enclosures & other parts of the device/system. According to some aspects, a device/system can operate without an SS. In aspects, a device/system can operate completely independently for at least a 24-hour period without an SS. In aspects, even if a T1S and a T2S were to reverse their temperatures relative to one another, e.g., TIS changes from becoming the warmer of TIS and T2S to the cooler of T1S and T2S, a device/system can operate, even if at a reduced efficiency or providing a reduced power output, during such a temperature reversal period.

Devices can also include fluid switch(es) (T1L/T2L switch(es)) that in operation alternate(s) the dispensing of T1L and T2L into the PG/PG chamber. In aspects, a fluid switch can serve to control the alternating dispensation of a first portion of an energy transfer liquid and a second portion of an energy transfer liquid into a PGC, the alternating dispensation of an energy transfer liquid into and dispersal of the energy transfer liquid out of a PGC, or both.

Aspects of device(s) described above and herein can apply to system(s)- and method(s)-directed AOTI described below and herein. E.g., devices in one aspect comprise source switch(es) (SS(s)) which reverse the sourcing of T1L and T2L. As such, methods can comprise use of a SS and systems can comprise devices comprising a source switch, or, alternatively, a SS can be a separate, secondary component of a system which operates cooperatively with a device.

Typically, at least a part of a DLCS will run along the exterior of the housing of a PGC container (i.e., on the outside of the barrier), inside the barrier, inside the chamber, or a combination thereof. In aspects, at least a part of a DLCS (e.g., most of the DLCS or generally all of the DLCS) is free of any contact with the housing (e.g., where the DLCS comprises portions in contact with T1S and T2S). In aspects, the PGC container housing/DLCS comprise(s) connection(s) to an SLCS. In aspects, energy transfer fluid (e.g., liquid) lines can be exterior to housing(s), e.g., can be exterior to a housing of a PGC container, heat exchange container, or both, or can be on the inside of a barrier, inside of a chamber, or any combination thereof. In aspects, at least a part of energy transfer fluid line(s) can be free of any contact with a housing. In aspects, energy transfer fluid line(s) can comprise connection(s) to a device, a system, or an external system such as an external system liquid conducting system (e.g., SLCS).

In aspects, the DLCS (or DLCS & SLCS), as described in US '192, are generally composed of piping or tubing or similar liquid conduits, e.g., a helical, spiral, or horizontally or vertically oriented liquid conduits. The liquid conduit(s) can be made of any suitable material that is non-reactive with the TML and impervious to DoS TML loss over extended periods of time and at operating pressures. In aspects, energy transfer fluid lines are made as short as feasible given the operating conditions and space, e.g., given the configuration of the device or system, as in aspects, shorter lines can improve device/system efficiency over longer lines. In aspects, any “line” facilitating transport of fluid can be referred to as a “conduit”. In aspects, the conduit(s) of device(s)/system(s) here is/are a tubing, e.g., a flexible tubing. In aspects such tubing can comprise one or more fittings or connectors capable of connecting two or more sections of tubing and/or connecting the tubing to one or more other components of a device or system. In aspects such a flexible tubing can comprise acrylonitrile butadiene styrene (ABS); a thermoplastic polymer such as a polycarbonate material; a polyethylene (PE) material such as, e.g., linear low-density polyethylene (LLDPE), low-density polyethylene (LDPE), medium-density polyethylene (MDPE), high-density polyethylene (HDPE), high molecular weight (HMW) high density polyethylene (HDPE); polypropylene (e.g., homopolymer, copolymer); polystyrene (e.g., high impact polystyrene (HIPS), crystal styrene); polyurethane (e.g., polyester, polyether); polyvinyl chloride (PVC), e.g. rigid PVC or flex PVC; synthetic rubber (e.g., thermoplastic vulcanizates (TPV), thermoplastic polyurethane (TPU), thermoplastic elastomer (TPE), olefin block copolymer (OBC); nylon, vinyl, or any such similar or equivalent plastic tubing materials having suitable compatibility and design capability characteristics. In aspects, a plastic used can comprise one or more plasticizers added to improve flexibility.

In aspects, the conduit(s) is/are a piping, e.g., a piping comprising any of, alone or in combination, straight, curved, or elbowed sections. In aspects the piping can be made of a non-TML-corrodible material (relative to the TML and in aspects relative to any environmental elements, e.g., water, sun, waste liquids or waste gases), e.g., a rigid plastic or a metal. In aspects, such piping can comprise a plastic described above or a similar or equivalent plastic having a rigid structure. In aspects, such piping can comprise a metal, e.g., nickel, chromium, molybdenum, manganese, silicon, copper, or alloys/blends, e.g., steel, such as heat-treated stress relieved steel 41/40, or any combination of alloys/metals providing suitable qualities for the DLCS(s) and SLCS(s) DEH. In aspects, pipe(s) can be made of stainless steel.

In aspects a DLCS or a SLCS, or, e.g., energy transfer fluid lines/conduits may be comprised of a single material. In aspects any DLCS, SLCS, or energy transfer fluid line/conduit in a single system may be comprised of the same material, while in alternative aspects any DLCS, SLCS, or energy transfer fluid line/conduit of the same system can each alone comprise two or more materials or when considered together can comprise two or more materials. In certain aspects, one or more sections of a DLCS, SLCS, or energy transfer fluid line/conduit can comprise tubing or piping of a different material than another one or more sections of the DLCS, SLCS, or energy transfer fluid line/conduit. For example, in certain aspects, (a) section(s) of a SLCS passing through T1S or T2S can comprise a material wherein heat transfer is different relative to sections of a SLCS not passing through T1S or T2S. For example, a portion of a SLCS passing through T1S or T2S can comprise a material wherein heat transfer is increased relative to sections of a SLCS not passing through T1S or T2S, thus e.g., as a portion of TML passes through the section of a SLCS exposed to T1S or T2S, it is effectively and sufficiently heated or cooled during passage through the section, and when traveling through a section of the SLCS between T1S or T2S and the device, the material of the DLCS is capable of reducing heat gain or loss, maintaining the temperature of the TML within at least about 50% of the temperature established by exposure to T1S or T2S, such as within ˜50%, ˜45%, ˜40%, ˜35%, ˜30%, ˜25%, ˜20%, ˜15%, ˜10%, ˜5%, or even within about 1% of the temperature established by exposure to T1S or T2S. In aspects, the material of the DLCS between T1S and/or T2S and the device is capable of preventing heat loss or gain by the TML of more than about 50%, ˜40%, ˜30%, ˜20%, ˜10%, ˜5%, or even by more than about 1%.

In aspects, a liquid conducting system can comprise any length of liquid conduction equipment (e.g., tubing, piping, or the like). Depending on the scale of the device/system and/or its proximity to T2S and T2S, tubing, piping, or the like can extend over a distance of inches/centimeters, yards/meters, or miles/kilometers. In aspects, liquid conducting systems can extend across feet, tens of feet, hundreds of feet or as much as about 0.25, ˜0.5, ˜0.75, ˜1, ˜2, ˜3, ˜4, or ˜5 miles or more, e.g., across about 1 meter, tens of meters, hundreds of meters, or, e.g., about 0.25, ˜0.5, ˜0.75, ˜1, ˜2, ˜3, ˜4, ˜5, ˜6, ˜7, ˜8, ˜9 or ˜10 kilometers or more.

In aspects, an energy transfer fluid line/conduit can comprise any distance/length of tubing, piping, or the like, depending on the scale of the device/system and/or, for example, the proximity of a primary PGC to one or more HECs.

According to aspects, a liquid conducting system (LCS) of devices/systems comprise source switch(es) (SS(s)) (sometimes ORT as an orientation switch (“OS”)). In certain facets, the SS can be a valve. In aspects, the valve can be located between a connected LCS (aka SLSC) and at least one DC of a device. In aspects, an SS changes the input to the DC/DC part from T1S to T2S; such a SS allowing the system to be operable when the gradient of temperature difference between the first temperature and second temperature inputs, e.g., T1S & T2S, in contact with the first and second portions, e.g., T1L & T2L, of the LCS input reverse (e.g., where T1S & T2S are environmental sources and time passes from night to day). That is, in aspects, the device is operable even when the high temperature/low temperature relationship between T1S & T2S switches (e.g., T1S goes from hot to cold and T2S correspondingly goes from cold to hot). In aspects, a LCS can comprise a SS for changing connection between dispensers of the device and the LCS, such that the 1st portion of the liquid from the LCS can be switched to receiving the 2nd portion of the liquid from the LCS and a component of the device receiving the 2nd portion of the liquid from the LCS can be switched to receiving the 1st portion of the liquid from the LCS.

In certain embodiments, device(s)/system(s) provided by the invention can operate continuously, without manual intervention, without one or more SS(s)/OS(s).

In aspects, a device or system comprises the ability to store a liquid (e.g., a first portion of a TML) having a first temperature, e.g., a “warm” fluid, and a liquid (e.g., a second portion of a TML) having a second temperature, e.g., a “cool” fluid. In aspects, such stored liquid can be used in operation, e.g., to restart a system after having been inactive or to continue operation of a system during a period of time during which the T1ΔTL between a T1S and a T2S is insufficient to support normal operation.

In aspects, devices comprise liquid switch(es), sometimes referred to as a T1L/T2L switch, that cause alternating dispensation of T1L and T2L into the PG. A T1L/T2L switch can be any mechanism capable of changing or controlling the TML that is to be dispensed on the next operation/actuation of the DC(s), such as a mechanical or mechanically driven switch, a valve, and the like. Such switch(es) can operate automatically in response to sensors, timers, programmable electronic processors, or combinations thereof. In aspects, T1L and T2L are dispensed by the dispensation component via separate dispensing conduits, each comprising their own plurality of dispensation components (DCs). In aspects, a T1L/T2L switch can cause the alternating dispensation of T1L from a first (e.g., a T1L) conduit, and T2L from a second (e.g., a T2L) conduit.

In aspects, devices comprise a liquid capture component (LCC). While an LCC can be open and allow collected liquid to flow into an LCS, device(s)/system(s) as a whole typically are classifiable as at least substantially closed to the environment in terms of pressure and fluid exchange. Thus, in aspects, e.g., dispensation of TML into PG, changing the pressure of the PG in the PG chamber, also ultimately changes the pressure of the LCS (and the TML within it) with which it is in fluid communication via the LCC, so that when the next TML is dispensed into the chamber, the TML is at a substantially similar pressure as the PG into which it is dispensed. In aspects, devices comprise an LCC which can be selectively opened and closed to selectively release or maintain fluid, e.g., energy transfer fluid (e.g., energy transfer liquid), within a primary PGC. In aspects, however, device(s)/system(s) in such an embodiment remain typically classifiable as at least substantially closed to the environment in terms of pressure and fluid exchange. Thus, in aspects, device(s)/system(s) comprising use of HEM(s) in HEC(s) within heat exchange container(s) can comprise at a time point during an operation cycle, substantially consistent pressure between the PGC and an HEC. In aspects, a detectably or significantly different pressure can exist between the PGC and an HEC.

In aspects, the device comprises pump(s) that pump a fluid, e.g., a TML or an energy transfer fluid, through one or more parts of the TMS. In aspects, pump(s) facilitate the alternating dispensation of T1L and T2L, selectively, automatically, or both. In aspects, pump(s) facilitate the transfer of fluid from a PGC to a heat exchange chamber, the transfer of fluid from a het exchange chamber to a PGC, or both. In some respects, a plurality of pumps, e.g., 2 or more pumps can operate to, for example, push TML through one or more DLCS or SLCS flow lines or, in embodiments, push energy transfer fluid through one or more energy transfer fluid lines. In some respects, a plurality of pumps can operate in series or in parallel. In aspects, only one pump is present within a DLCS or SLCS flow line. In aspects, only one pump is associated with each HEC (that is, each HEC is associated with a separate pump). In aspects, one pump is used within one DLCS or SLCS while two or more pumps are used in another DLCS or SLCS. In aspects, pump(s) mostly, generally, substantially only, or only push(es) TML or energy transfer fluid as opposed to pull(ing) TML or energy transfer fluid (e.g., by vacuum) through a DLCS, SLCS, or energy transfer fluid line. In aspects, a sufficient volume of liquid is collected by the LCC after each complete dispensation of T1L or T2L, or after each complete dispensation of energy transfer fluid (liquid) (or also or alternatively, after any number of completed T1L and/or T2L or energy transfer fluid (liquid) dispensations), and flows into a liquid collection line, such that in at generally all or all (GAOA) times during an operation cycle period, there is enough of a force of liquid flowing into the pump for the pump (a) to DoS maintain effective operation; (b) in most cases, generally all cases, or at least substantially cases, in operation, mostly, generally only, substantially only, or only pump(s) TML or energy transfer liquid, rather than PG; or (c), both (a) and (b).

In aspects, devices/systems comprise ≥1 pump(s) that pump fluid(s) through the device/system. Pump(s) can be components of a device (e.g., a part of a TMS). In aspects, multiple pumps can be present and part of either the device or the system. According to aspects, pump(s) can be present as a component of a liquid dispensation enclosure (that facilitates dispensation of T1L or T2L).

In aspects, a TMS comprises pump(s) which operate independently from a liquid dispensation enclosure. In aspects, pump(s) are not connected to the MC, mechanically linked to an MC (directly or indirectly), or both. In aspects, pump(s) selectively drive TML or energy transfer fluid through the TMS, through DC(s), or otherwise through the device/system. In aspects, operation of such pump(s) sometimes, most of the time, generally all of the time, or only is/are powered by extraneous or stored power. In aspects, pump(s) are partially, mostly, generally, or entirely powered by power generated by the device/system. In aspects, pump(s) are controllable programmatically (e.g., by a processing unit (“PU”) capable of receiving data, analyzing data, and controlling operation of pump(s) based on preprogrammed instructions stored and executable by the PU). In aspects, the device and/or system comprises temperature sensor(s) that detect the T1ΔT2 in part(s) of the device/system and controller(s) (e.g., PU(s)) that receives inputs from temperature sensor(s) and that controls the operation of the one or more pumps based upon such inputs. In aspects, devices or systems operate such that the device and/or systems automatically stop pumping liquid to a DC when the T1ΔT2 approaches, meets, or exceeds (e.g., falls below) predetermined threshold(s); automatically begins pumping liquid to a DC when the T1ΔT2 approaches, meets, or exceeds predetermined threshold(s); or both.

Pump(s) generally can be any suitable type of pump for moving/conducting TML through the device/system, in aspects pump(s) operate in a device/system on average over prolonged periods of use (e.g., ≥6, ≥12, ≥18, ≥24, ≥30, ≥36, ≥48, or ≥60 months) with low rates of failure (e.g., failure rates of less than ˜5%, ≤˜4%, ≤˜3%, ≤˜2%, ≤˜1%, ≤˜0.5%, ≤˜0.25%, or ≤˜0.1%). In aspects, a device/system comprises pump(s) capable of pumping SMGAOA TML or energy transfer fluid (liquid) through a significant distance, such as e.g., from a point of collection from a liquid capture component (LCC) of the device housing to DC(s) (through the DLCS or DLCS&SLCS or to an HEC and back to a PGC).

In aspects, TML passes through temperature input(s)/source(s) (T1S & T2S). In aspects, a single pump pumps MGAOSA or all TML captured by an LCC back to DC(s). In aspects, the device or device & system comprise(s) 2 separated parts of a TMS (1 for T1L and another for T2L). In aspects, a device/system comprises components configured to or means for routing a portion of TML collected by the LCC to the T1L part (“T1LP”) (also referred to as a “first path”) of a DLCS or combined DLCS&SLCS (“CDSLCS”) and an approximately equal portion of dispensed TML to a 2nd part (“T2LP”) (also referred to as a “second path”) of a DLCS/CDSLCS.

In aspects, the T1LP comprise(s) T1S input(s) and the T2LP comprises T2S input(s) or sources (collectively, T1S & T2S, respectively). The input(s) can be any suitable inputs. Typically, the inputs provide for indirect contact of the TML inside the DLCS or CDSLCS with the sources of temperature that generate T1 and T2 (e.g., a lake & an air mass, a heat exhaust and a cold exhaust, etc.). E.g., in aspects a T1S is, e.g., a location where the tubing, piping, or the like that makes up the DLCS or CDSLCS passes through a source of T1 (and the same is true for T2S). In aspects, the material of the LCS, the configuration of the LCS, or both, is adapted at the input(s)/source(s) to provide for better temperature transfer between the source of T1/T2 and the TML in the LCS.

In aspects, T1S and T2S are used to control the temperature of one or more heat exchange containers or HEC(s) or HEM(s) comprised therein. In aspects, this is accomplished by exposure of the heat exchange chamber directly to the T1S or T2S (e.g., a first heat exchange container is placed in a body of air, exposed, for example to warm sunlight and a second heat exchange container is placed in a body of water, exposed, for example, to the cool depths of such a body of water). In other aspects, a T1L or T2L, having their respective temperatures established by exposure to a T1S or T2S, can be used to establish the temperature of a heat exchange container or HEC or HEM held comprised therein. In aspects this can be accomplished by, e.g., circulating such a T1L or T2L around or within conduits within the container or HEC. Such a circulation and such conduits being effective in establishing the temperature of the HEM therein to be within no more than about 20%, such as ≤˜18%, ≤˜16%, ≤˜14%, ≤˜12%, ≤˜10%, ≤˜8%, ≤˜7%, ≤˜6%, ≤˜4%, ≤˜3%, ≤˜2%, or, for example, ≤˜1% of that of the T1L or T2L.

In aspects, multiple pumps are used to pump TMF/TML through the system. In aspects, 1 pump can selectively, automatically, or regularly pump TML through at least part of T1LP and a 2nd pump can selectively, automatically, or regularly pump TML through at least part of T2LP. In AOTI 3, 4, or more pumps are in the device/system. E.g., in one aspect, a 3rd pump selectively, automatically, or regularly drives TML through DC(s). In AOTI, at least 1 pump is not actuated to dispense TML from any DC by a mechanical connection to the movable component (MC).

In aspects, pump(s) use relatively small amounts of energy. According to certain embodiments, the energy used to operate pump(s) is at least about 50%, such ≥˜55%, ≥˜60%, ≥˜65%, ≥˜70%, ≥˜75%, ≥˜80%, ≥˜85%, ≥˜90%, ≥˜95%, or in aspects even up to ˜100% or 100% on average generated by the operation of the device at the time of operation. In certain facets, the energy to operate the pump(s) during an OC/OCP is at least ˜75%-˜100% on average generated by the operation of the device at the time of operation. However, in aspects, the amount of total energy output of the device used to operate the pump(s) over an extended period (e.g., a day, a week, a month, a quarter, a year, etc.) is <50% of such total output of the device, such as ≤˜33%, ≤˜20%, ≤˜10%, or ≤˜5%, ≤˜2%, or ≤˜1% of the total power generated by the device in such an extended period. This can be because, for example/inter alia, pump(s) may operate only a fraction of time that a device is in operation (e.g., ≤˜33%, ≤˜20%, ≤˜10%, or ≤˜5% of total device operation time over such an extended period).

Examples of suitable types of pumps that can be incorporated in device/systems include positive displacement pumps, centrifugal pumps, or axial flow pumps, e.g., a rotary-type positive displacement pump (e.g., a peristaltic, an internal gear, screw, shuttle block, flexible vane or sliding vane, circumferential piston, flexible impeller, helical twisted roots, or liquid-ring pump), a reciprocating-type positive displacement pump (e.g., a piston pump, plunger pump, or diaphragm pump), or a linear-type positive displacement pump (e.g., a rope or chain pump), or e.g. an impulse pump, velocity pump, steam pump, or valveless pump. According to AOTI, a device/system comprises rotary pump(s).

According to aspects, pump(s) can be operated/actuated or otherwise controlled by a controller, e.g., a PU, receiving input from one or more means of sensing temperature or pressure change(s) (e.g., from one or more such sensors such as a temperature and/or pressure sensor). In aspects, one or more thermocouples aid in the detection of system status and participate in the initiation of a pump based on the status of the environment such a one or more thermocouples detects.

### Changing Pressurized Gas Temperature/Moving PGC-MC(s)

In aspects, liquid(s)/fluid(s) can be dispensed into a PGC via dispensation (dispensing) component(s) (DC(s)). A chamber comprising DC(s) can comprise one or more of a liquid capture component (LCC). In aspects, a DC of a device is a multi-outlet DC (“MODC”) (e.g., a DC comprising ≥2 nozzles or other dispensing outlets). In aspects, a DC comprises a single outlet for each dispensed liquid or a single outlet through which two or more liquids, e.g., two portions of a TMLs or two portions of an energy transfer liquid, are dispensed.

In aspects, most, generally all, nearly all, or all of any dispensation of a first portion of fluid/liquid (e.g., T1L) occurs before any dispensation of a second portion of fluid/liquid (e.g., T2L) during some, most, generally all, nearly all, or all times of device operation. In aspects, most, generally all, nearly all, or all dispensation of a first portion of an energy transfer fluid into a PGC occurs in alternating fashion with a second portion of an energy transfer fluid into the same PGC, with a period between such dispensations wherein the PGC comprises at least substantially a PG instead of an energy transfer fluid. In aspects, such periods of time alternate a period wherein the PGC comprises a relatively warm PG and a period wherein the PGC comprises a relatively cool PG (relative warmth and coolness of the PG being relative to one another across time periods).

In certain aspects, (i) dispensing the TMF/TML or energy transfer fluid takes up no more than ˜10%, ˜20%, ˜25%, or ˜33% of the work/energy produced by the movement of the MC over the corresponding period or extended period of operation, (ii) the pressures of the TMF/TML or energy transfer fluid and PG before operation vary by no more than about 5%, or (iii) the operation of the device is consistent with both (i) and (ii).

In aspects, the device is configured to have a dispensation gap. In aspects, the device has an average dispensation gap that DoS enhances the work performed by the device during SMGAOA of operation. In aspects, the dispensation gap generally or substantially DoS enhances the work output of the device during SMGAOA periods of operation. In aspects, the dispensation gap in operation mostly is, generally is, substantially is, or always in operation is ˜0.1-˜2.5 seconds (aka, “sec”), ˜0.25-˜2.5 sec, ˜0.3-˜2.4 sec, ˜0.4-˜2.4 sec, ˜0.5-˜2 sec, ˜0.5-˜2.5 sec, ˜0.75-˜2.25 seconds, or ˜0.8-˜2.2 seconds.

Dispensing component(s) (DC(s)) will commonly be located within the interior of a PGC container housing, and typically most, generally all, or all of the outlets of DC(s) are located in PGC(s). In aspects, TML is deposited/dispensed on a single side of a SLIP. In aspects, a PGC-MC comprises only one contact surface (CS) and the DC is oriented to dispense liquid at least mostly, nearly only, or only on one side of the CS.

In aspects, a device comprises PGC(s) comprising both DC(s) and LCC(s). In aspects, devices comprise a single chamber within the first container comprising DC(s) and LCC(s) (a dispensation chamber comprising PG into which TML is dispensed) and a SLIP comprising no DoS PG (e.g., a SLIP that is open to the environment in part such as having one or more openings in the barrier yet maintains the pressure within the PGC).

In aspects, a device is adapted (e.g., dispensing component part(s) such as outlet(s) are arranged/configured) such that dispensing of TML droplets can occur in at least 25%, such as ≥33%, ≥40%, ≥50%, ≥60%, ≥66.6%, ≥70%, ≥75%, or ≥80% of the chamber holding PG. In facets, the device/system comprises a dispensation system comprising a plurality of DCs to dispense liquid into a single volume of PG. In aspects, a device is adapted (e.g., dispensing component part(s) such as outlet(s) are arranged/configured) such that dispensing energy transfer fluid (e.g., energy transfer liquid) which fills at least about 20%, ˜30%, ˜40%, ˜50%, ˜60%, ˜70%, ˜80%, ˜90%, or, e.g., ˜95% or more of the PGC. In aspects, a device is adapted (e.g., dispensing component part(s) such as outlet(s) are arranged/configured such a sufficient amount of energy transfer fluid (liquid) is dispensed to displace at least about 20%, ˜30%, ˜40%, ˜50%, ˜60%, ˜70%, ˜80%, ˜90%, or, e.g., ˜95%, ˜96%, ˜97%, ˜98%, ˜99%, or more of the PG in the PGC when the energy transfer fluid (liquid) is dispensed into the PGC holding PG.

According to certain aspects, a dispensation component (DC) can comprise a plurality of DCs. In aspects, a DC can comprise one or more conduits (also sometimes referred to as a dispenser tubes), which can each comprise a plurality of dispenser outlets which are uniformly spaced across the conduit. In aspects, the plurality of DCs can be positioned in any position relative to one another, such as next to or above/below one another. In aspects, such DCs can be positioned parallel to one another. In aspects, such dispensation components can intersect or cross above/below one another. In aspects, each of the DC(s) of a device comprise a plurality of dispensing outlets. In aspects, each dispensing outlet is capable of dispensing T1L and/or T2L in more than one direction during any single TML dispensation. In aspects, conduit(s) can comprise dispensing outlets which are non-uniformly spaced across the conduit. In aspects, a plurality of conduits can have dispensing outlets which are spaced mostly, generally, or only uniformly (with respect to each other). In alternative aspects, some, most, generally all, nearly all, or all conduits of a DC can have dispensing outlets which are spaced differently than those of another conduit.

In aspects, in at least some operating conditions, the area covered by T1L/T2L dispensed from one outlet of a DC overlaps the area covered by T1L/T2L dispensed from a second outlet of the same DC, another DC, or both. In aspects, in at least some operating conditions, the area covered by T1L/T2L dispensed from one outlet in one direction overlaps the area covered by T1L/T2L dispensed from a second outlet of the same DC, another DC, or both, in the opposite direction. In aspects TML dispensed by a dispensation component (e.g., conduit and associated outlets) fills at least approximately 50%, ≥˜75%, or ≥˜90% of the PG-filled chamber into which it is dispensed. In aspects, ≥25%, ≥33.3%, ≥50%, ≥66.6%, ≥75%, or ≥90% of dispensed TML travels across more than 10%, e.g., more than 25% or in aspects more than 50% of the chamber in the orientation in which the TML is dispensed (and the dispensed droplets have a corresponding velocity in order to achieve such a result). In aspects, most, generally all, nearly all, or all of the DC parts (e.g., DC conduits and any dispensation outlets comprised thereon/therein) are placed along one portion of the chamber in its largest dimension (e.g., down the length or longest dimension of a chamber or along one barrier component (e.g., along one wall) of a chamber or, e.g., positioned concentrically within a cylindrical chamber).

In aspects, the amount of TML released during each dispensation, the timing of TML dispensation (e.g., length of time TML is dispensed), the size of the CS(s) of the PGC-MC exposed to a TML, the size of VPCPS-MC(s), or other device characteristics or any combination thereof is/are selected such that it/they is/are suitable for addressing loss of available stroke length caused by the counter pressure exerted by the VPCPS, on the opposite side of the MC, maximizing the maximum work production of the device while conforming to the restrictions in device and/or system design provided by, e.g., the environment in which the device and/or system operates. In certain aspects, there is no substantial loss of available stroke length caused by the counter pressure exerted by the VPCPS, inasmuch as the formation of a perfect vacuum would eliminate such a loss. In aspects, such care in design affords the MC movement of a maximum stroke length while providing a balance in system efficiency.

According to aspects, at least about 10%, e.g., ≥˜20%, at least ˜30%, ≥˜40%, ≥˜50% or more, ≥˜60%, ≥˜70%, ≥˜80%, ≥˜90%, or even more of the liquid dispensed into a chamber does not contact the corresponding contact surface (CS) of the PGC-MC. In aspects, any liquid contacting the CS of the PGC-MC does not do so prior to losing (in the case of dispensed TML hotter than the PG into which it is dispensed, when dispensed) at least ˜40%, ≥-50%, ≥˜60%, ≥˜70%, ≥˜80%, ≥˜90%, or at least ˜95% of the T1L temperature. In aspects, any liquid contacting a CS does not do so prior to absorbing at least about 40%, ≥˜50%, ≥˜60%, ≥˜70%, ≥˜80%, at least about 90%, or at least about 95% of the temperature of the PG in cases where dispensed TML is colder than the PG into which it is dispensed.

In aspects, the dispensing component(s) (DC(s)), or more specifically the dispensing outlets, can be any suitable type of dispensing component outlet for dispensing droplets in the form of a spray, mist, or the like, of the TML, into the PG in the chamber(s). In aspects, dispensation of liquid as a mist is accomplished through a DC embodied as a nozzle. As used herein, the term “nozzle” refers to a device designed to control the direction or characteristics of a liquid flow as it exits an enclosed space. Such a nozzle can be any device comprising such characteristics and can assume any shape capable of accomplishing its required task of exposing liquid to the gas in such a manner so as to modify the temperature of the gas very quickly. Specific characteristics of such nozzles and the characteristics of the liquid dispensed therefrom are DFEH. In alternative aspects, the dispensing component comprises a dispensing outlet which dispenses a fluid, e.g., a liquid, in a stream, such that it dispenses significant volumes of fluid (liquid) in a relatively short period of time. In such aspects, it is the volume of dispensation and the speed in which such a dispensed volume can displace a volume of PG into which it is dispensed which aids in enhancing the efficiency of a device/system rather than the surface area of such a liquid so as to affect a temperature change. In such aspects, displaced PG is exposed to an HEM which affects the PG temperature change rather than an exchange of heat energy with the fluid directly.

In aspects, the volume of TML dispensed into the PG can modify the temperature of the PG into which it is dispensed sufficiently to cause a change in pressure in a PG and to cause a pressure differential on opposing sides of a PGC-MC, and hence causing movement of the PGC-MC (and, in aspects, associated movement of one or more MC(s) of the VPCPS). In aspects, the volume of TML dispensed into the PG is capable of sufficiently and adequately (e.g., quickly as is described elsewhere herein) modifying the temperature of the PG to at least approximately 60%, at least ˜65%, or at least ˜70%, such as at least approximately three quarters (%), or 75%, of the temperature of the TML. In aspects, while modifying the temperature of the PG to a temperature closer than 75% of that of the TML can continue to maintain operability of the system, heating or cooling the PG beyond that of ¾ of that of the TML can decrease system/device efficiency; e.g., more energy can be consumed in the process of narrowing the temperature differential between the TML and the PG than may be obtained from the work produced by such a reduction in temperature differential. In aspects, the device/system can be operated when the volume of TML dispensed into the PG modifies the temperature of the PG to less than approximately %, or 75%, of the temperature of the TML. In such circumstances, the device/system may produce less work than a system in which the PG is raised to close to 4 of that of the TML.

According to certain aspects, the device and/or systems described herein lack a powered active cooling system other than the TML. In aspects, MGAOSA or all cooling of PG during operation is attributable to the operation of the TMS (dispensing of TML).

In aspects, devices/systems comprise dispensation enclosure(s) (which may in some places herein be referred to as a dispensation housing, but which should be differentiated from the housing of the device comprising the MC), which receives TML from the DLCS (or SLCS) for selective or automatic release to a DC. In such aspects, the dispensation enclosure typically is capable of holding less than about 10 gallons (˜38 liters) of TML (e.g., T1L and T2L) while maintaining their separation, such as <˜8 gallons, ˜6 gallons, ˜4 gallons, ˜2 gallons, or <˜1 gallon (˜3.8 liters). In aspects, devices comprise 2 dispensation enclosures, 1 for relatively warmer temperature TML (e.g., T1L) and another for relatively cooler temperature TML (e.g., T2L). In aspects, the maximum volume of two such first and second chambers within a dispensation enclosure can be relatively equivalent, such as for example having a total maximum volume within ˜20%, within ˜15%, within ˜10%, within ˜5%, within ˜4%, within ˜3%, within ˜2%, or within ˜1% of each other. According to certain alternative aspects, the maximum volume of two such first and second chambers within a dispensation enclosure can differ from one another. According to certain embodiments, the device and/or system does not comprise any such dispensation enclosure.

Devices can comprise dispensation system(s) comprising any suitable dispensation components DC(s) (sometimes otherwise referred to (ORT) as a dispenser). In aspects, DC(s) can be present in only one container of a device/system (such as, e.g., in a chamber comprising a PGC-MC only). In aspects, DC(s) can be present in two or more containers of a device/system, such as, e.g., both in a primary container such as container comprising a PGC wherein one or more DCs can be present in a PGC and in one or more heat exchange containers, e.g., in each of any heat exchange chambers. In aspects, a DC can dispense an energy transfer fluid (liquid) into a PGC or into an HEC.

In aspects, SMGAOSA or all DC(s) are outside of the SL of the PGC-MC (e.g., within or below the IVS) when the DC is in a PGC comprising an MC. In aspects, at least a part of the DC(s) is within the SL. In certain aspects, a DC, if positioned or configured in such a manner so as to be at least substantially flush with a PGC wall, can be within an SL of a PGC-MC. In such aspects, at least one other DC can be present which is not positioned within an SL of a PGC-MC. In aspects, a single DC comprising a single dispensation outlet is positioned outside of the SL of a PGC-MC in a PGC. DC(s) can comprise nozzles, sprayers, misters, vents (e.g., project vents), and the like that expel, propel, spray, mist, or otherwise dispense TML in droplet/mist form into the PG in any suitable manner. DCs typically comprise ≥1 or ≥2 outlets. In aspects, the dispensation system comprises a plurality of DCs, e.g., two DCs, which may be embodied as conduits (e.g., “dispensation conduits”). Such conduits, which may also or alternatively be referred to as or embodied as “manifold(s)” or “tree(s)”, can in common aspects comprise a plurality of outlets, e.g., nozzles (or, aka vents). In aspects, T1L and T2L are dispensed through the same DC or parts of a DC. In aspects, T1L and T2L are dispensed through different DCs or different parts of a DC. In aspects comprising dispensation enclosure(s), DC(s), or parts of a DC, can receive stored TML from the dispensation enclosure(s) and dispense it through DC(s)/part(s) used for dispensation of T1L, T2L, or both, and/or can be dedicated to only dispensing dispensation enclosure TML.

In aspects, most, generally all, or substantially all (MGAOSA) or all of the DCs/DC part(s) are oriented so as to minimize uncontrolled release of TML into the PG. In aspects, DCs/DC part(s) (e.g., dispensation outlets) are oriented to dispense TML as a mist into the PG in an upward or horizontal direction, so as to reduce the risk of uncontrolled release of TML (e.g., via dripping which may have an increased likelihood of occurrence if TML were to be dispensed in a downward (gravitationally speaking) direction) and to maintain control over the dispensation of TML. Such configuration(s) are embodied in the figures incorporated and described herein. In aspects, dispensation outlets are positioned such that the release of TML therefrom is at approximately a 90-degree angle to the conduit to which the dispensation outlet (e.g., nozzle) is attached. In aspects, dispensation outlets are positioned such that TML dispensed therefrom is expelled from the outlet in a direction which is substantially parallel to the conduit to which the dispensation outlet is attached. In some respects, dispensation components, including dispensation outlets, are configured to expel the highest volume of an energy transfer fluid as quickly, as efficiently, or both as possible; hence in some such embodiments, dispensation components, including dispensation outlets, can be oriented to take advantage of gravity, and dispensation of energy transfer fluid can thus be in a direction characterizable as downward or toward the natural pull of gravity.

In certain aspects, one or more dispensation outlets of a dispensation component is capable of dispensing a TML in more than one direction. In aspects, TML dispensed from such an outlet can be dispensed in two or more directions simultaneously. In aspects, a dispensation outlet can dispense TML in 2, 3, 4, or 5 or more directions. In aspects, a dispensation outlet can dispense a TML in two directions, the directions being at about 45 degrees, ˜60 degrees, ˜75 degrees, ˜90 degrees, ˜105 degrees, ˜120 degrees, ˜135 degrees, ˜150 degrees, ˜165 degrees, or, e.g., about 180 degrees from one another (e.g., in opposite directions). In certain aspects, a device/system comprises two dispensation conduits, and in aspects one dispenses TL1, and one dispenses TL2, in alternating fashion, each dispensing conduit having multiple dispensation components, and at least two dispensing components of each conduit capable of simultaneously dispensing TML in two directions. In aspects, each dispensation conduit dispenses a TS1 or a TS2, wherein depending on the point in time of operation, TS1 could be the warmer or the colder of the TL1/TL2, and TS2 could be the warmer or the colder of the TL1/TL2. In aspects, TML is dispensed from each conduit one at a time, in alternating fashion, the T1L/T2L switch participating in establishing the alternating dispensation of TL1 and TL2.

In aspects, the dispensation pattern of a/one dispensation outlet can vary from that of another dispensation outlet of the same DC, another DC, or both. For example, in aspects the mist droplet size, the mist dispensation orientation, direction, shape, flight pattern, maximum travel distance, or other characteristics of dispensed TML from a single dispensation outlet can be different from that of another dispensation outlet of the same DC, another DC, or both. In aspects, such characteristics can vary within the same dispensation outlet, with a first dispensation point of a multi-directional dispensation outlet having one or more characteristics which varies from any second or more dispensation points of the same multi-directional dispensation outlet. In aspects, any two or more dispensation points of a single dispensation outlet, any two or more dispensation points of multiple dispensation outlets, or any two or more dispensation outlets, within the same DC or across multiple DCs, can share one or more dispensation pattern characteristics, and/or can differ by one or more dispensation pattern characteristics.

In aspects, DC(s) comprise 3 or more TML outlets, e.g., ≥˜4, ≥˜5, ≥˜6, ≥˜8, ≥˜10, ≥˜12, ≥˜15, ≥˜20, ≥˜25, ≥˜35, ≥˜50, ≥˜75, ≥˜100, ≥˜150, ≥˜200, ≥˜250 or ˜300 or more outlets. E.g., DC(s) can comprise ˜2-500, ˜2-200, or ˜2-100, ˜2-50, or ˜2-20 dispensers; ˜3-600, ˜3-300, ˜3-90, or ˜3-30 dispensers; ˜5-1000, ˜5-750, ˜5-500, ˜5-250, or ˜5-50 dispensers; or ˜10-1000, ˜10-500, or ˜10-100 dispensers, e.g., ˜20-800, ˜20-600, ˜20-400, ˜20-200, or ˜20-100 outlets. In aspects, a DC and the dispensing outlets of the DC reside along the barrier of the housing within the container in which they reside. That is, in certain aspects, the elements of the dispensation component are positioned along the wall or housing of the container in which they reside and do not extend into the central 75%, 70%, 65%, 60%, 55%, 50%, 40%, 45%, 40%, 35%, or 30% space of the chamber within which it resides. In such aspects, more than about 50%, such as more than about 55%, ˜60%, ˜65%, ˜70%, ˜75%, ˜80%, ˜85%, ˜90%, or ˜95% of the PG in the chamber is positioned on one side of the DC, e.g., the DC is positioned along a bottom or lower wall (barrier) of the container and TML is dispensed from the outlets of the DC in a generally upward fashion to make contact with the PG.

In alternative aspects, elements of a DC can extend upward from other elements of a DC. In aspects, a dispensing conduit can be positioned along a barrier of the housing within the container in which they reside, however the outlets of the DC can extend away from the dispensing conduit such that they extend into the central 75%, 70%, 65%, 60%, 55%, 50%, 40%, 45%, 40%, 35%, or 30% space of the chamber within which it resides. In such aspects, at least about 30%, such as at least ˜35%, at least about 40%, at least about 45%, at least about 50%, at least about 55%, at least about 60%, at least about 65%, or at least about 70% of the PG in the chamber can be described as being positioned above or below the dispensing outlet. For example, in some aspects, the outlets of a dispensing component, e.g., the outlets of a dispensing conduit are positioned such that they are coaxial with the container in which they reside (e.g., they are positioned along the center line (or, e.g., within ˜40%, ˜35, ˜30%, within ˜25%, within ˜20%, within ˜15%, within ˜10%, within ˜5%, or within ˜1% of the center line/central axis of the container within which they reside, as DFEH. In aspects of such embodiments, TML is dispensed from the outlets of the DC in a generally horizontal fashion to contact the PG above and below it. In aspects, TML is dispensed from the outlets of the DC in 2 opposing directions at a time to contact the PG both in front of and behind (e.g., on either side of) the outlet.

In aspects, dispensation of a TML using a DC comprising (a) manifold(s) or (b) tree(s) DoS aids in reducing the time for the dispensed TML to sufficiently modify the temperature of a PG into which it is dispensed so as to affect/effectuate movement of the MC, relative to the time it takes using a single dispenser dispensing TML as a mist having comparable droplet characteristics and dispensed in a comparable volume. In aspects, distributing the dispensation of TML as a mist throughout the chamber, e.g., throughout the PG, using one or more DC(s) in the form of a manifold or tree comprising multiple outlets DoS increases the volume of PG contacted by the TML, such contact allowing for improved heat exchange between the TML and the PG (e.g., over single outlet DC(s)). In aspects, outlets of a DC are positioned coaxially within the container, e.g., within the chamber, in which the DC resides. Stated another way, in aspects, outlets of a DC are positioned along the center line, or along the middle of, the container or chamber in which they reside. In aspects, dispensation of a TML using outlets of a DC comprising (a) manifold(s) or (b) tree(s), (e.g., dispensing conduits with multiple dispensing outlets), wherein the outlets of the DC are positioned within the central 40%, central 35%, central 30%, central 25%, central 20%, central 15%, central 10%, or central 5% of the central axis of the container within which the DC is positioned, DoS aids in reducing the time for the dispensed TML to sufficiently modify the temperature of a PG into which it is dispensed sufficiently to cause movement of the MC, relative to the time it takes to cause the same movement using a DC having outlets which reside outside of the central 40% of the axis of the container within which the DC is positioned. In further aspects, such DCs positioned within the central 40% (e.g., within the central 10% or central 5% or within the centra 1%) of the central axis of the container within which the DC is positioned further having outlets which dispense TML in at least 2 directions at once further DoS aids in reducing the time for the dispensed TML to sufficiently modify the temperature of a PG into which it is dispensed so as to affect/effectuate movement of the PGC-MC, relative to the time it takes a similar DC dispensing TML from such an outlet in a single direction.

In certain aspects, a DC in operation can comprise a plurality of dispensing outlets, and, further, a plurality of such outlets which dispense TML in at least two directions (for example DC outlet direction 1 (DCOD1), and DC outlet direction 2 (DCOD2)). It should be recognized that an outlet could, in embodiments, dispenses TML in a third, fourth, or more directions (e.g., DCOD3, DCOD4, etc.). In aspects, each outlet of a DC dispenses TML upon activation of TML dispensation from the DC at generally, substantially, or effectively, e.g., essentially, the same time. That is, each outlet of a DC dispenses TML upon activation of TML dispensation from the DC within 1 second, e.g., within ˜0.8 seconds, ˜0.6 seconds, ˜0.4 seconds, ˜0.2 seconds, ˜0.1 seconds, ˜0.05 seconds, ˜0.01 seconds, ˜0.005 seconds, about ˜0.001 seconds, ˜0.0005 seconds, ˜0.0001 seconds, or even less, of one another. In aspects, when TML is dispensed from two or more outlets of a DC in at least two directions (DCOD1 and DCOD2 of each outlet) at once effectively simultaneously, the space of the chamber comprising PG into which at least a portion of the TML dispensed from one outlet overlaps, at least in part, with the space into which at least a portion of the TML dispensed from a second outlet is dispensed. In aspects, about 20%, ˜25%, about 30%, about 35%, about 40%, about 45%, or, e.g., about 50% of the TML dispensed from each such dispensers can overlap. In aspects, about 20%, ˜25%, about 30%, about 35%, about 40%, about 45%, or, e.g., about 50% of the space covered by such TML dispensation from each such dispensers can overlap.

According to certain aspects, a) overlap of TML dispensed by/from two different outlets of a DC, b) overlap of space into which TML is dispensed by/from two different outlets of a DC, or c) both, can DoS improve upon the speed at which the temperature of the PG into which TML dispensation occurs changes sufficiently to cause movement of the PGC-MC. In aspects, decreasing the amount of time required for the PG to sufficiently change temperature, accordingly, decreases the amount of time for the PG to sufficiently change pressure to cause the PGC-MC to move. In aspects, this speeds up the rate of the back-and-forth movement of the MC, hence increasing the amount of work which can be performed by the device/system.

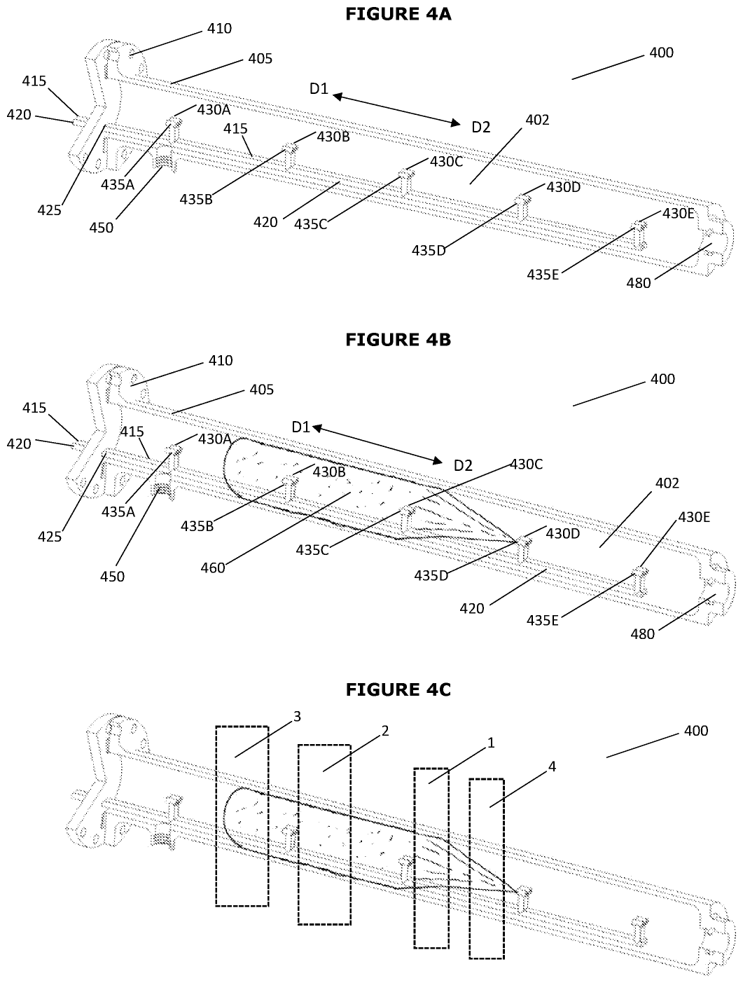

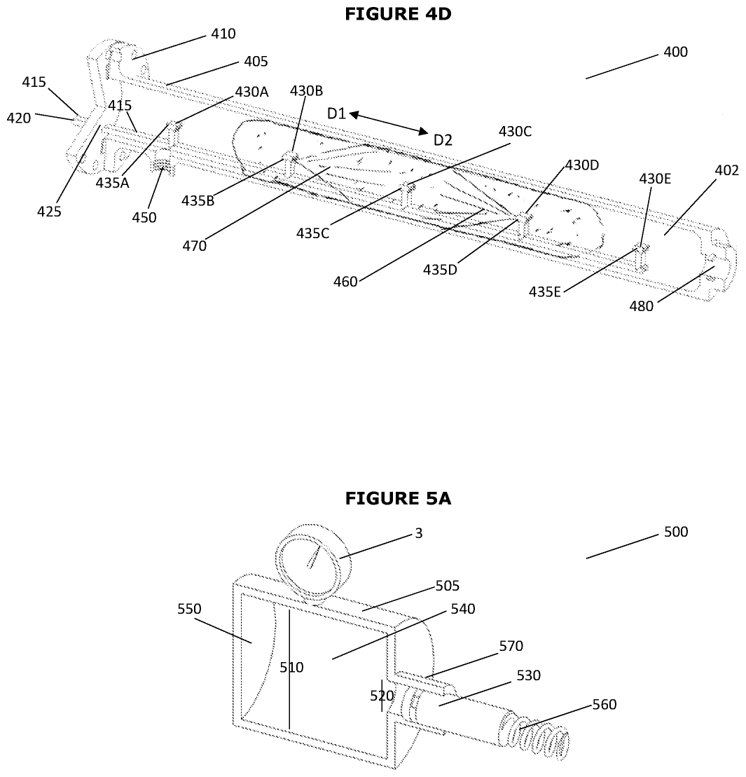

For the purpose of illustration of aspects of the invention, the following simplified example is provided, which also reflects similar embodiments shown in, e.g., FIGS. 4A-4D. An exemplary DC can, for example, comprise 4 outlets (DCOs), outlets 1, 2, 3, and 4 (which can be referred to as DCO1, DCO2, DCO3, DCO4), arranged in order from left to right such that outlet 1 is to the far left and outlet 4 is to the far right. Each of the 4 outlets can dispense TML in a first direction (D1) and a second direction (D2). Therefore, DC outlet 1 (DCO1) can dispense TML in a first direction and a second direction (DCO1D1 and DCO1D2). This is the same for outlets 2, 3, and 4. Direction 1 for each outlet is the same; for example, dispensing to the left as determined from one perspective. Direction 2 for each outlet is the same; for example, dispensing to the right from the same perspective. Therefore, for each outlet, DCO1D1, DCO2D1, DCO3D1, DCO4D1 dispensation is to the left, and for each of DCO1D2, DCO2D2, DCO3D2, and DCO4D2, dispensation is to the right. Dispensation from all outlets, in both directions, occurs effectively simultaneously. Upon activation of the DC, TML is dispensed from all of DCO1D1, DCO1D2, DCO2D1, DCO2D2, DCO3D1, DCO3D2, DCO4D1, and DCO4D2.

Upon dispensation from each dispensation outlet in each direction, dispensed TML can comprise 4 regions. In a first region, closest to the dispensation outlet, (referred to as region 4 in FIG. 4C), there is no significant mist; that is, TML has not sufficiently expanded into a mist from the dispensation outlet, leaving a region close to the outlet wherein minimal TML contacts PG of the chamber and, hence, little heat exchange occurs in that region due to TML dispensed from that dispensation outlet. In aspects, the PG of this region must also come into contact with a TML (e.g., a mist) to provide maximal efficiency in modifying the temperature and hence the pressure of the PG in the chamber. In a second region, moving outward from the dispensation outlet and referred to as region 1 in FIG. 4C, mist is formed from the dispensed TML. Such a region can be referred to as a “mist deployment zone.” In aspects, a detectable period can pass between when a TML dispensation is initiated and when a TML reaches such a region as a mist during operation. In this region, mist can form and expand outward over the available cross-sectional area of the chamber into which it is dispensed. In a third region, moving outward from this dispensation outlet and from the first two regions described, is a third region, referred to as region 2 in FIG. 4C. In aspects, this third region can be referred to as a “heat transfer zone” as detectible or significant heat can be exchanged between the mist and the PG of the chamber in this region. In a fourth region, moving outward from this dispensation outlet and from the first three regions described is a fourth region, referred to as region 3 in FIG. 4C. In aspects, this region represents the maximum extent, e.g., maximum distance, that the mist from any single dispenser travels in the direction in which it is dispensed across the length of the chamber. In aspects, DoS heat exchange can occur between TML and PG in any of the 4 regions described herein/shown in FIG. 4C. In aspects, more efficient heat transfer occurs in, e.g., region 2 than in region 4 or region 1, and in aspects, more efficient heat transfer occurs in, e.g., region 3 than in region 2, as in such regions more TML is in mist form and more of such mist has expanded outward to fill the chamber and make contact with PG therein. In “heat transfer zone” can refer to any zone in which DoS heat exchange between the mist and the PG of the chamber occurs.

TMF/TML dispensed from dispensing components in aspects can overlap. E.g., TML dispensed by DCO1D2 (in the above-described example), because outlet 1 is to the far left, can overlap with the TML dispensed by DCO2D1, as (1) DCO2 sits to the right of DCO1 and is dispensing in a first direction (to the left) toward DCO1, and DCO1 sits to the left of DCO2 and is dispensing in a second direction (to the right) toward DCO2. Thus, the space into which the TML is dispensed from each of these outlets can overlap. The same is true for, e.g., the TML, and the space into which it is dispensed, for DCO2D2 and DCO3D1, and DCO3D2 and DCO4D1. In aspects, dispensation from one outlet in one direction can overlap, such that the first region described above (and referred to as region 4 in the figures provided), that is, the region closest to each dispensation outlet and within which the PG of that region remains to some, generally some, most, mostly all, or completely untouched by TML dispensed from that outlet such that minimal heat exchange occurs between TML and PG, is encompassed by mist dispensed by a separate dispensation outlet. That is, for example, one or more of a mist deployment zone, heat transfer zone, or maximum distance region of a dispensed TML from one dispensation outlet can overlap with a region wherein there is minimum or no mist of another dispensation outlet.

In aspects, at least about 20%, at least ˜25%, at least ˜30%, at least ˜35%, at least ˜40%, at least ˜45% or more, such as at least ˜50%, at least ˜55%, at least ˜60%, at least ˜65%, at least ˜70%, or even more, such as at least about 75%, at least ˜80%, at least ˜85%, at least ˜90%, at least 95%, or even more of a TML dispensed from one dispensation outlet overlaps with the TML dispensed from one or more other dispensation outlets (together or also or alternatively individually).

In aspects, at least about 80%, at least ˜85%, at least ˜90%, at least ˜95%, at least ˜96%, at least ˜97%, at least ˜98%, at least ˜99%, at least ˜99.5%, or, e.g., even 100% of the PG in the chamber contacts a TML in the form of a mist. In aspects, the percentage of overlapping TML from two or more dispensers, the percentage of PG making contact with a TML, or both aids in a) DoS reducing the time it takes to sufficiently modify the temperature of the PG in the chamber to an extent to cause a pressure change in the PG; b) DoS reducing the time it takes to modify the pressure of the PG in the chamber to an extent to cause the PGC-MC to move; or c) both (a) and (b), over that of similar devices/systems wherein TML is dispensed from a single dispensation outlet, TML dispensed from two or more dispensation outlets overlap to a lesser degree (e.g., the percentage of overlap is reduced), a reduced total percentage of PG within a chamber is contacted with TML within the same period of time, or any or all combinations thereof.

In aspects, a device or system can comprise a single DC comprising outlets which are at least generally or substantially the same as one another. In aspects, a device or system can comprise a single DC comprising outlets which differ by at least one observable characteristic, such as size, shape, or dispensation orientation, dispensation pattern, size of mist droplets dispensed, distance from the dispensation conduit, or the like. In aspects, a device/system can comprise two or more DCs comprising outlets which are at least generally or substantially the same as one another. In aspects, a device/system can comprise two or more DCs comprising outlets which differ by at least one observable characteristic such as those described in this paragraph or other related such characteristics DEH. In aspects, a device/system can comprise two or more DCs wherein one or more dispensation outlets are effectively the same, and also or alternatively wherein one or more dispensation outlets differ by one or more characteristics, but which can vary by positioning between the DCs, such as e.g., the outlets of one DC are staggered in relation to the height, position, or both, of the outlets of a second DC. In aspects, selection of any such characteristics of DC(s) and DC outlet(s) can be made according to optimizing rate of heat exchange between TML and PG, time to initiate a reverse in direction of a PGC-MC from a first direction, device/system energy production, and/or any or all combinations thereof.

In aspects, a dispensing component (DC) can receive liquid from for example, a liquid dispensation enclosure, a liquid conducting system (LCS), or an interim TML holding area (e.g., a storage tank or the like which does not comprise a T1L/T2L switch, is not mechanically linked with a T1L/T2L switch, is not in contact with a T1L/T2L switch, or a combination thereof). According to certain common embodiments, a DC can be in operable communication with a LCS, such that at least one portion of liquid (e.g., T1L or T2L) from a LCS is accessible to a DC, either directly (e.g., a direct connection), or indirectly (e.g., via a dispensation enclosure). In aspects, a DC can receive liquid from an energy transfer fluid line/conduit.

In aspects, only one DC is active at a time; in aspects, only one portion of TML (T1L or T2L) is dispensed at a time, e.g., in aspects where DC(s) is/are only present on a single side of the MC. In such an embodiment, dispensation of T1L and T2L occurs in alternating sequence. In aspects, only one DC within a single container is active at a time. In aspects, two or more DCs within the same device/system, each residing in a different container, can overlap in their dispensation of fluid by about less than about 5 continuous seconds, such as <˜4 continuous seconds, <˜3 continuous seconds, <˜2 continuous seconds, or <˜1 second. In aspects, two or more DCs within the same device/system do not generally, substantially, or effectively overlap in time in their respective dispensation of fluid(s), such that effectively one DC stops dispensation as or before a second DC starts dispensation.

In aspects, a dispensation component (DC) can access a chamber via an access point in the housing whereby primarily, generally, substantially, or entirely no part of the DC projects into the chamber, e.g., in aspects the DC can be flush with the barrier of the chamber. In certain alternative aspects, a DC can project into a chamber, such that it resides to at least some extent inside of the barrier of the chamber. In aspects, SMGAOA of DC(s) reside within a PG chamber. In aspects, SMGAOA of DC(s)/DC components are positioned outside of the PGC-MC SL. In aspects, some or most of the DC(s)/DC components are positioned within, or overlap at least a portion of, the SL of the PGC-MC.

According to facets, injection of TML takes place in the form of a fine mist, e.g., as a cloud of droplets (e.g., a volume of gas comprising about 0.3-0.7 g/cubic cm, e.g., about 0.4-0.6 g/cubic cm, or about 0.5 g/cubic cm of liquid), such that the resulting temperature change of the PG into which the mist is dispensed, and corresponding pressure change within the chamber comprising the PG, can be as quick as possible, yet consumes the least amount of energy possible. In certain facets, injection of energy transfer fluid takes place in the form of a stream, such that the displacement of PG into which it is dispensed occurs as quickly as possible, and a sufficient volume of energy transfer fluid to is dispensed to displace a sufficient volume of PG to continue system operation occurs within a short amount of time, e.g., within less than about 10 seconds, such as <˜9, <˜8, <˜7, <˜6, <˜5, <˜4, <˜3, <˜2 seconds, or <˜1 second.

In aspects, TML mist comprises droplets having an average size, of between about 25 μm and about 150 μm, such as ˜30-90 μm, ˜35-70 μm, or ˜40-80 μm. In aspects, droplet size of a mist can also be described by Volume Mean Diameter (VMD). The VMD refers to the midpoint of droplet size (median), wherein half of the volume of spray is in droplets smaller, and half of the volume is in droplets larger, than the median. A VMD (DV0.5) of 400 μm, for example, indicates that half of the volume of spray is in droplets having a size smaller than 400 μm. A DV0.1 value indicates that 10% of the volume of spray is in droplets smaller than a given value, while a DV0.9 value indicates that 90% of the volume of spray is in droplets smaller than a given value, while 10% is larger than the given value. According to aspects, the TML has DV0.9 values of ˜70 μm, e.g., about 90% of the volume of the spray is in droplets having a size smaller than ˜70 μm. In aspects, the VMD (DV0.5) of the TML is about between ˜30-70 μm, such as between about 40-about 60 μm, as in about 50 μm.

According to certain aspects, the mist is dispensed in sufficient volume to cause a sufficient change in temperature of the PG into which it is dispensed, and a resulting pressure differential on opposing sides of the PGC-MC causing DoS movement of the PGC-MC to begin within about 1 second of the dispensation of the TML, e.g., within ˜0.9 seconds, ˜0.8 seconds, ˜0.7 seconds, ˜0.6 seconds, or ˜0.5 seconds. In aspects, the device is adapted such that most, GASA or all dispensations during operation cause the MC to DoS move within less than about ˜0.4 seconds, e.g., ≤˜0.3 seconds, ≤˜0.2 seconds, or ≤˜0.1 second, such as within about 0.05 seconds, ˜0.001 seconds, ˜0.0005 seconds, or within even ˜0.00001 seconds. In aspects, the pressure on the side of the PGC-MC is established by the VPCPS as DEH.

According to some facets, the droplets of the mist dispensed by one or more DC(s) have a DV0.9 value of about 70 μm, are dispensed in sufficient volume so as to affect a sufficient temperature change within the chamber to cause movement of the MC within about 0.1 seconds of the dispensation of the mist, or both the droplets of the mist dispensed by one or more DCs have a DV0.9 value of about 70 μm and are dispensed in sufficient volume so as to affect a sufficient temperature change within the chamber to cause movement of the MC within about 0.1 seconds of the dispensation of the mist.

In aspects, the pressure within the TML in the DLCS and the pressure of the PG in the chamber are at least about the same in RFOS. In aspects, the pressure of the pressurized chamber and the pressure of the temperature modulation system (TMS) vary by no more than about 20%, such as ≤about 17.5%, ≤˜15%, ≤˜12.5%, by ≤˜10%, by ≤˜7.5%, by ≤˜5%, or ≤˜2.5%, such as by ≤about 1% during regular operation.

According to some facets, some amount of dispensed liquid does not contact the contact surface (CS) of the movable component (MC). In aspects, at least about 10%, ≥˜20%, ≥30%, ≥˜40%, ≥˜50% or more, such as ≥˜60%, ≥˜70%, ≥˜80%, ≥˜90% or even more, such as ≥˜95% of the dispensed TML does not contact the CS of the MC. According to certain aspects, at least about 50%, ≥˜60%, ≥˜70%, ≥˜80%, ≥˜90%, or even more, such as ≥˜92%, ≥˜94%, ≥˜96%, ≥˜98%, ≥˜99%, or ≥˜99.5% of the TML does not contact the CS of the MC prior to exchanging at least about 50%, ≥˜60%, ≥˜70%, ≥˜80%, ≥˜90%, or at least about 95% or even more of its heat.

In aspects, the volume of TML required to heat or cool the PG increases as the pressure of the gas increases. Accordingly, in aspects, the operating pressure of the devices and systems described herein can dictate the volume of TML required to be dispensed to effectuate a change in temperature of the PG sufficient to cause PGC-MC movement, and such considerations are incorporated into device and/or system design. In aspects, a sufficiently high operating PG pressure can require dispensation of a TML volume sufficient to cause PGC-MC movement which is significant and can become a limiting factor in selecting the operating pressure of the device/system during device/system design (e.g., the energy required to dispense such a volume quickly becomes too high to be suitable and/or is too high to operate a suitably efficient device/system).

In aspects, the DC(s), e.g., a manifold DC (which may be described as a dispensing conduit comprising a plurality of dispensing outlets), extend(s) over at least ˜25% of the length of at least one IVS, and typically at least ˜50%, ≥˜65%, or ≥˜75% the length of the IVS. In aspects, the DC(s)/DC component(s) extend over ˜50% of a chamber's length, e.g., over 66.6% of a chamber, ≥˜75% of a chamber, e.g., ≥90% of a chamber length.

In aspects, a DC, e.g., a manifold DC, in operation dispenses a TML mist that fills (occupies as droplets) at least 30% of the IVS, e.g., ≥50%, ≥66.6%, ≥75%, or ≥85% or 90% of the IVS volume. In aspects, a DC, such as a manifold DC, in operation dispenses a TML mist that fills (occupies as detectable droplets) at least 30% of the chamber volume, e.g., ≥50%, ≥66.6%, ≥75%, or ≥85% or ˜90% or more of chamber volume.

In aspects, TML spray/mist contacts the majority of the volume (e.g., ≥˜50%, ≥˜60%, ≥˜70%, ≥˜80%, ≥˜90%, or ≥˜95%) of PG held within the IVS, chamber, or both.

In aspects, there is a DoS gap in time, e.g., a delay, pause, or a separation in time) between MGAOSA or all occurrences of TML dispensation (e.g., between any two dispensations of a TML), referred to herein as a dispensation gap. A dispensation gap is the period between the end of a dispensation of a first TML and the start of the dispensation of a second TML. In aspects, during the dispensation gap, the MC completes at least ˜50%, ˜75%, ˜95%, or about 100% of the SL before MGASAOA TML dispensations during operation. In aspects, a dispensation gap occurs in MGAOSA or all strokes of an MC in operation. In aspects, a dispensation gap is ≥˜0.1, ˜0.25, ˜0.5, ˜0.75 seconds, ˜1 second; ≤˜0.2 seconds; ≤˜2 seconds, ≤˜1.5 seconds, ≤˜1 second, ≤˜0.75 seconds, ≤˜0.5 seconds; ≤˜0.25 seconds; or CT. In aspects, configuring the device to include a dispensation gap of a specific duration enhances the amount of work performed by the device.

In aspects, an MC (e.g., a PGC-MC, a VPCPS-MC, or both) completes an SL prior to the dispensation of a TML which results in the MC reversing direction. In aspects, a TML may be dispensed during a stroke period, wherein the MC has not yet completed a full SL. In aspects, one or more stroke periods of any operating cycle period (OCP) may comprise no dispensation of a TML and one or more stroke periods of the same OCP may comprise dispensation of a TML.

In aspects, an OCP can comprise one or more gaps in time between the completion of an SL by an MC and the dispensation of the next TML. This gap in time occurs during a dispensation gap. In aspects, an OCP can comprise dispensation gaps in which such a gap between completion of an SL by an MC and dispensation of the next TML occurs and can comprise dispensation gaps in which no such gap between completion of an SL by an MC and dispensation of the next TML occurs.

In aspects, the average length of the stroke period and the average dispensation gap differ by ≤˜25%, ≤˜20%, ≤˜15%, ≤˜10%, ≤˜5%, ≤˜2.5%, or ≤˜1%. In aspects, the average stroke period and the average dispensation time generally, substantially only, or only, in operation, differ by ≤˜25%, ≤˜15%, ≤˜10%, ≤˜5%, or ≤˜2%.

In aspects, dispensation occurs when the MC reaches a minimum (triggering) stroke length. That is, in aspects, the means for modulating temperature, e.g., a TMS, does not create a new or modified temperature differential in the chamber sufficient to cause the MC to move in the next direction, until the MC has first reached a minimum/triggering SL in a first direction. In aspects, such a minimum SL is at least ˜60%, e.g., ≥˜65%, ≥˜70%, ≥˜75%, ≥˜80%, ≥˜85%, ≥˜90%, ≥˜92%, ≥˜94%, ≥˜96%, or at least about 98% of the entire SL. In certain aspects, such dispensation is automatically controlled, e.g., by incorporation of one or more timing devices (e.g., which may be an element of an OCC). In aspects, one or more control units can be a dispensation-gap-generating (or -controlling) automated component as a control unit can programmatically determine the timing of dispensation of TML. In aspects, an OCC comprises programming which defines a dispensation gap upon the completion of which an OCC directs the dispensation of TL1 or TL2, e.g., by directing the engagement of one or more pumps and/or one or more valves. In aspects, such a programmed dispensation gap value can be slightly longer, e.g., ˜0.001% longer, ˜0.01% longer, ˜0.05% longer, ˜0.1%, ˜0.3%, ˜0.5%, ˜0.7%, ˜0.9%, or ˜1% longer or more than the actual time it takes for an MC to complete a stroke length after dispensation of a first TML to ensure that the MC completes a full SL (stated another way, a programmed value can be slightly longer, e.g., ˜0.001%-˜1% longer, than a stroke period). In aspects, dispensation of T1L and T2L is programmed into CPU/PU(s) such that the MC completes a full SL≥˜50%, ≥˜60%, ≥˜70%, ≥˜80%, ≥˜90%, ≥˜95%, or for example in aspects ˜100% of the time before the next dispensation of a TML occurs.

In aspects, such similar timing and control occurs with dispensation of an energy transfer fluid (e.g., an energy transfer liquid) into a PGC, an HEC, or both. In aspects, such dispensation occurs according to sufficient movement of an MC (e.g., a PGC-MC). In aspects, such dispensation is automatically controlled such as, e.g., by an automated control component with preprogrammed preferences such as dispensation time intervals (e.g., an established time period between two or more dispensations). In aspects, there is no significant dispensation gap between two dispensations of energy transfer fluid wherein one dispensation is into a PGC, and another dispensation is into an HEC. In aspects, there is a dispensation gap such as a dispensation gap described above between dispensations of energy transfer fluid wherein one dispensation is into a PGC, and another is into an HEC.

In aspects, a dispensation gap can be governed by processor(s) that control operation of component(s) automatically (e.g., based on preprogrammed time intervals), selectively, or automatically in response to sensed conditions. For example, in one such embodiment, when the temperature of a chamber reaches a predetermined temperature, or the pressure of a chamber reaches a predetermined pressure, a sensor present in that chamber relays the temperature or pressure data to a processing unit wherein the processing unit receives such data and effectuates the dispensation of the next portion of liquid (T1L or T2L) into the PG chamber. As another example, in one such embodiment, a first portion of liquid (e.g., T1L) is dispensed into the chamber, a pre-programmed length of time is allowed to pass, as monitored by a processing unit, the completion of which effectuates the dispensation of T2L into the chamber.

In aspects, the device comprises a system that creates a gap in time between the completion of a SL by an MC and the dispensation of a TML or an energy transfer fluid, and the gap in time, the stroke period, the dispensation gap, or any or all thereof detectably or significantly increase(s) the work output or efficiency of the device.

In aspects, a change in the pressure of the PG, effectuated by the dispensation of a TML, causes a pressure differential to be established on opposing sides of a PGC-MC. The pressure on the PG-side of the PGC-MC is established by the PG; the pressure on the opposite side of the PGC-MC can in aspects also be established by a PG or in aspects can be established by a vacuum powered counter pressure system (VPCPS). The pressure differential between the two sides of the PGC-MC is what, in operation, causes the PGC-MC to move. In aspects, a change in the pressure of the PG, effectuated by the exposure of PG to HEMs having two different temperatures, causes a pressure differential to be established on opposing sides of a PGC-MC. The pressure on the PG-side of the PGC-MC is established by the PG; the pressure on the opposite side of the PGC-MC can in aspects also be established by a PG or in aspects can be established by a VPCPS (DEH).

In aspects, the housing of a first container (e.g., the housing of the container comprising PG and into which TML is dispensed), the housing of heat exchange container(s), or both comprises a liquid capture component (LCC). TML dispensed as a mist into PG, after having effectuated the temperature change, ultimately accumulates/collects in (e.g., in the “bottom” according to orientation, wherein the TML collects by force of gravity) of the chamber into which it is dispensed, where it can be collected by LCC(s). In alternative embodiments, energy transfer fluid dispensed as a stream and having displaced a PG in a PGC, or energy transfer fluid within a heat exchange chamber having displaced a PG in an HEC, can be collected by an LCC and exit the container by a route encompassing an LCC. An LCC can be any component capable of collecting collected TML or energy transfer fluid (liquid). In aspects, the LCC is a liquid flow guidance mechanism such as a shaped section within or connected to a part of the barrier (e.g., wall) of the housing, e.g., a notch, groove, sloped area, or the like, which leads collected liquid to an exit point, e.g., port, serving as a drain. In other aspects, the LCC comprises port(s) without any liquid guidance component(s). In certain aspects, an LCC may be absent. In some embodiments, a first container (e.g., more specifically, a primary PGC) or a second container (e.g., a heat exchange chamber comprising an HEC) can comprise a container wall, barrier component, barrier interior, or combination of the three which is shaped so as to direct fluid (liquid) out of the container/chamber through an exit location, such as a selectively openable and closable hole in the container wall, barrier component, barrier interior, or combination of the three (e.g., a port or exit point). Such an exit point can be configured to lead to, or in aspects be attached to, conduits to lead the exiting material to a new location. Such conduits can be, for example, energy transfer fluid lines/conduits or, e.g., conduits of an LCS.

In aspects, some or all the LCC is positioned within a PGC chamber outside of the SL of an MC held at least in part therein. In aspects, because the system is closed, and because device operation occurs under conditions whereby the pressure of the gas and the pressure of the liquid within the system are substantially equivalent unless/until acted upon by a TML), the liquid capture component (LCC) can in AOTI remain open to collect TML. In alternative aspects the LCC comprises a selectively or automatically, e.g., programmatically controlled, closure device/component. In aspects, the opening and closing of a first LCC can be automatically, e.g., programmatically controlled in coordination with the opening and closing of a second LCC within the same device/system.

In aspects, collected liquid exits a chamber via an LCC and flows through a TMS according to the volume of liquid within the TMS at the time of liquid collection. In aspects, collected liquid exits a chamber via an LCC and flows through a TMS according to direction provided by pumps, such pumps operating under manual or automated, preprogrammed control. In certain aspects, if the volume of liquid is lower in a T1L/TIS side of an LCS, the drained liquid flows toward that side of the LCS. In aspects if the volume of liquid is lower in a T2L/T2S side of an LCS, the drained liquid flows toward that side of the LCS.

In aspects, devices comprise operation component(s) that allow selective operation of components of the device/system or selective operation of the device/system. In aspects, operation can be controlled by human input, while in alternative embodiments, devices/systems or components can be operated automatically via the incorporation of components capable of monitoring, processing, and acting in response to one or more device conditions (e.g., a PU comprising programmable instructions and means for receiving sensor input(s)). In aspects, devices/systems or components are operated utilizing human input, automatically under the control of PU(s), or both.

### Monitoring of Performance and Conditions

In aspects, devices/systems comprise sensor(s) and, typically processor(s) for receiving, processing, and causing operation of one or more other devices or components based on such sensor data. Sensor(s) can include, e.g., temperature sensors for T1 & T2, T1L & T2L, or both, pressure sensors, motion, flow, humidity, sound, light, power, volume, or other types of sensors. Automated controls can allow the device/system to operate continuously over operating cycle(s) without human input/intervention. In aspects, such controls control pump(s) that promote or cause re-initiation of device/system operation after inactivity periods.

In aspects, devices comprise sensor(s). In aspects, the sensor(s) directly or indirectly control operation of one or more selectively operable component(s) of the device (e.g., a switch or a microcontroller). In aspects, sensor(s) comprise a temperature sensor (e.g., a thermocouple), a pressure sensor, a motion sensor, a flow, volume, humidity, or sound sensor, light sensor, power sensor, or combinations thereof.

Sensors can comprise temperature sensor(s), pressure sensor(s) (e.g., of TML, energy transfer fluid, PG, vacuum chambers, or any or all thereof), motion sensor(s) (e.g., monitoring PG or PG flow, MC movement, TML or energy transfer fluid flow, or any or all thereof), flow sensor(s) or humidity sensor(s) (e.g., monitoring dispensed TML or energy transfer liquid into a chamber), sound sensor(s), light sensor(s), power sensor(s), volume sensor(s) (e.g., the volume of an energy transfer liquid in a PGC, HEC, or both), etc. In aspects, a sensor can be a thermocouple. In aspects, SMGAOA operation of components (e.g., DC(s) or pump(s)) is directed in response to a timer.

In aspects, some, most, generally all, or all (SMGAOA) sensor(s) of the device/system share data with processing unit(s) (PU(s)) comprising stored instructions for analyzing the data & controlling component(s) in response to criteria. PU(s) can be a component of the device or part of a system. In aspects, PU(s) analyze data from ≥2 sensors in evaluating whether to initiate action(s) by other component(s) (e.g., pump(s), DC(s), etc.). E.g., data from a sensor in a chamber or part of a chamber on a 1st side of the SL and data from a sensor in the chamber/chamber part on the opposite side of the SL can be combined to evaluate T1ΔT2, the pressure differential, or both, and such combined data used by the PU to evaluate whether to initiate or stop action(s) by device component(s) (e.g., switch(es), pump(s), or DC(s)).

In aspects, sensors can be placed in liquid conducting lines (LCL(s)) of a LCS to monitor the temperature of portions of liquid (T1L and T2L) as they are modified by temperature inputs (T1S and T2S) of such systems. In aspects, sensors can be placed in LCL(s) of an LCS to monitor flow patterns. In aspects, sensor(s) can be placed in energy transfer fluid lines/conduits to monitor energy transfer fluid flow patterns. In facets, sensor(s) are positioned external to a device or system to measure, e.g., environmental conditions near a device/system.

### Automated Control of Components

In facets, the invention provides an automated system for performing useful work comprising (a) a device according to any of the device aspects of the invention but further comprising selectively operable pump(s) (“SOP(s)”) that when activated pump temperature modulating liquid (TML) into pressurized gas chamber(s) (PGC(s)) using stored power or extraneous power, (b) temperature sensor(s) that detect T1&T2, T1L&T2L, T1G&T2G, or a combination of any or all thereof, and (c) an electronic control unit comprising memory storing programmable instructions for operating the SOP(s) and processor(s) that receive inputs from the temperature sensor(s) and executes instructions that control the operation of the SOP(s) based upon such inputs and preprogrammed instructions. In facets, the invention provides an automated system for performing useful work comprising (a) a device according to any of the device aspects of the invention but further comprising SOP(s) that when activated pump energy transfer fluid from HEC(s) to PGC(s), into PGC(s), out of PGC(s), into HEC(s), out of HEC(s), or any combination thereof. Preprogrammed SOP operating instructions can comprise instructions relating to differences in T1HEM & T2HEM, T1&T2, T1L&T2L, or T1G&T2G. In aspects, preprogrammed SOP operating instructions can comprise instructions related to promoting or causing re-initiation of the device by operating a pump to re-start movement of the PGC-MC). In aspects, data collection processes comprise processes performed in the sensor(s) (i.e., the sensors comprise specialized function computers, such as microprocessor(s) or system-on-a-chip components). In aspects, the processor is located remote from the device or system. In aspects, the processor is part of a computer that comprises means for storing and analyzing device operation data (e.g., such a computer can comprise a machine learning unit that learns to optimize re-initiation of the MC through machine learning training methods/models, such as through supervised machine learning methods/models known in the art). In aspects, device(s)/system(s) can comprise microcontrollers which control the opening and closing of valves, switches, and the like of the device/system and which can, in aspects, be in communication with or at least in part under the control of processor(s).

Another aspect of the invention is embodied in an automated system for performing work comprising a device according to device AOTI comprising a fluid switch (T1L/T2L switch) that is under the control of a processor unit and operates during operation according to preprogrammed instructions. In aspects, the processor/computer causes a detectable gap in time between operation of the switch and, thus, the reversal in direction of the MC. In aspects, the gap in time DoS increases work output of the device. In aspects, the processor/computer controls the sequenced movement of energy transfer liquid(s) (e.g., multiple portions of energy transfer liquid) and PG within a device/system, such as, e.g., providing control of one or more of: (1) the opening of an LCC in a PGC to provide for the dispersal/exiting of a first portion of energy transfer liquid from the PGC; (2) the closure of the LCC to provide for the closing off of the exit point in the PGC; (3) the opening of a dispensation component (or entry point) to provide entry of PG into the PGC; (4) the opening of an LCC in an HEC to provide for the dispersal/exiting of a second portion of energy transfer liquid from an HEC; (5) the closing of the LCC in the HEC to provide for the closing off of the exit point in the HEC; (6) the opening of a dispensation component in a PGC to provide for entry of energy transfer fluid into a PGC; (7) the opening of a dispensation component (or entry point) to provide for entry of PG into an HEC); and (8) the opening of a dispensation component (or entry point) to provide for entry of an energy transfer liquid into an HEC.

In aspects, a device/system comprising a processor unit (PU) also includes temperature sensor(s), pressure sensor(s), or CT (e.g., PG, TML, or HEM pressure/temperature sensor(s); energy transfer fluid, TML, or MC motion sensor(s); or CT) and the PU comprises means for receiving such data from the sensor(s) and preprogrammed instruction(s) for triggering action(s) in response thereto (e.g., providing an audible visual, or audiovisual alarm).

The terms “processor” or “processor unit” (PU) provides implicit support for any type of computer system comprising computer readable memory (including non-transient computer readable media) and one or more processor(s) that can read instructions and data stored in such memory and control one or more outputs (data outputs such as displays, messages, and the like; alarms; or control of one or more device/system components as exemplified herein).

Another aspect of the invention is embodied in an automated system for performing work comprising a device according to device aspects comprising a fluid switch (T1L/T2L switch) that is under the control of a processor unit and operates during operation according to preprogrammed instructions. In aspects, the processor/computer causes a detectable gap in time between operation of the switch and, thus, the reversal in direction of the MC. In aspects, the gap in time DoS increases work output of the device.

In aspects, a device/system comprising a processor unit (PU) also includes temperature sensor(s), pressure sensor(s), or CT (e.g., PG or TML pressure/temperature sensor(s), TML/MC motion sensor(s), or CT) and the PU comprises means for receiving such data from the sensor(s) and preprogrammed instruction(s) for triggering action(s) in response thereto (e.g., providing an audible or, visual, or audiovisual alarm).

In aspects, PU(s) include means for receiving instructions from and relaying messages to user interface(s) (e.g., mobile phones, web pages, etc.), allowing users to control operation of the device/system.

In aspects, a device/system comprises PM(s) as DEH that can act as a safety mechanism and AOA comprises selectively operable or automatic/automated safety feature(s) (“SOOASF(s)”). In aspects, SOOASF(s) comprise automatable shut off valves or switches, typically linked to sensor(s), where, e.g., reaching or crossing a threshold triggers the automated activity of the SOOASF(s). In aspects, SOOASF(s) are linked to programmable processing unit(s) that direct operation of such feature(s) upon occurrence of an event that meets criteria in preprogrammed instruction(s) stored/executable by such PU(s).

According to aspects, the systems described herein can comprise a secondary component comprising an automated control system (e.g., PU(s)). In aspects, such an automated control system (“ACS”) can facilitate the automated operation of the device and/or system or component(s) thereof, thus, e.g., manual intervention in operation is not necessary under most, generally all, or at least substantially all conditions/situations.

In aspects, an ACS may further comprise at least one PU, at least one automated control, at least one data processor, or any combination thereof whereby at least one component, action, function, process, state/condition, or result/output of the system/device or operation can be monitored and/or controlled without human intervention, or data collected resulting from monitoring of any at least two or more of a component, action, function, process, or result from the system or system operation can be processed into monitorable and/or actionable data. In aspects, any one or more such units or processors can be combined to form a unit which may be referred to as a central processing unit (“CPU”). In aspects, PU(s) or a CPU can operate cooperatively with sensor(s), such that data from the one or more sensors can be an input to such an ACS. According to certain aspects, a controller, e.g., a microcontroller can be present in the device/system and can turn motors of, for example, a pump, on and/or off at different times, providing a more nuanced control over such operation. In aspects, such controllers are under the control, at least part of the time, of PU(s)/CPU.

In aspects, such an automatic control system can aid in determining whether there is enough net gain to operate the system, performing ongoing calculations of net energy consumption and net energy gain facilitating continuous performance evaluation. In aspects, if a system fails to generate a sufficient amount of energy so as to either consume more energy than is produced or fails to produce at least as much energy as a predetermined threshold, the automated control system can direct the shut-down of the system until such time that conditions exist where sufficient energy can be produced to either produce more energy than is consumed in operation or to produce at least as much energy as a predetermined threshold; at which time, in aspects, the automated control system can direct the system to resume operation.

In aspects, devices/systems comprise automated component(s)/system(s). In aspects, devices/systems or components thereof comprise electronic operation control component (OCC(s)). In aspects, an OCC comprises an electronic control unit (ECU) for collecting data from one or more points in a device and/or system and for relaying data to other components of an OCC such as a processor unit. In aspects, the processor unit is a part of the ECU. In aspects, the ECU comprises at least one data collection unit (DCU), means for relaying temperature information data from the DCU, and a processor unit.

In aspects, an automated system comprises pressure sensor(s), means for relaying pressure sensor information to PU(s)/CPU, and the processor(s) comprises preprogrammed instructions for evaluating pressure data against standard(s) to determine if pressure problems exist in the device. In aspects, the OCC can address ≥2 variables within a device or system such as both temperature and pressure. In aspects, processor(s) control component(s) (e.g., DC(s), pump(s), etc.). In aspects, processor(s) signal alarm(s) (e.g., audio, visual, or digital alarms sent to interface(s)).

In aspects, the DCU of an ECU of an OCC stores and executes instructions to receive data from one or more sensors. In aspects, the DCU stores and executes instructions to receive primary and secondary temperature data from one or more sensor(s) of the device that correspond to a first temperature and second temperature. E.g., a first temperature can be a temperature of a body of PG prior to having a TML applied, or a first temperature can be a temperature of a body of PG having been exposed to a first HEM, and a second temperature can be a temperature of the same body of PG after having a TML applied and prior to the next dispensation of TML or a second temperature can be a temperature of the same body of PG having been exposed to a second HEM. In aspects, such collection or receipt of data can occur at preprogrammed measurement intervals during an operation cycle comprising periods of device operation and intervening periods (e.g., periods when the device and/or system is not in operation, such as for example during periods where T1ΔT2 is unsuitable for device or system operation). In certain aspects, such preprogrammed measurement intervals are timed intervals, e.g., intervals of ˜1, ˜2, ˜3, ˜4, ˜5 seconds. In aspects such intervals are longer than ˜5 seconds, such as intervals of ˜6, ˜7, ˜8, ˜9, ˜10, ˜15, ˜20, ˜25, or for example ˜30 seconds or even longer, such as intervals of about every 45 seconds, ˜1 minute, ˜1.5 minutes, ˜2 minutes, ˜2.5 minutes, ˜3 minutes, ˜3.5 minutes, ˜4 minutes, ˜4.5 minutes, ˜5 minutes, or even longer. In aspects such intervals are intervals of a fraction of a second, such as intervals 5-0.9 seconds, ≤˜0.5, ≤˜0.1, ≤˜0.09, ≤˜0.05, ≤˜0.01, ≤˜0.009, ≤˜0.005, ≤˜0.001, ≤˜0.0009, ≤˜0.0005, ≤˜0.0001 seconds, or less.

In aspects, the DCU of an ECU of an OCC can store and execute instructions to receive primary and secondary temperatures from sensors and each sensor can receive such data at the same or different intervals or in response to the same or different conditions. In aspects, processor(s) receive signal(s) from sensor(s) in relatively short intervals, e.g., intervals of ≤1 second such as when monitoring the temperature of a PG. In aspects, it may be sufficient to receive data in longer intervals, e.g., intervals of 30 seconds or 1 minute or more, such as when monitoring the temperature of a temperature input (such as T1S or T2S, or T1L or T2L).

In aspects, a DCU can store, and in aspects share, collected data with at least one data processing device, e.g., a processing unit (PU) as described EH. In such aspects the DCU works cooperatively with one or more other components for successful automatic operation of the automated systems DH. In aspects, one or more data collection unit(s) of the system can be (an) integral component(s) of one or more sensor(s).

In aspects the ECU, in addition to DCU(s), comprises a means for relaying data, such as pressure or temperature data from the DCU. In aspects, the means for relaying such, e.g., pressure or temperature data from the DCU can be any means of successfully sharing information data from one point to another including but may not be limited to parallel transmission, serial transmission (including synchronous or asynchronous transmission), wireless communication channel(s), or the like, and data may be represented as, e.g., an electromagnetic signal such as an electrical voltage, microwave, radio wave, or infrared signal or the like. In aspects, temperature information data can be encrypted. AOA, the temperature information data may not be encrypted.

In aspects, in addition to DCU(s) and at one least data relay mean(s), a device/system comprises an ECU comprising one or more processor units (PU(s)). In aspects, a PU is a part of a device/system OTI. In aspects the processor unit is located remotely from the device, such as at short or long distances from the device or system, e.g., within a matter of inches/centimeters, a matter of feet, within a matter of yards/meters, or within a matter of miles/kilometers, such as 1-5 miles (1.6-8 km), 1-10 miles (1.6-16 km), 1-25 miles (1.6-40.2 km), 1-50 miles (1.6-80.5 km), 1-75 miles (1.6-120.7 km), or 1-100 miles (1.6-160.9 km) or more, such as across cities, across counties, or across states, administrative divisions, provinces, or their equivalents, or even across countries.

In aspects, a processor unit (PU) comprises at least one unit capable of receiving the data relayed from the DCU. In aspects, a PU that receives data relayed from the DCU is capable of receiving data received by parallel transmission, serial transmission (including synchronous or asynchronous transmission), wireless communication channel(s), or the like, and receiving data represented as, e.g., an electromagnetic signal such as an electrical voltage, microwave, radio wave, or infrared signal or the like. In aspects, the processor unit can receive and interpret encrypted data. Also/alternative a PU can receive, data that is not be encrypted.

In aspects, PU(s) further comprise means for storing and executing instructions relevant to the operation of the device/system or components thereof (e.g., a computer or device comprising microprocessor(s) that can run suitable software for receiving, analyzing, displaying, relaying, or acting on sensor input(s), e.g., comprising controlling the operation of component(s) of the system/device). In aspects, such instructions can be instructions for determining the relationships between the difference in two values to a predetermined threshold, e.g., a difference between a primary and secondary temperature (e.g., such a first action of the processor can be to mathematically calculate a T1ΔT2) and an intermittent off period threshold (e.g., such a second action of the processor can be to mathematically calculate the difference between the calculated T1ΔT2 and a predetermined threshold). In aspects such a threshold can be a pre-determined T1ΔT2 threshold at which it has been determined that operating the device or system is e.g., unsuitable, non-preferable, suboptimal, or impossible.

In aspects, when the device or system is in a non-operating state (e.g., upon system start up or after a pause in operation due to unsuitable operating conditions), PU(s) can execute stored instructions for initiating operation of DC(s) to reinitiate the device/system after conditions meet pre-programmed conditions and the instructions indicate that system re-initiation should occur. Such instruction can be, e.g., to operate one or more pumps, to dispense a volume of T1L or T2L into a volume of PG, or for example to both operate pump(s) and to dispense a volume of a TML.

In aspects, PU(s) can comprise stored instructions to automatically stop, via automated execution of such stored instructions, pumping liquid into a DC when the T1ΔT2 between the first portion (e.g., T1L) and second portion (e.g., T2L) of a TML falls below a predetermined threshold, and automatically begins pumping liquid to a DC when the T1ΔT2 between the first portion (e.g., T1L) and second portion (e.g., T2L) of a TML meets or exceeds a predetermined threshold, based on its analysis of the data collected/received and the stored instructions. In aspects, the T1ΔT2 threshold for device/system operation can be ≤1° C. as DEH.

In aspects, the processor unit operates one or more T1L/T2L switches, aka fluid switch(es), of the device (or AOA a T1L/T2L switch present in a system in which the device is one component) and the processor unit stores and executes instructions for operating a T1L/T2L (fluid) switch. In aspects, instructions for operating a T1L/T2L switch can comprise algorithms for calculating system status parameters and acting upon such calculations (e.g., calculating one or more T1ΔT2 values). In aspects, instructions for operating a T1L/T2L (fluid) switch can comprise receipt, analysis, and execution upon data related to time intervals, according to which the processor unit instructs the T1L/T2L (fluid) switch to dispense T1L or T2L based on timed dispensation intervals.

In aspects, PU(s) (sometimes ORT simply as “processor(s)”) stores and executes algorithm(s) capable of establishing a dispensation gap (a gap in time between the completion of dispensation of TL1 and the start of dispensation of TL2) for primarily all, generally all, substantially all or all of the strokes of the MC during regular operation. In aspects, the processor controls operation of components or actions of one or more device and/or system components participating to create the dispensation gap, such as for example the processor can control TML dispensation timing (such as for example by controlling a T1L/T2L switch or the operation of one or more pumps), movement of the MC (e.g., directly or indirectly), movement of a movable connector, and the like.

In aspects, the processor comprises means for storing, retrieving, and further processing any of the data received in an operating cycle of the device. In aspects such data could be received from a device or system described herein, including but not limited to T1L, T2L, T1S, T2S, timed intervals, pressure of PG in any specific location within a device or system, work, or energy production, or the like and processing of any combination of such data. In aspects, such data could be received from an source not directly related to a single operating device or system, such as from a connected device or system (e.g., when devices or systems of the present invention are connected to increase power generation capabilities as DEH), or an external source, such as an external system or device waste generator, a weather station, an internet source, data provided via human input, external sensors such as environmental temperature, light, pressure, or other types of sensors, energy consumption reports or calculations (e.g., when a device or system is utilized to operate a device such as a car or a facility (e.g., a home or building) wherein energy is being drawn from the device or system as it is being produced), or other such data sources impacting or directing the operation of a device or system or otherwise providing context to an operator related to the environment in which the device or system is being operated.

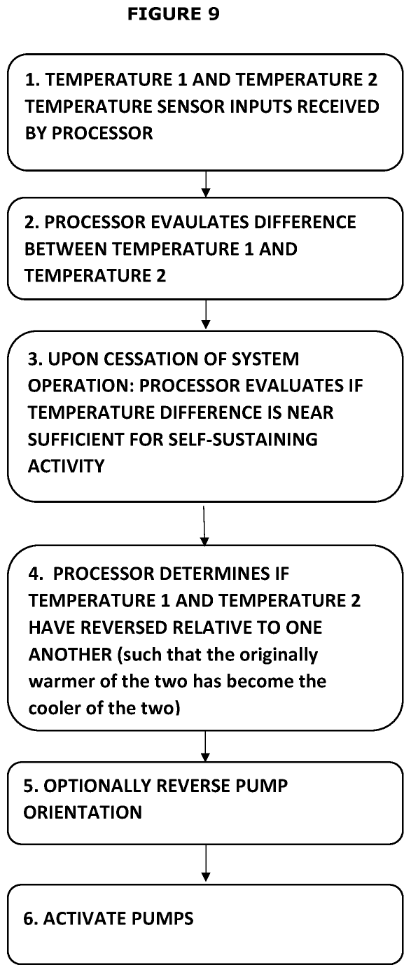

An exemplary automated system/method is illustrated by the flow chart of FIG. 9. In aspects, (1) 1st & 2nd temperature sensor inputs are received by a PU; (2) the processor evaluates the T1ΔT2; (3) upon cessation of system operation, the processing unit (processor) evaluates if T1ΔT2 is near sufficient for self-sustaining device/system activity; (4) processing unit (processor) determines if the first and second temperatures have reversed relative to one another, e.g., the originally warmer of the two has become the cooler of the two); (5) optionally reversing the orientation of one or more pumps; and (6) activating the pumps.

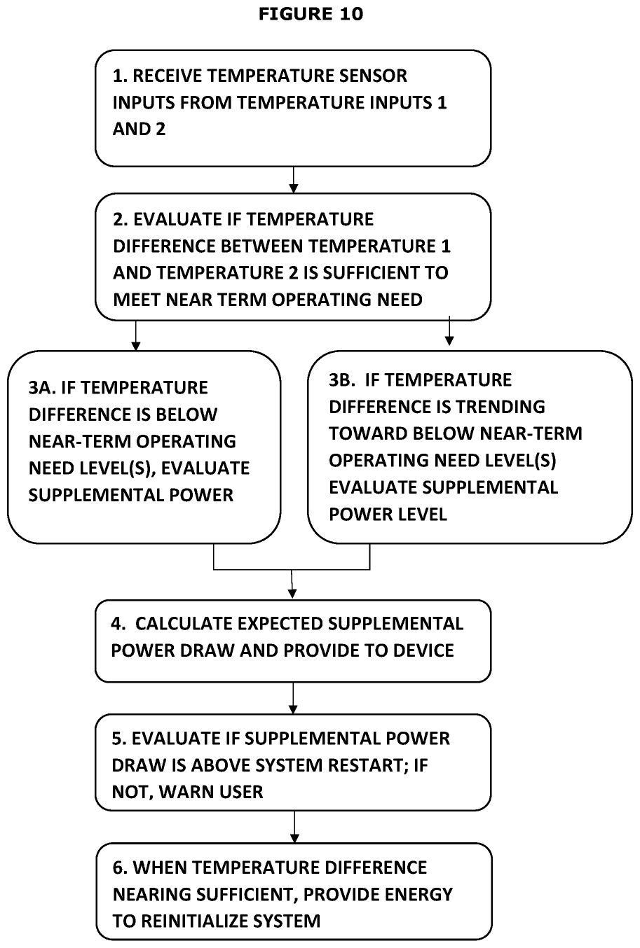

FIG. 10 provides another exemplary embodiment of an automated control system/method (electronic control unit (ECU)) comprising an associated powered device. In this embodiment, the associated powered device is a car waste heat system. In this exemplary aspect, (1) the ECU receives temperature sensor inputs from first and second temperature inputs; (2) the ECU evaluates if T1ΔT2 is sufficient to meet near term operating needs; (3A) if T1ΔT2 is determined to be below near term operating need level(s), evaluating supplemental power or (3B) if T1ΔT2 is trending toward below near term operating need level(s), evaluating supplemental power levels; (4) calculating expected supplemental power draw and providing such calculated requirements to the device; (5) evaluating if the supplemental power draw is above system restart thresholds; if not, providing a warning to the user; (6) when the T1ΔT2 is nearing sufficient, providing energy to reinitialize/restart the system.

In aspects, an automated system comprises a device that comprises means for measuring movement of the PGC-MC or, also or alternatively, one or more VPCPS-MCs, means for relaying the movement measurement data to the processor (e.g., processing unit), and the processor comprises instructions for evaluating the movement information to the expected movement of the moveable component based on the primary temperature and secondary temperature data.

In aspects means for measuring movement of an MC can be a motion detector, a mechanically operated switch, a motion-initiated boundary trigger such as a light or laser, a camera with associated visually based distance calculation algorithms, or the like.

In aspects, the means for relaying the movement measurement data to the processor can be any means, such as data transmitted by parallel transmission, serial transmission (including synchronous or asynchronous transmission), wireless communication channel(s), or the like, and receiving data represented as, e.g., an electromagnetic signal such as an electrical voltage, microwave, radio wave, or infrared signal or the like. In aspects, the processor unit can receive and interpret encrypted data. AOA, the processor unit can receive, data that is not be encrypted.

In aspects, instructions stored by the processor (e.g., processing unit) for comparing or evaluating the movement information of an MC to the expected movement of the MC comprises utilizing the primary temperature and secondary temperature data. In aspects, expected movement of an MC is determined based on the T1ΔT2 of the PG pre- and post-TML dispensation, e.g., upon each operating cycle, or T1L and T2L. In aspects the actual movement of the MC is compared to such an expected movement, and if movement of the MC is not sufficiently comparable to that of the expected movement of the MC according to a predetermined threshold, the processor can in aspects provide an alert to or AOA direct the automatic shutdown of a device or system.

In aspects, the system comprises a viewable user interface that allows a human operator to observe the status of one or more of the temperature(s), pressure(s), or movement(s) monitored conditions of the device/system. In aspects, such an interface can provide the user with raw data, the results of data calculations, trend data, device or system alerts generated by the processor, related system or operational data, or any internal or external data selected for being viewable to a user via such an interface. In aspects the interface is a computer monitor (e.g., desktop or laptop monitor). In aspects the interface is a mobile device such as a smart device (e.g., a smart phone or pad device). In aspects data is presented via a software interface. In aspects data is presented via a web page or web-based application. In aspects data is presented via a locally stored application. In aspects, the user interface is an interactive interface component. In aspects, the interactive interface receives instructions from a user on changing operating parameter(s) of the device or component(s) (e.g., amount of dispensed TML; frequency of dispensation; forced operation of pump(s); dispensation gaps(s), modifying, adding, or deleting a gap in time between the completion of an SL by an MC before a TML is dispensed; or combinations of any or all thereof). In aspects, the interface may provide options for alerting the user to certain conditions and provide the ability for a user to respond to such alerts, e.g., to take action to resolve a suboptimal operating condition to resolve a mechanical issue, or the like, such as for example by directing the processor to take a specific action (e.g., to initiate a pump or to shut down the system).

### B. Heat Exchange Systems(s): Heat Exchange Chamber(s) (HEC(s)) and Heat Exchange Material(s) (HEM(s))

In aspects, device(s)/system(s) provided by the invention comprise one or more containers in addition to a first primary container comprising a movable component (e.g., a PGC-MC). In aspects, one or more second (e.g., a second and a third) container can be component(s) of a heat exchange system. In aspects, a heat exchange system can comprise one or more containers, each comprising a heat exchange chamber (HEC). In aspects, each HEC can comprise heat exchange material (HEM). In aspects, HEM serves to modify the temperature of PG when PG is exposed thereto.

In aspects, a container comprising a heat exchange material can have any one or more of the characteristics of a PGC described above in terms of size, shape, and dimensionality. However, typically, a heat exchange container does not comprise an MC. Thus, typically, a heat exchange container does not comprise an opening to allow for the protrusion of a PM. However, to exemplify for sake of clarity, a heat exchange container (and also each HEC, HECs being described below) can comprise a barrier component and a barrier interior which is mostly, generally, or completely impervious to the unintentional loss of a fluid held therein.

In aspects, a TMS can comprise one heat exchange container. In aspects, a TMS can comprise two or more heat exchange containers. In aspects, a container of an HES can comprise a heat exchange chamber (HEC). In aspects, each container of a temperature modulating system (TMS) can comprise a single HEC. In aspects, a TMS can comprise two heat exchange containers, each comprising an HEC and accordingly a device can comprise a first and a second HEC (HEC1 and HEC2).

In aspects, each HEC can comprise a heat exchange material (HEM). In aspects, the purpose of the HEM is to facilitate a rapid change in temperature of a PG exposed thereto. Such an HEM can be any HEM which is inert relative to any liquid (e.g., relative to any energy transfer liquid) or gas (e.g., any PG) exposed thereto (here “inert” having the same interpretation as provided in other disclosure here when discussing the characteristics of a material being “inert” relative to a liquid or a PG). In aspects, the temperature of each HEM is established by either direct or indirect exposure to a temperature source (e.g., a T1S or T2S). Thus in aspects, suitable HEM is a material which can take on and maintain the temperature of the temperature source, such that it is able to maintain a temperature which is within about, e.g., 10%, ˜9%, ˜8%, ˜7%, ˜6%, ˜5%, ˜4%, ˜3%, ˜2%, or, e.g., within ˜1% or less, e.g., within less than 1% of the temperature of the temperature source to which it is directly or indirectly exposed. In aspects, the HEM is capable of transferring heat to, or absorbing heat from, a fluid to which it is exposed, such as a PG. In aspects, such a heat exchange occurs quickly; that is, in aspects, when a PG is exposed to an HEM, the PG is capable of establishing a temperature within less than about 10%, e.g., <˜9%, <˜8%, <˜7%, <˜6%, <˜5%, <˜4%, <˜3%, <˜2%, or, e.g., <˜1% of that of the HEM within less than about 10 seconds, such as, e.g., <˜9 seconds, <˜8 seconds, <˜7 seconds <˜6 seconds, <˜5 seconds, <˜4 seconds, <˜3 seconds, <˜2 seconds, or <˜1 second, such as, e.g., <˜0.5 seconds, <˜0.1 seconds, <˜0.05 seconds, <˜0.01 seconds, <˜0.005 seconds, <˜0.001 seconds, <˜0.0005 seconds, <˜0.0001 seconds, or even less. Accordingly, in aspects, suitable HEMs are HEMs having a high surface area-to-volume ratio.

In aspects, exemplary HEM material(s) include a metal (e.g., aluminum, titanium, brass, copper, nickel, or combinations such as copper/nickel, or alloys such as cobalt alloy or aluminum alloys or steel, e.g., stainless steel, chrome moly, or other heat exchange materials known in the art.

In aspects, HEM material can be provided in any shape, size, or configuration suitable for incorporation into a HEC of the device(s)/system(s) here, such as being provided as a solid, a coil, a sheet strip, a plate, a bar, or as a net, nest, or other intertwined fiber-like shape, porous presentation/configuration, or otherwise non-compact, low-density configuration which provides an increased surface area-to-volume ratio (e.g., having a surface area-to-volume ratio greater than that of a solid maintaining the same volume). In aspects, steel wool is a suitable heat exchange material. In certain aspects, having a coarseness grade of at less than 1 (medium), less than 0 (medium fine), less than 00 (fine), less than 000 (extra fine), or, e.g., having a coarseness grade of 0000 (super fine) or less is particularly advantageous due to its increased surface-area-to-volume ratio. In aspects, the higher the surface-area-to-volume ratio of the HEM, the faster the temperature change of the PG making contact therewith is accomplished, and the more efficient the device/system containing such an HEM can be.

In aspects, a device/system can comprise one or more heat exchange chambers (HECs) each comprising a single HEM (e.g., a device/system can comprise a single type of HEM). In aspects, a device/system can comprise two or more HECs wherein at least one HEC comprises an HEM which is different from at least one other HEM within the device/system. In aspects, each HEC can be individually selected according to the role it plays within the device/system. In aspects, a first HEC in a device/system can be a heat increasing chamber and a second HEC in a device/system can be a heat decreasing (e.g., cooling) chamber. In aspects, each chamber can comprise an HEM selected specifically for its role in heating or cooling, respectively, a material with which it makes contact. In aspects, an HEM can differ from any other HEM(s) by its size, shape, or configuration, its surface area-to-volume ratio, the amount of energy it can absorb as heat from a given quantity of material, (e.g., a liquid or a gas), the amount of energy it can release as heat when at the same temperature as another material, or any combination thereof.

According to aspects, HEM(s) can establish the temperature of a PG. In aspects, device(s)/system(s) provided by the invention comprise at least two HEMs (which can be referenced as HEM1 and HEM2), each differing from the other in its temperature during at least about 75%, ˜80%, ˜85%, ˜90%, ˜95%, ˜97%, ˜98%, ˜99%, or during at least about 99.5% of any operating period. In aspects, a first HEM (HEM1) can be referred to as a “warm” HEM in that its temperature is controlled by a temperature source (e.g., TS1) which is relatively warmer than that of a second HEM (HEM2) which is controlled by a temperature source (e.g., TS2) which is relatively cooler than that of the first HEM (HEM1). Such a TS1 and a TS2 can be an, e.g., a naturally occurring environmental source or, e.g., an environment resulting from a technological process such as a waste stream as is described herein and in US '192. In certain aspects, at least one TS is a naturally occurring environment (such as, e.g., a body of air or a body of water), and the temperature of the HEM is established either directly or indirectly by such a TS. In aspects, such HEMs can be referred to as, e.g., heat increasing or heat decreasing, and the chambers in which they are respectively held can be referred to as heat increasing chamber(s) (HIC(s)) and heat decreasing chamber(s) (HDC(s)). In aspects, PG exiting an HIC has a DoS higher temperature than when it entered the HIC. In aspects, PG exiting an HDC has a DoS lower temperature than when it entered the HDC. In aspects, the status of which HEM is warmer or cooler relative to another can reverse at least once during a 24-hour operating period, as can occur in, for example, an embodiment where a T1S is a body of air and a T2S is a body of water, and at least once during a 24-hour period which environmental source is warmer or cooler than the other can switch, such as can happen when day passes into night or night passes into day. In aspects, the temperature of HEM1 and HEM2 maintain a temperature differential of at least about 1° C. during at least about 75%, ˜80%, ˜85%, ˜90%, ˜95%, about 96%, about 97%, about 98%, or, e.g., during at least about 99% of a 24-hour operating period. In such aspects, the HEMs have a sufficient temperature differential to impart a significant difference in temperature to PG when PG is exposed to each HEM respectively, such that the alternating exposure of PG to HEM1 and HEM2 create suitably different temperatures in the PG to yield different pressures of the PG, which are sufficiently different to cause a movable component of a PGC (e.g., a PGC-MC of a primary pressure modulating system) to alternatingly move back and forth. In aspects, an HEC can be configured to maintain a gas, a liquid, or both a liquid and a gas. In aspects, an HEC can be configured to maintain a gas, e.g., a PG, and a liquid, e.g., an energy transfer liquid, in alternating fashion. In aspects, as stated above, an HEC can comprise a BC, a BI, or both which are inert relative to any gas or liquid to which it may be exposed, and, further, is sufficiently non-reactive with such gas or liquid to prevent any significant loss of liquid or gas resulting in the need to repressurize the device/system, replace any gas or liquid, or both within less than about 1 months of starting operation, such as, e.g., within <˜2 months, <3 months, <˜4 months, <˜5 months, <˜6 months, or more, such as <˜8 months, <˜10 months, or, e.g., less than about 12 months, or, e.g., resulting in the need to repressurize the device/system prior to the lifetime of the first expiring system seal, (e.g., ˜12 months (1 year), ˜16 months, ˜20 months, ˜24 months (2 years), ˜28 months, ˜32 months, or ˜36 months (3 years).

### C. Vacuum Pressure Counter Pressure System (VPCPS) Devices and Components

In aspects, device(s)/system(s) herein are configured to provide a counter pressure to the movement of an MC caused by a change in pressure of a PG. For example, when an increase in PG pressure occurs on one side of an MC, the MC can be pushed toward and against a counter pressure on the opposite side of an MC. When a decrease in PG pressure occurs on one side of an MC, the MC can in aspects be pushed by the counter pressure toward the PG having experienced a decrease in pressure. In aspects, such a counter pressure can be provided by a separate volume of pressurized gas. In alternative aspects, such an opposing or counter pressure can be provided by the atmosphere. In aspects, such an opposing or counter pressure can be provided by a vacuum. In such aspects, the counter pressure is opposite of that provided by a second volume of pressurized gas. In aspects a counter pressure can be a vacuum counter pressure. In aspects, an increase in PG pressure occurring on one side of an MC can cause movement of an MC in a first direction, and a decrease in PG pressure the MC can cause movement of an MC in a second direction, caused at least in part by a vacuum on an opposite side of the MC. When a decrease in PG pressure occurs on one side of an MC, the MC can in aspects be pulled by a vacuum pressure, toward the PG having experienced the decrease in pressure. In aspects, without a counter pressure system of some kind, the device(s)/system(s) provided by the invention are inoperable. In aspects, counter pressure provides the balance to the applied pressure or, e.g., decrease in pressure, provided by a PG such that reaching an equilibrium between the two pressures on either side of an MC (such as a PGC-MC) establishes the end point or near end point of a stroke length. In aspects, an alternative counter-pressure system or component is also or alternatively employed, e.g., a counter-pressure system that does not rely on or does not mostly rely on vacuum pressure is employed. Such other means for application of counterpressure (e.g., mechanical devices, gas/pneumatic systems, magnetic systems, and the like) are known in the art.

In aspects, devices can comprise vacuum powered counter pressure systems (VPCPS(s)). In aspects, VPCPS(s) comprise vacuum chamber(s) that also comprise a housing, barrier component(s), and barrier interior(s) (BI(s)). In aspects, such components can share comprise one or more of the characteristics of those components as described here in conjunction with other containers or chambers, such as primary pressurized gas containers or chambers and heat exchange containers or chambers. In aspects, vacuum chambers of VPCPS(s) can comprise an MC (VPCPS-MC). In aspects, the diameter of vacuum chamber(s) can be substantially uniform, such that the diameter of VPCPS-MC(s) is generally or nearly the same, as that as of an associated vacuum chamber. In aspects, a vacuum chamber can comprise openings through which a part of a VPCPS-MC SL extends.

In aspects, the system comprises a PGC-MC which moves back and forth in alternating fashion in response to pressure differentials created on either side of the MC by the alternating dispensation of a TML into a chamber comprising PG on one side of the MC. With each movement in a first direction caused by dispensation of a TML into the PG chamber, the PGC-MC encounters a back pressure applied by vacuum powered counter pressure system (VPCPS). In aspects, that back pressure represents approximately 0-100%, such as 0 to ˜90%, ˜0-˜80%, ˜0-˜70%, ˜0-˜60%, ˜0-˜70%, ˜0-˜60%, or ˜0-˜50%, such as no more than about 50%, no more than ˜40%, no more than ˜30%, no more than ˜20%, no more than ˜10%, no more than ˜5%, or, e.g., no more than ˜1% of the otherwise maximum distance the MC could move in response to a temperature differential absent a backpressure from a VPCPS. In aspects, the VPCPS provides a constant resistance to movement of the PGC-MC in one direction (e.g., when PG expands due to exposure to a suitable TML) and provides the counter pressure for moving a PGC-MC in an opposite direction when, e.g., a PG contracts due to exposure to a suitable TML, or, e.g., experiences a reduction in temperature due to exposure to an HEM). In aspects, a device comprising a VPCPS produces at least about 30% more, such as at least ˜35% more, ˜40% more, ˜45% more, ˜50% more, ˜55% more, ˜60% more, ˜65% more, ˜70% more, ˜75% more, ˜80% more, ˜85% more, ˜90% more, or even ˜100% more (e.g., that is, about two times more) energy than a similar device utilizing pressurized gas (e.g., a second volume of PG) as a backpressure, such as those devices and systems described in prior U.S. patent application Ser. No. 16/985,192 filed by the Applicant, which is specifically incorporated by reference.

In aspects, a vacuum is established with the device at a starting state. In aspects, the vacuum pressure is established according to the size (e.g., surface area), of the movable components in the VPCPS, the size (e.g., surface area) of the PGC-MC, the starting pressure of the pressurized gas in the PGC, the relationship between any two or more of the above, or a combination of the above. In aspects, a pressure change on one side of a movable component caused by a change in temperature of the pressurized gas causes the movable component to move. In aspects, the vacuum pressure is such that, once established on one side of a VPCPC-MC (and, in aspects, the PG-MC), pressure changes on an opposite side of a PGC-MC caused by a change in temperature of a PG cause movement of a PGC-MC over a stroke length in one direction wherein over the stroke length in that direction, the moveable component encounters a substantially constant resistance; e.g., the resistance, e.g., the opposing force, does not change more than about 50%, ˜25%, ˜20%, ˜15%, ˜10%, ˜5%, ˜3%, or, e.g., does not change by more than about 1% over the stroke length in that direction.

In aspects, a PG on one side of the PGC-MC is increased due to an increase in its temperature. In aspects, the increased pressure causes the PGC-MC to move, creating a larger volume of space in which the PG resides. In aspects, the PGC-MC continues to move to a point at which the PG reaches a pressure which is mostly, generally, substantially, or essentially equivalent to its pressure prior to having its temperature (and, hence, its pressure) increased. In aspects, the movement of the PGC-MC in response to the increase in pressure of the PG meets no detectable or significant increase in resistance the further the PGC-MC moves. In aspects, the end of the stroke of the MC is established at the point wherein the pressure of the PG is mostly, generally, substantially, or essentially equivalent to its pressure prior to having its temperature (and hence its pressure, increased).

In aspects, a PG on one side of the PGC-MC is decreased due to a decrease in its temperature. In aspects, the decreased pressure causes the PGC-MC to move in the opposite direction the PGC-MC moves in response to an increase in pressure of the PG. In aspects, the vacuum present on the opposite side of the PGC-MC causes the movement of the PGC-MC in response to a decrease in pressure.

In aspects, the alternating exposure of a PG having an increased pressure and a decreased pressure on a first side of an MC, wherein the MC has a VPCPS on a second, opposite, side of the MC providing counter pressure to such pressure changes on the first side of the MC, causes the alternating movement of the movable component which can be captured as work and converted to usable energy.

In aspects, a PGC-MC moves back-and-forth along a path having a stroke length in response to the alternating exposure of a first side of the PGC-MC to a PG having a first and a second pressure. In aspects, the first and second pressures of the PG are established by the alternating direct or indirect exposure of the PG to at least a first and a second temperature source respectively. In aspects, at least one of the at least first and second temperature sources each being one of a naturally occurring environmental condition or an environmental condition formed by a waste stream produced by a technological process. In aspects, the vacuum on a second side of the PGC-MC (e.g., within a VPCPS), opposite the first side, providing a counter pressure to the first and second pressures of the PG on the first side of the PGC-MC, aids in the back-and-forth movement of the PGC-MC.

In one specific embodiment, device(s) of the invention comprise:

(1) a primary pressure modulating system (“PPMS”) comprising (a) a pressurized gas chamber (“PGC”) (b) a first moveable component (or PGC-MC) positioned in the PGC, (c) a pressurized gas (PG) contained in the PGC, and (d) a temperature modulating system (TMS) comprising (i) a temperature modulating liquid (TML) having a first portion and a second portion (T1L and T2L), each TML portion having a different temperature in operation, the differences in temperature between T1L and T2L being sufficient to cause movement of the PGC-MC across at least most of the MC's stroke length in an at least one direction, and (ii) a dispensation system that in operation alternately dispenses T1L and T2L to alternatingly change PG temperatures; and
(2) a vacuum-powered counter pressure system (“VPCPS”) comprising (a) a second (vacuum) container and (b) a VPCPS movable component contained in the vacuum container (a VPCPS-MC), the movement of the VPCPS-MC being operationally linked to the movement of the PGC-MC, wherein, in operation, the VPCPS generates a vacuum that creates a counter pressure to the pressure of the PG, causing movement of the PGC-MC in a 2^{nd} direction that is at least substantially opposite to the 1st direction.

Vacuum pressure in embodiments comprising a vacuum pressure counter pressure system (VPCPS) is typically established prior to operation (in RFOS). Typically, vacuum chambers in VPCPS devices/systems are at least substantially closed. As with other components that are described herein as closed with respect to the environment, such components alternatively can be described as “enclosed” or “isolated” from the environment. Typically, vacuum in vacuum chambers exhibit no DoS loss of pressure in most, generally all, essentially all, or all periods of device operation. Such embodiments can also include embodiments wherein the device/system comprises temperature modulating system (TMS) comprising a heat exchange system (HES) wherein the HES comprises HEC(s) and HEM(s).

In aspects, the vacuum generated by the VPCPS promotes or causes the “pulling” of the PGC-MC (and VPCPS-MC(s)) in one direction. In aspects, a vacuum is constant and, hence, its presence at least permits “pushing” the PGC-MC away from the vacuum pressure of the VPCPS when pressure of the PG sufficiently increases due to exposure of the PG to a portion of TML at relatively higher temperature than the previous temperature of the PG.

In aspects, the VPCP system comprises at least a second container (the first container being a part of the primary PMS, maintaining within it a PG, DC(s), a PGC-MC, etc.), at least a second MC, and a vacuum. In aspects, the vacuum can be referred to as a vacuum component. In aspects, the vacuum component does not refer to any vacuum-generating component, but, rather a chamber/container comprising a vacuum pressure, which acts on other component(s) that are operably linked to, e.g., a MC.

In aspects, the VPCPS comprises at least a second container. In some aspects, the VPCPS comprises at least a second and a third container. In further aspects, the VPCPS of a device/system can comprise a 4^{th}, 5^{th}, 6^{th} container, or more containers, each having the characteristics and housing the components, described here for the at least second (and third) containers. In aspects, the second and third containers of a device/system comprise a housing that houses a second (within the second container) and a third (within the third container), movable component (MC). Each such MC can be referred to as a vacuum powered counter pressure system (VPCPS) movable component (MC) (VPCPS-MC). The housing of the second and third containers can in aspects comprise a barrier component, e.g., walls, that form a chamber in which the VPCPS-MCs (respectively) are located. In aspects, the housing or barrier component comprises one or more visual aid component(s) (VAC(s)) DEH. In aspects, a first side of a VPCPS-MC of each container, and the barrier of the container, define a chamber within the container. In aspects the chamber can comprise a vacuum, such that the first side of a VPCPS-MC aids in the maintenance of a vacuum chamber. It is this/these vacuum chamber(s), e.g., within 1^{st} and 2^{nd} containers, which characterize the VPCPS, and create the counter pressure to the pressure established in the first container of the device/system comprising the PG. As will be described elsewhere, mechanical connection(s) between the PGC-MC and the VPCPS-MC(s) create a relationship such that the pressure on the second side of the PGC-MC, e.g., opposite that defined by the PG, is defined by, or established by the vacuum chamber(s).

In aspects, the temperature, material composition, or any similar characteristics of the barrier modulates the average vacuum pressure of the vacuum chamber by ≤˜1% during MGASAOA operation cycles, such as less than ˜0.85%, ≤0.7%, ≤0.6%, ≤0.5%, ≤0.4%, ≤0.3%, ≤0.2%, or ≤0.1% of the average vacuum pressure. In aspects, the barrier of any container of the VPCPS is comprised of material which is capable of maintaining the vacuum pressure of the VPCPS within ≤˜0.1% of the average vacuum pressure during MGASAOA operation cycles.

In devices that comprise a closed vacuum powered counter pressure system (VPCPS), an RFOS comprises generation of a vacuum pressure in the vacuum chamber(s). The VPCPS comprises VPC-MC(s) that are movingly engaged with PGC-MC(s), such that movement of the PGC-MC(s) causes movement of the VPC-MC(s).

In aspects, a device comprises a VPCPS the device comprises and only a single PGC or there is only a single PGC and PGC associated with ≥1 vacuum chamber(s) and ≥1 VPCPS-MC(s) (e.g., 2 vacuum chambers, each comprising a VPCPS-PC).

In any of such devices, the VPCPS can further comprise a second container comprising a housing comprising (i) a barrier component (e.g., a collection of 1, 2, 3, 4 or more walls) that is at least substantially impervious to unintentional vacuum loss and that forms (ii) a selectively sealable chamber (a “vacuum chamber”) comprising or capable of creating and maintaining a vacuum, the chamber defined at least in part by a (second) MC (a VPCPS-MC). A vacuum typically is created and maintained within the VPCPS, more specifically within the chamber defined by the housing and a first side of the second MC or VPCPS-MC, with the second side of the second movable component typically being exposed to the atmospheric pressure of the surrounding environment.

In aspects, the vacuum generated by the VPCPS applies a force to (pull on) the PGC-MC (and VPCPS-MC(s)) in one direction, and at least permits the movement of the PGC-MC away from the vacuum when pressure of the PG sufficiently increases due to exposure of the PG to a portion of TML at relatively higher temperature than the previous temperature of the PG. Thus, in aspects, the vacuum is a pressure that is overcome by the pressure causing movement of the MC in the direction against the vacuum, and the vacuum correspondingly promotes movement of the MC in the opposite direction, DoS increasing the speed of movement of the MC along an entire SL and back.

In aspects, in operation, the PG typically fills a volume of the PGC on one side of the PGC-MC, while a vacuum, within the VPCPS, is maintained on the opposite side of the PGC-MC. In operation, in aspects a TML is exposed to the T1S and T2S; a fluid switch (TL1/TL2 switch) alternates delivery of T1L and T2L to DC(s) and DC(s) alternately dispense T1L and T2L into the PG. In operation, in aspects, a volume of PG is alternatingly exposed to HEMs having different temperatures, such volume of PG being alternatingly present on a single side of an MC such as a PGC-MC, while a vacuum, within the VPCPS, is maintained on the opposite side of the PGC-MC. The presence of the vacuum can be provided indirectly, such as, e.g., via the presence of separate container(s) providing the vacuum.

In certain aspects, devices/systems herein can comprise one or more working pistons/PGC-MCs (MC of the primary PMS) having a diameter less than half of the largest diameter of the housing within which it resides, while also comprising at least one MC of a VPCPS having a diameter which differs from the diameter of the housing within which the VPCPS-MC reside(s) by no more than about 0.5%, no more than about 0.3%, or no more than about 0.1%. In other aspects, the diameter of at least part of an MC is such that the device comprises a single chamber within the first container and located on a single side of the MC and comprising PG, in which PG can flow from one side of the SL to the other (around the MC and between the outer diameter of the MC and the barrier). In aspects, flow around or past an MC of a first container (an MC of a primary pressure modulating system, e.g., a working piston/MC) is created by flow passage(s) in the barrier, created by, e.g., inclusion of a narrower diameter of part of an MC, passages in an MC, or a combination of any thereof. In aspects comprising flow passages in a barrier, outside of an MC, interior of MC, or combination thereof, such passage(s) can be restricted so that such devices can still comprise a SLIP that comprises openings exposed to the environment and closed to PG. In aspects, one or more MCs present in the VPCPS can have one or more similar such characteristics thus allowing in aspects a modification in the level of vacuum created by movement of a VPCPS-MC, as such a passage would create a release of vacuum pressure.

In aspects, containers, e.g., chambers defined by housings or barriers of such containers, of second, third, or more containers of a VPCPS comprise no dispensation components. In aspects, no TML or energy transfer liquid is dispensed within a container of a VPCPS.

In aspects, at least a portion of each container of the VPCPS is at least substantially closed with respect to the environment when in operation due to the presence of a VPCPS-MC creating a movable closure on one end of each container. In AOTI, MGASAOA devices exhibit no DoS loss of any vacuum pressure or created vacuum pressure therein. In aspects, the vacuum of the VPCPS, once established, in aspects upon, but not prior to, initial operation (though which is be present in aspects prior to initial operation), varies by ≤˜5%, ≤˜4%, 9-3%, ≤˜2%, or ≤˜1%, over the course of operation and, except for the difference in pressure caused by the movement of a VPCPS-MC from a starting position to a second position representative of an end of a stroke length of the VPCPS-MC, such a vacuum pressure is maintained throughout operating cycle periods of ≥6, ≥12, ≥24, or ≥60 months. In aspects, upon initial system establishment, no vacuum may present (e.g., no vacuum chamber may be present as any present VPCPS-MC may be positioned such that it has not pulled away from a barrier of a container of the VPCPS such that a vacuum and a vacuum chamber has been established).

According to aspects, re-establishment of a sealed chamber for establishing a vacuum is required, on average, no more than the earlier of a) the lifetime of the first expiring system seal, (e.g., ˜12 months (1 year), ˜16 months, ˜20 months, ˜24 months (2 years), ˜28 months, ˜32 months, or ˜36 months (3 years)), or b) a point in time wherein the system loses at least ˜5%, such as at least ˜5.5%, at least ˜6%, at least ˜6.5%, at least ˜7%, at least ˜7.5%, at least ˜8%, at least ˜8.5%, at least ˜9% at least ˜9.5%, or at least ˜10% of its vacuum pressure when the system is in continual use. In aspects, the TML, PG, vacuum chamber, or any combination thereof require re-pressurization or re-establishment/adjustment no more than once per month, e.g., no more than once every ˜2 months, once every ˜4 months, once every ˜6 months, once every ˜8 months, once every ˜10 months, or once every ˜1 year, such as once every ˜14 months, once every ˜16 months, once every ˜18 months (1.5 years), once every about 20 months, once every ˜22 months, or once every ˜24 months.

In aspects, a VPCPS-MC can be of any size, shape, or configuration so as to be capable of both communicating with one or more other components of the device/system (e.g., the PGC-MC) and establishing and maintaining a vacuum chamber in a container within which it resides. In aspects, such a VPCPS-MC is a piston-like device, having a “plunger-” or “piston-” like element and a connecting element, often embodied or described as a rod however which may take on any suitable size, shape or configuration for connecting the plunger- or piston-like element to one or more other components of the device/system.

In aspects, the diameter of at least a part of VPCPS-MC(s), e.g., the “plunger” or “piston” component of an MC aiding in the establishment of a vacuum chamber within the VPCPS, and the inner diameter of the housing of the VPCPS container (e.g., second or third container of the device/system and comprising a vacuum), differ by no more than about 0.5%, about 0.4%, about 0.3%, about 0.2%, about 0.1% or even less, such as by no more than ˜0.09%, ˜0.08%, ˜0.07%, ˜0.06%, ˜0.05%, ˜0.04%, 0.03%, 0.02%, or 0.01% or even less. Accordingly, a VPCPS-MC can, in aspects, create a substantially or effectively impassible barrier with respect to any air or gas, making it capable of creating and maintaining a vacuum chamber on one side of the VPCPS-MC within the container upon movement of the VPCPS-MC and can serve as one defining wall of such an established vacuum chamber space.

In some aspects, the connecting element of the VPCPS-MC connecting to the plunger/piston-like element of the VPCPS-MC and further connecting to one or more other components of the device/system, can be any suitable size or shape or have any suitable characteristics which allow for a) the transfer of motion of the PGC-MC to the plunger/piston-like element of the VPCPS-MC to which it is directly connected, and b) the transfer of motion from the plunger/piston-like element of the VPCPS-MC to which it is directly connected to the PGC-MC. In aspects such a connecting element is embodied as a rod or pole, e.g., a piston rod. In aspects, this component is referred to as the VPCPS-MC connector, or VPCPS-MC-C.

In certain aspects, the VPCPS-MC-C, can have a diameter that is less than half of that of the VPCPS-MC plunger- or piston-like component. In aspects, the VPCPS-MC-C can have a diameter that is less than about 50%, less than ˜45%, less than ˜40%, less than ˜35%, less than ˜30%, less than ˜25%, less than ˜20%, less than ˜15%, or, e.g., less than ˜10% of that of the diameter of the VPCPS-MC-C plunger- or piston-like component.

In aspects, the VPCPS-MC-C serves at least in part to connect a PGC-MC to the VPCPS-MC, such that the two are operationally linked. In aspects, the PGC-MC can be any PGC-MC within a device having one or more of the characteristics or embodiments described here. That is, for example, the PGC-MC can be present in a device described in, e.g., US '192 wherein the VPCPS replaces the pressurized gas back pressure in such disclosed devices; or, e.g., the PGC-MC can be present in a device comprising a heat exchange system (HES) having HEC(s) and HEM(s) described here. In aspects, VPCPS-MC-C(s) and PGC-MC(s) (or in aspects more specifically a piston rod/connecting element of a PGC-MC) can connect to a VPCPS-MC unifying connector (VPCPS-MC-UC) serving to mechanically join the components. In aspects, two or more VPCPS-MC-Cs are connected to a single component serving to join VPCPS-MCs such that movement transferred to one is effectively simultaneously transferred to another.

In aspects, a VPCPS-MC-UC can comprise/be any device/component suitable for carrying out such tasks. In aspects a VPCPS-MC-UC can have any suitable shape, configuration, and composition. In aspects, a VPCPS-MC-UC can be a rod, plate, bar, an enclosed element such as a cylinder- or box-like structure, a ring, a hoop, or the like.

In certain embodiments, the VPCPS-MC-UC is a component located outside of the housing of the first container. In aspects, the VPCPS-MC-UC is a component located outside of the housing of a second or a third container. In aspects, the VPCPS-MC-UC is a component not housed within any housing. In aspects, the VPCPS-MC-UC is connected to a PM which extends from the body of a PGC-MC through one or more SLIPBO(s). In aspects, the VPCPS-MC-UC is connected to a rod (e.g., a piston rod) extending from a side of a PGC-MC opposite that comprising the CS. In aspects, movement of the PGC-MC is translated via VPCPS-MC-UC to one or more other components of the device, either directly or indirectly, through physical or mechanical interaction.

In aspects, movement of the PGC-MC causes movement of the VPCPS-MC, and movement of the VPCPS-MC causes movement of the PGC-MC. In aspects, the connection is such that movement of one causes effectively immediate movement of the other. In certain aspects, the VPCPS-MC-C(s), VPCPS-MC-UC(s), or both link the PGC-MC and a VPCPS-MC such that the pressure on the side of the PGC-MC opposite the PG is defined by the vacuum pressure of the chamber within the VPCPS. In certain aspects, the pressure on a first side of a VPCPS-MC is defined by a vacuum within a vacuum chamber while the pressure on the opposite side of the VPCPS-MC is defined by atmospheric pressure.

In aspects, the VPCPS-MC-UC is connected directly or indirectly to a PGC-MC. In aspects, movement of a PGC-MC causes movement of the VPCPS-MC-UC, movement of the VPCPS-MC-UC causes movement of the VPCPS-MC-Cs connected thereto, and, ultimately, movement of the VPCPS-MC-Cs cause movement of the VPCPS-MCs. Movement of the VPCPS-MCs modifies the vacuum chambers with which they are associated, the vacuum chambers providing the counter pressure to the pressure created in and by the primary temperature modulating system (e.g., changes in pressure of the PG). In aspects, when the pressure of the PG is reduced relative to that of vacuum chamber(s), the VPCPS-MC-UC can serve to transfer movement of VPCPS-MCs to a PGC-MC.

In aspects, VPCPS-MC-UC(s), VPCPS-MC-C(s), or both primarily comprise, substantially consist of, or generally consist of (PCSCOGCO), consist essentially of (CEO), or consist of a material that is non-water, non-TML corrosive and environmentally tolerant material (e.g., tolerant to environmental exposures such as heat, cold, sun, water, and the like) and has a yield strength of at least about 40,000 psi, such as ≥˜50,000 psi, ≥˜60,000 psi, ≥˜70,000 psi, or ≥˜80,000 psi, and comprises a tensile strength of at least about 60,000 psi, ≥˜65,000 psi, ≥˜70,000 psi, ≥˜75,000 psi, ≥˜80,000 psi, ≥˜85,000 psi, or ≥˜90,000 psi. In aspects, an VPCPS-MC-UC comprises a material which is non-water corrosive and is made of a material comprising a yield strength of ≥˜40,000 psi and a tensile strength of ≥˜60,000 psi.

In aspects, each VPCPS-MC can have a predefined, expected stroke length. Such a VPCPS-MC stroke length can be determined based upon system configuration which can consider system constraints including size and expected work production. In aspects, as DH, the expected stroke length of any one or more VPCPS-MCs is related to, e.g., is determined in relation to, the expected SL of the PGC-MC, with the ratio of the diameters of PGC-MC:VPCPS-MCs at least aiding in defining such expected SL(s). In aspects, the presence of a VPCPS-MC-UC allows for a device/system to transfer motion of a PGC-MC to multiple VPCPS-MCs, such that a system can have a 1:1, 1:2, 1:3, 1:4, 1:5, 1:6, 1:7, 1:8, 1:9, 1:10 or even higher ratio of PGC-MC(s) to VPCPS-MC(s) diameters. In aspects, the smaller the surface area of the PGC-MC (e.g., the smaller the surface area of the CS) the shorter the required SL.

According to aspects, the relationship between the surface area of the contact surface of the PGC-MC and a surface area of a VPCPS-MC is such that if one is increased, the other can be increased in order to provide functionality and/or optimal functionality of the device/system. In some respects, the relationship between the surface area of the contact surface of the PGC-MC and the volume of the vacuum container(s) of the VPCPS are such that if one is increased, the other can be increased in order to provide functionality and/or optimal functionality of the device/system. In aspects, the ratio between the diameter of the PGC-MC and the diameter of the VPCPS-MC(s) is between ˜1:2-1:10, such as between ˜1:2-1:8, 1:2-1:6, or e.g., between ˜1:2-1:4.

In aspects, a stroke length (SL) of the PGC-MC(s) is smaller than a corresponding dimension of the PGC within which the PGC-MC at least partially resides (e.g., the length of the PGC). E.g., in aspects a/the PGC-MC does not enter an/any IVS.

In aspects, there typically is a sufficient T1ΔT2 in operation of a device/system to detectably promote movement of the PGC-MC in at least a 1st direction (in aspects, the T1S and T2S are selected/configured to provide such as T1ΔT2 most of the time, on average, generally all of the time, nearly all of the time, or all of the time). In such aspects, alternating dispensing of T1L & T2L can, e.g., create a pressure differential on opposing sides of the PGC-MC, which causes the MC to repeatedly move back and forth along/across the SL, aided by the counter pressure system. In aspects, alternating exposure of PG to HEMs having different temperatures creates a pressure differential on opposing sides of the PGC-MC, which causes the MC to repeatedly move back and forth along/across the SL, DoS aided by the vacuum pressure counter pressure system (VPCPS).

In aspects in which devices comprise PGC-MC(s) and VPCPS-MC(s), both types of MCs are typically oriented in substantially the same or same orientation. In aspects, the SL of PGC-MC(s) and VPCPS-MC(s) are nearly or entirely identical. An SL typically is smaller in its largest dimension (e.g., length) than the corresponding dimension of the container/housing (e.g., where a PGC container comprises IVS(s)). In operation, an MC typically moves in alternating fashion (back-and-forth along the applicable SL).

In aspects, whenever there is a sufficient temperature difference between the first portion of TML and the second portion of TML (e.g., between TL1 and TL2), the alternating dispensing of TL1/TL2 into the PG creates a pressure differential within the PG chamber of the first container and the vacuum chamber(s) of the VPCPS (e.g., within the second and third containers of the device/system) such that the PGC-MC is forced to move across at least a part of a stroke length. In aspects, whenever there is a sufficient temperature difference between HEM1 and HEM2 and a volume of PG is alternatingly exposed to HEM1 and HEM2, the alternating exposure of the PG to HEM1 and HEM2 causes a pressure differential within the PGC of the first container and the vacuum chamber(s) of the VPCPS (e.g., within the second and third containers of the device/system) such that the PGC-MC is forced to move across at least a part of a stroke length.

In aspects, upon device/system establishment, the VPCPS-MC within the second and/or third container is positioned completely, e.g., is extended 100%, as far as it is capable of being physically placed, into the respective container. In aspects, the VPCPS-MS of each container is pressed as much as is possible up against a first end wall/barrier of their respective containers. In aspects, this creates a space, or lack thereof, on one side of the VPCPS-MC (e.g., the second and third VPCPS-MCs) which is generally, substantially, almost completely, or completely absent of any air or other gas. In aspects, it is in this state that the first end/wall of the container of the VPCPS is closed, that is, effectively and suitably sealed, such that retraction of the VPCPS-MC from this position creates a vacuum. Retraction of the VPCPS-MC from this position creates a vacuum; the space within which the vacuum is created in referred to herein as the vacuum chamber.

In aspects, retraction of the VPCPS-MC from this starting position occurs prior to operation to a point at which a pressure differential across the two sides of the PGC-MC is at least substantially equal. In aspects, an increase in pressure on the PG side of the PGC-MC causes a movement of the PGC-MC to a position wherein the pressure differential across it equalizes once again. In aspects, to reach such a position, the operational connection between the PGC-MC and the VPCPS-MC as described previously causes movement of the VPCPS-MC when the PGC-MC moves in response to the pressure increase of the PG. In aspects, such a movement causes the VPCPS-MC to move from its starting position, away from the volume of space comprising the vacuum. In aspects, the vacuum serves as the counter pressure to the pressure on the PG side of the PGC-MC, such that the VPCPS-MC is retracted or moved in the opposite direction, toward its starting point, when the pressure of the PG on the opposite side of the PGC-MC is reduced.

In aspects, the movement of the VPCPS-MC from its first position to its second position can be referred to as the VPCPS-MC stroke length (VPCPS-MC-SL). In aspects, movement of the PGC-MC is operationally connected to multiple VPCPS-MCs, such as second and third VPCPS-MCs, such that movement of the PGC-MC in response to a change in pressure in the PG causes movement of both a second and third VPCPS-MCs each within respective second and third containers of the VPCPS, such that vacuum chambers are created within each of the second and third chambers, and the sum or total of the vacuum pressure created by the two chambers creates the counter pressure to the PG chamber. This operational connection can at least in part be facilitated by a VPCPS-MC-UC (DFEH). In aspects, the PGC-MC moves upon the establishment of a pressure differential to a position such that the pressure on the PG side of the PGC-MC and the pressure represented by the sum of any vacuum pressure established in the VPCPS (e.g., the sum of the vacuum pressure from the first and second vacuum chambers) are at least substantially equivalent.

In aspects, the distance a PGC-MC travels can be affected by the size of single vacuum chamber, or the sum volume of a plurality of vacuum chambers, within the VPCPS on the non-PG side of the PGC-MC. In aspects, the larger the volume of a single vacuum chamber, or also or alternatively the larger the total volume of vacuum established in the VPCPS, the shorter the distance traveled by the PGC-MC to reach a point of equilibrized pressure. In aspects, the smaller the volume of a single vacuum chamber, or also or alternatively the smaller the total volume of vacuum established in the VPCPS, the longer the distance traveled by the PGC-MC to reach a point of equilibrized pressure. The determination of the size/volume of the pressure chamber(s) created within the VPCPS is made in collaboration with the determination of the size of the PGC-MC and, e.g., the size of and pressure within the PG chamber of the first container, such that the dynamics of the system are appropriate for a suitably sized device/system (e.g., as determined by physical constraints of location, output constraints in terms of work productivity, or the like).

In aspects, it is the vacuum component that in operation of the device/system, applies a vacuum to one end of the working movable component. In aspects, the device/system in operation has a vacuum pressure which is at least equal to the pressure created by expanding gas in a PGC. In aspects, the device/system in operation has a vacuum pressure which is detectably or significantly greater than the pressure created by expanding gas in a PGC. In aspects, the device/system in operation has a vacuum pressure which is detectably or significantly less than the pressure created by expanding gas in a PGC. In aspects, the device/system has a vacuum pressure which requires sufficient pressure change in the PGC to overcome, e.g., a sufficient pressure change in the PG of a PGC after, e.g., a TML is dispensed into the PG or, in alternative embodiments, a PG having had its temperature affected by an HEM enters a PGC, having been displaced in an HEC by an energy transfer liquid.

In aspects, as described previously, movement of the PGC-MC causes, via a connection to a VPCPS-MC-C (and in aspects a VPCPS-MC-UC), movement of a VPCPS-MC. In aspects, the ratio between the surface area of the CS of the PGC-MC and the diameter of the plunger/piston-like element of the VPCPS-MC determine the relationship between the stroke length of the PGC-MC and the stroke length of the VPCPS-MC during any one or more operating cycles. In aspects, the larger the VPCPS-MC diameter:PGC-MC diameter ratio, the smaller the VPCPS-MC:PGC-MC SL ratio. In aspects, the smaller the VPCPS-MC diameter:PGC-MC diameter ratio, the larger the VPCPS-MC:PGC-MC SL ratio. The ratio in diameters of the PGC-MC and the VPCPS-MC(s) can be selected such that their SLs are the same, as in common aspects they are mechanically connected by, e.g., a VPCPS-MC-UC. In aspects, the diameter of a VPCPS-MC, the diameter of the PGC-MC (e.g., the diameter of the CS of the PGC-MC), or both, are selected based upon the operational constraints of the device/system, such, e.g., as device/system size, location, work output expectations, and other considerations related to restrictions and requirements.

### D. Other Possible Components/Characteristics

In one aspect, simplicity of design can be an aspect of certain devices/systems of the invention (OTI). Accordingly, according to certain aspects, the device and/or systems of the present invention lack certain components.

In aspects, the devices and/or systems describe herein lack a “displacer”, that is, any component referred to commonly as a displacer in Stirling engine-related technology or functioning in such a manner. In aspects, devices/systems lack a solid displacer component/element. In Stirling engine technology, a displacer is a component that operates as a special-purpose piston. In Stirling-type engines, a displacer works to move the gas (working gas) back and for the between the hot and cold exchangers. A displacer in this type of use is, as noted, a piston-like component which comprises space around its outermost edges so as to allow gas or air within the engine to easily move between heated and cooled sections of the engine. In Stirling engine technology, the displacer serves to control when the gas chamber is heated and when it is cooled: when the displacer is in a first position (e.g., near the top of a cylinder in which it resides), most of the gas inside the engine can be heated by an external heat source and allowed to expand. As pressure builds, the power piston, a separate piston in a Stirling engine, is forced upward. When the displacer is in a second position (e.g., near the bottom of a cylinder in which it resides), most of the gas inside the engine is allowed to cool and hence contracts, causing a pressure drop, and making it easier for the power piston to move downward and to compress the gas. In aspects, devices and or systems describe herein lack any component functioning or operating in such a manner or present to accomplish such a function.

As noted, in certain aspects, device(s)/system(s) lack any such displacer which is made of a solid material. That is, in aspects, device(s)/system(s) herein can comprise a fluid, such as a liquid, which can provide displacement activity or function, such as displacing a PG within a defined space when such a liquid is added to the defined space comprising PG.

In aspects, devices/systems OTI lack any cooling system/component other than the TML, and any cooling that occurs within the device/system takes place only by the means for modulating the temperature of the PG through the dispensing of the TML.

In aspects, devices and systems lack rollers, bearings, or other such mechanical means of reducing friction between the MC and the chamber within which it is positioned (e.g., between the MC and the barrier). In aspects, the devices and systems lack any wedges or similar or equivalent mechanical components other than the movable connector, and MRE(s) for communicating movement of the movable component to other parts of the device. In some facets, the devices and systems lack a compression spring, flywheel, or other similar means of storing momentum required to maintain continuous operation of the device. In aspects, the devices and/or systems lack means of storing energy for use within the device to maintain operation other than optionally comprising battery(ies).

In aspects, the devices and systems described herein do not comprise a rotating mixer or means of forcibly mixing TML & PG upon dispensation of a TML into a PG, such mixing being only that which occurs by dispensation through DC(s). In aspects, the barrier (e.g., walls), of the housing of the device comprise(s) no flaps or movable parts, other than that which may be present as a valve. In aspects, the devices/systems of the present invention lack any baffle or fan component. In aspects, the device is non-buoyant, e.g., the device does not float when placed in water.

In aspects a secondary component of a system described herein can comprise PG tank(s). In aspects, such a one or more gas tanks may be utilized upon system start up to provide the system with a suitable amount of a pressurized gas, but due to the closed nature of the system may be used relatively infrequently thereafter, as has been described elsewhere herein. In aspects, the one or more gas tanks can comprise the gas used as the PG of the system, such as, e.g., nitrogen (N2) gas.

In aspects, a device lacks any component that would be considered a “storage tank.” E.g., in aspects, no part of a DLCS has a diameter ≥10× the average diameter of the DLCS, e.g., no part of the DLCS has a diameter ≥7×, ≥5×, ≥4×, ≥3×, or ≥2× the average diameter of the DLCS. In system aspects, no part of a SLCS has a diameter ≥10, ≥7, ≥5, ≥4, ≥3, or ≥2 than the average diameter of the SLCS, DLCS, or both.

### E. Systems Including Devices

A device (heat engine) can be a stand-alone device comprising all components required/selected for operation or a device can be a part of system(s) comprising secondary component(s), the device and secondary component(s) cooperatively operating together to form system(s) capable of producing work and possibly performing other function(s) (e.g., controlling operation of aspects of the device, converting the device's work into other forms of energy, and the like). In aspects, the principles applicable to a device or system are similar, thus, e.g., some aspects are described as a device/system (or device(s)/system(s) (e.g., non-limiting examples include the embodiments shown in FIGS. 1, 2, and 6, which can either be a device comprising a DLCS that contacts T1S & T2S or a system comprising both DLCS & SLCS, with parts of the SLCS contacting T1S & T2S).

In aspects, the invention provides systems comprising one or more heat engine devices and secondary component(s), e.g., an extended liquid conducting system (“ELCS”) that in operation holds & conducts TML wherein a 1st portion is in contact with T1S, and a 2nd portion is in contact with T2S, and comprises connection element(s) capable of connecting the device to the ELCS to maintain a closed TMS. In aspects, the system also comprises a power-generating device/component that uses work of the device to generate electricity. In aspects, the device also (i.e., also or alternatively) comprises a power generator that converts the work of the device, induced by the T1ΔT2, to transferrable energy (e.g., an electricity generator).

In aspects, the invention provides a complex comprising system(s)/device(s), as described in any aspect of this disclosure, which further comprise a power-generating device or component, (b) the complex further comprises secondary power source(s), (c) both the system(s) and the secondary power source(s) provide power to associated powered apparatus(es), structure(s), or network(s) (e.g., a vehicle, house, or appliance), (d) the complex comprises electronic sensor network(s) which comprises (1) temperature sensor(s) (e.g., as described above), (2) second sensor/data collection unit(s) that collect the available energy in the second (or more) power source, and (3) 3rd data collection unit(s)/component(s) that receive or collect the anticipated energy demand of the apparatus(es), structure(s), or network(s); (e) the complex comprises means for relaying information signals from the first, second, third, or more sensors; (f) the complex comprises electronic programmable complex control unit(s) that receive the information signals from the sensors and store and execute preprogrammed instructions for directing energy from the system(s) or second (or more) power sources to the apparatus(s), structure(s), or network(s) depending on the differences between the primary temperature(s) and secondary temperature(s), the energy needs of the apparatus(es), structure(s), or network(s), and the amount of energy in the second (or more) power source(s).

In aspects, MC(s) of a device/system is/are coupled with a power-generating device/system, such that movement of an MC generates or can generate power (e.g., electricity). In aspects, the energy generated by the MC's work can be transferred to associated components/systems via an energy/power take off mechanism, for conversion to electrical energy or other form of energy. In aspects, movement of the one or more MCs can generate power or electricity directly, e.g., where at least part of the housing operates as a linear electrical generator.

In aspects, multiple low temperature differential powered devices can be connected or networked. In aspects, such networked systems can comprise device(s) having different operating parameter(s) allowing some of such device(s) to generate work while others may experience a period of non-operation.

In aspects, a device/system can be connected to unrelated power source(s)/system(s), e.g., a hydroelectric power generating system, wind turbine(s), solar power generating system(s), etc., and therewith providing coordinated energy sources. In aspect(s), devices/systems comprise energy storage devices/components, e.g., batteries, which in methods can cover periods where device(s) are not generating work/energy.

In aspects, a device and/or a system comprises a minimum power generation threshold, below which the device/system is deemed less optimal or unsuitable to continue to operate and is temporarily stopped. In aspects, such analysis, stopping or starting, is controlled by an electronic PU/CPU acting on preprogrammed stored instructions.

In aspects, the threshold of power production at which the device and/or system in which the device operates can be deemed unsuitable for operation can be the point at which the energy produced reaches a production level that is within at least about 0.5% of that value, such as no more than about 0.45% of that value, ≤˜0.4%, ≤˜0.35%, ≤˜0.3%, ≤˜0.25%, ≤˜0.2%, ≤˜0.15%, or for example ≤˜0.1% or ≤˜0.05% of the energy consumed by the device. In aspects, the energy consumed by the device is related only to pump(s) and/or pump(s) operation, e.g., pump pressure. In aspects, wherein the device comprises or is in a system comprising control unit(s) capable of automatically controlling the device/system, operation can be automatically stopped until such a time when the energy of the system/device produced is at least ˜0.1%, 0.5%, 1%, 2%, 5%, 7.5%, 10%, 12.5%, 15%, or 20% greater than the amount energy consumed to operate the system or device.

In aspects, device(s) having any of the above-described features are comprised in system(s) comprising secondary component(s) outside of the device(s).

In aspects, such secondary components can comprise, but may not be limited to, a LCS (a SLCS), an automated control system, gas tank(s), pump(s), or any such component which may supplement or enhance the operation of the device or provide for added functionality, increased efficiency, or any one or more of the above.

In aspects, a system described herein is a substantially closed system (“substantially closed” being defined EH). In aspects, the closed system is pressurized such that the pressure is substantially uniform in both the gas and liquid portions of the system prior to operation. Such attempts to balance as much as possible the high pressure of the system (such pressures DFEH) provide for an increased operating efficiency of the system. Accordingly, for example in certain embodiments, less energy is required to dispense liquid as a mist into the PG; the dispensed TML is maintained at primarily, generally, substantially the same or the same operating pressure as the PG into which it is dispensed. In aspects, the system can maintain its pressure (e.g., maintain the pressure within the first container comprising the PG) without the need for re-pressurization, for extended periods of time as DEH. In aspects, the system can maintain its ability to create and/or maintain vacuum pressure within the VPCPS, without the need for re-sealing or the like, for extended period s of time as DEH.

In aspects, secondary component(s) comprise power-generating device(s)/component(s) that receives energy from the device and uses it to generate power. In aspects, the power-generating device receives energy from the device and uses the received energy to generate electricity. Such a conversion can be any conversion methods or means as has been previously described. In aspects, the system is capable of receiving and relaying electricity generated by the device and optionally comprises a secondary component for generating electricity from work performed by the device.

In aspects, the system has an energy production capacity of at least 10 kWh, an average energy output of at least 7.5 kWh, or an energy production capacity of at least 10 kWh and an average energy output of at least 7.5 kWh. In aspects, the system has an energy production capacity of at least 10-25 kWh, an average energy output of at least 7.5-20 kWh, or an energy production capacity of at least 10-25 kWh and an average energy output of at least 7.5-20 kWh. In aspects, the system is capable of generating the average energy output whenever there is a temperature differential of about 5° C. or more between the temperature of HEM1 and HEM2, between the temperature of PG after exposure to HEM1 and the temperature of PG after exposure to HEM2, between the first temperature input (T1S) in contact with the first portion of liquid (T1L) of the LCS and the second temperature input (T2S) in contact with the second portion of liquid (T2L) of the LCS, or between the TML dispensed from the one or more dispensers of the device in alternating fashion. In aspects, the system is able to generate the average energy output whenever there is a temperature differential of about 1° C. or more between HEM1 and HEM2, the PG after exposure to HEM1 and the temperature of PG after exposure to HEM2, between TIS and T2S, or between T1L and T2L dispensed from the one or more DCs of the device in alternating fashion.

According to embodiments, the system is capable of being connected with one or more additional devices or systems having the characteristics described herein, or to a power generating system unrelated to the systems described herein. In aspects, such an unrelated system could be, for example, a coal, nuclear, hydro, wind, solar, or other type of energy production system. For example, a system of the present invention can be connected to a solar production system or a wind-powered system or a hybrid engine of a vehicle. In aspects, such a connection facilitates the expansion of the total amount of power production.

According to aspects, secondary component(s), device component(s), or both, can be designed to be specifically mated to other device/system component(s). In aspects, such components can be designed to only be mated to the device of the present invention and not to other devices. In aspects, the device of the present invention is designed to be inoperable unless it mated with a secondary component designed to be mated with the device; for example, the device of the present invention can be designed so as to not be capable of mating with similar such devices, such as for example those made as counterfeit or genericized products. In aspects, such preferable mating between the device and secondary components of the system can be controlled by the presence of one or more indicators on a secondary component and the device which can communicate to the device or a component of a system (e.g., to a controller or PU) that the secondary component is suitable for use. In aspects, one such indicator is a radio frequency identification (RFID) tag or an identifier having similar characteristics. In aspects, secondary components can comprise an RFID tag which controls operability & non-operability of the device/system, the device and secondary component(s) designed to be paired with other component(s) comprising a compatible tag and only operable therewith.

In aspects, a complex comprising a system having any of the characteristics, features, and operational capabilities DEH is provided, in which the system/device comprises a power-generating device or component and a secondary power source, where the device/system and secondary power source provide power to an associated powered apparatus, structure, or network (e.g., an appliance, automobile/vehicle, building such as a house, facility, etc.). In aspects, the complex can comprise an electronic sensor network comprising a plurality of DCUs, such as a first, a second, and a third DCU, the characteristics of such DCUs being any one or more characteristics of a DCU DEH. In aspects, one or more DCUs store and execute preprogrammed instructions to receive inputs, such as pressure or temperature inputs. In aspects, such temperature inputs can be primary and secondary temperatures from one or more sensor(s) of the device corresponding to a first temperature and second temperature at preprogrammed measurement intervals during an operation cycle, such an operation cycle comprising periods of device operation and intervening periods. In aspects, one or more DCUs can collect the available energy in the second power source. In aspects, one or more DCUs collect the anticipated energy demand of the apparatus, structure, or network.

In aspects, the complex comprises means for relaying information signals from a plurality of DCUs, such as from a first, second, and third DCU. In aspects, means for relaying such information signals, e.g., pressure or temperature data, available energy in a second power source, or anticipated energy demand of an apparatus, structure, or network, from a DCU can be any means of successfully sharing information data from one point to another including but may not be limited to parallel transmission, serial transmission (including synchronous or asynchronous transmission), wireless communication channel(s), etc., and data may be represented as, e.g., an electromagnetic signal such as an electrical voltage, microwave, radio wave, or infrared signal, etc. In aspects, temperature information data can be encrypted. AOA, the temperature information data may not be encrypted. In aspects, one or more DCUs can relay information signals to one or more processors (e.g., to one or more processing units).

In aspects, the complex comprises an electronic programmable complex control unit (EPCCU). In aspects, the EPCCU receives the information signal(s) from one or more DCUs and stores data. In aspects the EPCCU executes preprogrammed instructions for directing energy from the system or a second power source to the apparatus, structure, or network. In aspects, which preprogrammed instructions are executed depends on the differences (calculated by e.g., a processor, e.g., a processing unit) between the primary temperature and secondary temperature, the energy needs of the apparatus, structure, or network, and the amount of energy in the second power source. In aspects, for exemplary purposes, if a T1ΔT2 is incapable of supporting sufficient power production to meet the needs of an apparatus, structure, or network, then for example the EPCCU could direct the initiation of a secondary power source, the bringing online of a second power production system, the shutdown of a device or system, or the modification of one or more modifiable operating parameters.

In aspects, the complex comprises a viewable user interface. In aspects the interface can be any interface that allows a human operator to observe the status of operational aspects of the complex, e.g., specifically the primary temperature and secondary temperature, the energy level of the second power source, the anticipated energy need of the apparatus, structure, or network, or a combination thereof. In aspects such an interface is a computer monitor (e.g., desktop or laptop monitor). In aspects the interface is a mobile device such as a smart device (e.g., a smart phone or pad device). In aspects data is presented via a software interface. In aspects data is presented via a web page or web-based application. In aspects data is presented via a locally stored application. In aspects, the user interface is an interactive interface component. In aspects, the interactive interface is capable of receiving instructions from a user on changing one or more of the operating parameters of the device (e.g., amount of dispensed liquid; frequency of dispensed liquid; forced operation of pumps; dispensation gap(s); modifying, adding, or deleting a gap in time between the completion of an SL by an MC before a TML is dispensed; or combinations of any or all thereof), changing sourcing of energy from the second power source, or a combination thereof. In aspects, the interface may provide options for alerting the user to certain conditions and provide the ability for a user to respond to such alerts, e.g., to take action to resolve a suboptimal operating condition to resolve a mechanical issue, or the like, such as for example by directing the processor to take a specific action (e.g., to initiate a pump or to shut down the system).

### F. Methods and Device Performance

In aspects, the invention provides methods of transforming a temperature differential into useful work. In aspects, such methods include method(s) comprising (a) providing (1) a TML held within a closed TMS comprising (2) a container comprising (i) a sealed chamber having an IVS making up ≥5%, ≥10%, ≥15% or ≥20% of the chamber, a PG, and a PGC-MC having an SL that in aspects does not include the IVS; (b) establishing a closed system pressure in the PG and TML before regular operation thus, e.g., the pressure of the liquid having a first temperature & a second temperature is substantially the same as that of the pressurized gas; (c) exposing one portion of the TML to a T1S and a second portion of the TML to a T2S; and (d) dispensing droplets of the TML into the PG in an alternating fashion through a dispensing component (DC) creating alternating T1G and T2G conditions in the PG, the change in T1G & T2G causing the PGC-MC to move back-and-forth along the SL due to a counter pressure on the opposite side of the MC provided by a VPCPS. In aspects, the method comprises changing the source of TML in a 1st portion of the DC from T1 to T2 and changing the source of TML in a 2nd portion of the DC from T2 to T1 at least once over the course of a 24-hour period, (e.g., when the TIS is a lake and the T2S is the air in an environment the sources are switched when time passes from day to night).

In aspects, methods for transforming a temperature differential into useful work comprise providing an energy transfer fluid and a pressurized gas. In aspects, the method comprises providing a primary pressure modulating system and a temperature modulating system. In aspects, the primary pressure modulating system used in the method comprises a first, primary container, the primary container comprising an MC positioned in the primary container and which n operation moves an SL when acted upon by a minimum force. In aspects, the primary container further comprises a primary pressure chamber (primary chamber) and a second pressure chamber (secondary chamber) within the primary container, or, alternatively, access to a VPCPS. In aspects, the primary pressure chamber and either the secondary chamber or the VPCPS are separated from one another by the MC. In aspects, the primary chamber of the method is configured to maintain both a PG and a liquid in alternating fashion. In aspects, the temperature modulating system comprises a heat exchange system (HES). In aspects, the HES used in the method comprises first and second heat exchange chambers (HECs) each configured to maintain both the PG and a portion of the liquid in alternating fashion. In aspects, a first HEC (HEC1) comprises a first heat exchange material (HEM) (HEM1) and a second HEC comprises a second HEM (HEM2). In aspects, the temperature modulating system of the method further comprises the energy transfer fluid (liquid), which in aspects has a first portion and a second portion, each accessible to the primary chamber and each accessible to a separate HEC (HEC1 or HEC2). In aspects, in performance of the method, the first and second portions of energy transfer liquid alternatingly displace the PG such that the PG is alternatingly exposed to HEM1 and HEM2. In aspects, during the performance of the method, HEM1 and HEM2 maintain a temperature differential of at least 1° C. during at least about 90% of a 24-hour operating period. In aspects, in performance of the method, the alternating exposure of the PG to HEM1 and HEM2 alternatingly increases and decreases the temperature of the PG, and, accordingly, the pressure of the PG, such that the MC of the primary pressure modulating system moves back and forth across a stroke length in response to the pressure change. In aspects, the alternating movement of the MC is captured (e.g., by a power off-take device) and translated into useable energy such as, e.g., electricity. In aspects, the method comprises use of one or more temperature sources which can be naturally occurring (such as, e.g., a body of air or a body of water) or an environment resulting from a technological process (such as, e.g., a waste stream) to establish one or more operating temperatures of the device/system, such as, e.g., to establish the temperature of HEM1 or HEM2 or also or alternatively to establish the temperature of a first and second portion of energy transfer liquid or, also or alternatively, to establish a first and a second temperature of a PG.

Aspects relating to methods of the invention and devices/systems of the invention can be applied to one another herein unless otherwise indicated. E.g., in aspects, methods are performed when the T1ΔT2 is 10 degrees C. or less, e.g., ≤7.5° C., ≤5° C., ≤2.5° C., or ≤1° C.

In aspects, dispensing of TML into the PG causes ≥25%, ≥33%, 50%, generally all, nearly all, or all the PG in chamber(s) to DoS change temperature, creating a pressure differential in the chamber(s) that causes the PGC-MC to move from area(s) of high to low pressure and in the process to convert the energy of the temperature difference into useful work.

In aspects, alternating exposure of PG to HEM1 and HEM2 causes ≥33%, ≥50%, generally all, nearly all, or all the PG to DoS change temperature, and when such PG is exposed to a PGC-MC, it causes the PGC-MC to move from area(s) of high to low pressure and, in the process, to convert the energy of the temperature difference into useful work.

In aspects, the device liquid conducting system (DLCS) of the TMS (or DLCS & SLCS) and the PG have a substantially equal pressure when in RFOS (i.e., have pressures that differ by ≤˜5%, ≤˜4%, ˜3%, ≤˜2%, ≤˜1.5%, or less than ˜0.5%. In aspects, the device operates at high pressure(s) in the TML and PG. In aspects, the pressure of the PG, TML, or both is ˜12 to ˜720 atmospheres (ATM) (176-10,600 psi), e.g., ˜12-710 ATM (176-10,400 psi), ˜12-700 ATM, ˜12-675 ATM, ˜12-650 ATM, ˜12-620 ATM, ˜12-600 ATM (176-8800 psi), such as ˜20-720 ATM (290-10,600 psi), ˜50-720 ATM, ˜75-720 ATM, ˜100-720 ATM, ˜125-720 ATM, ˜150-720 ATM, or ˜200-720 ATM or ˜300-720 ATM (e.g., 15-600, 25-650, or 25-500 ATM). In aspects, pressure within the chamber during operation is sufficiently high so as to cause any heating or cooling of the gas caused by the barrier to make up ≤2%, or less than about 1% (e.g., ≤0.5%) of the average gas temperature in the chamber during an operating cycle.

In aspects, the liquid conducting system (LCS) and the PG have approximately equal or substantially equal pressure at points in time where a TML is dispensed into the PG (e.g., have pressures that differ by ≤˜5%, such as ≤˜2% or ≤˜1%). In aspects, in operation, a TML is dispensed into a PG chamber having a different pressure than the pressure of the PG when in RFOS, e.g., a pressure that is within ˜30%, within ˜25%, within ˜20%, within ˜15%, within ˜10%, or within about 5% of the PG pressure when the device is in RFOS. In aspects, the DLCS of the TMS (or DLCS & SLCS) and the PG have pressures within ≤˜5% of one another at points in time where a TML is dispensed into the PG while the pressure of the PG into which the TML is dispensed during operation is within about 30% of the PG when in RFOS for at one cycle period of the device. In aspects, the difference in pressure between the TML and PG (a) ≥˜33% of the time, at least most of the time, or generally all of the time, in operation, and (b) in RFOS, differ by ≤˜15%, ≤˜10%, ≤˜5%, ≤˜2.5%, ≤˜1.5%, ≤˜1%, or ≤˜0.5%.

According to facets, the pressure of the PG within the device, and the pressure of the liquid within the device, can be such that they vary by no more than about 15% prior to operation, e.g., in RFOS such pressures vary by no more than ˜7.5%, no more than ˜5%, ≤˜3.5%, no more than ˜3%, ≤˜2.5%, no more than ˜2%, no more than ˜1.5%, or e.g., by ≤1% or about ≤0.5% prior to operation. Such devices can be characterized as comprising “pressure balanced” TML and PG components in RFOS.

In aspects, the alternating dispensing of the liquid into the pressurized gas creates a temperature differential in a PG chamber that causes the PGC-MC to repeatedly move back and forth across a SL, with a counter pressure facilitating the back-and-forth movement facilitated by a VPCPS DEH. According to certain aspects, the alternating dispensation of T1L and T2L occurs on the same side of the PGC-MC (contacting the same contact surface thereof) and typically into only 1 IVS. In aspects, the alternating exposure of PG to HEM1 and HEM2 creates a temperature differential in a PGC that causes the PGC-MC to repeatedly move back and forth across a SL, with a counter pressure facilitating the back-and-forth movement facilitated by a VPCPS.

In operation and immediately prior to operation (in a “ready for operation” (“RFO” state or “RFOS”), devices of the invention comprise closed liquid (TMS) and gas systems. In a RFOS, the pressures of the TML or in embodiments energy transfer liquid & PG typically are substantially similar. In operation and immediately prior to operation (in a “ready for operation” (“RFO” state or “RFOS”), devices comprise closed liquid (TMS) and gas systems. In a RFOS, the pressures of the TML & PG typically are substantially similar.

In aspects, devices are selectively openable. E.g., chamber(s) of the device, aspects of the temperature modulating system, or both can be selectively openable. Opening can, in aspects occur outside of operation. Opening can, in aspects, occur during operation such as, e.g., when an LCC or dispensation component is opened. However, in such aspects, such opening typically does not expose the interior of the device(s)/system(s) to an outside environment such that the internal pressure of the system is DoS modified by the outside environment. When closed, a selectively openable device typically maintains pressure in the TMS and PG, maintains pressure within a selectively openable chamber of a VPCPS, or both, such as within +/−≤5%, ≤3%, or ≤1%, over a period of operation (e.g., ≥1 week, ≥1 month, ≥3 months, ≥6 months, or ≥1 year).

According to embodiments, devices comprise closed and at least initially similarly pressured TML and PG systems. In aspects, the TML and PG pressure remain within at least about 5%, e.g., within at least about 4.5%, 4%, 3.5%, 3%, 2.5%, 2%, 1.5%, or within at least about 1% of each other in RFOS, at initial operation, or both. “Initial operation” in this sense and others, unless otherwise indicated, means initiation of operation in an OCP, including but not limited to the first time a device is ever operated.

In aspects, devices are characterizable as being at least substantially closed with respect to PG or TML in operation. In AOTI, MGASAOA devices exhibit no DoS TML or PG loss during most, generally all, nearly all, or all OCP(s). In aspects, the pressure of the PG and the TML, once established, typically prior to initial operation, vary by ≤5%, and, except for pressure introduced by temperature modulation brought about by dispensing T1L and T2L into the chamber, maintain such similar pressure throughout operating cycle periods of ≥6, ≥12, ≥24, or ≥60 months.

According to aspects, re-pressurization of the TML, PG chamber, any pressure modulating system, any heat exchange system, or any combination is required, on average, no more than the earlier of a) the lifetime of the first expiring device/system seal, (e.g., ˜12 months (1 year), ˜16 months, ˜20 months, ˜24 months (2 years), ˜28 months, ˜32 months, or ˜36 months (3 years)), or b) a point in time wherein the system loses at least ˜5%, such as at least ˜5.5%, at least ˜6%, at least ˜6.5%, at least ˜7%, at least ˜7.5%, at least ˜8%, at least ˜8.5%, at least ˜9% at least ˜9.5%, or at least ˜10% of its pressure when the system is in continual use, In certain aspects, no such re-pressurization is required during any period of operation of a device/system. In aspects, the TML, PG, or both require re-pressurization no more than once per month, e.g., no more than once every ˜2 months, once every ˜4 months, once every ˜6 months, once every ˜8 months, once every ˜10 months, or once every ˜1 year, such as once every ˜14 months, once every ˜16 months, once every ˜18 months (1.5 years), once every about 20 months, once every ˜22 months, or once every ˜24 months.

In aspects, the PGC-MC, in most, generally all, nearly all, or all strokes, moves until the PGC-MC reaches a position whereby either (a) the PG pressure on either side of the PGC-MC or (b) the PG pressure on a first side of the PGC-MC and the vacuum chamber(s) reach(es) approximate equilibrium (at least approximate pressure balance). In aspects, upon or about reaching such an approximate pressure balance, the next cycle of TML dispensation occurs, creating an opposite change in pressure in the PG chamber, forcing movement of the PGC-MC in response, typically returning along the SL, until again the PGC-MC reaches a point of approximate pressure balance with the vacuum chamber(s) of the VPCPS. E.g., dispensation of TML in aspects occurs as the pressure on either side of the PGC-MC (e.g., by force of the VPCPS) approaches a pressure balance (e.g., pressures on opposing sides of the PGC-MC are within ˜15%, within ˜10%, within ˜5%, or within ˜2.5% of one another).

In aspects, in operation, dispensing pressurized TML (AKA the “liquid”) into the PG consumes, on average, generally, or only no more than about 33% of the work produced by movement of any one or more MC(s). In aspects, dispensing pressurized TML takes up ≤˜30%, ≤˜25%, ≤˜20%, ≤˜17%, or ≤˜15%, e.g., no more than ˜13%, ≤˜10%, ≤˜7%, ≤˜5% of the work produced by the movement of any one or more MC(s).

In aspects, methods comprise a step of reinitiating movement of the MC after any period of inactivity caused by the T1ΔT2 falling below a threshold. In aspects, the re-initiation step comprises applying power to the PGC-MC to cause the PGC-MC to move along the SL at a time when the T1ΔT2 is above or approaching a threshold after which the MC will move without extraneous power input. In aspects, such a re-initiation step is performed automatically (e.g., in response to a programmable controller).

In certain embodiments, the invention is a method of transforming a temperature differential into work comprising: (a) providing (i) a liquid held within a closed system, (ii) an enclosed movable component (MC) (e.g., “PGC-MC”), and (iii) a first volume comprising pressurized gas (PG) held within the closed system maintained on a first side of a movable component such that the MC partially defines a void space (IVS) having a length that is at least 7.5% of the length of the first volume; (b) a vacuum-powered counter pressure system (VPCPS) maintained on a second side of the movable component and comprising one or more VPCPS movable components (VPCPS-MC); (c) exposing one portion of the liquid within the closed system to a first condition having a first temperature and a second portion of the liquid within the closed system to a second condition having a second temperature to cause a first portion of the liquid to have a first temperature and a second portion of the liquid to have a second temperature; (d) establishing a closed system pressure before regular operation wherein the pressure of the liquid having a first temperature and a second temperature is substantially the same as that of the pressurized gas; and (e) causing a first portion of the liquid and a second portion of the liquid to contact the pressurized gas in alternating fashion in sprayed droplet form creating a pressure differential on opposing sides of the MC, and hence causing the MC to move, wherein the system maintains operability if the first and second conditions change, such that the warmer of the two conditions becomes the colder of the two conditions and the colder of the two conditions becomes the warmer of the two conditions. In aspects, such a method can be conducted using any one or more devices, systems, or devices or systems having the operational characteristics of the devices and/or systems described herein.

In aspects, at least one of the 1st or 2nd conditions, e.g., at least 1 of the T1S & T2S, is an environmental source/condition. In one aspect, the 1st & 2nd conditions are environmental sources/conditions. In aspects, the 1st or 2nd condition(s) is a body of air. In aspects, the 1st or 2nd condition(s) is a body of water. In aspects, ≥1 of the 1st and 2nd conditions is a waste stream. In aspects, both are waste streams.

In aspects, a method is capable of continually producing power when the temperature differential between the first condition and the second condition is as low as about 15° C., such as low as ˜10° C., ˜8° C., ˜6° C., ˜4° C., ˜2° C., or as low as about 1° C.

In aspects, a method is capable of continually producing power under circumstances wherein at least one of the first or second conditions is an environmental condition and the first and second conditions reverse their relative temperatures, e.g., conditions wherein the once warmer of the two conditions becomes the cooler of the two conditions and the once cooler of the two conditions becomes the warmer of the two conditions. In aspects, such a reversal of conditions can happen one or more or two or more times during a 24-hour period. In aspects, the method is capable of operating continuously for at least about 50% of a 24-hour period, such as at least about 55%, ≥˜60%, ≥˜65%, ≥˜70%, ≥˜75%, ≥˜80%, ≥˜85%, ≥˜90%, or e.g., at ≥95% of a 24-hour period.

According to embodiments, a liquid (TML) contacts the pressurized gas (PG) by being dispensed as a mist into the PG. In aspects, the liquid is dispensed through one or more dispenser components (DC(s)) capable of converting the liquid from a flowing liquid into a mist. In aspects, the mist has a suitable droplet size so as to effectuate a temperature change of the PG into which it is dispensed and to create a T1ΔT2 across the chamber sufficient to cause movement of the MC upon each dispensation of the mist (e.g., within the times DEH). In aspects, DC(s) comprise outlets which dispense in at least two different directions simultaneously. In aspects, the TML dispensed from a first outlet overlaps with the TML dispensed from a second outlet such that the volume of PG with which the TML makes contact upon dispensation is DoS higher than that contacted if outlets dispense TML in a single direction. In aspects, a pressure change which is sufficient to cause movement of the PGC-MC occurs more quickly in methods utilizing DC(s) comprising outlets dispensing TML in a plurality of directions at once than in methods utilizing DC(s) comprising outlets dispensing TML in a single direction. In aspects, DC(s) in such methods is/are located within ˜20%, e.g., ˜15%, ˜10%, or ˜5% of the central axis of the container within which it resides. In aspects, DC(s) are positioned coaxially within the container within which they reside.

In aspects, the droplets of the mist dispensed as part of a method comprise a Volume Median Diameter (VMD) of between about 25 μm and about 150 μm, e.g., between about 30-90 μm, or e.g., between about 40 μm and about 80 μm. In aspects, the droplets of the mist dispensed as part of the method have a DV0.9 value of between about 50-about 90 μm, such as between about 60-about 80 μm, or for example about 70 μm.

In aspects, the mist dispensed in certain methods described herein is mist from a first portion (e.g., T1L) and a second portion (e.g., T2L) of liquid, alternatingly dispensed such that each makes contact a single volume of PG in alternating sequence on the same side of the movable component.

In aspects, methods described herein can comprise dispensation of a volume of TML into the PG capable of modifying the temperature of the PG into which it is dispensed sufficiently to cause a PG pressure differential and hence movement of the PGC-MC. In aspects, the volume of TML dispensed into the PG in such methods is capable of sufficiently and adequately (e.g., quickly as is described elsewhere herein) modifying the temperature of the PG to approximately three quarters (%), or 75%, of the temperature of the TML. In aspects, while methods comprising modifying the temperature of the PG to a temperature closer than 75% of that of the TML can continue to maintain operability of the system, heating or cooling the PG beyond that of ¾ of that of the TML can decrease system/device efficiency; e.g., more energy can be consumed in the process of narrowing the temperature differential between the TML and the PG than may be obtained from the work produced by such a reduction in temperature differential. In aspects, the device/system can be operated by methods comprising a volume of TML dispensed into the PG which modifies the temperature of the PG to less than approximately ¾, or 75%, of the temperature of the TML. In such circumstances, the method may produce less work than a method in which the PG is raised to approximately ¾ of that of the TML.

According to aspects, a change in pressure of the PG causes the PGC-MC to move, the counter pressure for such movement provided by the VPCPS.

According to certain embodiments, if an alternating cycle of dispensing first and second portions of liquid of a device or system of the methods described herein fails to repeat, e.g., failure of an MC (e.g., a PGC-MC) to move a minimum distance (minimum stroke distance), failure of the method to produce a minimum amount of work, or both failure of the MC to move a minimum distance and failure of the method to produce a minimum amount of work, as may happen for example when the temperatures of T1L and T2L fail to have a minimum T1ΔT2, the method can comprise restarting the system by exposing one portion of the liquid (e.g., T1L) to at least a first volume of the PG. In certain facets, the exposure forces the MC to move a minimum distance, forces the method to resume production of a minimum amount of work, or forces both the MC to move a minimum distance and the method to resume production of a minimum amount of work.

In aspects, the exposure of one portion of the liquid to at least a first volume of PG can be by automated, manually controlled, or optionally automated or manually controlled means such that an MC (e.g., a PGC-MC) is forced to move a minimum distance, the method resumes production of a minimum amount of work, or both the MC is forced to move a minimum distance and the method resumes production of a minimum amount of work. In aspects, the same one or more dispensing components (DCs) used to alternatingly dispense first and second portions of liquid can be used to dispense a TML, e.g., either T1L or T2L, to restart the system within the methods described EH. In aspects, a separate DC can be used to dispense a TML to restart the system. In aspects, a method OTI comprises an automated system restart, lacking human intervention, if a cycle fails to repeat. Per aspects, methods OTI comprise exposure of portion(s) of TML to at least a first volume of the PG which occurs in an automated fashion, without human intervention, when a minimum stroke distance, a minimum power output, or minimum stroke distance and minimum power output parameter fails to be met.

In aspects, methods described herein comprise a gas which substantially remains in the same relatively distinct location or locations within the devices and/or systems utilized in the method, thus, e.g., they do not pass from one relatively distinct location within a device or system to another. In aspects, in application of the method, gas is not forced to pass through a path comprising angles to move from one location to another, e.g., it does not pass through a tortuous route from one chamber, container, housing, or otherwise distinct location to another. In aspects, any movement or flow of gas within the closed system in regular operation is substantially in the same orientation. In alternative aspects, such as, e.g., in methods comprising use of heat exchange materials located in containers separate from a primary container comprising a PGC, PG can move from one location to another, such as, e.g., from one container to another, such transport in aspects including passage through one or more conduits. In aspects, such conduits are two-way conduits. In aspects, a gas can pass in both directions through such a two-way conduit, such as in one direction when the gas is displaced from a PGC and moves to an HEC, and in the opposite direction when the gas is displaced from the HEC and moves to the PGC. Such features of a conduit apply both to methods described here and devices described elsewhere in this disclosure.

According to certain aspects, the invention provides a method of energy production capable of producing at least about 5 kWh of energy, such as ≥˜6 kWh, ≥˜7 kWh, ≥˜8 kWh, ≥˜9 kWh, or ≥˜10 kWh, of energy, such as ≥˜12 kWh, ≥˜14 kWh, ≥˜16 kWh, ≥˜18 kWh, or at least about 20 kWh of energy. In aspects, such energy production capabilities can be even higher, such as for example at least about 40 kWh, ≥˜60 kWh, ≥˜80 kWh, or ≥˜100 kWh can be produced by methods OTI. According to some aspects, the invention provides a method of energy production which is capable of producing an amount of energy (kWh) which is DoS greater than that provided by the methods disclosed in US '192, such as, e.g., at least about 1%, ˜2%, ˜3%, ˜5%, ˜10%, ˜20%, ˜30%, ˜40%, ˜50%, ˜60%, ˜70%, ˜80%, ˜90%, or about 100% or greater than methods disclosed in US '192.

In some facets, the present invention describes a method of energy production capable of producing an average energy output of at least about 3 kWh, such as ≥˜3.5 kWh, ≥˜4 kWh, ≥˜4.5 kWh, ≥˜5 kWh, ≥˜5.5 kWh, ≥˜6 kWh, ≥˜6.5 kWh, ≥˜7 kWh, ≥˜7.5 kWh, ≥˜8 kWh, ≥˜8.5 kWh, ≥˜9 kWh, ≥˜9.5 kWh, or at least about 10 kWh or even more, such as an average energy output of at least 12 kWh, at least 14 kWh, at least 16 kWh, at least 18 kWh, at least 20 kWh, or even more. According to some aspects, the invention provides a method of energy production which is capable of producing an average energy output (kWh) which is DoS greater than that provided by the methods disclosed in US '192, such as, e.g., at least about 1%, ˜2%, ˜3%, ˜5%, ˜10%, ˜20%, ˜30%, ˜40%, ˜50%, ˜60%, ˜70%, ˜80%, ˜90%, or about 100% or greater than methods disclosed in US '192.

In aspects, the methods described herein utilize devices and systems described herein which are pressurized, e.g., the gas, liquid, or gas- and liquid-containing portions of the system are pressurized, and or a component of a system is sealed such that a vacuum is or can be established, upon system start up. In aspects, to maintain operability, re-pressurization of the gas, liquid or gas- and/or liquid-containing components used in the methods described herein, and/or re-sealing of components establishing or maintaining a vacuum, need occur no more than the earlier of a) the lifetime of the first expiring system seal (e.g., about 6 months, ˜1 year, ˜1.5 years, ˜2 years, ˜2.5 years, or ˜3 years), or b) a point in time wherein the system loses at least about 5% of its pressure when the system is in continual operation, such as about once (1×) per month, 1× every ˜2 months, 1× every ˜4 months, 1× every ˜6 months, 1× every ˜8 months, 1× every ˜10 months, 1× every ˜1 year, 1× every ˜1.5 years, 1× every ˜2 years, 1× every ˜2.5 years, or for example once every ˜3 years.

In aspects, the methods described herein comprise operational steps which are mechanically linked. In aspects, a PGC-MC is mechanically linked directly or indirectly to one or more VPCPS-MCs. Alternatively, in aspects the methods described herein comprise operational steps which are not mechanically linked, such as for example aspects of the method wherein dispensation of a TML or energy transfer fluid (liquid) occurs via automated control(s)).

In aspects, the methods of energy production described herein do not comprise any step involving the displacement of a PG, e.g., through the use of a displacer to move a gas from one distinct location within a device or system of the method to a different distinct location within a device or system of the method; do not comprise a step of using stored energy to sustain the method; do not comprise a step of actively cooling a component or system partaking in the method to maintain operability beyond that which occurs from the alternating dispensation of liquid; or any combination of any or all thereof. In alternative aspects, the methods of energy production described here comprise displacement of PG using a liquid displacer, such as, e.g., an energy transfer liquid.

In certain facets, methods OTI comprise use of one or more pumps, such as for example one or more rotary pumps, to initiate, maintain, or enhance the dispensation, e.g., spraying of TML, as droplets of liquid (e.g., a mist) into the PG; to conduct liquid through a temperature modulation system or an LCS; or any combination of any or all thereof.

The methods of work (e.g., energy) production described herein can in aspects comprise monitoring component(s), operation(s), or process(es) of a method. In aspects, the method comprises monitoring the temperature difference between the first volume of PG and second volume of PG and automatically pumping TML or energy transfer fluid in response to pre-programmed conditions (e.g., differences in such temperatures). In aspects, a preprogrammed condition can be or can relate to one or more temperature(s), pressure(s), passage(s) of time, a repositioning or movement of a component, an energy demand, an energy supply, or any condition relevant to the conduct of the methods described herein.

In aspects, methods OTI comprise converting the movement of MC(s) into electrical energy. In aspects, the conversion of the movement of MC(s) into electrical energy is accomplished via a power off-take component which is a component of a device used in the method. In aspects, the conversion of the movement is accomplished via a power-off-take component which is a component of a system used in the method.

According to some aspects, an MC, e.g., a PGC-MC or, correspondingly, a/an MC of a VPCPS (VPCPS-MC) is capable of completing at least about 60, ≥˜100, ≥˜200, ≥˜300, ≥˜400, at least about 500, ≥˜600, or more, such as at least approximately 700, ≥˜800, ≥˜900, or ≥˜about 1000 strokes per minute in peak operation of the device, a “stroke” being the maximum distance the MC can travel in one direction. According to some aspects, an MC is capable of completing a DoS increased number of strokes per minute in peak operation of the device over the MCs disclosed in US '192, such as, e.g., at least about 1%, ˜2%, ˜3%, ˜5%, ˜10%, ˜20%, ˜30%, ˜40%, ˜50%, ˜60%, ˜70%, ˜80%, ˜90%, or about 100% or more strokes than the number of strokes per minute of an MC disclosed in US '192.

In aspects, the average temperature of TIS, T2S or both DoS changes over MGASAOA 24-hour periods in OCPs (e.g., when the temperature inputs are environmental locations, such as a lake and air). In such aspects, the average temperatures of T1S and T2S can change in such a manner that TIS is warmer than T2S during portion(s) of a 24-hour period and T1S is colder than T2S input during the other portion(s) of the same 24-hour period. This can occur, for example, when one temperature input is a body of water and a second temperature input is a body of air, e.g., during the day the air is warmer than the water however during the night the air is cooler than the water.

Typically, where T1 and T2 are equal or at a near equal threshold temperature difference (e.g., less than about 2, 1.5, 1.25, or 1° C. different) the MC will fail to complete the SL and eventually cease moving for at least some period of time. In aspects, as T1 & T2 begin to differ again, approaching or exceeding the threshold, the PGC-MC will begin to move and eventually move the entire SL. In aspects, the device or system can comprise a means for injecting TML to reinitiate movement of the PGC-MC, by operation of a pump using stored or extraneous power. In aspects, injection of either T1L or T2L can be manually selected for restarting the device or system. In aspects, the device or system comprises an automated control for selecting either T1L or T2L for restarting the device or system. In certain facets, after the device/system has ceased operation due to a lack of sufficient temperature differential between T1S and T2S, injection of either T1L or T2L once a sufficient temperature between T1S and T2S has been reestablished is capable of restarting the system.

In aspects, T1S & T2S are environmental inputs, and the device/system is operable, on average, at least 10 of every 24 hours, e.g., ≥12 of each 24 hours, ≥14 of every 24 hrs., ≥16 of every 24 hrs., ≥20 of each 24 hours, or ≥22 of every 24 hours, or ≥˜50%, at least about 60%, ≥70%, at least about 80%, ≥˜90%, or even more of a typical 24-hour period.

In aspects, movement of an MC (e.g., a PGC-MC, a VPCPS-MC, or both, can perform a variety of useful work. E.g., an MC can comprise a converter or mechanism for converting movement of the MC into other forms of work. In aspects, such a mechanism can be selected from a group comprising a rack mechanism, e.g., a rack and pinion mechanism; a roller mechanism, e.g., a roller pinion mechanism; a magnetic, hydraulic, piezoelectric, or any other such similar or equivalent mechanism KITA. In aspects, an MC provides means of or specific components for connecting a device to a power source take off. In aspects, the converter comprises an electricity generating device.

In aspects, less than about 50%, such as 5-45%, 5-40%, 5-35%, or less than ˜30%, e.g., ≤˜25%, ≤˜20%, ≤˜15%, or less than about 10% of the energy generated by the device is used in dispersing liquid, pumping liquid, or both. In aspects when the device is operating as a component of a system, less than about 50%, ≤˜45%, ≤˜40%, ≤˜35%, or ≤˜30%, such as less than ˜25%, ≤˜20%, ≤˜15%, or even less than about 10% of the energy generated by the system is used in dispersing liquid, pumping liquid, or both.

In aspects, the devices and systems described herein produce at least about 2×, ≥˜3×, ≥˜4×, ≥˜5×, ≥˜10×, ≥˜25×, ≥˜50×, ≥˜75×, or at least about 100× (100 times) the amount of energy consumed by operation when the T1ΔT2 or T1GΔT2G is at least 10° C. (e.g., such as ≥˜10° C., ≥˜12° C., ≥˜14° C., ≥˜16° C., ≥˜18° C., or ≥˜20° C.) upon each alternating dispensation of T1L and T2L. In aspects, devices and systems comprise means of converting work of an MC to produce energy.

In aspects, the work produced by the device can be further transformed to other types of energy, such as for example but not limited to electrical energy, hydraulic energy, pneumatic pressure energy, high temperature heat energy, and the like.

In aspects, the device can comprise a means of generating electricity. Such a means can comprise any means capable of generating electricity, such as but not limited to movement of an MC generating electricity directly such as an MC operating as a linear electric generator; the device comprising a means of converting movement of the MC to electricity; or for example the device comprising an off-take component such as a rack component of a rack and pinion mechanism, piezoelectric blocks, means of converting linear motion to rotational motion such as to drive a rotor, flywheel, or other such means KITA. In aspects, energy conversion mechanisms can be present in any part of the device or system capable of capturing work. In aspects, a PM of an MC can operate as a safety component and may connect to, or operate in conjunction or cooperatively with, a power off-take device such as those described elsewhere herein. In aspects, a VPCPS-MC-UC or other moving component of a device/system can connect to or operate in conjunction or cooperatively with, a power off-take device. According to certain aspects, a movable component can be a linear generator and can serve directly as a power generation device. In one aspect a mechanism for transferring work from the device/system for conversion into usable energy is an electromagnetic motor. In aspects, a mechanism for transferring work from the device/system for conversion into usable energy is a rack, e.g., a rack and pinion system.

In aspects, the devices and systems described herein can produce significant work, such as e.g., at least ˜2 to at least about 100 times the amount of energy consumed by operation when the temperature of the PG modified by the TMS or by contact with an HEM is changed by at least 10° C. upon each alternating dispensation of TML. In aspects, the device and/or system within which the device is operating has an energy production capacity of at least about 5 kWh, such as ≥˜5 kWh, ≥˜6 kWh, ≥˜7 kWh, ≥˜8 kWh, ≥˜9 kWh, ≥˜10 kWh, ≥˜12 kWh, ≥˜14 kWh, ≥˜16 kWh, ≥˜18 kWh, or for example at least about 20 kWh. In aspects, the devices and systems described herein produce an average energy output of at least about 5 kWh, ≥˜5.5 kWh, ≥˜6 kWh, ≥˜6.5 kWh, ≥˜7 kWh, ≥˜7.5 kWh, ≥˜8 kWh, ≥˜8.5 kWh, ≥˜9 kWh, ≥˜9.5 kWh, ≥˜10 kWh, or even more, such as at least about 12 kWh, ≥˜14 kWh, ≥˜16 kWh, ≥˜18 kWh, or at least about 20 kWh, such as ≥˜22 kWh, ≥˜24 kWh, ≥˜26 kWh, ≥˜28 kWh, ≥˜30 kWh, ≥˜32 kWh, ≥˜34 kWh, ≥˜36 kWh, ≥˜38 kWh, or even ≥˜40 kWh or more. In aspects, the devices and systems described herein are capable of producing such maximum energy output and average energy output when there is at least an about 1° C. difference between the temperatures of the first and second liquid portions or between the temperatures of HEM1 and HEM2, such as ≥˜2° C., ≥˜3 degrees Celsius, ≥˜4° C., or ≥˜5° C. differential between the first and second liquid portions or between HEM1 and HEM2.

In aspects, devices/systems can power small appliances, vehicles, buildings, towns, and the like, either alone or when connected to other devices or systems capable of energy production. According to certain aspects, the amount of energy the device or system is capable of producing is sufficient to operate an average automobile or average motorboat. In aspects, one or more devices or systems of OTI is capable of being connected to any one or more other devices and or systems OTI such that multiple devices or systems operate as a single energy production unit. In aspects, such a unit can be capable of generating enough power to meet the energy needs of larger devices, systems, or facilities or habitats, e.g., but not limited to, a small apartment, an average single-family home, a duplex, an apartment building, a small town, a medium sized city, or their energy-requiring equivalents, or, e.g., to meet even larger energy needs such as that of a city. In aspects, a device is mounted to a building or is part of a power generating operation for a town.

In aspects, devices and/or systems are capable of being connected to one or more other types of energy production systems, such as nuclear, coal, wind, solar, hydro, or the like, to expand energy production capabilities. In aspects, the devices and systems described herein are one component of a multi-component power generation system.

In aspects, the devices and systems described herein are advantageous in that they can operate quietly, efficiently, and in an environmentally friendly manner (e.g., they contribute minimal, generally no, substantially no, or no waste which is detrimental to the environment such as air or water quality). In aspects, the devices and systems described herein may find utility in applications wherein other power sources are not feasible due to infrastructure, cost, space or sound limitations, or the like.

In aspects, the devices and or systems within which the device operates can generate electricity and the device and or system can further comprise one or more batteries for storing energy. Such energy stored in the battery can, in some facets, be used to operate components of the device or system such as, for example, pump(s), or can for example be used to supplement the energy production when, for example, the device or system produces a below average amount of energy and/or the device or system fails to operate or ceases operation due to an insufficient temperature differential between TIS and T2S and/or T1L and T2L (and also or alternatively between HEM1 and HEM2 or between a PG when exposed to HEM1 and when the PG is exposed to HEM2).

In aspects, automated controls or human intervention can be utilized to restart a device/system when operation stops due to T1ΔT2 falling below a threshold or for other reasons.

### G. Design and Fabrication of Devices

The invention also provides a system for fabricating a low temperature differential energy device (such as, e.g., a low temperature differential energy device in certain embodiments described here) comprising (a) entering a required work output for the device to be fabricated to a device design & fabrication processor comprising means for receiving inputs from a user & preprogrammed instructions for analyzing the inputs; (b) entering a series of inputs into the device design and fabrication processor and directing the device design and fabrication processor to generate an estimated work output that the device is expected to produce based on the inputs; (c) entering constraints associated with the inputs; (d) directing the design and fabrication processor to adjust the variables associated with the inputs based on the constraints & ordering the modulation of variables based on either preprogrammed or inputted criteria to generate a device design anticipated to provide the required work output; & (e) causing the output of a design description, causing the fabricating, or both, of component(s) of the device based on the calculated variables.

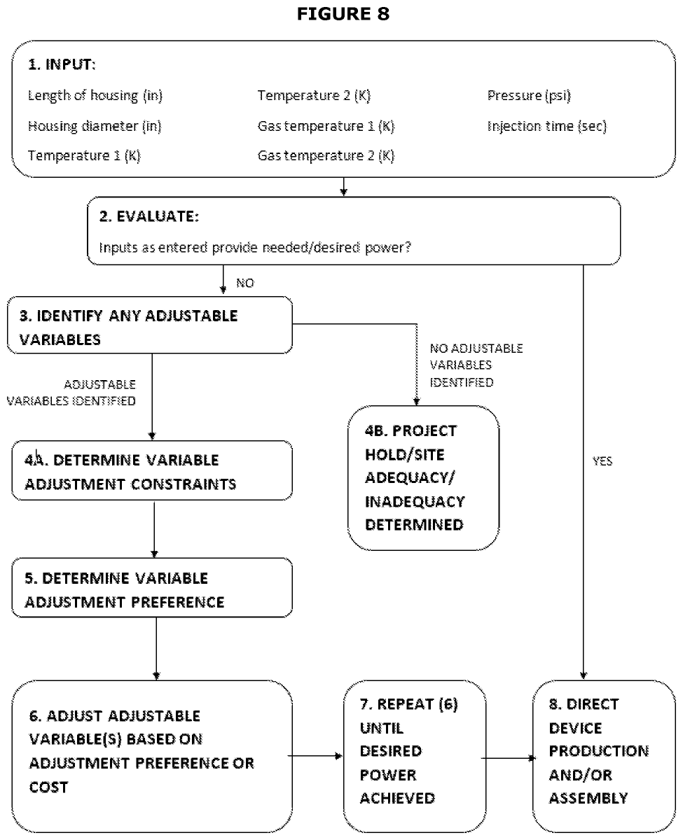

Another aspect of the invention is system(s)/method(s) for producing a device/system. In aspects, such methods/systems comprise the use of an electronic processor unit for designing and in aspects also directing the fabrication of component(s) of such a system. In aspects, as described and illustrated in FIG. 8, such a system comprises (1) the input of specific device parameters; (2) evaluating whether the inputs are sufficient as entered to provide the required power output; (3) identification of any adjustable variables; (4) either pausing device design to reconsider feasibility if no suitable adjustable variables are identified or alternatively determining variable adjustment constraints of variables identified; (5) determining variable adjustment preferences; (6) adjusting adjustable variable(s) based on adjustment preference or, e.g., cost; (7) repeating adjustment of adjustable variable(s) until desired power is achieved; and (8) directing device production and/or assembly.

In aspects, the invention described herein is a system for fabricating a low temperature differential energy device having one, some, or most of the characteristics, features, or operational capabilities described herein, comprising entering a required work output for the device to be fabricated to a device design and fabrication processor (DDFP), entering a series of inputs into the DDFP, including characteristics related to device operation and design as well as any existing constraints related to such device inputs, and directing the DDFP to generate an estimated work output that the device is expected to produce based on the inputs.

In aspects the DDFP comprises means for receiving inputs from a user and preprogrammed instructions for analyzing the inputs. In aspects, such means of communicating electronic data can be any one or more means as described EH, e.g., as described for means of a DCU to relay information to e.g., a processing unit (PU).

In aspects, inputs related to the device design entered into the DDFP comprise chamber length; anticipated first temperature; anticipated second temperature; anticipated first gas temperature generated by dispensing first temperature modified liquid (temperature modification liquid, or TML) into the chamber; anticipated second gas temperature generated by dispensing second temperature modified liquid (TML) into the chamber; anticipated chamber pressure; anticipated chamber diameter; and anticipated time between TML injections. In aspects, the system further comprises entering constraints associated with any one or more of the inputs and directing the design and fabrication processor to adjust the variables associated with the inputs based on the constraints. In aspects, such exemplary constraints may be but may not be limited to a limit on the maximum or minimum first or second temperatures (e.g., as dictated by the temperature input sources, maximum or minimum gas temperatures possible from a TML, maximum chamber pressure, space or manufacturing limitation which limit the maximum chamber diameter, and the like. Similar such inputs may be applicable for varying embodiments, such as, e.g., anticipated first and second PG temperatures after PG is exposed to each of a first and second heating material (HEM1 and HEM2) and anticipated time between the presence of PG having a first temperature and pressure and the presence of the PG having a second temperature and pressure within a PGC.

In aspects, a DDFP system further comprises modulation of variables based on either preprogrammed or inputted criteria to generate a device design anticipated to provide the required work output. In aspects, such modulation can be one or more cycles of variable adjustment. In aspects, upon entry of the inputs, or upon one or more cycles of modifying or adjusting variables (as needed to reach a suitable device design) associated with the inputs based on the constraints also thereto entered, a suitable device design is obtained.

In aspects, a DDFP system further comprises the ability to cause, order, or otherwise initiate the fabrication of one or more components of the device based on the calculated variables. Such fabrication can be local or can be caused, ordered, or otherwise initiated at a distance, such as via communication of such a design to a remote manufacturing facility. In aspects, such fabrication can be directed directly by components of the DDFP system (e.g., PU(s)). AOA, such fabrication can be directed by a secondary facility, with the system providing instructive data or parameter data, such as the parameters for, e.g., component dimension(s).

For example, a DDFP can comprise a processor utilizing any suitable combination of the following eight inputs to generate component(s) of a device for a device with a total amount of work output (in Watts) or to design a device that will provide the total amount of work output: (1) stroke length of piston; (2) temperature of a first portion of liquid (T1L); (3) temperature of a second portion of liquid (T2L); (4) temperature of the gas as modified by the first portion of liquid (TIG); (5) temperature of the gas as modified by the second portion of liquid (T2S) (wherein the differential between the temperature of the first portion of liquid and the temperature of the gas after having experienced heat exchange with the first portion of liquid is the same as the temperature differential between the temperature of the second portion of liquid and the temperature of the gas after having experienced heat exchange with the second portion of liquid); (6) pressure of the system (PG pressure and TML pressure being at least approximately equal in the RFOS); (7) diameter of the movable component (e.g., piston); and (8) the injection time of the liquid into the gas. Such inputs can be entered into a user interface of a DDFP system, and an automated calculation can be performed by data processing software.

In aspects, the CPU/PU(s) of such a DDFP system has preprogrammed instructions that allows the system to evaluate, reject, approve, or modify value(s) of such a calculation based on constraints provided by a user, cost of such modification(s), availability of component(s), regulatory requirement(s), or combinations of some or all thereof. In aspects, the PU(s)/CPU making such calculations is preprogrammed with scoring measurements (e.g., +/−point(s) for each possible change) or other calculations that provide the PU(s)/CPU with the ability to calculate and provide possible combination(s) of such variable(s), optionally with associated cost(s), component availability information, and the like, and optionally to further direct the manufacture of component(s) for such a device/system.

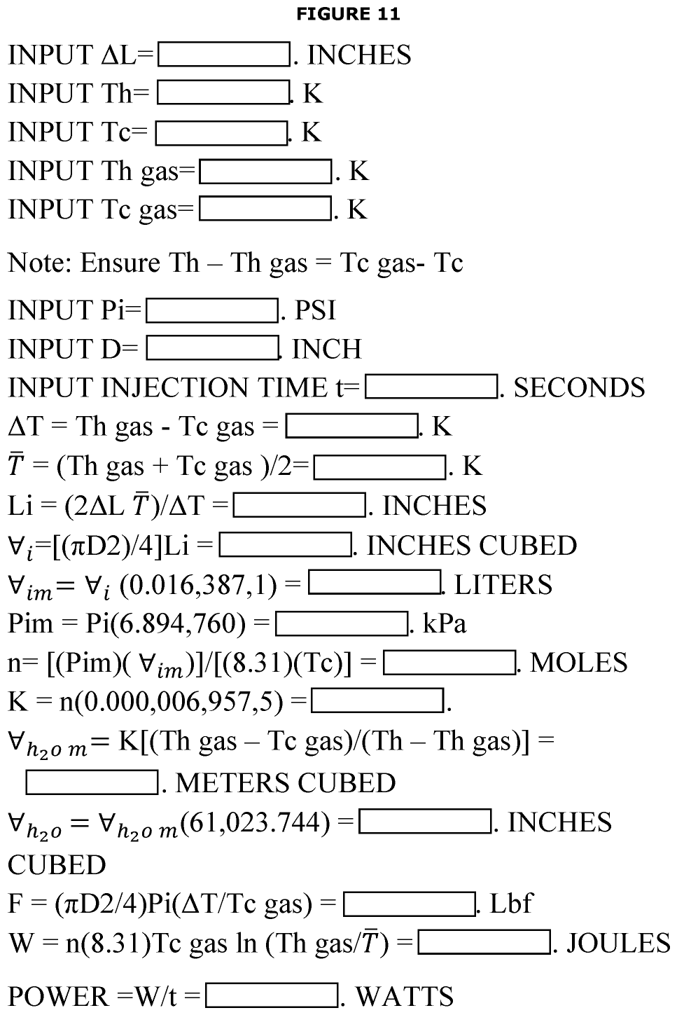

For example, in a system in which water is the liquid in the system and nitrogen is the PG, the inputs shown in FIG. 11 can be provided to DDFP to arrive at an expected work/power output, which can be evaluated to evaluate a proposed device against desired output. A system utilizing inputs other than water may require modification to, e.g., account for the specific heat of the liquid utilized. Persons of ordinary skill in the art will be able, in numerous/most cases without application of undue experimentation, to use such variables in different orders to make calculations relating to component(s) by re-working such calculations and such variables can be preprogrammed into a CPU/PU to provide users with different starting points and outputs for designing the component(s) of devices/systems of the invention.

### ILLUSTRATIVE EMBODIMENTS DEPICTED IN THE FIGURES

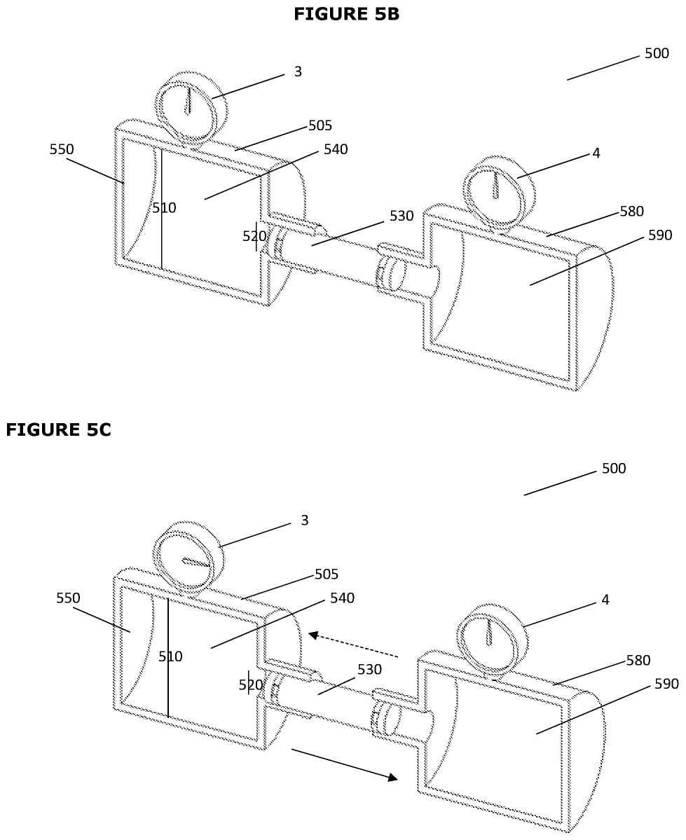

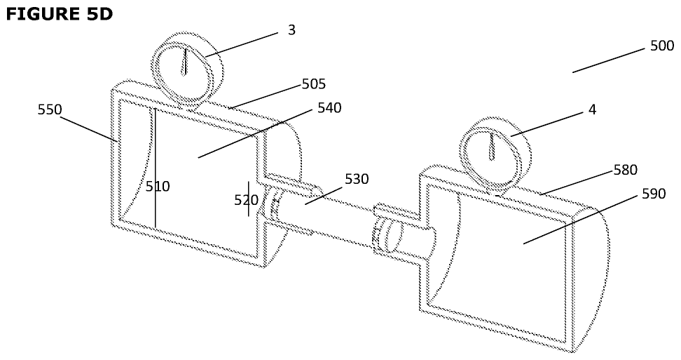

The Figures of this disclosure and following related description of aspects in connection therewith are provided for the purpose of further illustrating examples of devices and systems of the invention and the operation thereof. Such embodiments provided should not be construed as limiting (e.g., figures/components may not be drawn to scale; some elements are provided primarily for illustrating operation (e.g., FIGS. 5A-5D, status indicators 3 and 4), and several alternative embodiments are within the scope of the disclosure (see elsewhere herein).

FIGS. 5A-5D illustrate an exemplary overview of the operating principles (500) of a device OTI, which can, in aspects, apply to embodiments illustrated by additional figures. Hence FIGS. 5A-5D are described here first.

FIG. 5A specifically illustrates a first container housing component (505) of a low temperature differential powered device (“LTDPD”), as shown embodied as a cylindrical device (and herein in the description of figures sometimes referred to as “the cylinder” (505 referring to the housing component shown as a cylinder) having a first diameter (510)). Movable component (MC) (530), exemplified as a piston, is positioned within a reduced diameter, second portion of the cylinder (570) having a second, reduced diameter (520), such that MC (530) serves to establish one essentially sealed end of a chamber (540) within the cylinder (505). The chamber (540) within the cylindrical housing (505) can be sealed on both its first end (550) by a housing cap (not shown—see reference 29 of FIGS. 1-3) and the second end sealed by movable component (530). Housing cap (again, not shown) aid in substantially sealing the housing from unwanted pressure or gas loss. Housing cap can also provide an entry or connection point for other device components as illustrated in, e.g., FIGS. 1-3, e.g., DC(s) (not shown in FIG. 5A). Chamber (540) is filled with a pressurized gas (PG) (e.g., N₂).

In operation, piston/MC (530) moves when the pressure in the chamber (540) is sufficiently different from the pressure on the opposing side of the movable component, which occurs when a first or second portion of liquid (T1L or T2L) having a sufficient temperature difference (sufficient T1LΔT2L) from the temperature of the pressurized gas is dispensed (process and dispensers not shown). In embodiments, this occurs when T1L or T2L is dispensed into the PG chamber (540).

FIG. 5A illustrates that the MC (530), when forced to move upon the change in pressure of chamber (540) established when a TL1 or TL2 is dispensed into the PG therein, must move in relation to a counter pressure on the opposite side of the MC (530), illustrated in FIG. 5A as a spring (560). If a TML is dispensed into the PG of chamber 540 having a sufficiently warmer temperature than the PG, the PG will expand and cause the MC (530) to move to the right, pushing against the counter pressure of the spring (560). If a TML is dispensed into the PG of the chamber (540) having a temperature sufficiently cooler than the PG, the PG will compress and the counter pressure (e.g., the counter pressure from the spring (560)) will cause the MC (530) to move to the left.

In the illustrative embodiments shown in FIGS. 5A-5D, status indicators (3 and 4) are provided primarily for the purpose of demonstrating operation of the device and to aid in understanding (such components often may not be present in a device in such a form). The status indicators (3 and 4) are shown as pressure gauges. As discussed elsewhere, but not shown, other sensor(s) can be incorporated in a device/system (e.g., a temperature or pressure sensor measuring the state of the PG/TML). In aspects, no such indicator is present. Devices can have pressure sensors at, e.g., locations (3) and (4) such that the pressure on either side of the movable component are known by the device and/or system at any given time. Pressure sensors or other sensors can also alternatively be present in other locations of a device/system.

FIG. 5B continues the demonstration of operation principles of the illustrated device (500) and replaces the spring (560) of FIG. 5A with a second cylindrical housing (580) having a chamber (e.g., second chamber, 590) filled with PG similar to that of the first housing (505). This illustrates, as also described in the incorporated parent patent application that a second volume of PG can be used as a counter pressure within a device/system, such that the back and forth movement of an MC (530) can be accomplished by establishing a pressure differential between two volumes of pressurized gas maintained within housing chambers (540 and 590) on either side of a movable component (530), the back and forth movement of the MC (530) caused by alternatingly modifying the temperature of the PG on a single side of the MC (530) (e.g., within housing 505, the mechanisms for which are not shown).

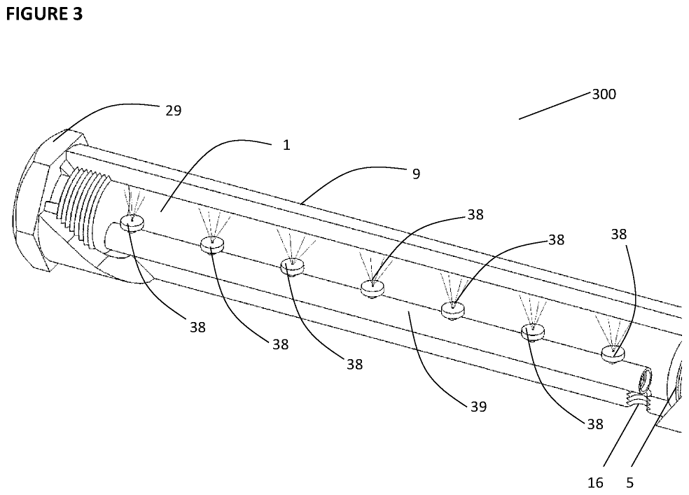

As indicated by the status indicators (3 and 4) shown in FIG. 5B, the pressure in chamber 1 (540) and chamber 2 (590) is substantially the same, reflecting either the RFOS or the MC/piston (530) completing a full stroke. A protruding member (PM) (not shown; see reference 6 of FIGS. 1 and 2) (described as a “safety component” or “dual purpose safety component” in some figure descriptions) can be positioned within a SLIPBO (sometimes called a “slot”) (not shown; see reference 15 of FIGS. 1 and 2) such that it prevents unintentional extended movement or travel by the MC. A PM (not shown; see reference 6 of FIGS. 1 and 2) can connect to one or more other components of a device/system, such as a vacuum powered counter pressure system movable component unifying connector (VPCPS-MC-UC) (see FIG. 6A, reference 685).

FIG. 5C further continues the demonstration of operating principles of a depicted device (500) and illustrates a state following the dispensation of a liquid (TML) having a first temperature (TL1) into the first chamber 1 (540) from a first dispenser (not shown) (e.g., a “hot” liquid). The hot liquid, upon dispensation as a mist, exchanges its heat with the PG of the first chamber (540) and hence the temperature of the PG in chamber 1 (540) increases. As a result, the pressure increases in chamber 1 (540) as indicated by the status indicator (pressure gauge) (3). Piston (530) then moves in a first direction (indicated by a solid arrow), toward chamber 2 (590) having a lower pressure (as indicated by the status indicator (4), chamber 2 (590) also comprising PG and providing a counter pressure, also referred to as a back pressure (indicated by a dashed arrow). Repositioning of the MC (530) is not shown.

Continuing the description of operating principles of the depicted device (500) in FIG. 5D, MC (530) moves in the first direction (repositioning not shown) until the pressure in chamber 1 (540) and chamber 2 (590) again reach a state of substantial equality as indicated by status indicators (pressure gauges) (3) and (4) being substantially the same.

Thus, FIGS. 5A-5D exemplify stages of basic operation of an exemplary device (e.g., 100, 200, and 600), with FIG. 5B illustrating a device in ready for operation state (RFOS); FIG. 5C illustrating the dispensation of a temperature modification liquid (TML); and FIG. 5D illustrating the end of an exemplary 1^{st} stroke length wherein the pressures of chambers 1 (540) and 2 (590) re-equilibrate after movement of the MC (530), MC (530) having moved to a new position where the pressures of chambers 1 (540) and (590) are again substantially equal. Further, dispensation of a 2^{nd} liquid dispensation (e.g., a “cold” liquid, e.g., a liquid or portion of TML having a lower temperature than the temperature of PG within chamber 1 (540) and even further less than that of the first portion of liquid (the hot liquid)) will reduce the temperature of the PG held within chamber 1 as the PG exchanges its heat with the liquid. Accordingly, the pressure of the PG in chamber 1 is reduced and, as a result, MC/piston moves in a second direction, opposite that of the first direction, back toward its original starting position shown in FIG. 5B (this reversal not shown). In doing so, piston moves toward chamber 1, chamber 1 still comprising PG and providing the counter pressure, or back pressure to such movement. MC/piston moves until the pressure in chamber 1 and chamber 2 again reach a state of substantial equality, as shown in FIG. 5B. Any liquid (TML) dispensed as a mist which has accumulated in the chamber is collected by LCC (16; not shown) and is returned to the LCS (not shown) as DEH. When suitable condition(s) again exist, the cycle repeats.

The above fundamental operating premises can be applied to the further descriptions of devices/systems provided below. As exemplified by FIGS. 5A-5D, the device/system comprises a counter pressure system; exemplified for illustrative purposes in FIG. 5A as a spring and then in FIGS. 5B-5D as a second volume of pressurized gas. Such an embodiment is further described in additional detail in the description of FIGS. 1 and 2 below. The invention described herein provides an advancement of such a counter pressure system, the counter pressure system presently described being a vacuum powered counter pressure system (VPCPS) which is described in detail in the description of FIG. 6A.

FIG. 1 illustrates an exemplary device (100), comprising a more detailed description of an embodiment of the illustrative cylinder shown in FIGS. 5A-5D as component 505. The cylinder of FIG. 1 is shown with components not shown in FIGS. 5A-5D, such as, e.g., end cap (29), dispensers (13, 23), LCC a, PM (6), SLIPBO (60), and barrier wall (15). Exemplary sensors (3 and 4) are shown. Movable component (5) is shown. Two chambers (1 and 2) are shown on opposing sides of the MC (5), each comprising a PG. It should be appreciated in considering FIG. 1 that the cylinder and its components can be replaced by further embodiments of such cylinders comprising a vacuum powered counter pressure system (VPCPS) as will be described further herein. FIG. 1 further describes additional components of a device/system. Specifically, additional components shown include pump (7), motor (8), liquid collection line (30), valve (41) and temperature input exposure lines (10) and (20) (forming a liquid conducting system (LCS)). Further, temperature inputs (42) and (43) (T1S & T2S, respectively) are shown for illustrative purposes only and are not drawn to expected scale. FIG. 1 illustrates an early embodiment of the device(s)/system(s) (100) as disclosed in the incorporated parent patent application (US'192), wherein two volumes of PG are present within the cylindrical housing (within chamber 1 (1) and chamber 2 (2), and the second volume, or aliquot, of PG gas within chamber 2 (2) serves to provide the counter pressure for system operation. In considering FIG. 1, it should be appreciated that the additional components shown and described, such as components 7, 8, 10, 20, 30, 41-43, can be present in addition to various embodiments of systems comprising a VPCPS. In the illustrative embodiment of FIG. 1, status indicators (3 and 4) are shown as pressure gauges. As discussed elsewhere, sensor(s), other than pressure gauges can be incorporated into a device/system (e.g., a temperature or pressure sensor measuring the state of the PG/TML). In aspects, no such indicator is present. Devices can have pressure sensors at, e.g., locations (3) and (4) such that the pressure on either side of the movable component are known by the device and/or system at any given time. Device(s)/system(s) can have pressure sensors or other types of sensors located at different locations within a device/system.

As indicated by the status indicators (3) and (4) of FIG. 1, the operational status of the device/system exemplified by FIG. 1 is that of equal pressure on opposing sides of the movable component (5); that is, the pressure of the pressurized gas in each of chamber 1 (1) and chamber 2 (2) is substantially the same, reflecting that the movable component (5) embodied as a piston has completed a full stroke or the device is in a RFOS. As shown, MC (5) has completed a full stroke length to the left. The protruding member (PM) (6) (described as a “safety component” or “dual purpose safety component” in some figure descriptions) is positioned within the SLIPBO (sometimes ORTA a “slot”) (60) in wall (15) of the cylindrical housing such that it prevents unintentional extended movement or travel by the MC (5). The cylindrical housing, comprising two chambers of PG (chamber 1 (1) and chamber 2 (2)) each located on opposite sides of MC (5), can be sealed at its ends by a housing cap (29) (a housing cap may also or alternatively be referred to herein as a cylinder cap, in embodiments wherein the housing is embodied as a cylinder). A housing cap (29) can aid in substantially sealing the housing from unwanted pressure or gas loss. Housing cap (29) can also provide an entry or connection point for other device components as shown, such as entry points for liquid collection lines, e.g., temperature exposure lines (10 and 20) which can connect to dispensation components (e.g., DCs 13 and 23).

Chamber 1 (1) and chamber 2 (2) are filled with a pressurized gas (PG) (e.g., N₂). TML (e.g., TL1 and TL2) is dispensed into a single chamber (chamber 1 (1)) via dispensation components (DCs) (13 and 23) in an alternating fashion, one TML per dispenser. In operation, piston/MC (5) moves when the pressure in the chamber 1 (1) is sufficiently different from the pressure within chamber 2 (2), which occurs when a first or second portion of liquid (T1L or T2L), having a sufficient temperature difference between them (sufficient T1LΔT2L) and a sufficient difference in temperature of the pressurized gas, is dispensed into the pressurized gas of chamber 1 (1). When such a pressure differential is created on either side of MC (5), MC (5) moves in the direction of lower pressure. The distance of such movement (e.g., the stroke length, SL) is restricted by a counter or back pressure, in this embodiment provided by the second volume of PG in chamber 2 (2). Unintentional, extended movement of the MC (5) can in aspects be limited by the PM (6), sliding within the SLIPBO (60) within the wall (15) of the container, e.g., when serving as a safety mechanism and preventing unintentional extended movement or travel of MC (5).

In the state of the device as shown, a first portion of TML (e.g., TL1, has been dispensed from a first dispenser (e.g., dispenser 13) having a cooler temperature than that of the PG of chamber 1 (1). Hence the pressure of PG in chamber 1 (1) became lower than that of the PG in chamber (2), and the MC (5) moved to the left (as can be identified by the PM (6) being to the left within the SLIPBO (60)), movement forced by the pressure exerted by the higher-pressure PG of chamber 2 (2) to a point at which the pressure within each chamber became at least substantially the same (as indicated by status indicators (3 and 4).

In this present state, and/or when suitable conditions are met, a 2^{nd} portion of liquid (second portion of TML, e.g., TL2) having a 2^{nd} temperature, higher than the 1^{st} portion of liquid (e.g., higher than the “cold” liquid, or cold TML, previously dispensed, and higher than the current temperature of the PG) is dispensed in the form of a mist from a second dispenser (23) into chamber 1 (1). TL2, being warmer than the PG in chamber 1 (1) will cause the PG in chamber 1 (1) to expand and hence cause the MC (5) to move to the right, pushing against the counter pressure of the PG in chamber (2). Movement of the MC (5) will be to a point at which chamber 1 (1) and chamber 2 (2) reach an at least substantially equal pressure.

In aspects, a suitable condition that triggers dispensation of the second liquid (a “triggering condition”) can be MC/piston (5) reaching a point where the pressure of the PG in chamber 1 (1) is substantially equal to that of the PG of chamber 2 (2). In aspects, a triggering condition is the PG in chamber 1 (1) reaching a predetermined pressure, the PG in chamber 1 (1) reaching a predetermined temperature, or both. In aspects, a triggering condition is the PG in chamber 2 (2) reaching a predetermined pressure or the PG in chamber 2 (2) reaching a predetermined temperature. In aspects, the triggering condition is the passage of a predetermined time period. In aspects, the triggering condition is MC/piston (5) substantially completing or completing a stroke (traveling the SL).

When suitable condition(s) again exist, the cycle repeats. For example, the next dispensation of liquid can occur upon occurrence of a 2^{nd} triggering condition, which can be any triggering condition(s) discussed above in connection with a 1st triggering condition.

TML TL1 and TL2 dispensed in alternating fashion as a mist from each of the first dispenser (13) and second dispenser (23) ultimately collects within chamber 1 (1). Upon collection, the accumulated liquid drains from chamber 1 (1) through liquid capture component (LCC) (16). LCC (16) is positioned within chamber 1 (1), typically mostly or entirely outside of the distance traveled in a stroke length by the MC/piston (5) such that the MC/piston (5) does not interfere with LCC (16). The LCC (16) provides entry of expended TML into a liquid conducting system (LCS), the components of which are now described.

The device/system can operate at a pressure which is substantially the same throughout; hence TML/liquid drained from chamber 1 (1) through LCC (16) is able to flow naturally to the part of the LCS containing the lowest volume of liquid (e.g., in embodiments wherein two flow lines are immediately available to an LCC (16) (not shown). As shown in FIG. 1, TML drained from chamber 1 (1) through LCC (16) flows into liquid collection line (30). Motor (8) selectively/automatically drives operation of pump (7). Pump (7) receives liquid drained from the cylinder and flowing through liquid collection line (30) and pumps it through temperature exposure lines (10) and (20). One portion of the liquid received from liquid collection line (30) is directed through valve (41) to temperature exposure line (10) and one portion is directed through valve (41) to temperature exposure line (20). Valve (41) can serve to split the two portions of TML into what will become, after exposure to temperature inputs, TL1 and TL2. Temperature exposure lines (10) and (20) each expose respective portions of liquid held therein to first and second temperature inputs or temperature sources (TIS and T2S), respectively (42, 43). In an exemplary aspect, T1S & T2S are environmental inputs. During most of the day, T1S & T2S have an average temperature differential (T1ΔT2) that meets the established operational criteria of the designed system. For example, first temperature exposure line (10) can pass through a lake and second temperature exposure line (20) can pass through hot desert air. As described elsewhere herein, at two points during the day, the temperature of the two environmental temperature inputs can reverse relative to one another, such that a first input, which was originally warmer than the second, becomes cooler than the second and the second, which was originally cooler than the first, becomes warmer than the first. A switch, e.g., a source switch, (not shown), within the system can be present to control for the reversal and hence allow for continuous operation during such periods. Such a switch can be present as part of a device or as a part of a larger system.

First and second temperature exposure lines (10) and (20) can be received by and/or can pass through housing/cylinder cap (29). Exposure lines (10) and (20) can connect to housing/cylinder cap (29) by a threaded connection (not shown). First and second temperature exposure lines (10) and (20) can be connected directly or indirectly to dispensers (13 and 23).

Motor (8) can be actuated by an operation control unit or components thereof, within the description of figures referred to as a logic controller (40). Such a logic controller (40) can in part receive data from one or more sensors or other means of detection of, e.g., a pressure sensor or a temperature sensor or a flow sensor, or the like (not shown). Such a logic controller can also direct function(s) of the system based on the input from sensor(s). FIG. 1 illustrates a logic controller in abstract form (not shown as specifically connected to the device/system). In aspects the logic controller can be a component of a device or a component of a system. In aspects, the logic controller can be positioned remotely from the device or system and receive data from one or more components of a device or system from a distance.

FIG. 2 illustrates an alternative simple/prototype embodiment of a device/system (200), similar to the embodiment of FIG. 1 and, like the embodiment of FIG. 1, illustrates use of a second aliquot of PG to provide the device counter pressure according to earlier disclosure, supra. The cylindrical housing and elements thereof and shown as directly associated therewith are the same as those shown in FIG. 1. In this embodiment, liquid collection line (30) directs liquid collected from the LCC (16) to two pumps (11) and (21), operated by motors (12) and (22), respectively. Liquid received by pump (11) from liquid collection line (30) pumps the liquid through a first temperature input exposure line (10). Liquid received by pump (21) received from liquid collection line (30) pumps the liquid through a second temperature input exposure line (20). Liquid passing through temperature input exposure lines (10) and (20) are each exposed to different temperature inputs (T1S (42) and T2S (43)) and return liquid portions having different average temperatures (T1L and T2L) back to the device for reuse as dispensed mist, to be dispensed in alternating fashion from dispensers 13 and 23. Because the device/system is pressure balanced with respect to the pressure of the liquid and the PG, TML collected by LCC (16) and flowing into liquid collection line (30) can flow to either pump 11 or pump 21 according to the volume of TML within different parts of the system; that is, TML will be allowed to flow to the part of the system comprising the lowest volume (e.g., less volume in pump 11 and temperature exposure line 10 can lead to TML from liquid collection line 30 flowing into pump 11; less volume in pump 21 and temperature exposure line 20 can lead to TML from liquid collection line 30 flowing into pump 21. Like FIG. 1, elements showing in FIG. 2 can be present in alternative embodiments, such as, for example, components 1, 2, 3, 4, 5, 6, 16, 13, 23, and 29 can be replaced with a component comprising a vacuum powered counter pressure system, such as the system illustrated in FIG. 6A.

FIG. 3 is a side cutaway view of a first container of a device/system (300), the first container being a component of a primary pressure modulating system (PMS) of a device/system, comprising a cylindrical housing (9) and a dispensing component comprising a dispenser tube (39) and a line of dispenser outlets (38) located in a chamber (1). In this early embodiment disclosed in Applicant's prior application(s), supra, multiple dispenser outlets, e.g., nozzles (38), are present as part of a dispensing component (DC) embodied as a manifold or a “dispenser tree.” Single dispenser tube (39) receives liquid through an access port (not shown) in cylinder cap (29). Dispenser tube (39) comprises multiple dispenser nozzles (38), (seven (7) shown for exemplary purposes)) from which liquid received in the dispenser tube (39) is dispensed as a mist into the PG of chamber 1 (1). Use of an collection/array of misters, e.g., as illustrated by the “dispenser tree” allows for enhanced dispersion of TML dispensed as a mist throughout the PG of the chamber over that dispensed by, e.g., a single dispenser, such as that exemplified in the embodiments of FIG. 1 and FIG. 2, causing a rapid temperature change and hence a quicker transition of the MC (5) to the opposite direction of travel, increasing the amount of work a device can do in a given period of time; that is, a single dispensation point in a single location within the chamber which may take longer to sufficiently modify the temperature of the PG in the chamber so as to cause MC (5) movement). FIG. 3 illustrates a dispenser tree positioned within the chamber beyond the LCC (16) and SL of movable component (MC) (5). The dispensing component (comprising dispenser tube (39) and dispensing outlets (38)) is positioned along one wall of the cylindrical container. In this embodiment, the dispenser outlets (38) do not extend in a significant manner outward from the dispenser tube (39) and into chamber 1 (1). The dispensation component (DC), not shown to scale, resides within a space DoS below the central axis of the chamber, e.g., in aspects within a space outside of the central 50% of the volume of chamber 1 (1) relative to or oriented around its elongated central axis. This is in contrast to the embodiment of outlets illustrated in FIGS. 4A-4D, wherein outlets are positioned along the central axis, described therein.

FIGS. 4A-4D illustrate an alternative embodiment (400) of a DC within a container, embodied as a cylindrical housing (405). These figures represent improvements above those presented in Applicant's earlier Application(s), supra, and can provide enhanced system efficiency. FIGS. 4A-4D are cutaway views of a first container of a device/system (400), the first container (405) being a component of a primary PMS of a device/system. FIG. 4A provides an embodiment wherein the first container comprises a cylindrical housing (405) comprising a chamber (402) housing a pressurized gas (PG) and two dispensing components, each comprising a dispenser tube (415 and 420) running in parallel with one another, and each dispenser tube (415 and 420) comprising a plurality of dispenser outlets (430A-E and 435A-E). Each dispensation outlet (430A-E and 435A-E) dispenses TML therefrom in two directions, D1 and D2. Housing (405) further comprises a liquid capture component (LCC) (450) leading to a liquid collection line (not shown). Dispensing components enter the chamber (402) via entry port(s) (425) in end cap (440), the entry port shown as a single element, but which can comprise two separate entry points for each of dispenser tubes 415 and 420. Dispensing components extend along a portion of the chamber (402) but not the totality of its length, leaving a space into which a movable component (not shown) can extend during operation. The movable component (not shown) is positioned within and in aspects extends from, an area of reduced diameter of the cylindrical cylinder (480). In aspects, the space into which the movable component does not extend is an internal void space (TVS) (not labeled).

In aspects, during operation, one dispenser tube of 415 and 420 (e.g., 415) comprises TL1 and the other dispenser tube of 415 and 420 (e.g., 420) comprises TL2. In aspects, during operation, TL1 and TL2 are dispensed from each of the dispensing components (DCs) in alternating fashion, exiting each dispenser tube (415 and 420) via each set of dispensing outlets (430A-E and 435A-E) respectively.

FIGS. 4B-4D illustrate the operation of the dispensation component embodiment (400); the dispensation of TL1 or TL2 (the depicted characteristics of the dispensation of TML being applicable to dispensation of either or both TL1 and TL2 from either DC depicted), along with the characteristics of such dispensation. As shown in FIG. 4B, in a first aspect, a TML, e.g., TL1, is dispensed in a first direction (D1) from one side of a multi-directional dispensation outlet (435D). Not shown in FIG. 4B for the purpose of simplicity, is the dispensation of such TL1 from all dispensation outlets of the first dispensation component (435A-E) in both directions D1 and D2). T1 is dispensed in the form of a mist as DEH. The mist dispensed from outlet 435D in a first direction D1 expands into a first volume (460) of chamber (402), contacting the PG contained therein, and capable of modifying the temperature of the PG with which it makes contact.

FIG. 4C is the same as FIG. 4B, however most labeling has been removed for sake of simplicity. The TML dispensed as a mist, that is, the mist produced by each dispensation outlet for each direction in which it dispenses mist, comprises four zones, or regions. FIG. 4C illustrates these regions. In region 1 (1), mist is formed from the fluid in a “mist deployment zone”. Region 2 (labeled 2) is a mist “heat transfer zone.” Region 3 (labeled 3) is the maximum extent, or distance, that mist dispensed from that particular dispensation outlet travels down the chamber. Near “mist deployment zone” (region 1 (labeled 1)) is region 4 (labeled 4) where there is no mist present.

In operation, mist is dispensed from the dispensation outlet. In region 4 (4), closest to the dispensation outlet, there is no mist present. In this region, there is minimal exchange of heat between the PG and the TML. Dispensed TML then travels and expands into the next region, region 1 (1), the “mist deployment zone”. In this region, a mist forms and spreads out over the available cross-sectional area of the container. In this region, heat exchange begins between the PG and the TML mist. Mist then travels and further expands into region 2 (2), the mist “heat transfer zone”. Here, mist has maximally expanded into the diameter of the chamber such that maximum heat exchange between the TML and the PG of the chamber is possible. The end of this region is noted as region 3(3), the maximum distance that the mist extends within the chamber from the dispensation outlet in the direction of dispensation.

Of note in FIG. 4C is the fact that the deployment of the mist from a dispenser is such that the mist expands a sufficient distance to encompass at least one (or more) additional dispensation outlets.

FIG. 4D illustrates a concurrent dispensation from that of a second dispensation outlet (435B) of the same dispensation component, located at a distance along the dispensing tube (420) from the first dispensation outlet. FIG. 4D depicts dispensation of T1 from this second dispensation outlet at the same time as the dispensation of T1 from the first dispensation outlet, in a second direction, D2. Not shown, for the sake of simplicity, is the fact that T1L would be in normal operation dispensed in both directions of at least one, some, or all of the dispensation outlets of the dispensation component simultaneously. Dispensation of TL1 from the second dispensation outlet in the direction D2 is again in the form of a mist as DEH. This mist dispensed from the second outlet in a second direction D2 expands into a second volume (470) of chamber (402) and contacting the PG contained therein, and capable of modifying the temperature of the PG with which it makes contact. The dispensation pattern of mist dispensed from the second outlet in the second direction D2 is characterized by also having 4 zones or regions, as previously described.

Of note is the demonstration that the volume 470 overlaps with the volume 460; and, further, the volume 470 encompasses region 4 (4 of FIG. 4C) such that areas wherein no mist is presented by one dispensation outlet is encompassed by the mist dispensed from a second (or more) other dispensation outlets. In this way, overlapping mist sprays cover the entire gas region in the pressurized chamber. Demonstrated by FIG. 4D is an embodiment whereby such multi- (e.g., bi-)-directional dispensation of TML from multi- (e.g., bi-)-directional dispensation outlets of a dispensation component provides advantages over that of uni-directional dispensation from dispensation components comprising uni-directional dispensation outlets, in that it ensures that an increased volume of PG within the chamber is contacted by a TML quickly/in a shorter period of time than would otherwise be possible. In aspects, multi-directional dispensation outlets allow for enhanced dispersion of TML dispensed as a mist throughout the PG of the chamber, causing contact with a higher volume of PG in a shorter amount of time, leading to an even more rapid temperature change within the chamber, and hence leading to the movement of the movable component in a shorter period of time.

Further illustrated in FIGS. 4A-4D is the elevation, or extension, of dispensation outlets (430A-E and 435A-E) above dispenser tubes (415 and 420). Dispensation outlets (430A-E and 435A-E) of FIGS. 4A-4D (unlabeled in 4C) extend further from dispenser tubes 415 and 420 than the dispensation outlets (38) from dispenser tube (39) of FIG. 3. Dispenser outlets (430A-E and 435A-E) of FIGS. 4A-4D are aligned co-axially with the cylindrical housing (405) and are oriented to dispense TML in a direction at least initially parallel to dispenser tubes (415 and 420), e.g., in a horizontal direction. This is in contrast to the embodiment of FIG. 3 wherein the dispenser outlets (38) are oriented to dispense TML at least initially in a direction perpendicular to dispenser tube (39); e.g., in a single, upward direction. In this manner, TML dispensed as a mist can expand in all directions quickly, further increasing exposure to PG in a short period of time, and hence leading to, in aspects, even faster temperature change of PG and movement of the MC more quickly than in embodiments wherein a) the dispensing outlets dispense TML in a single direction, or b), the dispensing outlets dispense TML in two or more directions at once but not from a coaxially positioned location (e.g., not from a location within ˜40%, ˜35%, ˜30%, ˜25%, ˜20%, ˜15%, ˜10%, ˜5%, or within ˜1% of the central axis of the cylindrical housing.)

Turning now to FIGS. 6A and 6B, components of this illustrated embodiment are shown as a replacement of, e.g., an alternative to, the dual-PG-chamber embodiment shown in FIGS. 1 and 2. For sake of clarity and for the purpose of illustration, the single-pump configuration of the FIG. 1 embodiment is provided as FIG. 6B. The grayed area of 6B is shown as being replaced by the components shown in FIG. 6A. In the embodiments of the device of FIGS. 1 and 2, a second volume of PG provides the counter pressure driving the alternating movement of the MC (see grayed area of FIG. 6B), as opposed to a vacuum powered counter pressure system as provided by the embodiment in FIG. 6A. Again, FIG. 6B shows the device/system of FIG. 1, with the dual-chamber cylindrical housing shaded and replaced by the components of FIG. 6A (dashed- and dotted-line showing this replacement), and the short dotted-lines in 6A and 6B referring to, for the sake of orientation, matching positions within the two figures (e.g., wherein lines of an LCS attach to the components of 6A). It should be understood that the components of 6A could also be applied to or associated with a device comprising two pumps such as that shown in FIG. 2, even though only the single pump embodiment is provided for illustrative purposes (6B).

Referring to FIG. 6A, components of a device (600) comprising a vacuum powered counter pressure system (VPCPS) are shown. The far-left ends (as presented) of temperature input exposure lines (610 and 620) can be connected to other aspects of embodiments described herein, such as, e.g., LCS components exemplified in FIG. 1/components of 6B (unlabeled and not grayed). The far-right ends (as presented) of temperature input exposure lines (610 and 620) in FIG. 6A connect to a first container (601) comprising a chamber comprising PG (PG chamber) (605) at connection point (612). First container (601) is embodied as a cylinder having portions with varying diameters as will be described. Connection point (612) can, in aspects, be a passage through a housing cap or other container/chamber sealing device (not shown). Connection point (612) can, in embodiments, comprise one or more dispensation components, dispensation outlets, or both, and/or connections thereto. Of note is the fact that for the purpose of simplifying FIG. 6A, dispensation components are not shown. However, it should be understood that one or more dispensation components are present within the PG chamber (605), e.g., such as those exemplified in FIGS. 4A-4D, and receive TML from temperature input exposure lines 610 and 620, disposing portions of TML received from 610 and 620 having different temperatures, in alternating fashion into the PG chamber (605).

First container (601) comprises PG chamber (605) and comprises an area having a first diameter (613) and a second diameter (614). The first diameter (613) is larger than the second diameter (614). The portion of the cylinder (601) having a reduced diameter (620) can comprise a PGC-MC (630). PGC-MC (630) can comprise one or more elements, e.g., a plunger/piston element and optionally a rod element attached to the plunger/piston element having a diameter different from that of the plunger/piston element. As shown, PGC-MC (630) is a single element having a single diameter. PGC-MC (630) is effectively the same diameter as the internal diameter of the portion of the cylinder having a reduced diameter (620); that is, has effectively the same diameter (614) as the reduced diameter portion (620) of cylinder (601), with enough of a difference to allow for the PGC-MC (630) to move within the portion of the container having a reduced diameter (620), yet to maintain the pressure of PG within the PG chamber (605). Movement of the PGC-MC (630) occurs when the pressure of the PG within the PG chamber (605) changes such that a pressure differential exists on either side of PGC-MC (630), the opposing sides of PGC-MC (630) being on a first side the PG chamber (605) and on a second side the areas of vacuum pressure (645 and 670) of second and third VPCPS containers (635 and 660, respectively).

Second container (635) and third container (660) represent components of the VPCPS. Second container (635) comprises a VPCPS-MC (640) which can divide second container (635) into two portions and can further aid in establishing a vacuum therein. VPCPS-MC (640) can separate second container (635) into a first portion comprising a vacuum (645) and a second portion at atmospheric pressure (650). VPCPS-MC (640) comprises a connecting element (a VPCPS-MC-C) (655), which connects the plunger/piston-like component of the VPCPS-MC (640) to one or more other components of the system, such as, e.g., the VPCPS-MC unifying connector (VPCPS-MC-UC) (685) described below.

Third container (660) comprises a VPCPS-MC (665) which can divide third container (660) into two portions and can further aid in establishing a vacuum therein. VPCPS-MC (665) can separate third container (660) into a first portion comprising a vacuum (670) and a second portion at atmospheric pressure (675). VPCPS-MC (665) comprises a connecting element (a VPCPS-MC-C) (680), which connects the plunger/piston-like component of the VPCPS-MC (665) to one or more other components of the system, such as, e.g., the VPCPS-MC-UC (685).

PGC-MC (630) and VPCPS-MC-Cs (655 and 680) can be connected to the vacuum powered counter pressure system (VPCPS) movable connector (MC) unifying connector (UC) (VPCPS-MC-UC) (685).

For exemplary purposes, the reader can imagine a state of operation of device (600) wherein PGC-MC (630) has completed a stroke length such that it has reached the end of its stroke length to the right (when viewing FIG. 6A). In this state, the pressure of PG in the PG chamber (605) and the vacuum pressure in VPCPS vacuum chambers (645 and 670) is effectively equal. In operation, the pressure in the PG chamber (605) is reduced through the dispensation of a TML into the PG of the PG chamber (605) which has a temperature below the temperature of the PG. Dispensation occurs through a dispensation component (not shown but which can have the characteristics of DC of FIGS. 4A-4D) having received TML (a “cold” TML) from one of temperature input exposure lines (610 or 620, e.g., 610) of an LCS. Upon dispensation, the cold TML exchanges heat with the PG in the PG chamber (605). This heat exchange causes the PG to contract. In contracting, the pressure within the PG chamber (605) becomes less than the vacuum pressure in vacuum chambers (645 and 670). Thus, the PGC-MC (630) moves toward and/or into or further into the PG chamber (605). Movement of the PGC-MC (630), because of its connection to the VPCPS-MC-UC (685) and the connection of the VPCPS-MC-UC (685) to VPCPS-MC-Cs (655 and 680) causes movement of VPCPS-MCs (640 and 665). Vacuum chambers of the VPCPS (645 and 670) are reduced in volume as VPCPS-MCs (640 and 665) move to the left as viewed, being pulled by the vacuum within chambers 645 and 670 respectively, in response to the reduced pressure in the PG chamber (605). Movement of PGC-MC (630), and, accordingly, movement of VPCPS-MCs (640 and 665) continues until the pressure in the PG chamber (605) and that of vacuum chambers (645 and 670) are effectively equal once again.

In continued operation, the pressure in the PG chamber (605) is increased through the dispensation of a TML into the PG of the PG chamber (605) which has a temperate above the temperature of the PG. Dispensation occurs through a dispensation component (not shown) having received TML (a “hot” TML) from the second temperature input exposure line (e.g., 620). Upon dispensation, the hot TML exchanges heat with the PG in the PG chamber (605). This heat exchange causes the PG to expand. In expanding, the pressure within the PG chamber (605) becomes higher than the pressure being exerted by the vacuum in vacuum chambers (645 and 670). Thus, the PGC-MC (630) moves away from and/or further out of or out of the PG chamber (605). Vacuum chambers of the VPCPS (645 and 670) increase in volume as VPCPS-MCs (640 and 665) move to the right as viewed, pulling away from/against the vacuum (e.g., constant pressure of the vacuum) within chambers 645 and 670 respectively, in response to the increased pressure in the PG chamber (605). Movement of PGC-MC (630) continues until the pressure in the PG chamber (605) and that of vacuum chambers (645) and (670) are effectively equal once again.

This cycle continues upon the alternating dispensation of cold and hot TML into the PG of the PG chamber (605) as has been described EH.

In aspects (not shown), any one of MC (630), a PM attached to MC (630), VPCPS-MC (640), VPCPS-MC (665), PM(s) attached to VPCPS-MCs (640 and 665), connecting element (655), connecting element (680), or VPCPS-MC-UC (685) can be a component within or connected to an energy of-take mechanism such that movement of any one or more such components is captured as work which can be converted into usable energy.

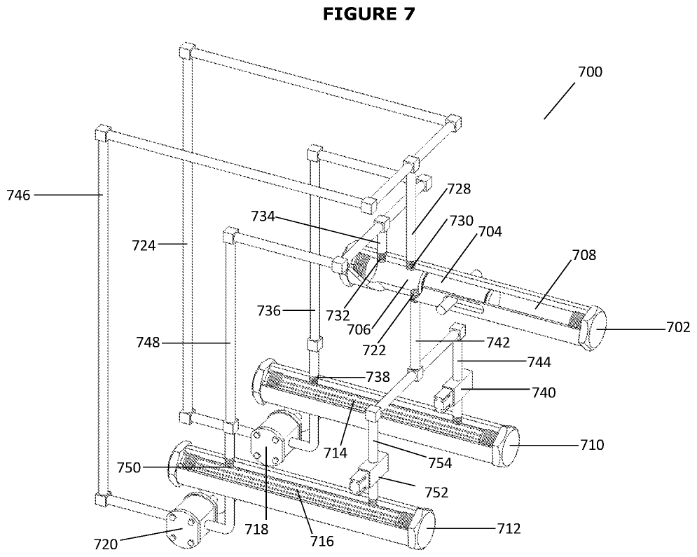

In aspects (not shown), a VPCPS can comprise chamber (660), comprising (670) and (665), with (665) connected to (680); and chamber (635), comprising (645) and (640), with (640) attached to (655), with each of (680) and (655) attached to (685), wherein (685) is physically connected to (630) which in embodiments can be one side of an MC, such as any MC described herein within a system capable of operating using the vacuum powered counter pressure system described here, such as, e.g., the MC as shown in FIG. 6B or the MC shown in, e.g., FIG. 7.

FIG. 7 illustrates an alternative embodiment of the device provided by the invention. The embodiment provided in FIG. 7 is a device utilizing one or more heat exchange materials to aid in the rapid heating and cooling of the pressurized gas, so as to facilitate rapid back-and-forth stroke length movement of the movable component(s) (MC(s)) of devices described herein. It should be understood that FIG. 7 is simply an illustration of the operating principles of the device(s) provided by the invention and is not drawn to scale nor does it necessarily reflect the exact structure, size, shape, position, or relative positioning of operating components of the device(s).

The device of the embodiment illustrated in FIG. 7 comprises a primary pressure modulating system and a temperature modulating system.

The primary pressure modulating system comprises a first primary container (702) comprising a movable component (704) positioned in the primary container (702). The first primary container (702) comprises a first, primary pressure chamber (706) and a second, secondary pressure chamber (708). The primary and secondary pressure chambers (706 and 708) are separated by the movable component (704).

The temperature modulating system comprises a heat exchange system (HES) and an energy transfer liquid. The HES comprises a first heat exchange chamber (HEC1) (710) and a second heat exchange chamber (HEC2) (712). Each of the first and second heat exchange chambers (710 and 712) comprise a heat exchange material, (714) and (716) respectively. Pumps (718) and (720) distribute liquid from HEC1 (710) and HEC2 (712) respectively from the heat exchange chambers into the primary pressure chamber (706) in primary container (710) of the primary pressure modulating system.

An exemplary description of an operating cycle of a device of such an embodiment is as follows. Pressurized gas (PG) is held in primary pressure chamber (706). To start, as shown in FIG. 7, the PG is at a relatively cool temperature and is at relatively low pressure (“cool PG”), and accordingly, movable component (704) is shown positioned to the far left of its stroke length. To start, liquid capture component (LCC) (722) is closed. HEC1 (710) is a “hot” heat exchange chamber. To start, a first volume of energy transfer liquid is present in HEC1 (710). HEC2 (712) is a “cold” heat exchange chamber. To start, a second volume of energy transfer liquid is present in HEC2 (712). Energy transfer liquid is pumped from HEC1 (710) by pump (718) through energy transfer liquid conducting system lines (724 and 728). Energy transfer liquid is dispensed through dispensing component (730) into the primary pressure chamber (706) within the primary container (702) of the primary pressure modulating system. The energy transfer liquid displaces the pressurized gas in primary pressure chamber (706). The displaced pressurized gas exits primary pressure chamber (706) via pressurized gas inlet/outlet (732). The displaced pressurized gas travels through the 2-way pressurized gas conducting system lines (734 and 736), entering the first heat exchange chamber (HEC1) (710) via pressurized gas inlet/outlet (738). The pressurized gas is then warmed by exposure to first heat exchange material (714) in HEC1 (710) forming a “warm PG”. The heating of the pressurized gas increases the pressure of the pressurized gas.

LCC (722) is opened, and energy transfer fluid is allowed to exit the primary pressure chamber (706), followed by closing of the LCC (722). Upon its exit, the increased pressure of the warm PG is transferred back through the 2-way pressurized gas conducting system lines (734 and 736), such that the pressure in the primary pressure chamber (706) is increased. The increase in pressure in the primary pressure chamber (706) causes movement of the movable component (704) to the right. Upon the exit of the energy transfer fluid from primary pressure chamber (706) via LCC (722), the energy transfer fluid is directed via valve (740) through energy transfer fluid lines (742 and 744) into HEC1 (710).

The energy transfer liquid held in HEC2 (712) is pumped by pump (720) through energy transfer liquid conducting system lines (746 and 728). Energy transfer liquid is dispensed through dispensing component (730) into the primary pressure chamber (706) within the primary container (702) of the primary pressure modulating system. The energy transfer liquid displaces the warm PG in primary pressure chamber (706). The displaced pressurized gas exits primary pressure chamber (706) via pressurized gas inlet/outlet (732). The displaced pressurized gas travels through the 2-way pressurized gas conducting system lines (734 and 748), entering the second heat exchange chamber (HEC2) (712) via pressurized gas inlet/outlet (750). The pressurized gas is then cooled by exposure to second heat exchange material (716) in HEC2 (712) (forming a “cool PG”). The cooling of the pressurized gas decreases the pressure of the pressurized gas.

LCC (722) is opened, and energy transfer fluid is allowed to exit the primary pressure chamber (706), followed by closing of the LCC (722). Upon its exit, the decreased pressure of the cool PG is transferred back through the 2-way pressurized gas conducting system lines (734 and 748), such that the pressure in the primary pressure chamber (706) is decreased. The decrease in pressure in the primary pressure chamber (706) causes movement of the movable component (704) to the left. Upon the exit of the energy transfer fluid from primary pressure chamber (706) via LCC (722), the energy transfer fluid is directed via valve (752) through energy transfer fluid lines (742 and 754) into HEC1 (710).

The energy transfer liquid held in HEC1 (710) is pumped by pump (718) through energy transfer liquid conducting system lines (724 and 728). Energy transfer liquid is dispensed through dispensing component (730) into the primary pressure chamber (706) within the primary container (702) of the primary pressure modulating system. The energy transfer liquid displaces the cool PG in primary pressure chamber (706). The displaced pressurized gas exits primary pressure chamber (706) via pressurized gas inlet/outlet (732). The displaced pressurized gas travels through the 2-way pressurized gas conducting system lines (734 and 736), entering the first heat exchange chamber (HEC1) (710) via pressurized gas inlet/outlet (738). The pressurized gas is then warmed by exposure to second heat exchange material (714) in HEC1 (710) (forming a “warm PG”). The warming of the pressurized gas increases the pressure of the pressurized gas.

FIG. 8, FIG. 9, FIG. 10, and FIG. 11 are each separately referred to and described within the Detailed Description provided herein (above).

### EXAMPLES

### Example 1

### Testing of a Manifold Dispenser Device Comprising Co-Axially Aligned, Multi-Directional Outlets in a Device Comprising a Vacuum Powered Counter Pressure System

The following is a prophetic example that illustrates expected operation of a device according to certain aspects of the invention.

An experiment can be conducted using a set of multi-directional, multi-dispenser outlet (e.g., manifold) dispensation components positioned within a first container, a sealed cylindrical housing, the housing having a barrier defining the cylindrical shape and a chamber within. The housing and/or closure components of the housing may incorporate one or more visual aid components to facilitate viewing inside of the chamber. The housing will comprise at least one gas fill valve, accessing a chamber of PG. The housing will also comprise at least one, likely two SLIPBOs (slots) through which a PM (e.g., a safety component) attached to a PGC-MC will be allowed to extend.

A PGC-MC in the form of a piston will be positioned within the chamber, defining one end of the chamber comprising PG (PG chamber). A PM (safety component in the form of a pin) will extend from the PGC-MC and through the SLIPBO (slot(s)) in the housing. This will aid in observing movement of the PGC-MC. The dispensation outlets will be those exemplified in FIGS. 4A-4D. The housing will be sealed on the opposite end of the chamber from the PGC-MC with an end cap; however, this housing cap will be provided with an access port allowing for the dispensation components to be connected to the source(s) of temperature modification fluid. The temperature modification fluid is expected to be WD-40 or a fluid having substantially similar characteristics DEH. Multiple temperature modification fluids may be tested under the same experimental conditions.

A vacuum powered counter pressure system equivalent to that described in FIG. 6A will be present in the tested device. The PGC-MC described above will have a connecting element, e.g., a piston rod that connects to a VPCPS-MC-UC. A second container and a third container, each comprising a VPCPS-MC as described in FIG. 6A, will be present with each VPCPS-MC comprising a connecting element which also connect to the VPCPS-MC-UC such that movement of the PGC-MC causes movement of the VPCPS-MCs. The ratio of the diameter of PGC-MC to the diameter of the VPCPS-MCs will be such that the distance moved upon suitable condition (e.g., suitable pressure changes within the device/system) by the PGC-MC and the VPCPS-MCs is the same, as they will be operationally connected by a VPCPS-MC-UC. A vacuum will be established in the second and third containers on one side of each VPCPS-MC therein such that pressure changes on one side of the PGC-MC (the side facing the pressurized gas in the first container) is countered by the pressure of the vacuums in the second and third containers. The space on the second side of the VPCPS-MCs, opposite the vacuum, will be exposed to atmospheric pressure.

Using the gas fill valve, the PG chamber in the first container on the first side of the PGC-MC will be filled with a gas (e.g., likely nitrogen gas) and is expected to be pressurized to approximately 2000 psi (such as about 2000 psi+/−10%. Multiple gases may be tested under the same experimental conditions. Multiple pressures may be tested under the same experimental conditions. Pressure gauges and/or sensors accessing this chamber and the vacuum chambers of containers 2 and 3 of the VPCPS can be positioned to monitor the pressure in the chambers. The source of temperature modification liquid will also be pressurized to the approximate pressure of the pressurized gas, e.g., approximately 2000 psi, so that it will be substantially the same as the pressurized gas to create an essentially pressure balanced, substantially pressure balanced, or pressure balanced system. In the ready for operation state, the working piston can be positioned such that a PM attached thereto is positioned effectively in the center of the SLIPBO through which it extends; that is, the working piston can be positioned in the middle of its available stroke length. The VPCPS-MCs can be positioned in the middle of their available respective stroke lengths, with a vacuum on one side of each that is essentially pressure balanced, substantially pressure balanced, or pressure balanced with that of the PG chamber.

The temperature of the of the first temperature modification liquid (TL1) at the start of the experiment can be approximately 338 K, the temperature of the second temperature modification liquid (TL2) at the start of the experiment can be approximately 300 K, and the temperature of the nitrogen at the start of the experiment can be approximate 300K, thus, e.g., the temperature differential between the two liquids TL1 and TL2 is expected to be between approximately 30-40 K, e.g., about 35-40 K. Multiple temperatures of temperature modification fluids may be tested under the same experimental conditions.

At the start of the experiment, the system will be closed and essentially pressure balanced, substantially pressure balanced, or pressure balanced. Using a pump, e.g., a rotary pump, a first portion of temperature modification liquid (e.g., a “hot liquid”) will be pumped from the TL1 liquid source (having a temperature of, e.g., approximately 338 K) into one dispensation component and out of the plurality of multi-directional dispensation outlets (nozzles). Almost immediately, that is, as observed visually, as soon as the liquid is pumped into and exposed to the nitrogen gas, the pressure in the chamber in which the liquid is dispensed will increase due to the heating of the gas by TL1 and resulting in expansion of the PG. The safety component (PM) is expected to be observed to immediately move toward the end of the slot away from the end of the housing comprising the dispensation components. The VPCPS-MCs are also expected to be observed to move along with the PGC-MC, to a point where the new pressure within the PG chamber again equals the pressure of the vacuum in the vacuum chambers of containers 2 and 3.

Upon substantial completion of a stroke length of the PGC-MC, a second portion of TML (a “cold liquid”; TL2) will be pumped from the TL2 liquid source (having a temperature of approximately 300 K) into the second dispensation component and out of the plurality of multi-directional dispensation outlets of the second DC. Almost immediately, that is, as observed visually, as soon as the liquid is pumped into and exposed to the nitrogen gas, the pressure in the chamber in which the liquid is dispensed is expected to decrease due to the cooling of the gas. As a result, the pressure differential between the PG chamber and the vacuum chambers of containers 2 and 3 will be different resulting in an expected almost immediate observation of the safety component (PM) of the PGC-MC moving back toward the end of the SLIPBO (slot) toward the end of the housing comprising the dispensation components. Movement of the VPCPS-MCs is expected as well, with the VPCPS-MCs moving back across their stroke length to a position wherein, again, the pressure in the PG chamber matches that of the vacuum chambers of containers 2 and 3.

This experiment is expected to successfully demonstrate that use of such multi-directional, multi-outlet liquid dispensation components can cause a fast and effective temperature change in a pressurized gas, which can be effectively countered by the presence of a vacuum-powered counter pressure system which together can facilitate improved operating efficiency and total work performed of such low temperature differential devices. It is expected that the system(s) of this experiment will produce at least between 200-1000 pounds (lbs.) (about 91-about 454 kg) of force, likely closer to between about 400-about 800 lbs. (about 181-about 363 kg) of force, e.g., about 600 lbs. (272 kg) of force, or even more, such as >1000 lbs. (454 kg) of force. It is expected that this experiment will produce at least about 1.5 times, ˜1.6 times, ˜1.7 times, ˜1.8 times, ˜1.9 times, or even ˜2 times the amount of work as a similar experiment conducted using a device comprising a dual-pressurized gas chamber as opposed to a VPCPS, such as those devices described in FIGS. 1 and 2 herein.

### EXEMPLARY ASPECTS OF THE INVENTION

The following is a non-limiting list of aspects of the invention, which are presented as a list of paragraphs. Similar to patent claims, aspects described in the paragraphs of this section may make reference to (depend on/from) one or more other paragraphs. Readers will understand that such references mean that the features/characteristics or steps of such referenced aspects are incorporated into/combined with the referring aspect. E.g., if the aspect of paragraph 501 refers to the aspect of paragraph 500, it will be understood that both the elements, steps, or characteristics of paragraph 500 and paragraph 501 are described in paragraph 501.

In aspects, the invention provides a device for transforming temperature differences into work comprising (1) a primary pressure modulating system comprising (a) a first container, (b) a first movable component positioned in the first container, (c) a pressurized gas contained in the first container, and (d) a temperature modulating system comprising (i) a liquid having a first portion and a second portion each having a different temperature, and (ii) a dispensation system that in operation alternately dispenses the first portion liquid and second portion liquid to create temperature differences in the first container that cause the movable component to repeatedly move back and forth across a stroke length; and (2) a vacuum powered counter pressure system comprising (a) a second container, (b) a second movable component, the movement of the second moveable component being operationally linked to the movement of the first movable component, and (c) a vacuum component that in operation applies a vacuum to one end of the second movable component.

In aspects, the invention provides the device of paragraph [0476], wherein the alternating dispensing of the first portion liquid and second portion liquid creates pressure differences in the first container causing the first movable component to repeatedly move back and forth across the stroke length.

In aspects, the invention provides the device of paragraph [0477], wherein movement of the first movable component results in movement of the second movable component.

In aspects, the invention provides the device of any one or more of paragraphs [0476]-[0478], wherein the dispensation system alternatingly dispenses first and second portions of liquid on a single side of the first movable component, into a single volume of pressurized gas.

In aspects, the invention provides the device of any one or more of paragraphs [0476]-[0479], wherein the vacuum powered counter pressure system provides a counter pressure participating in causing the movement of the first movable component back and forth across the stroke length.

In aspects, the invention provides the device of any one or more of paragraphs [0476]-[0480], wherein the vacuum powered counter pressure system further comprises a third container and a third movable component.

In aspects, the invention provides the device of paragraph [0481], wherein the third movable component is operationally linked to the movement of the first movable component and the second movable component.

In aspects, the invention provides the device of any one or both of paragraphs [0481] and [0482], wherein in operation the vacuum component applies a vacuum to one end of the third movable component.

In aspects, the invention provides the device of any one or more of paragraphs [0476]-[0483], wherein the first container is at least substantially impervious to unintentional fluid (e.g., liquid) loss.

In aspects, the invention provides the device of any one or more of paragraphs [0476]-[0484], wherein the second container of the vacuum-powered counter pressure system is at least substantially impervious to unintentional loss of vacuum pressure.

In aspects, the invention provides the device of any one or more of paragraphs [0476]-[0485], wherein the device operates as an at least substantially closed system with respect to the gas and the liquid.

In aspects, the invention provides the device of paragraph [0486], wherein the device operates as an at least substantially closed system with respect to the gas, the liquid, and the vacuum.

In aspects, the invention provides the device of any one or more of paragraphs [0476]-[0487], wherein the first movable component has a diameter at least 10% smaller than the largest diameter of the first container.

In aspects, the invention provides the device of any one or more of paragraphs [0476]-[0488], wherein the first movable component has a diameter at least 10% smaller than the largest diameter of the second container.

In aspects, the invention provides the device of any one or more of paragraphs [0476]-[0489], wherein in operation, the first movable component moves a stroke length when acted on by a minimum force, the stroke length being smaller than one or more dimensions of the first container such that the movable component does not enter an internal void space within the first container.

In aspects, the invention provides the device of any one or more of paragraphs [0476]-[0490], wherein the dispensation system alternately dispenses the first portion liquid and second portion liquid in droplet form into a portion of the first container.

In aspects, the invention provides the device of any one or more of paragraphs [0476]-[0491], wherein the dispensation system alternately dispenses the first portion liquid and the second portion liquid in droplet form into a portion of the first container, and wherein when contact with a portion of liquid with the pressurized gas causes the pressure within the first container to increase, the first movable component is forced to move by and/or with the vacuum on the opposite side of the movable component, and when contact with a portion of liquid with the pressurized gas causes the pressure within the first container to decrease, the first movable component is forced to move away from and against the vacuum powered counter pressure system.

In aspects, the invention provides the device of any one or more of paragraphs [0476]-[0492], wherein the dispensation system comprises a plurality of dispensation components to dispense liquid into a single volume of the pressurized gas.

In aspects, the invention provides the device of any one or more of paragraphs [0476]-[0493], wherein the dispensation system comprises a plurality of conduits, each dispensing a portion of liquid.

In aspects, the invention provides the device of paragraph [0494], wherein each conduit comprises a plurality of dispensing outlets, such as between about 5 and about 300 dispensation outlets.

In aspects, the invention provides the device of any one or more of paragraphs [0493]-[0495], wherein the dispensation outlets of the dispensation components are oriented such that a minimum force is required to dispense liquid.

In aspects, the invention provides the device of any one or more of paragraphs [0493]-[0496], wherein the dispensation system dispenses liquid from dispensation outlets oriented concentrically within the first container, according to at least one orientation within the first container.

In aspects, the invention provides the device of any one or more of paragraphs [0493]-[0497], wherein the dispensation system dispenses liquid from dispensation outlets in two opposing directions.

In aspects, the invention provides the device of any one or more of paragraphs [0493]-[0496], wherein the dispensation system dispenses liquid from non-concentrically oriented dispensation outlets in two opposing directions.

In aspects, the invention provides the device of any one or both of paragraph [0498] or paragraph [0499], wherein the dispensation system dispenses liquid from the dispensation outlets in two opposing directions simultaneously.

In aspects, the invention provides the device of any one or more of paragraphs [0495]-[0500], wherein the liquid is dispensed through one or more dispensing outlets capable of forming a mist composed of droplets of the liquid having a volume median diameter (VMD) of between about 25 μm and about 150 μm.

In aspects, the invention provides the device of paragraph [0501], wherein the droplets of the liquid have a volume median diameter (VMD) of about 40-about 80 μm.

In aspects, the invention provides the device of any one or both of paragraph [0501] or paragraph [0502], wherein the droplets of the liquid have a DV0.9 value of about 70 μm.

In aspects, the invention provides the device of any one or more of paragraphs [0475]-[0503], wherein the dispensation system dispenses liquid in droplet form such that at least 80% of the pressurized gas within the first container is contacted with liquid in droplet form.

In aspects, the invention provides the device of paragraph [0504], wherein the dispensation system dispenses liquid in droplet form such that (i) at least 85% of the volume of the first container is filled with liquid in droplet form, (ii) at least 85% of the pressurized gas within the first container is contacted with liquid in droplet form, or (iii) both (i) and (ii).

In aspects, the invention provides the device of paragraph [0505], wherein the dispensation system dispenses liquid in droplet form such that (i) at least 90% of the volume of the first container is filled with liquid in droplet form, (ii) at least 90% of the pressurized gas within the first container is contacted with liquid in droplet form, or (iii) both (i) and (ii).

In aspects, the invention provides the device of paragraph [0506], wherein the dispensation system dispenses liquid in droplet form such that (i) at least 95% of the volume of the first container is filled with liquid in droplet form, (ii) at least 95% of the pressurized gas within the first container is contacted with liquid in droplet form, or (iii) both (i) and (ii).

In aspects, the invention provides the device of any one or more of paragraphs [0493]-[0507], wherein in at least two portions of the area of the first container comprising the pressurized gas, the area into which liquid dispensed by one dispensation outlet in one direction overlaps with the area into which liquid is dispensed by a second dispensation outlet in a second direction.

In aspects, the invention provides the device of any one or more of paragraphs [0476]-[0508], wherein in regular operation, the liquid is dispensed in sufficient volume, with a sufficient surface area, such that when a temperature difference of at least 3° C., at least 4° C., or at least 5° C. exists between the first and second portions of liquid, each actuation of a dispensing outlet causes the first movable component to move within about 0.25 seconds, within about 0.15 seconds, or within about 0.1 seconds of the liquid being dispensed.

In aspects, the invention provides the device of any one or more of paragraphs [0476]-[0509], wherein the first movable component is capable of completing at least about 250 strokes per minute when the device is in regular operation.

In aspects, the invention provides the device of paragraph [0510], wherein the first movable component is capable of completing at least about 500 strokes per minute in peak operation.

In aspects, the invention provides the device of paragraph [0511], wherein the first movable component is capable of completing at least about 1000 strokes per minute in peak operation.

In aspects, the invention provides the device of any one or more of paragraphs [0476]-[0512], wherein the device further comprises a fluid switch which in operation alternates the dispensing of the first portion liquid and the second portion liquid.

In aspects, the invention provides the device of paragraph [0513], wherein the movement of the movable component triggers the operation of the fluid switch, either directly or indirectly, such that sufficient movement of the first movable component causes the fluid switch to alternatingly dispense liquid from the first portion and second portion to the dispensing system.

In aspects, the invention provides the device of any one or more of paragraphs [0476]-[0514], wherein in operation the pressure of the gas and the pressure of the liquid are such that (i) dispensing the liquid takes up no more than 33% of the work produced by the movement of any movable component, (ii) the pressure of the liquid and the gas before regular operation vary by no more than 5%, or (iii) both (i) and (ii).

In aspects, the invention provides the device of any one or more of paragraphs [0476]-[0515], wherein the device comprises a converter that converts the movement of any movable component into energy, useful work, or both.

In aspects, the invention provides the device of any one or more of paragraphs [0476]-[0516], wherein the liquid comprises one or more liquids that have (i) a viscosity of between about 0.75 to about 3.5 centipoise at temperatures between 295-315 degrees Kelvin and atmospheric pressure; (ii) a specific heat of between about 1.6 kJ/(kg K) to about 4.4 kJ/(kg K); (iii) a surface tension of between about 20 to about 75 dynes/cm; a freezing point of between approximately 210 K to about 275 K; or (iv) a combination of any or all of (i)-(iii).

In aspects, the invention provides the device of paragraph [0517], wherein the liquid has a viscosity of between about 0.75 to about 3.5 centipoise at 295-315 degrees Kelvin and atmospheric pressure.

In aspects, the invention provides the device of any one or both of paragraph [0517] or paragraph [0518], wherein the liquid has a specific heat of about 1.6 kJ/(kg K) to about 4.4 kJ/(kg K).

In aspects, the invention provides the device of any one or more of paragraphs [0517]-[0519], wherein the liquid has a surface tension of between about 20 to about 40 dynes/cm.

In aspects, the invention provides the device of any one or more of paragraphs [0517]-[0520], wherein the liquid has a freezing point of approximately 210 K-about 275 K.

In aspects, the invention provides the device of any one or more of paragraphs [0517]-[0521], wherein the liquid is at least primarily a liquid selected from the group comprising water, turpentine, kerosene, or WD-40® or its equivalent.

In aspects, the invention provides the device of any one or more of paragraphs [0517]-[0522], wherein the liquid is a liquid that is non-corrosive to any material making up a device wall/barrier or contact surface.

In aspects, the invention provides the device of any one or more of paragraphs [0517]-[0523], wherein the liquid at least generally consists of turpentine, kerosene, or WD-40® or its equivalent.

In aspects, the invention provides the device of any one or more of paragraphs [0476]-[0524], wherein the pressure in the device in operation is between about 12 and about 720 atmospheres (between about 175-about 10600 psi).

In aspects, the invention provides the device of any one or more of paragraphs [0476]-[0525], wherein the gas is an inert gas and the specific heat of the gas (Cp, Cv, or both) is greater than air.

In aspects, the invention provides the device of paragraph [0526], wherein the gas is nitrogen.

In aspects, the invention provides the device of any one or more of paragraphs [0476]-[0527], wherein the vacuum pressure in the device in operation is at least equivalent to the greatest pressure created in a pressurized gas chamber.

In aspects, the invention provides the device of any one or more of paragraphs [0476]-[0528], wherein the pressure of the gas is sufficiently high so as to cause any heating or cooling of the gas caused by a barrier of the first container to be less than about 1% of the average gas temperature in the first container at any given time during regular operation.

In aspects, the invention provides the device of any one or more of paragraphs [0476]-[0529], wherein about 40% or less of the energy generated by the device is used in dispersing liquid, pumping liquid, or both.

In aspects, the invention provides the device of paragraph [0530], wherein less than about 30% of the energy generated by the device is used in dispersing liquid, pumping liquid, or both.

In aspects, the invention provides the device of any one or more of paragraphs [0476]-[0531], wherein (a) the device is re-pressurized, on average, after initial start-up no more than once every two years; (b) the vacuum of the vacuum powered counter pressure system is reestablished, on average, after initial start-up no more than once every year; (c) the device is re-pressurized, and/or the vacuum of the vacuum powered counter pressure system is reestablished, no more than the earlier of (i) the lifetime of the first expiring system seal (e.g., about 2 years), or (ii) a point in time wherein the system loses at least 5% of its pressure and/or vacuum pressure when the system is in continual operation, or (d) any two or more of (a)-(c) are true.

In aspects, the invention provides the device of any one or more of paragraphs [0476]-[0532], wherein the device comprises an operation component that allows the device to be selectively operable.

In aspects, the invention provides the device of any one or more of paragraphs [0476]-[0533], wherein at least a portion of the first container comprises the temperature modulating system and such a portion lacks any component, separate from the temperature modulating system, that causes a temperature change in the container such that the temperature of the container changes the temperature of the pressurized gas by more than 10% in regular operation.

In aspects, the invention provides the device of any one or more of paragraphs [0513]-[0534], wherein the fluid switch comprises one or more valves which alternate the dispensation of liquid at the first temperature and liquid at the second temperature.

The device of paragraph [0535], wherein the fluid switch operates automatically during regular operation.

In aspects, the invention provides the device of any of paragraphs [0475]-[0536], wherein the device comprises at least 1 connection element for connecting the device to a liquid conducting system comprising at least 2 temperature inputs that are each exposed to different temperatures creating the first portion liquid and the second portion liquid.

In aspects, the invention provides the device of any one or more of paragraphs [0516]-[0537], wherein the converter comprises an electricity generating device.

In aspects, the invention provides the device of any one or more of paragraphs [0476]-[0538], wherein ≥˜30% of dispensed liquid does not contact the contact surface of the first movable component.

In aspects, the invention provides the device of paragraph [0539], wherein ≥80% of the dispensed liquid does not contact the contact surface of the first movable component.

In aspects, the invention provides the device of any one or more of paragraphs [0476]-[0540], wherein a) the relationship between the surface area of the contact surface of the movable component and i) a surface area of a movable component of the vacuum powered counter pressure system, or ii) the volume of the vacuum container(s), or iii) both is such that if one increases, the other must be increased as well to maintain optimal functionality of the device system; b) the ratio between the diameter of the working movable component and the diameter(s) of the movable components of the vacuum powered counter pressure system is between about 1:2-1:10; or at least one aspect of (a) and aspect (b) are true.

In aspects, the invention provides the device of any one or more of paragraphs [0476]-[0541], wherein given any set temperature difference, the smaller the diameter of the first working component, the shorter the stroke length of the first working component.

In aspects, the invention provides the device of any one or more of paragraphs [0476]-[0542], wherein the smaller the diameter of the first working component, the smaller the diameter requirement of the second working component for any given temperature difference and any given stroke length; the smaller the total volume of the vacuum container(s); or both.

In aspects, the invention provides the device of any one or more of paragraphs [0476]-[0543], wherein the device comprises ≥1 pump(s) that can selectively drive dispensation of liquid into the first container.

In aspects, the invention provides the device of paragraph [0544], wherein the one or more pumps comprise one or more rotary pumps.

In aspects, the invention provides the device of any one or both of paragraph [0544] or paragraph [0545], wherein the energy to operate the one or more pumps is at least about 75-100% on average generated by the operation of the device.

In aspects, the invention provides the device of any one or more of paragraphs [0476]-[0546], wherein the device comprises one or more temperature sensors that detect the temperature differential in one or more parts of the device and a controller that receives inputs from the one or more temperature sensors and that controls the operation of the one or more pumps based upon such inputs.

In aspects, the invention provides the device of paragraph [0547], wherein the one or more temperature sensors comprise one or more thermocouples.

In aspects, the invention provides the device of any one or more of paragraphs [0476]-[0548], wherein the device is configured such that, in operation, there is a detectable gap in time (dispensation gap) between completion of dispensation of the first portion liquid (first temperature modification liquid) and the start of dispensation of the second portion liquid (second temperature modification liquid) during generally all or all strokes of the first movable component during regular operation.

In aspects, the invention provides the device of paragraph [0549], wherein the dispensation gap is created by operation of a dispensation-gap-generating mechanical component.

In aspects, the invention provides the device of paragraph [0549], wherein the dispensation gap is determined by a computer algorithm based on data received from one or more sensors or based on internally calculated parameters such as, for example, parameters based in time calculations and optionally comprises a period of time between the completion of a stroke length by the first movable component and dispensation of a temperature modification liquid.

In aspects, the invention provides the device of any one or more of paragraphs [0476]-[0551], wherein the device comprises a system that (a) automatically stops pumping liquid to the dispensing system when the temperature difference between the first portion and second portion falls below a predetermined threshold, and (b) automatically begins pumping liquid to the dispensing system when the temperature difference between the first portion and second portion exceeds a predetermined threshold.

In aspects, the invention provides the device of any one or more of paragraphs [0476]-[0552], wherein at least one movable component comprises a safety component which limits the maximum stroke length of the movable component and prevents the movable component from traveling beyond any pre-defined maximum stroke length of the movable component.

The device of paragraph [0553], wherein any movable component present within the device comprises a safety component which limits the maximum stroke length of the movable component and prevents the movable component from traveling beyond any pre-defined maximum stroke length of the movable component.

In aspects, the invention provides the device of any one or both of paragraph [0553] or paragraph [0554], wherein the first movable component comprises a safety component adapted to connect the movable component to a system component located outside of the first container.

In aspects, the invention provides the device of paragraph [0555], wherein the system located outside of the first container is a component of a) the vacuum powered counter pressure system; b) an energy production system; or c) both.

In aspects, the invention provides the device of any one or more of paragraphs [0553]-[0556], wherein at least one safety component is comprised of a material which is non-water corrosive and is made of a material comprising at yield strength of at least about 60,000 psi, a tensile strength of at least about 75,000 psi, or both a yield strength of at least about 60,000 psi and a tensile strength of at least about 75,000 psi.

In aspects, the invention provides the device of any one or more of paragraphs [0476]-[0557], wherein the device lacks an active cooling system, other than the liquid, such that any cooling that occurs within the system takes place only by the dispensing of the liquid.

In aspects, the invention provides the device of any one or more of paragraphs [0476]-[0558], wherein the device produces at least three times the amount of energy it consumes in operation when the temperature of the pressurized gas modified by the temperature modulation system is changed by at least 10° C. upon each alternating dispensation of liquid from a first portion having a first temperature and a second portion having a second temperature.

In aspects, the invention provides the device of paragraph [0559], wherein the device produces at least 50 times the amount of energy it consumes in operation when the temperature of the pressurized gas modified by the temperature modulation system is changed by at least 10 degrees ° C. upon each alternating dispensation of liquid from a first portion having a first temperature and a second portion having a second temperature.

In aspects, the invention provides the device of paragraph [0560], wherein the device produces at least 100 times the amount of energy it consumes in operation when the temperature of the pressurized gas modified by the temperature modulation system is changed by at least 10° C. upon each alternating dispensation of liquid from a first portion having a first temperature and a second portion having a second temperature.

In aspects, the invention provides the device of any one or more of paragraphs [0476]-[0561], wherein the housing is stationary in operation.

A selectively openable, extended operation system for transforming temperature differences into work comprising (a) a device according to any one or more of paragraphs [0476]-[0562], (b) one or more secondary components separate from the device of (a) comprising a liquid conducting system capable of holding and conducting a liquid comprising (i) a first portion in contact with a first temperature input, and (ii) a second portion in contact with a second temperature input, and (c) at least one connection element capable of connecting one or more secondary components of (b) to a connection element of the device of (a).

In aspects, the invention provides the system of paragraph [0563], wherein the 1 or more secondary components of the system comprises a power-generating device that receives energy from the device & uses received energy to generate electricity.

In aspects, the invention provides the system of any one or both of paragraph [0563] or paragraph [0564], wherein the system is capable of receiving & relaying electricity generated by the device, & optionally comprises a secondary component that generates electricity from the device's work.

In aspects, the invention provides the system of any one or more of paragraphs [0563]-[0565], wherein the system comprises (a) an automated control unit; (b) at least one automated control; (c) at least one data processor, or (d) a combination of any or all thereof, such that at least one component, action, function, process, or result of the system or system operation can be monitored; at least one component, action, function, or process of the system can be controlled without human intervention; any collection of collected data resulting from monitoring any at least two or more of a component, action, function, process, or result from the system or system operation can be processed into monitorable, actionable, or monitorable or actionable data; or any combination thereof.

In aspects, the invention provides the system of any one or more of paragraphs [0563]-[0566], wherein the movable component of the device is coupled with a power-generating system, such that the operation of the device generates electrical energy.

In aspects, the invention provides the system of any one or more of paragraphs [0563]-[0567], wherein the system comprises a switch for changing the connection between the dispensers of the device and the liquid conducting system, such that a component of the device receiving the first portion of the liquid from the liquid conducting system is switched to receiving the second portion of the liquid from the liquid conducting system and a component of the device receiving the second portion of the liquid from the liquid conducting system is switched to receiving the first portion of the liquid from the liquid conducting system.

In aspects, the invention provides the system of paragraph [0568], wherein the switch is a valve located between the liquid conducting system and the device.

In aspects, the invention provides the system of any one or both of paragraph [0568] or paragraph [0569], wherein the switch allows the system to be operable when the relative temperatures of the first and second portions input reverse such that the first warmer of the two portions becomes the cooler of the two portions and the first cooler of the two becomes the warmer of the two portions.

In aspects, the invention provides the system of any one or more of paragraphs [0563]-[0570], wherein the system has an energy production capacity of at least 20 kW.

In aspects, the invention provides the system of any one or more of paragraphs [0563]-[0571], wherein the average energy output of the system is at least 15 kWh.

In aspects, the invention provides the system of any one or both of paragraph [0571] or paragraph [0572], wherein the system is able to generate the average energy output whenever there is a temperature differential of about 5° C. or more between the first temperature input in contact with the first portion of liquid of the liquid conducting system and the second temperature input in contact with the second portion of liquid of the liquid conducting system, or between the liquid dispensed from the one or more dispensers of the device in alternating fashion.

In aspects, the invention provides the system of paragraph [0573], wherein the system is able to generate the average energy output whenever there is a temperature differential of about 1 degree C. or more between the first temperature input in contact with the first portion of liquid of the liquid conducting system and the second temperature input in contact with the second portion of liquid of the liquid conducting system, or between the liquid dispensed from the one or more dispensers of the primary device in alternating fashion.

In aspects, the invention provides the system of any one or more of paragraphs [0563]-[0574], wherein less than 10% of the energy generated by the system is used in dispersing the liquid.

In aspects, the invention provides the system of any one or more of paragraphs [0563]-[0575], wherein the system is re-pressurized, or the vacuum is re-established, no more than once per month on average during operation.

In aspects, the invention provides the system of any one or more of paragraphs [0563]-[0576], wherein the difference in temperature between the first portion and second portion of the liquid in the liquid conducting system arises by exposing the first portion to the first temperature input and exposing the second portion to the second temperature input, wherein either or both of the first and second temperature inputs are an environmental condition or waste stream.

In aspects, the invention provides the system of paragraph [0577], wherein the system is on average operable at least 70% of each day.

In aspects, the invention provides the system of any one or more of paragraphs [0563]-[0578], wherein the difference in temperature between the first portion and second portion arises due to at least one of the first portion or second portion being exposed to a temperature input which is a waste heat stream.

In aspects, the invention provides the system of any one or more of paragraphs [0563]-[0579], wherein the system is capable of being connected with one or more additional systems having the characteristics described in aspects [0563]-[0579], or with one or more additional devices having the characteristics described in aspects [0475]-[0562], or to a power generating system unrelated to the systems described herein (for example a solar production system or a wind-power production system or a hybrid engine of a vehicle) so as to expand the total amount of power production.

An automated system for performing useful work comprising (a) a device according to any one or more of paragraphs [0547]-[0562], and (b) an operation control component comprising an electronic control unit which comprises (1) at least one data collection unit that stores and executes instructions to receive primary and secondary temperatures from one or more sensor(s) of the device that correspond to the first temperature and second temperature at preprogrammed measurement intervals during an operation cycle comprising periods of device operation and intervening periods and sharing collected data with at least one data processing device; (2) means for relaying temperature information data from the data collection unit; and (3) a processor unit comprising (i) at least one unit capable of receiving the data relayed from the data collection unit and (ii) means for storing and executing instructions for determining the relationships between the difference in the primary and secondary temperatures and an intermittent off period threshold, wherein the system automatically executes instructions for initiating operation of a dispensing component to reinitiate the system after conditions are such that the instructions indicate that system re-initiation should occur.

In aspects, the invention provides the system of paragraph [0581], wherein the processor executes instructions to (a) stop pumping liquid to a dispensing component when the temperature difference between the first portion and second portion falls below a predetermined threshold, and (b) to begin pumping liquid to a dispensing component when the temperature difference between the first portion and the second portion exceeds a predetermined threshold, based on its analysis of the data and the instructions.

In aspects, the invention provides the system of any one or both of paragraph [0607] or paragraph [0582], wherein the device comprises a fluid switch according to aspect [0513], the fluid switch being under control of the processor unit and the processor unit storing and executing instructions for operating the fluid switch.

In aspects, the invention provides the system of paragraph [0583], wherein the device comprises the features of paragraph [0581].

In aspects, the invention provides the system of any one or more of paragraphs [0581]-[0584], wherein the processor executes the algorithm of paragraph [0551] and controls operation of components of the device to establish a dispensation gap.

In aspects, the invention provides the system of any one or more of paragraphs [0581]-[0585], wherein the data collection unit(s) of the system are integral components of the sensor(s).

In aspects, the invention provides the system of any one or more of paragraphs [0581]-[0586], wherein the processor unit is located remotely from the device (either at a short distance or far distance away).

In aspects, the invention provides the system of any one or more of paragraphs [0581]-[0587], wherein the device comprises a pressure sensor, means for relaying pressure sensor information to the processor, and the processor comprises instructions for evaluating device pressure against a standard to determine if pressure problems exist in the device.

In aspects, the invention provides the system of any one or more of paragraphs [0581]-[0588], wherein the device comprises means for measuring movement of one or more moveable component(s), means for relaying the movement measurement data to the processor, and the processor comprises instructions for evaluating the movement information to the expected movement of the moveable component(s) based on the primary temperature and secondary temperature data.

In aspects, the invention provides the system of any one or more of paragraphs [0581]-[0589], wherein the processor comprises means for storing, retrieving, and further processing any of the data received in an operating cycle of the device.

In aspects, the invention provides the system of any one or more of paragraphs [0581]-[0590], wherein the system comprises a viewable user interface that allows a human operator to observe the status of one or more of the temperature, pressure, and movement monitored conditions of the device.

In aspects, the invention provides the system of paragraph [0591], where the user interface comprises an interactive interface component for receiving instructions from a user on changing one or more of the operating parameters of the device (e.g., amount of dispensed liquid, frequency of dispensed liquid, forced operation of pumps, dispensation gap(s), or combinations of any or all thereof).

A system for fabricating a low temperature differential energy device according to any one or more of paragraphs [0476]-[0588], comprising (a) entering a required work output for the device to be fabricated to a device design and fabrication processor comprising means for receiving inputs from a user and preprogrammed instructions for analyzing the inputs; (b) entering a series of inputs into the device design and fabrication processor comprising chamber length; anticipated first temperature; anticipated second temperature; anticipated first gas temperature generated by dispensing first temperature modified liquid into the chamber; anticipated second gas temperature generated by dispensing second temperature modified liquid into the chamber; anticipated chamber pressure; anticipated chamber diameter; and anticipated time between injections (anticipated dispensation gap); and directing the device design and fabrication processor to generate an estimated work output that the device is expected to produce based on the inputs; (c) entering constraints associated with the inputs; (d) directing the design and fabrication processor to adjust the variables associated with the inputs based on the constraints and ordering the modulation of variables based on either preprogrammed or inputted criteria to generate a device design anticipated to provide the required work output; and (e) causing the output of a design description, causing the fabrication, or both, of one or more components of the device based on the calculated variables.

A method of transforming a temperature differential into work comprising: (a) providing (i) a liquid held within a closed system, (ii) an enclosed movable component, and (iii) a first volume comprising pressurized gas held within the closed system maintained on a first side of a movable component such that the movable component partially defines a void space having a length that is at least 7.5% of the length of the first volume; (b) a vacuum-powered counter pressure system maintained on a second side of the movable component; (c) exposing one portion of the liquid within the closed system to a first condition having a first temperature and a second portion of the liquid within the closed system to a second condition having a second temperature to cause a first portion of the liquid to have a first temperature and a second portion of the liquid to have a second temperature; (d) establishing a closed system pressure before regular operation such that the pressure of the liquid having a first temperature and a second temperature is substantially the same as that of the pressurized gas; and (e) causing a first portion of the liquid and a second portion of the liquid to contact the pressurized gas in alternating fashion in sprayed droplet form creating a pressure differential on opposing sides of the movable component, and hence causing the movable component to move, wherein the system maintains operability if the first and second conditions change such that warmer of the two conditions becomes the colder of the two conditions and the colder of the two conditions becomes the warmer of the two conditions.

In aspects, the invention provides the method of paragraph [0594], wherein the method comprises use of at least one device according to any one or more of paragraphs [0476]-[0588].

In aspects, the invention provides the method of paragraph [0595], wherein the method can continually produce power when the temperature differential between the first condition and the second condition is as low as 10 degrees C.

In aspects, the invention provides the method of paragraph [0596], wherein the method can continually produce power when the temperature differential between the first condition and the second condition is as low as 5 degrees C.

In aspects, the invention provides the method of paragraph [0597], wherein the method can continually produce power when the temperature differential between the first condition and the second condition is as low as 1 degree C.

In aspects, the invention provides the method of any one or more of paragraphs [0594]-[0598], wherein the first condition and second condition are environmental conditions.

In aspects, the invention provides the method of paragraph [0599], wherein one of the 1^{st} & 2^{nd} conditions is a body of water and at least one of the 1^{st} & 2^{nd} conditions is air.

In aspects, the invention provides the method of any one or more of paragraphs [0594]-[0600], wherein at least one of the first and second conditions is a mechanical or industrial waste stream.

In aspects, the invention provides the method of paragraph [0601], wherein both the 1^{st} & 2nd conditions are waste streams.

In aspects, the invention provides the method of any of paragraphs [0594]-[0602], wherein a 1st portion of the liquid and a second portion of the liquid contact the volume of pressurized gas in alternating sequence on the same side of the MC, and wherein when contact with a portion of liquid causes an increase in pressure within the first volume comprising the pressurized gas, the movable component is forced to move against the vacuum on the opposite side of the MC, and when contact with a portion of liquid causes a decrease in pressure within the first volume comprising the pressurized gas, the movable component moves with or is forced to move by the vacuum pressure applied by the vacuum on the opposite side of the MC.

In aspects, the invention provides the method of any one or more of paragraphs [0594]-[0603], wherein the pressurization of the pressurized gas occurs upon system start up and wherein re-pressurization of the gas must occur no more than the earlier of a) the lifetime of the first expiring system seal (e.g., about 2 years), or b) a point in time wherein the system loses at least 5% of its pressure when the system is in continual operation.

In aspects, the invention provides the method of any one or more of paragraphs [0594]-[0604], wherein the establishment of the vacuum occurs upon system start up and wherein re-establishment of the vacuum must occur no more than the earlier of a) the lifetime of the first expiring system seal (e.g., about 2 years), or b) a point in time wherein the system loses at least 5% of its vacuum pressure when the system is in continual operation.

In aspects, the invention provides the method of any one or more of paragraphs [0594]-[0605], wherein the method further comprises exposing one portion of the liquid to the first volume of the pressurized gas upon failure of the movable component to move a minimum distance (minimum stroke length), failure of the method to produce a minimum amount of work, or both failure of the movable component to move a minimum distance and failure of the method to produce a minimum amount of work, such that the movable component is forced to move a minimum distance, the method resumes production of a minimum amount of work, or both the movable component is forced to move a minimum distance and the method resumes production of a minimum amount of work.

In aspects, the invention provides the method of paragraph [0606], wherein the exposure of one part of the liquid to at least a first volume of the pressurized gas takes place in an automated fashion, without human intervention, when minimum stroke length and power output parameters fail to be met.

In aspects, the invention provides the method of any one or more of paragraphs [0594]-[0607], wherein the method is capable of producing at least 20 kW of energy.

In aspects, the invention provides the method of any one or more of paragraphs [0594]-[0608], wherein the average energy output produced by the method is at least 7.5 kWh.

In aspects, the invention provides the method of any one or more of paragraphs [0594]-[0609], wherein the method is capable of continuously producing work when the temperature of the first and second conditions reverse, such that the once warmer of the two conditions becomes the cooler of the two conditions and the once cooler of the two conditions becomes the warmer of the two conditions.

In aspects, the invention provides the method of any one or more of paragraphs [0594]-[0610], wherein the liquid makes contact with the pressurized gas by being dispensed as a mist into the pressurized gas through one or more dispensers capable of converting the media from a fluid liquid into a liquid mist, the mist having a Volume Median Diameter (VMD) droplet size of between about 25 μm and about 150 μm.

In aspects, the invention provides the method of paragraph [0611], wherein the liquid is dispensed as a mist into the pressurized first gas through one or more dispensers capable of converting the liquid from a fluid liquid into a mist having a Volume Median Diameter (VMD) droplet size of between about 30 μm and about 90 μm.

In aspects, the invention provides the method of paragraph [0612], wherein the liquid is dispensed as a mist into the pressurized first gas through one or more dispensers capable of converting the liquid from a fluid liquid into a mist having Volume Median Diameter (VMD) droplet size of about 40 μm and about 80 μm.

In aspects, the invention provides the method of any of paragraphs [0611]-[0613], wherein the droplet size has a DV0.9 value of about 70 μm.

In aspects, the invention provides the method of any one or more of paragraph [0611]-[0614], wherein the droplets are dispensed in sufficient volume so as to affect a sufficient temperature change within the chamber to cause movement of the movable component in a direction opposite to the direction moved by the movable component after the previous mist dispensation.

In aspects, the invention provides the method of any one or more of paragraphs [0594]-[0615], wherein sufficient movement of the movable component in either a first or a second direction causes the dispensation of the liquid in the form of a mist into the pressurized gas, the movement of the movable component in a first direction causing dispensation of the liquid having a first temperature and the movement of the movable component in a second direction causing dispensation of the liquid having a second temperature.

In aspects, the invention provides the method of paragraph [0616], wherein sufficient movement of the movable component is at least 5% of the maximum distance it could travel when the system is producing at least its average amount of power output (maximum stroke length).

In aspects, the invention provides the method of any one or more of paragraphs [0594]-[0617], wherein dispensation of the liquid is actuated by a mechanism not mechanically linked to the movement of the movable component.

In aspects, the invention provides the method of any one or more of paragraphs [0594]-[0618], wherein the method does not comprise a step of displacing a pressurized gas, a step of using stored energy to sustain the method, or a step of actively cooling a component or system partaking in the method to maintain operability.

In aspects, the invention provides the method of any one or more of paragraphs [0594]-[0620], wherein the method comprises applying a pump, such as a rotary pump, to the system, to initiate, maintain, or enhance the spraying of the droplets of liquid into the gas or to conduct liquid through the liquid conducting system.

In aspects, the invention provides the method of paragraph [0620], wherein the method comprises monitoring the temperature difference between the first volume of pressurized gas and second volume of pressurized gas and automatically pumping liquid in response to pre-programmed conditions.

In aspects, the invention provides the method of any of paragraphs [0594]-[0621], wherein flow of gas within the closed system in regular operation is substantially in the same orientation.

In aspects, the invention provides the method of any of paragraphs [0594]-[0622], wherein the method comprises converting the movement of the movable component into electrical energy.

In aspects, the invention provides the method of any one or more of paragraphs [0594]-[0623], wherein the method comprises using any one or more of the devices described in aspects [0475]-[0553].

In aspects, the invention provides the method of any one or more of paragraphs [0594]-[0624], wherein the method comprises using any one or more of the systems described in aspects [0476]-[0562].

A device for transforming temperature differences into work comprising: (1) a primary pressure modulating system comprising a first, primary container, comprising, (a) a movable component (MC) positioned in the primary container that in operation moves a stroke length (SL) when acted on by a minimum force, and (b) a primary pressure chamber (primary chamber) and a second pressure chamber (secondary chamber) within the primary container separated from one another by the movable component (MC), wherein the primary chamber is configured to maintain both a pressurized gas (PG) and a liquid in alternating fashion; (2) a temperature modulating system comprising (a) a heat exchange system (HES) comprising (i) a first heat exchange chamber (HEC1) configured to maintain both the pressurized gas (PG) and the liquid in alternating fashion and comprising a first heat exchange material (HEM1), (ii) a second heat exchange chamber (HEC2) configured to maintain both the pressurized gas (PG) and a liquid in alternating fashion and comprising a second heat exchange material (HEM2), (b) an energy transfer liquid comprising a first portion accessible to both the primary chamber and the first heat exchange chamber (HEC1) and a second portion accessible to both the primary chamber and the second heat exchange chamber (HEC2); wherein, in operation, (3) the first and second portions of energy transfer liquid alternatingly displace the pressurized gas such that the pressurized gas is alternatingly exposed to the first and second heat exchange materials, (4) the first heat exchange material (HEM1) and the second heat exchange material (HEM2) maintain a temperature differential of at least 1 degree Celsius during at least 90% of a 24-hour operating period, (5) the alternating exposure of the pressurized gas to the first and second heat exchange materials alternatingly increases and decreases the temperature of the pressurized gas, and accordingly the pressure of the pressurized gas, such that the movable component of the primary pressure modulating system moves back and forth across a stroke length in response to the pressure change.

In aspects, the invention provides the device of paragraph [0626], wherein the device operates as an at least substantially closed system with respect to the pressurized gas and the energy transfer liquid.

In aspects, the invention provides the device of any one or both of paragraph [0626] or paragraph [0627], wherein the first heat exchange chamber is a heat increasing chamber, whereby the temperature of a unit of pressurized gas leaving the chamber is higher than the temperature of that same unit of pressurized gas when it entered the chamber during any single operation cycle.

In aspects, the invention provides the device of paragraph [0628], wherein the first heat exchange chamber is capable of changing the temperature of the pressurized gas held therein within 5 seconds of the gas entering the first heat exchange chamber.

In aspects, the invention provides the device of paragraph [0629], wherein the first heat exchange chamber is capable of changing the temperature of the pressurized gas held therein within 3 seconds of the gas entering the first heat exchange chamber.

In aspects, the invention provides the device of paragraph [0630], wherein the first heat exchange chamber is capable of changing the temperature of the pressurized gas held therein within 1 second of the gas entering the first heat exchange chamber.

In aspects, the invention provides the device of any one or more of paragraphs [0626]-[0631], wherein the second heat exchange chamber is a heat decreasing (e.g., cooling) chamber, whereby the temperature of a unit if pressurized gas leaving the chamber is lower than the temperature of that same unit of pressurized gas when it entered the chamber during any single operation cycle.

In aspects, the invention provides the device of paragraph [0632], wherein the second heat exchange chamber is capable of changing the temperature of the pressurized gas held therein within 5 seconds of the gas entering the second heat exchange chamber.

In aspects, the invention provides the device of paragraph [0633], wherein the second heat exchange chamber is capable of changing the temperature of the pressurized gas held therein within 3 seconds of the gas entering the second heat exchange chamber.

In aspects, the invention provides the device of paragraph [0634], wherein the second heat exchange chamber is capable of changing the temperature of the pressurized gas held therein within 1 second of the gas entering the second heat exchange chamber.

In aspects, the invention provides the device of any one or more of paragraphs [0626]-[0635], wherein the first and second heat exchange materials are the same material.

In aspects, the invention provides the device of any one or more of paragraphs [0626]-[0636], wherein the heat exchange material is characterizable as having a high surface area-to-volume ratio.

In aspects, the invention provides the device of any one or more of paragraphs [0626]-[0637], wherein the heat exchange material is a steel wool having a coarseness grade of 1 (medium) or less.

In aspects, the invention provides the device of any one or more of paragraphs [0626]-[0638], wherein the heat exchange material is a steel wool having a coarseness grade of 0 (medium fine) or less.

In aspects, the invention provides the device of any one or more of paragraphs [0626]-[0639], wherein the heat exchange material is a steel wool having a coarseness grade of 00 (fine) or less.

In aspects, the invention provides the device of any one or more of paragraphs [0626]-[0640], wherein the heat exchange material is a steel wool having a coarseness grade of 000 (extra fine) or less.

In aspects, the invention provides the device of any one or more of paragraphs [0626]-[0641], wherein the heat exchange material is a steel wool having a coarseness grade of 0000 (super fine) or less.

In aspects, the invention provides the device of any one or more of paragraphs [0626]-[0635], wherein the first and second heat exchange materials are different materials.

In aspects, the invention provides the device of paragraph [0643], wherein the first heat exchange material and the second heat exchange material differ from one another in their surface area-to-volume ratio, the amount of energy they can each absorb as heat from a given quantity of material, the amount of energy they release as heat when they are each at the same temperature, or any combination thereof.

In aspects, the invention provides the device of paragraph [0644], wherein at least one of the first heat exchange material and the second heat exchange material is a steel wool.

In aspects, the invention provides the device of any one or more of paragraphs [0626]-[0645], wherein each portion of energy transfer liquid is accessible to the primary chamber and a single heat exchange chamber.

In aspects, the invention provides the device of any one or more of paragraphs [0626]-[0646], wherein neither portion of the energy transfer liquid is used to establish the temperature of either the first or the second heat exchange material.

In aspects, the invention provides the device of paragraph [0647], wherein the temperature of the first heat exchange material is established by exposure of the first heat exchange chamber in which it resides to a first environmental source, and the temperature of the second heat exchange material is established by exposure of the second heat exchange chamber in which it resides being exposed to a second environmental source.

In aspects, the invention provides the device of paragraph [0648], wherein the environmental sources are each selected from a body of air, a body of water, or an environment resulting from a technological process (e.g., a waste stream).

In aspects, the invention provides the device of any one or more of paragraphs [0626]-[0649], wherein at least one portion of the energy transfer liquid is exposed to a naturally occurring environmental source which establishes the temperature of the at least one portion of energy transfer liquid.

In aspects, the invention provides the device of paragraph [0650], wherein both the first and second portions of energy transfer liquid are exposed to a first and a second environmental source, respectively, which each establish the temperature of each respective first and second portions of energy transfer liquid.

In aspects, the invention provides the device of any one of paragraph [0650] or [0651], wherein each portion of energy transfer liquid having a temperature established by exposure to an environmental source establishes the temperature of the heat exchange material to which it is exposed during normal operation.

In aspects, the invention provides the device of any one or both of paragraph [0651] or paragraph [0652], wherein each environmental source is selected from a body of air, a body of water, or an environment resulting from a technological process (e.g., a waste stream).

In aspects, the invention provides the device of any one or more of paragraphs [0626]-[0653], wherein the secondary chamber of the primary pressure modulating system is associated with a vacuum powered counter pressure system.

In aspects, the invention provides the device of paragraph [0654], wherein the vacuum powered counter pressure system comprises (a) a second container, (b) a second movable component, the movement of the second movable component being operationally linked to the movement of the first movable component, and (c) a vacuum component/function that in operation applies a vacuum to one end of the second movable component.

In aspects, the invention provides the device of any one or more of paragraphs [0626]-[0655], wherein the device does not comprise a dispensation component which dispenses liquid in the form of drops (e.g., does not comprise a dispensation component which dispenses liquid in the form of a mist).

In aspects, the invention provides the device of any one or more of paragraphs [0626]-[0656], wherein the first heat exchange material and the second heat exchange material maintain a temperature differential of at least about 1 degree Celsius during at least about 95% of a 24-hour operating period.

In aspects, the invention provides the device of paragraph [0657], wherein the first heat exchange material and the second heat exchange material maintain a temperature differential of at least about 1 degree Celsius during at least about 97% of a 24-hour operating period.

In aspects, the invention provides the device of paragraph [0658], wherein the first heat exchange material and the second heat exchange material maintain a temperature differential of at least about 1 degree Celsius during at least about 98% of a 24-hour operating period.

In aspects, the invention provides the device of paragraph [0659], wherein the first heat exchange material and the second heat exchange material maintain a temperature differential of at least about 1 degree Celsius during at least about 99% of a 24-hour operating period.

What is claimed is:

1. A method of converting a temperature differential into work comprising:
(a) providing a device comprising (I) a pressurized fluid, (II) a movable component that moves in alternating directions along a stroke length in response to force applied on the movable component, (III) a vacuum, and (IV) access to first and second temperature sources, the first and second temperature sources having sufficiently different temperatures to create a pressure difference that can move the movable component, wherein, upon initial operation of the device the movable component is contained in the pressurized fluid and the pressurized fluid and the vacuum remain at least substantially closed with respect to the outside environment,
(b) temporarily causing the pressurized fluid and first temperature source to be in contact, directly or indirectly, to increase temperature in the pressurized fluid, thereby applying a force to move the moveable component in a first direction;
(c) temporarily contacting the pressurized fluid, directly or indirectly, with the second temperature source, to decrease temperature in the pressurized fluid, the second side of the movable component being oriented at least substantially opposite of the first side of the moveable component, thereby applying a force to move the movable component in the second direction; and
(d) permitting the vacuum to apply a force on the second side of the movable component, thereby detectably promoting movement of the movable component in the second direction.

2. The method of claim 1, wherein the method comprises applying at least two separate vacuums.

3. The method of claim 2, wherein the pressurized gas is maintained at a pressure of between 175-10,600 psi during most periods of operation.

4. The method of claim 1, wherein the first and second temperature sources are each naturally occurring environmental conditions.

5. The method of claim 4, wherein one naturally occurring environmental condition is a body of air, one naturally occurring environmental condition is a body of water, or both.

6. The method of claim 5, wherein, at least once during a 24-hour period, the average temperature of the first and second temperature sources reverse such that a warmer of the two temperature sources becomes the cooler of the two temperature sources and a cooler of the two temperature sources becomes the warmer of the two temperature sources, and wherein the method maintains operation over the course of the 24-hour period without intervention.

7. The method of claim 6, wherein the first and the second temperature source each have an average temperature over a 24-hour period which differs from the other by at least 1-degree Celsius.

8. The method of claim 1, wherein at least one of the first and second temperature sources is a mechanical or industrial energy waste stream.

9. The method of claim 1, wherein an average of at least 7.5 kWh of energy is generated from the alternating movement of the movable component when there is an at least a 10-degree Celsius temperature differential between the first and second temperature sources.

10. The method of claim 9, wherein the method has an energy production capacity of at least 15 kW, an average energy output of at least 10 kWh, or both.

11. A device for transforming a temperature differential into work comprising
(a) a movable component having a first side and a second side, wherein the first and second sides are at least substantially opposite each other and wherein the movable component is configured to move back-and-forth along a path having a stroke length when acted on by a sufficient force;
(b) a pressurized fluid; and
(c) a vacuum, wherein the first side of the movable component is in communication with the pressurized fluid and the second side of the movable component is in communication with the vacuum;
(d) a first temperature source; and
(e) a second temperature source, wherein
the device is at least substantially closed with respect to the pressurized gas and the vacuum, and wherein, in operation (I) the alternating contact of the pressurized fluid to the first temperature source and the second temperature source results in the pressurized fluid causing the movable component to move in a first direction and at least substantially opposite second direction, respectively and (II) the first pressure, the second pressure, or both, are each detectably countered by the vacuum.

12. The device of claim 11, wherein the device comprises use of at least 2 vacuums.

13. The device of claim 11, wherein the pressurized gas is maintained at a pressure of between 175-10,600 psi during most periods of operation.

14. The device of claim 13, wherein the generates an average of at least 15 kWh of energy from the alternating movement of the movable component when there is at least a 10-degree Celsius temperature differential between the first temperature source and the second temperature source.

15. The device of claim 11, wherein a first and a second temperature source are each naturally occurring environmental conditions.

16. The device of claim 11, wherein one naturally occurring environmental condition is a body of air, one naturally occurring environmental condition is a body of water, or both.

17. The device of claim 16, wherein the first and the second temperature source each have an average temperature over a 24-hour period which differs from the other by at least 1-degree Celsius.

18. The device of claim 17, wherein, at least once during a 24-hour period, the average temperature of the first and second temperature sources reverse such that a warmer of the two temperature sources becomes the cooler of the two temperature sources and a cooler of the two temperature sources becomes the warmer of the two temperature sources, and wherein the device maintains operation over the course of the 24-hour period without intervention.

19. The device of claim 18, wherein the method has an energy production capacity of at least 15 kW, an average energy output of at least 10 kWh, or both.

20. The device of claim 11, wherein the pressurized fluid is a pressurized gas.
